(19) United States
(12) Patent Application Publication
(10) Pub. No.: US 2012/0239417 A1
(43) Pub. Date: Sep. 20, 2012

(54) HEALTHCARE WALLET PAYMENT PROCESSING APPARATUSES, METHODS AND SYSTEMS

(76) Inventors: Stacy S. Pourfallah, Oakland, CA (US); Renee Y. Lutzen, Omaha, NE (US)

(21) Appl. No.: 13/411,559

(22) Filed: Mar. 3, 2012

Related U.S. Application Data
(60) Provisional application No. 61/449,224, filed on Mar. 4, 2011.
(60) Provisional application No. 61/449,226, filed on Mar. 4, 2011.
(60) Provisional application No. 61/449,561, filed on Mar. 4, 2011.

(51) Int. Cl. G06Q 20/36; G06Q 20/10; G06Q 50/22

(52) U.S. Cl. 705/2

(57) ABSTRACT

The HEALTHCARE WALLET PAYMENT PROCESSING APPARATUSES, METHODS AND SYSTEMS (hereinafter “H-Wallet”) transforms patient insurance information, and healthcare procedure schedule information inputs via H-Wallet components into medical claim settlement outputs. In one embodiment, a method is disclosed, comprising: obtaining a user healthcare payment request including user credentials; retrieving healthcare product details and a payment amount from the user healthcare payment request; obtaining balance information of a list of user accounts; determining a recommended account for the obtained user healthcare payment request based on the retrieved healthcare product details, payment amount and the obtained balance information; transmitting a list of user account including the recommended account with the obtained balance information to the user mobile device; receiving a user selection of the recommended account; verifying payment eligibility of the recommended account for the obtained payment request; and processing fund transfer from the recommended account to a healthcare provider.

### PRIORITY CLAIM

Applicant hereby claims priority under 35 U.S.C. §119 to U.S. Application Ser. No. 61/449,224, entitled “Apparatuses, Methods And Systems For A Mobile Healthcare Payment Platform,” U.S. Application Ser. No. 61/449,226, entitled “Healthcare Incentive Program Apparatuses, Methods And Systems,” and U.S. Application Ser. No. 61/449,561, entitled “Universal Healthcare Payment Collection Apparatuses, Methods And Systems,” all filed on Mar. 4, 2011.

The aforementioned applications are hereby expressly incorporated by reference.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present innovations are directed generally to healthcare payment, and more particularly, to HEALTHCARE WALLET PAYMENT PROCESSING APPARATUSES, METHODS AND SYSTEMS.

### BACKGROUND

A flexible spending account (FSA) is a financial account which is set up by a user setting aside a portion of their income. For example, the FSA may be used for medical expenses, dependent care, and/or the like. A user needs to collect receipts of payments eligible for FSA reimbursement, and send the receipts to a FSA administer program. Upon verifying eligibility of the expenses, the FSA administer program may return the user payment amount to the user, by an authorized transfer of funds from the user's FSA account to the user.

### BRIEF DESCRIPTION OF THE DRAWINGS

The accompanying appendices and/or drawings illustrate various non-limiting, example, innovative aspects in accordance with the present descriptions:

FIGS. 1A-1C show a block diagram illustrating examples of H-Wallet;

FIGS. 2A-2B provide block diagrams illustrating data flows between H-Wallet and affiliated entities within various embodiments of the H-Wallet;

FIGS. 3A-3E provide block diagrams illustrating logic flows of H-Wallet payment within various embodiments of the H-Wallet;

FIGS. 4A-4B provide diagrams illustrating account enrollment within embodiments of the H-Wallet;

FIGS. 4C-4E provide diagrams illustrating payment recommendation within embodiments of the H-Wallet;

FIGS. 5A-5C provide diagrams illustrating example rules of healthcare payment within embodiments of the H-Wallet;

FIGS. 6A-6D provide data/logic flow diagrams illustrating healthcare incentive offering and redemption within embodiments of the H-Wallet;

FIGS. 7A-8B provide data/logic flow diagrams illustrating healthcare collection portal within embodiments of the H-Wallet;

FIG. 9A shows a data flow diagram illustrating an example social pay enrollment procedure in some embodiments of the H-Wallet;

FIG. 9B shows a logic flow diagram illustrating example aspects of social pay enrollment in some embodiments of the H-Wallet, e.g., a Healthcare Portal Enrollment (“HPE”) component;

FIGS. 10A-C show data flow diagrams illustrating an example social payment triggering procedure in some embodiments of the H-Wallet;

FIGS. 11A-C show logic flow diagrams illustrating example aspects of social payment triggering in some embodiments of the H-Wallet, e.g., a Healthcare Portal Payment Triggering (“HPT”) component;

FIGS. 12A-B show logic flow diagrams illustrating example aspects of implementing wallet security and settings in some embodiments of the H-Wallet, e.g., a wallet security and setting (“WSS”) component;

FIGS. 13A-13B provide example flows illustrating payment portal for user amount collection within embodiments of the H-Wallet;

FIGS. 14A-14D provide exemplary screens illustrating payment portal via a social media platform within embodiments of the H-Wallet;

FIG. 15 provides a combined data and logic flow illustrating doctor-patient portal bill collection within embodiment of the H-Wallet;

FIG. 16 provides a data flow diagram illustrating healthcare insurance adjudication within embodiments of the H-Wallet;

FIGS. 17A-17C provide logic flow diagrams illustrating healthcare insurance adjudication and post-payment reconciliation within embodiments of the H-Wallet;

FIGS. 18A-19B provide exemplary mobile user interfaces (UIs) illustrating healthcare mobile wallet within embodiments of the H-Wallet;

FIGS. 19C-19D provide exemplary screens illustrating healthcare social portal access control within embodiments of the H-Wallet;

FIGS. 20A-B show data flow diagrams illustrating an example purchase transaction authorization procedure in some embodiments of the H-Wallet;

FIGS. 21A-B show logic flow diagrams illustrating example aspects of purchase transaction authorization in some embodiments of the H-Wallet, e.g., a Purchase Transaction Authorization (“PTA”) component;

FIGS. 22A-B show data flow diagrams illustrating an example purchase transaction clearance procedure in some embodiments of the H-Wallet;

FIGS. 23A-B show logic flow diagrams illustrating example aspects of purchase transaction clearance in some embodiments of the H-Wallet, e.g., a Purchase Transaction Clearance (“PTC”) component;

FIG. 24 shows a logic flow diagram illustrating example aspects of transaction data aggregation in some embodiments of the H-Wallet, e.g., a Transaction Data Aggregation (“TDA”) component;

FIGS. 25-26 provide block diagrams illustrating infrastructure within embodiments of the H-Wallet; and

FIG. 27 shows a block diagram illustrating embodiments of a H-Wallet controller;

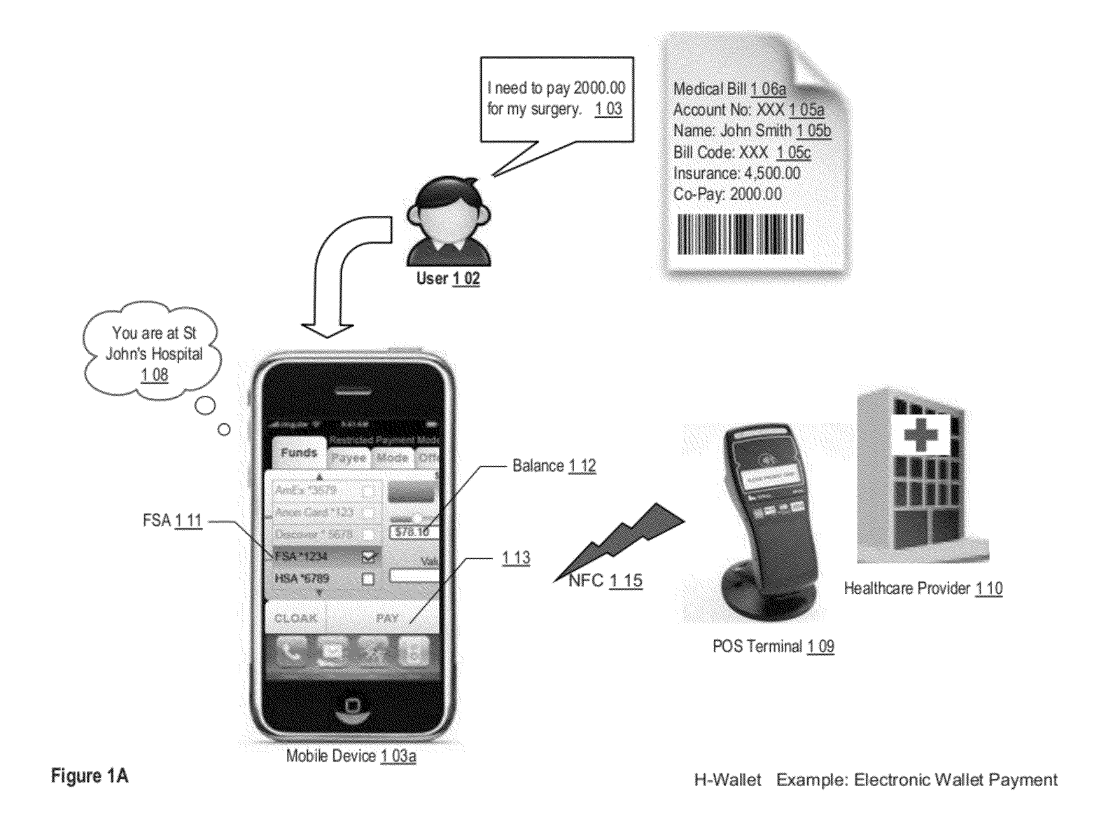

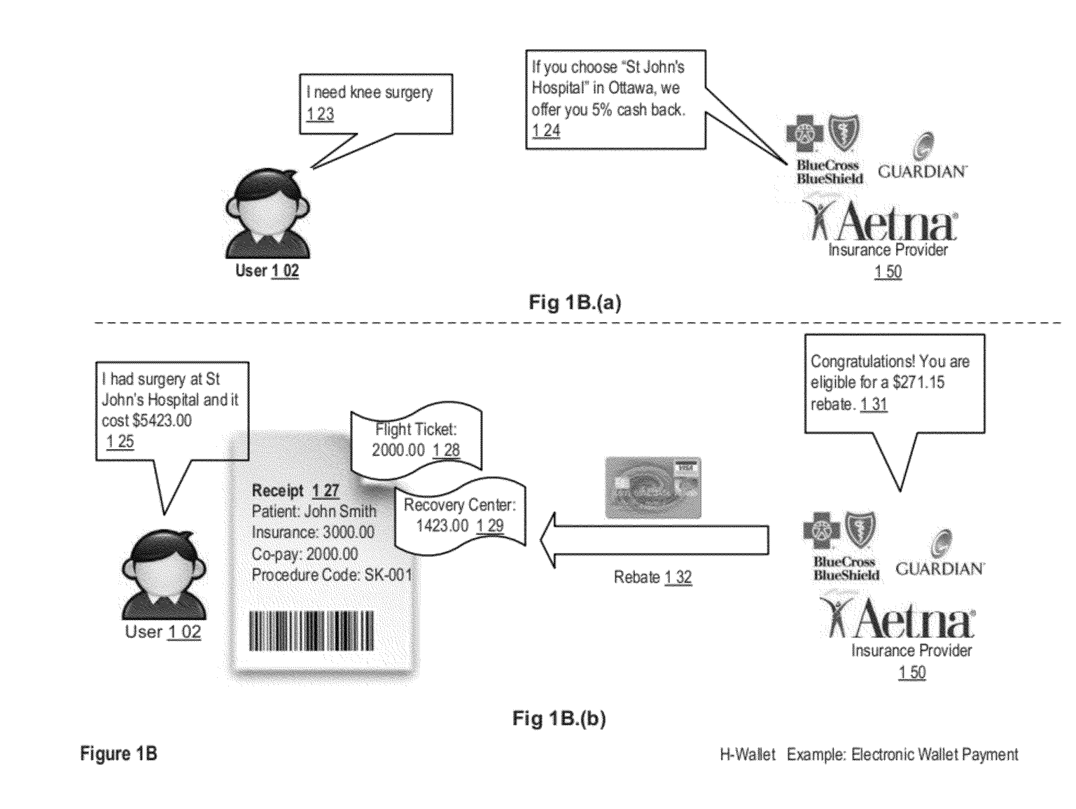

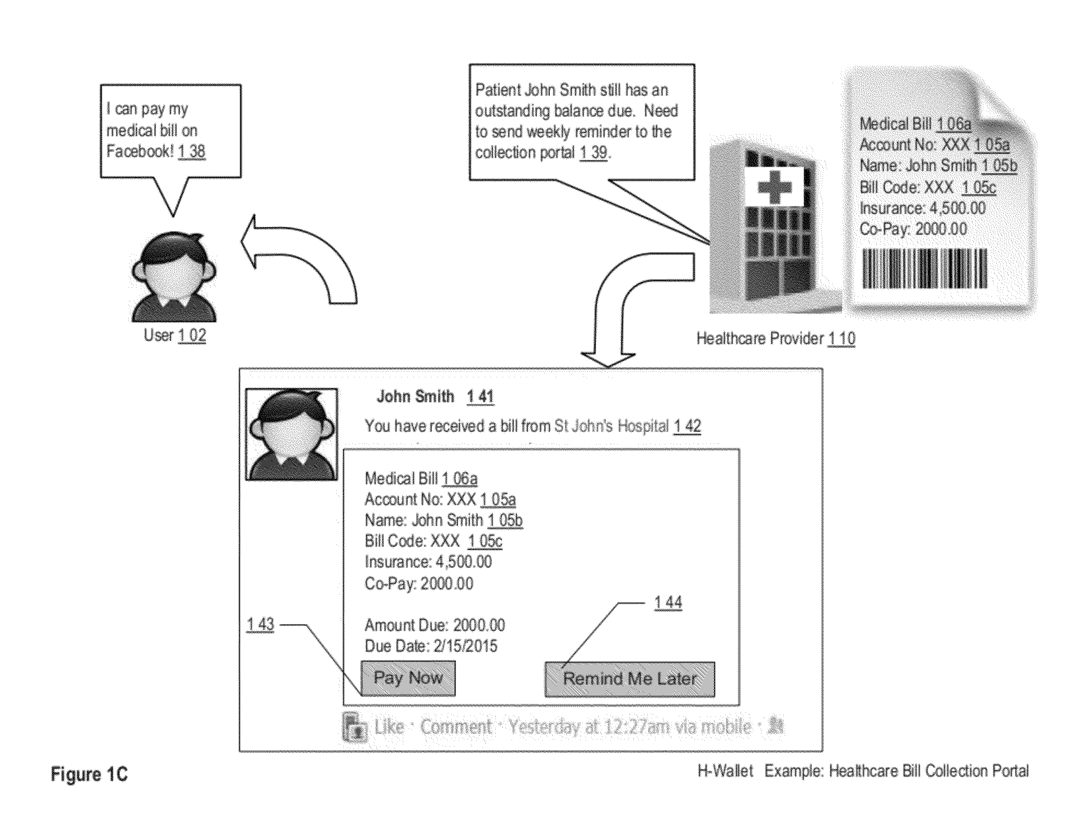

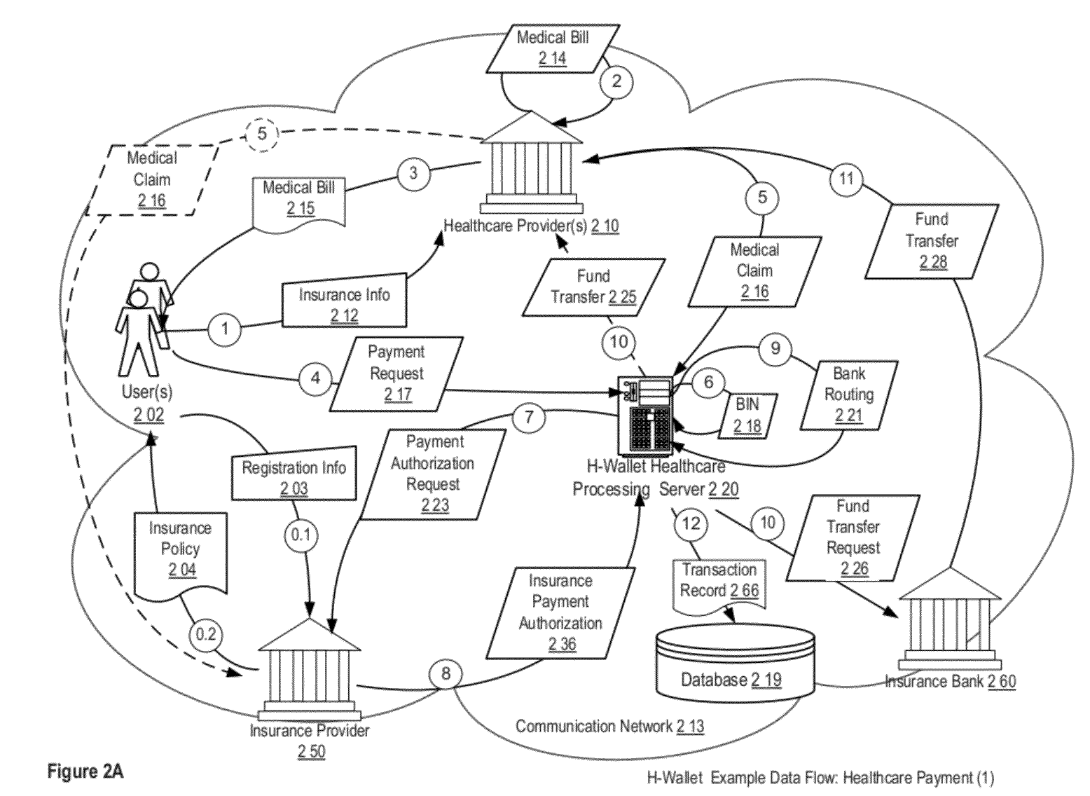

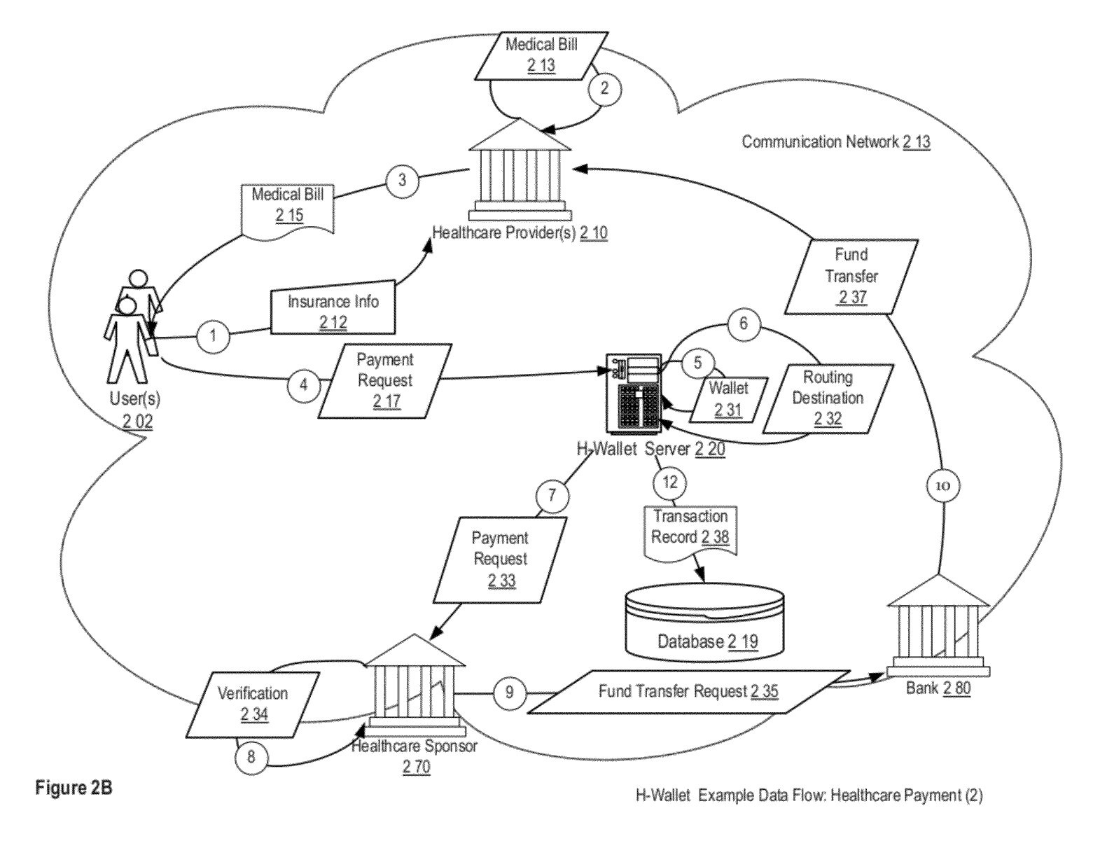

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

The HEALTHCARE WALLET PAYMENT PROCESSING APPARATUSES, METHODS AND SYSTEMS (hereinafter “H-Wallet”) provides a healthcare payment platform which facilitates healthcare payment from a user selected qualified healthcare payment account in real-time.

In one embodiment, a user may operate a payment device (e.g., a mobile wallet component instantiated on a smart phone, a healthcare prepaid card etc.) for checkout at a healthcare service provider, wherein the mobile computing device is web enabled, and may receive a communication from a point of service terminal (POS). The communication may include a balance due bill of a healthcare provider for healthcare to a user. The web enabled mobile computing device may execute an application that derives an optimized payment of the balance due bill that substantially maximizes incentives and minimize penalties in paying the healthcare provider for the healthcare provided to the user. The optimized payment is transmitted from the web enabled mobile computing device to the POS for further authorization processing of one or more currency amounts to be paid from respective accounts to satisfy the balance due bill.

### H-Wallet

FIG. 1A provides an exemplary H-Wallet healthcare payment within embodiments of the H-Wallet. In one implementation, a user 102 may receive a medical bill 106a from a healthcare provider (e.g., a hospital, a dental office, a physician's office, a pharmacy, etc.), which may comprise a user account number 105a, patient name 105b, a bill code 105c, and/or the like. The medical bill 106a may further specify an amount for the medical service/product purchased, including an insured amount and a patient responsible amount. For example, as shown in FIG. 1A, the patient “John Smith” may have an insured amount of “$4,500.00” and a user co-pay amount of “$2,000.00.”

In one implementation, the user 102 may engage a mobile wallet for the user co-pay. For example, the user may launch the mobile wallet and select an enrolled account in the wallet, such as, but not limited to a bank account (e.g., a credit card account, a debit account, etc.), a virtual currency account (e.g., Amazon points account, flight mileage account, etc.), alternative payment accounts (e.g., PayPal, etc.), and/or the like. In further implementations, the user may have enrolled restricted use accounts with the H-Wallet. In one implementation, a restricted-use account may be a financial account having funds that can only be used for payment of approved products (e.g., prescription drugs, vaccine, food, etc.) and/or services (e.g., healthcare treatment, physical examination, etc.). Examples of a restricted use account may comprise Flexible Savings Accounts (FSA), one or more Health Savings Accounts (HSA), Line of Credit (LOC), one or more government insurance programs (i.e., Medicare or Medicaid), various private insurance-rules, various other restricted use favored payment accounts such as employment benefit plans or employee pharmacy benefit plans, and income deduction rules, and/or the like. Within implementations, the approval process of payment with a restricted use account may be administered by a third party, such as, but not limited to FSA/HSA administrator, government unemployment program administrator, and/or the like.

In further implementations, the mobile wallet may intelligently recommend an account in the wallet for the instant payment. For example, the mobile wallet may detect the user's location at a healthcare provider 108 via its GPS component, and thus may recommend healthcare benefit accounts for user payment by highlighting the accounts “FSA” in and “HSA”. When the user selects the FSA account in, the wallet may display an available balance 112 of the FSA account. The user may then tap on a “pay” button 113 of the mobile wallet to initiate a user payment transaction.

In one implementation, the user mobile wallet may transmit a payment transaction request to the Point of Sale (POS) terminal 109 at the healthcare provider no via Near Field Communication (NFC) protocol 115.

In one implementation, as shown in FIG. 1A.(b), upon the user receiving medical service at a healthcare provider, the healthcare provider 110 may issue a medical bill 106a, which may comprise information such as a user account number 105, user name 105b, bill code 105c, proposed insurance amount and user's co-pay amount. In one implementation, the user 102 may receive a print out of the bill at healthcare provider no, and/or receive an electronic bill at his mobile device 103a (e.g., via email, text message, etc.). The user 102 may operate the re-loaded H-Wallet vehicle, e.g., an electronic wallet enabled mobile device 103a, a prepaid magnetic card 103b, etc., for payment at a healthcare provider no upon receiving medical service, e.g., after the scheduled knee surgery. In one implementation, a user 102 may provide a H-Wallet vehicle a point of sale (POS) terminal 109 at the healthcare provider no for payment. For example, the user 102 may swipe a magnetic prepaid card 103b, or just tap on his mobile wallet 103a (e.g., an Apple iPhone, etc.) to initiate payment at the POS terminal 109. Upon verification from the insurance provider 150, the provisionally pre-authorized funds 104a loaded into the user's prepaid card may be transferred to the healthcare provider 110 for medical claim. For example, the pre-authorized funds 104a may be provisionally loaded into the user's prepaid vehicle for insurance payment, and may be confirmed upon the insurance carrier's verification, e.g., verifying whether the tentatively paid medical service matches with the user previously scheduled medical service at 103, etc.

FIG. 1B provides an exemplary diagram illustrating a healthcare insurance incentive within implementations of the H-Wallet. In one implementation, as shown in FIG. 1B(a), the user 102 may provide information of healthcare needs 123 to their insurance provider 150 to obtain a healthcare insurance incentive. For example, the insurance provider 150 may provide options to the user including incentive rebate rewards to the user, if the user agrees to accept healthcare service at a specified provider 124. For example, if the user selects an international provider, e.g., “St John's Hospital in Ottawa,” which may have a lower price for medical service compared to United States providers, the insurance provider 150 may pay a lower insured amount for the medical service and, the insurance provider may provide a financial incentive award to the patient.

In one implementation, as shown in FIG. 1B(b), upon receiving the healthcare service at the insurance specified healthcare provider, the user 102 may submit a rebate request 125 with the user payment receipt 127, including expenses for flight tickets 128, recovery center cost 129, and/or the like to the insurance provider 150. Upon verifying the eligibility of the rebate request, the insurance provider 150 may provide a rebate amount 131 to the user, e.g., by loading the user's account 132, electronic wallet, and/or the like.

FIG. 1C provides an exemplary diagram illustrating healthcare bill collection portal within embodiments of the H-Wallet. In one implementation, upon user 102 receiving healthcare service from a healthcare provider 110, the healthcare provider may generate a medical bill 106a including a request to the user to pay the patient responsible portion. In one implementation, the healthcare provider no may attempt to collect the user responsible portion 239. For example, in one implementation, the healthcare provider 110 may provide the user amount due information to the H-Wallet platform, which may set up automatic reminders that may be prompted to the user's electronic wallet. For another example, the H-Wallet platform may establish a social media profile for the healthcare provider no, which may send reminders to the user via a social media platform (e.g., Facebook, Google+, Twitter, Tumblr, etc.).

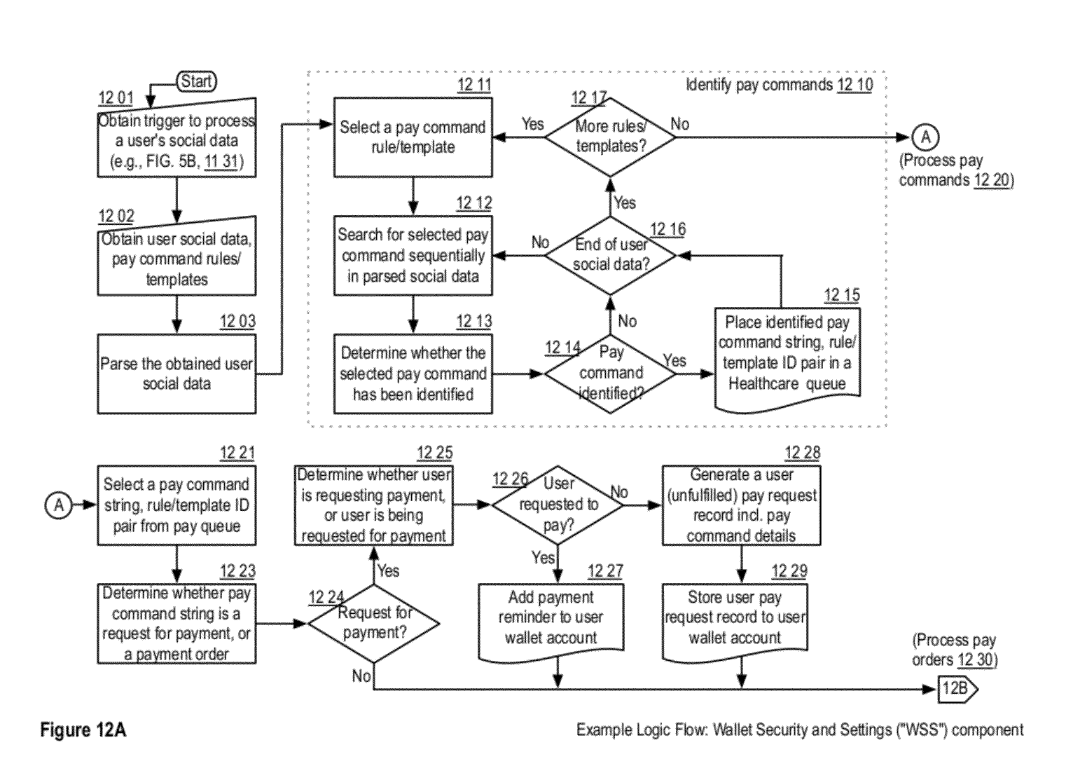

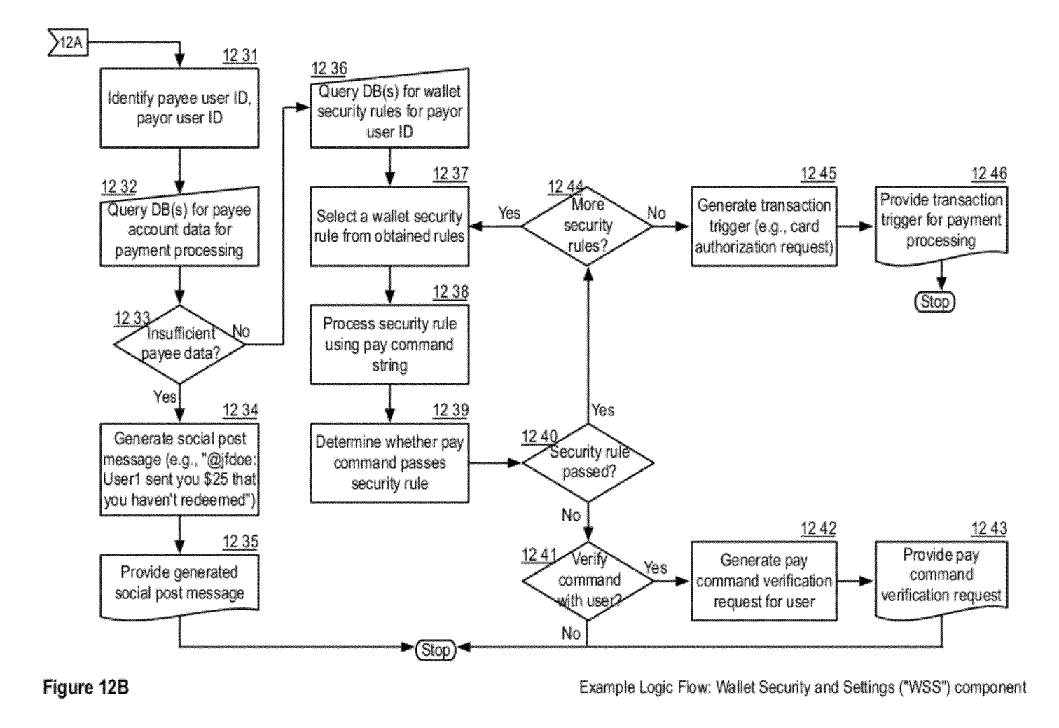

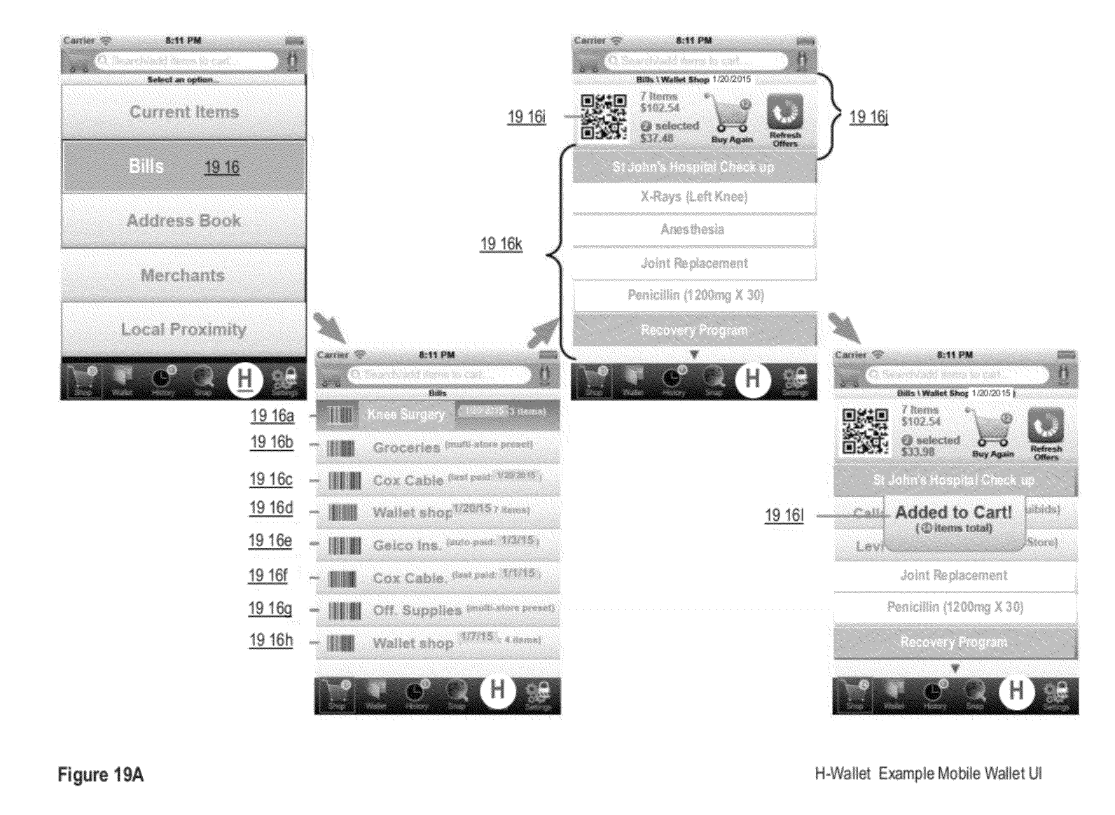

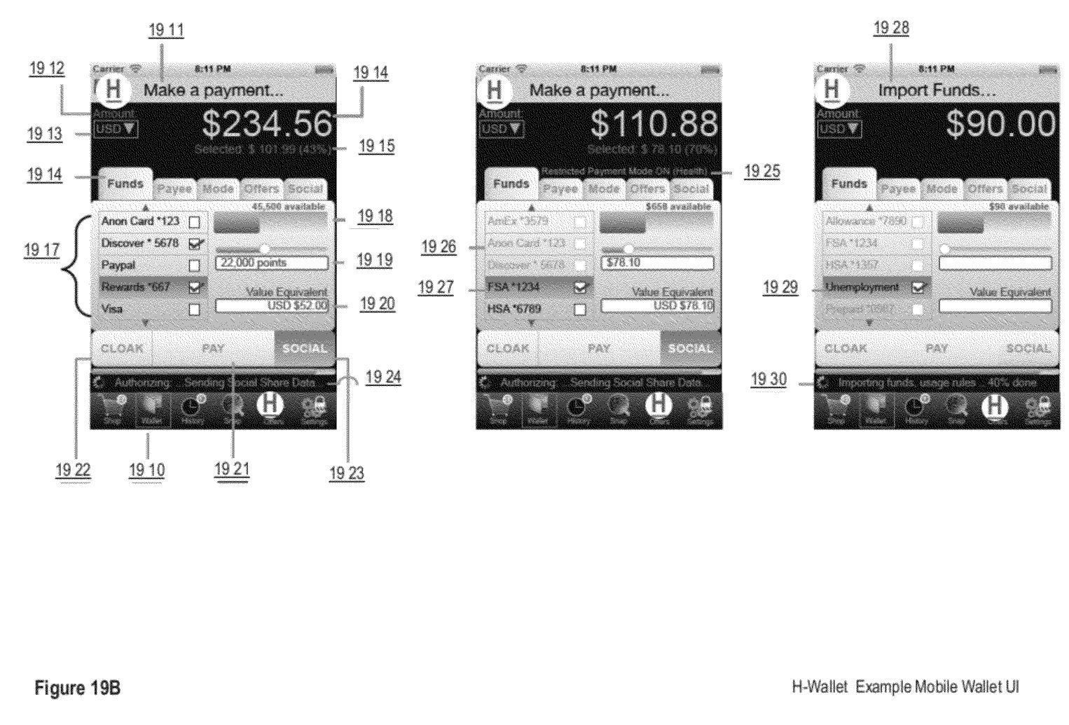

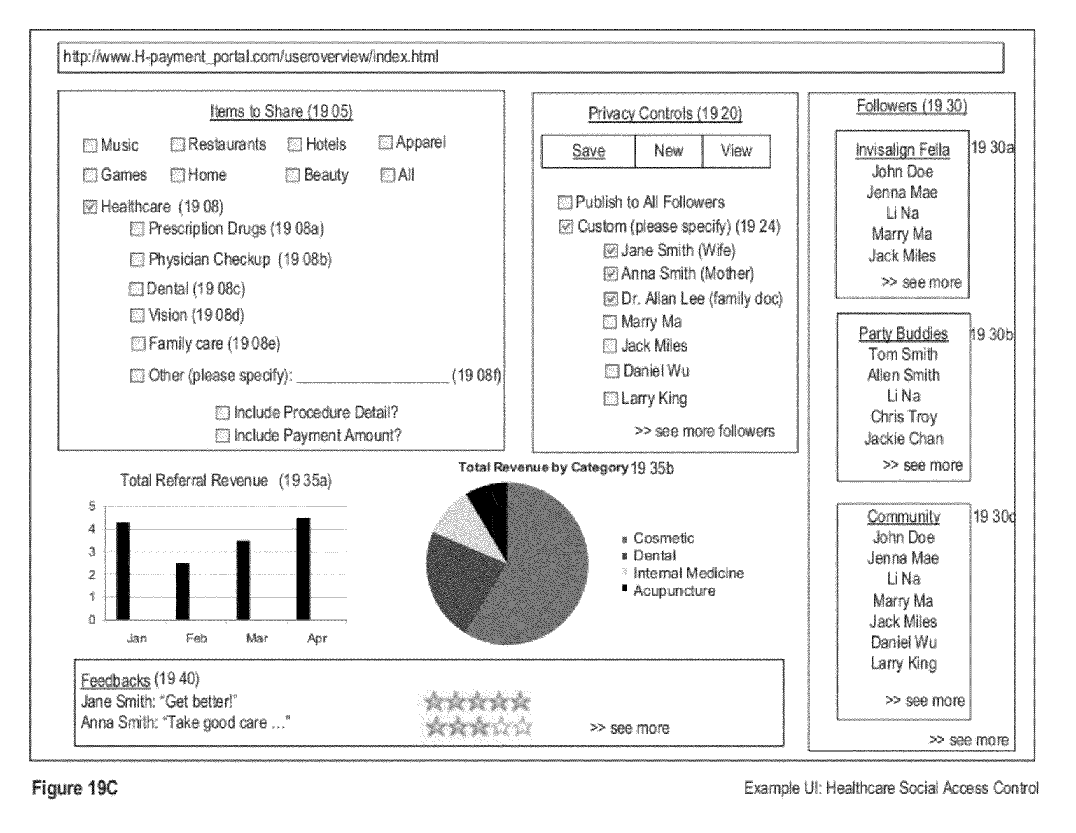

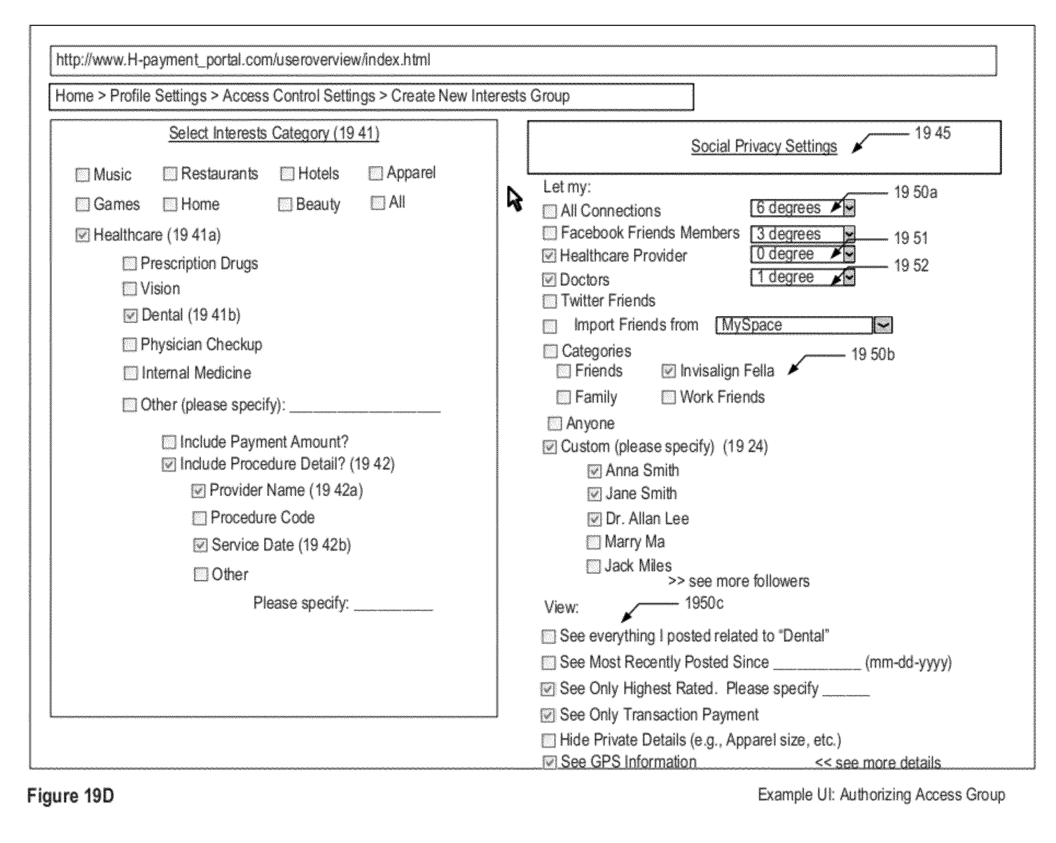

In one implementation, the payment portal via a social media platform may be triggered upon user opt-in and verification. Without user authorization, the H-Wallet may not release billing information to the social media platform. In one implementation, communication between H-Wallet and the social media platform including user secure information is compliant with wallet security and settings (e.g., see FIGS. 12A-12B) to protect user private information. In further implementations, a user may exert access control of his healthcare payment information over social media, allowing only an authorized group of his social connections to view such information. For example, when a user “John Smith” has paid for a medical bill of a “knee surgery” to “St John's Hospital,” he may only allow social contact “St John's Hospital” and close family members to view the social media feeds indicating the payment, e.g., see FIGS. 19C-19D.

As shown in FIG. 1C, the user “John Smith” 241 may receive a bill reminder from the healthcare provider “St John's Hospital” 142 via a social media platform, which may comprise a secured message showing a medical bill 106a. In one implementation, the user may elect to click on “Pay Now” button 143 to pay his medical bill via social media 138, or to choose “remind me later” 144. For example, upon opting to “Pay Now,” the user may be linked to a secured H-Wallet payment window to continue electronic payment.

FIGS. 2A-2B provides a data block diagram illustrating data flow between healthcare payment entities (H-Wallet server, user and affiliated entities) within embodiments of the H-Wallet. Within various embodiments, as shown in FIG. 2A, one or more user(s) (patient(s)) 202, H-Wallet server 220, H-Wallet database(s) 219, healthcare provider(s) 210, insurance provider 250, insurance bank 260, and/or the like are shown to interact via various communication networks 213 to facilitate healthcare insurance payment.

Within various embodiments, the user (e.g., a patient, etc.) 202 may include a wide variety of different communications devices and technologies within embodiments of H-Wallet operation. For example, in one embodiment, the patient 102 may operate devices such as, but not limited to, terminal computers, work stations, servers, cellular telephony handsets, smart phones, PDAs, and/or the like.

In one embodiment, the H-Wallet server 220 may be equipped at a terminal computer of the patient 202. In another embodiment, the H-Wallet server 220 may be a remote server which is accessed by the user 202 via a communication network 113, such as, but not limited to local area network (LAN), in-house intranet, the Internet, and/or the like. In a further implementation, the H-Wallet healthcare provider 210 may communicate with the user 202 via a POS terminal, and/or be integrated with a user 202 at a computer terminal.

Within embodiments, prior to receiving healthcare service or purchasing healthcare products, the user 202 may obtain an insurance program, e.g., by submitting registration information 203 to an insurance provider 250. For example, the user 202 may fill out an insurance application form via a web based application to the insurance provider 250. An exemplary eXtensible Markup Language (XML) formatted user registration message 203 may take a form similar to the following:

```
POST /InsuranceApp.php HTTP/1.1
Host: 64.134.25.22
Content-Type: Application/XML
Content-Length: 718
<?XML version = “1.0” encoding = “UTF-8”?>
<InsuranceApp>
    <TimeStamp> 11:11:23 </TimeStamp>
    <Date> 09-09-2015 </Date>
    <InsurnaceStartDate> 01-01-2016 </InsuranceStartDate>
    <InsuranceEndDate> 12-31-2016 </InsuranceEndDate>
    <InsuranceType> Employer Sponsored </InsuranceType>
    <ProgramCode> PPO </ProgramCode>
    <User>
        <UserName> John Smith </UserName>
        <UserID> JS0000 </UserID>
        <AccountNo> 0000 0000 0000 </AccountNO>
        <Password> 0000 </Password>
        <PasswordQ>
            <Question1> Where were you born </Question1>
            <Answer1> New York </Answer>
            ...
        </PasswordQ>
        <Employer> SuperFast Software Co. </Employer>
        <AnnualIncome> 100,000.00 </AnnualIncome>
        ...
    </User>
    <Employer>
        <ID> 092034 </ID>
        <GroupID> 43498ABC </GroupID>
        <Name> SuperFast Software Co. </Name>
        <Address>
            <Line1> ...</Line1>
            <Line2> ...</Line2>
            <Zipcode> 00000 </Zipcode>
            ...
        </Address>
        ...
    </Employer>
...
</InsuranceApp>
```

In one implementation, the insurance provider 250 may underwrite an insurance policy 204 for the user, and issue an insurance device to the user 202, e.g., an insurance card, etc. For example, the insurance provider 250 may maintain an insurance record of the user 202 at a database. An exemplary XML formatted user insurance record 204 may take a form similar to the following:

```
POST /UserInsurance.php HTTP/1.1
Host: 64.134.25.00
Content-Type: Application/XML
Content-Length: 718
<?XML version = “1.0” encoding = “UTF-8”?>
<UserInsurance>
    <User>
        <UserName> John Smith </UserName>
        <UserID> JS0000 </UserID>
        <AccountNo> 0000 0000 0000 </AccountNO>
        <Password> 0000 </Password>
        <PasswordQ>
            <Question1> Where were you born </Question1>
            <Answer1> New York </Answer>
            ...
        </PasswordQ>
        <Employer> SuperFast Software Co. </Employer>
        <AnnualIncome> 100,000.00 </AnnualIncome>
        ...
    </User>
  <BIN> 0009090fdsfdf </BIN>
    <Insurance>
        <InsuranceID> BB0008PPO </Insurance>
        <InsurnaceStartDate> 01-01-2016 </InsuranceStartDate>
        <InsuranceEndDate> 12-31-2016 </InsuranceEndDate>
          <InsuranceType> Employer Sponsored </InsuranceType>
        <ProgramCode> PPO </ProgramCode>
        <GroupID> 8943243 </GroupID>
        <InsuranceCoverage>
            <ProcedureCode1> 60% </ProcedureCode1>
            <ProcedureCode2> 60% </ProcedureCode2>
            ...
    </Insurance>
        ...
</UserInsurance>
```

Upon establishing an insurance policy with the insurance provider 250, the user 202 may submit their insurance information 212 (e.g., the insurance ID, user information, etc.) to a healthcare provider 210 upon visiting the office. The healthcare provider 210 may perform an insurance provider pre-check, e.g., checking whether the provider is an in-network provider, the coverage of the insurance policy, and/or the like. Based on the retrieved insurance coverage information, the healthcare provider 210 may generate a medical bill 213 including a calculated insured amount and a user responsibility amount.

For example, the user 202 may receive a medical bill 215, indicating the details of the treatment, and the payment amount due, including an amount of the insurance coverage, and the patient's co-pay amount. In one implementation, the user may receive a printed bill at the POS terminal at the hospital; may receive an electronic bill in the email, instant messaging, a healthcare web portal, a mobile wallet, and/or the like. The healthcare provider 210 may pre-check the insurance information of the patient, and thus make an estimate of the insured amount and user co-payment amount, which may be reflected into the medical bill 115. For example, in one implementation, an exemplary XML implementation of the medical bill 214 may take a form similar to:

```
POST /MedBill.php HTTP/1.1
Host: 64.134.25.33
Content-Type: Application/XML
Content-Length: 718
<?XML version = “1.0” encoding = “UTF-8”?>
<MedBill>
    <BillID> MD 0000123 </BillID>
    <BillDate> 09-09-2015 </BillDate>
    <BillTimeStamp> 14:23:56 </BillTimeStamp>
    <BillCode> 0543 </BillCode>
    <Patient>
    <UserID> 123456789 </UserID>
    <UserName> John Smith </UserName>
    </UserAddress> 111 White road </UserAddress>
    <UserPhoneNumber> 000-000-2222 </UserPhoneNumber>
    ...
    </UserDeviceID> 11111111 </UserDeviceID>
    <UserLicenseInfo> .... .</UserLicenseInfo>
    ...
    </Patient>
    ...
    <Procedure>
    <ProcedureCode> Sur-Knee-Left </ProcedureCode>
    <ProcedureDate> 09-09-2011 </ProcedureDate>
    <ProviderID> SPH001 </ProviderID>
    <ProviderName> St John's Hospital </ProviderName>
    ...
    </Procedure>
    <Insurance>
    <InsuranceID> BB0008PPO </Insurance>
    <InsuranceType> Regular </InsuranceType>
    <InsuranceCoverage>
        <ProcedureCode1> 60% </ProcedureCode1>
        <ProcedureCode2> 60% </ProcedureCode2>
        ...
    </Insurance>
<BillSummary>
    <TotalAmount> 12,000.00 </TotalAmount>
    <Insured> 5,000.00 </Insured>
    <PatientResp> 7,000.00 </PatientResp>
    <AmountDue> 7,000.00 </AmountDue>
    ...
</BillSummary>
...
</MedBill>
```

In one implementation, the healthcare provider may generate a HTTP POST message to the H-Wallet server 220, seeking for medical claim 216, wherein the XML-formatted message may take a form similar to:

```
POST /ClaimRequst.php HTTP/1.1
Host: www.Hospital.com
Content-Type: Application/XML
Content-Length: 718
<?XML version = “1.0” encoding = “UTF-8”?>
<ClaimRequest>
<RequestID> SHP-0001 </RequestID>
<RequestDate> 09-09-2015 </BillDate>
<RequestTimeStamp> 14:23:56 </RequestTimeStamp>
<User>
        <UserName> John Smith </UserName>
        <UserID> JS0000 </UserID>
        <AccountNo> 0000 0000 0000 </AccountNO>
        <Password> 0000 </Password>
        <PasswordQ>
            <Question1> Where were you born </Question1>
            <Answer1> New York </Answer>
            ...
        </PasswordQ>
        ...
</User>
    <Insurance>
        <InsuranceID> BB0008PPO </Insurance>
        <GroupID> 123456789 </GroupID>
        <InsuranceType> Regular </InsuranceType>
        <InsuranceCoverage>
            <ProcedureCode1> 60% </ProcedureCode1>
            <ProcedureCode2> 60% </ProcedureCode2>
        </InsuranceCoverage>
        <BIN> 0009203920390 </BIN>
            ...
    </Insurance>
  ...
  <Time> 19:20:23 </Time>
  <Date> 09-01-2011 </Date>
<Claim>
        <Procedure>
        <ProcedureCode> Sur-Knee-Left </ProcedureCode>
        <ProcedureDate> 09-09-2011 </ProcedureDate>
        <ProviderID> SPH001 </ProviderID>
        <ProviderName> St John's Hospital </ProviderName>
        ...
        </Procedure>
        <TotalAmount> 12,000.00 </TotalAmount>
        <EstimatedInsured> 5,000.00 </EstimatedInsured>
        <PatientResp> 7,000.00 </PatientResp>
        ...
</Claim>
...
</ClaimRequest>
```

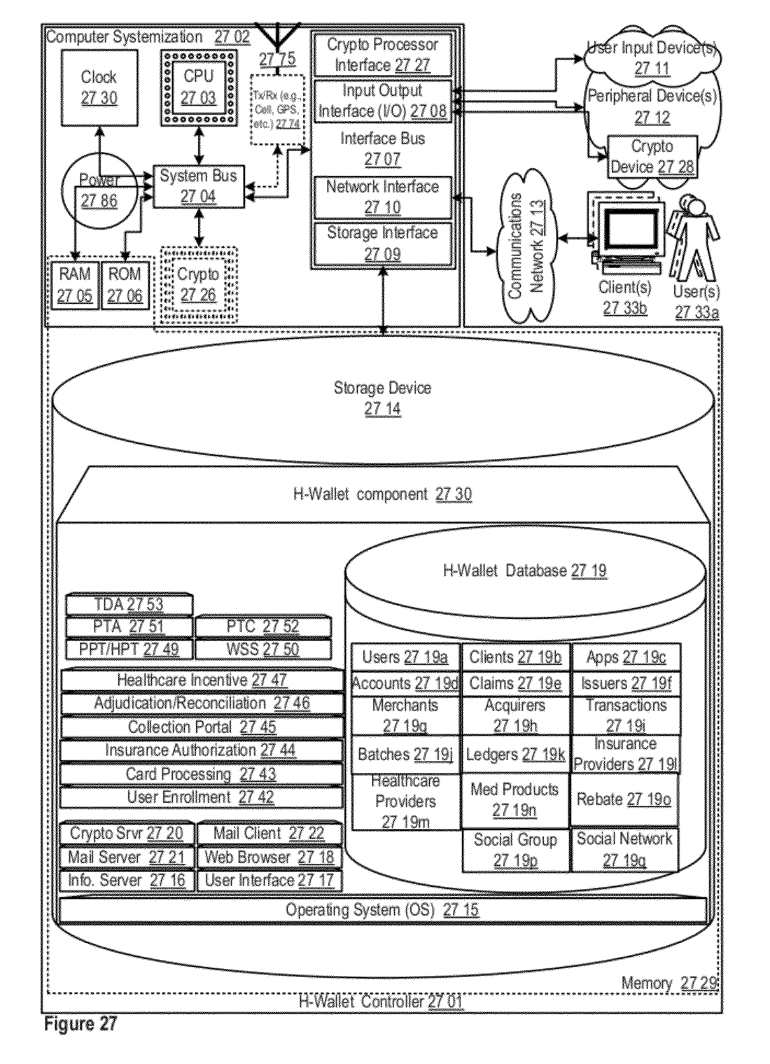

In one implementation, the H-Wallet server 220 may obtain a BIN number 218 (e.g., a 16 digit code, etc.) from the received medical claim 216, based on which the H-Wallet may determine insurance provider routing information 221. For example, the H-Wallet server 220 may query an insurance provider database (e.g., 2719l in FIG. 27) and obtain routing destination 221 (e.g., an IP address, port address, gateway, etc.) of the BIN.

In one implementation, the H-Wallet server 220 may generate a payment authorization request 219 and route the message to the insurance provider 250 based on the BIN-based routing destination. For example, the H-Wallet may generate a HTTPS POST message to make an authorization request 219 in the form of data formatted according to the XML. Below is an example HTTP(S) POST message including an XML-formatted message of the authorization request 223 for the H-Wallet server:

```
POST/AuthorizationRequst.php HTTP/1.1
Host: www.H-Wallet.com
Content-Type: Application/XML
Content-Length: 718
<?XML version = “1.0” encoding = “UTF-8”?>
<AuthorizationRequest>
<Time> 17:40:40 </Time>
<Date> 09-09-2015 </Date>
<User>
    <UserName> John Smith </UserName>
    <UserID> JS0000 </UserID>
    <Password> 0000 </Password>
    <PasswordQ>
        <Question1> Where were you born </Question1>
        <Answer1> New York </Answer>
        ...
    </PasswordQ>
    <Employer> ABC Software CO. </Employer>
    ...
</User>
<Insurance>
    <InsuranceID> BB0008PPO </Insurance>
    <GroupID> 123456789 </Group>
    <InsuranceType> Regular </InsuranceType>
    <InsuranceCoverage>
        <ProcedureCode1> 60% </ProcedureCode1>
        <ProcedureCode2> 60% </ProcedureCode2>
        ...
    </InsuranceCoverage>
  </Insurance>
    ...
<Procedure>
    <ProcedureCode> Sur-Knee-Left </ProcedureCode>
    <ProcedureDate> 09-09-2014 </ProcedureDate>
    <ProviderID> SPH001 </ProviderID>
    <ProviderName> St John's Hospital </ProviderName>
    ...
</Procedure>
<Claim>
    <Amount> 5,000.00 </Amount>
    <TotalAmount> 12000.00 </TotalAmount>
    ...
</Claim>
...
</AuthorizationRequest>
```

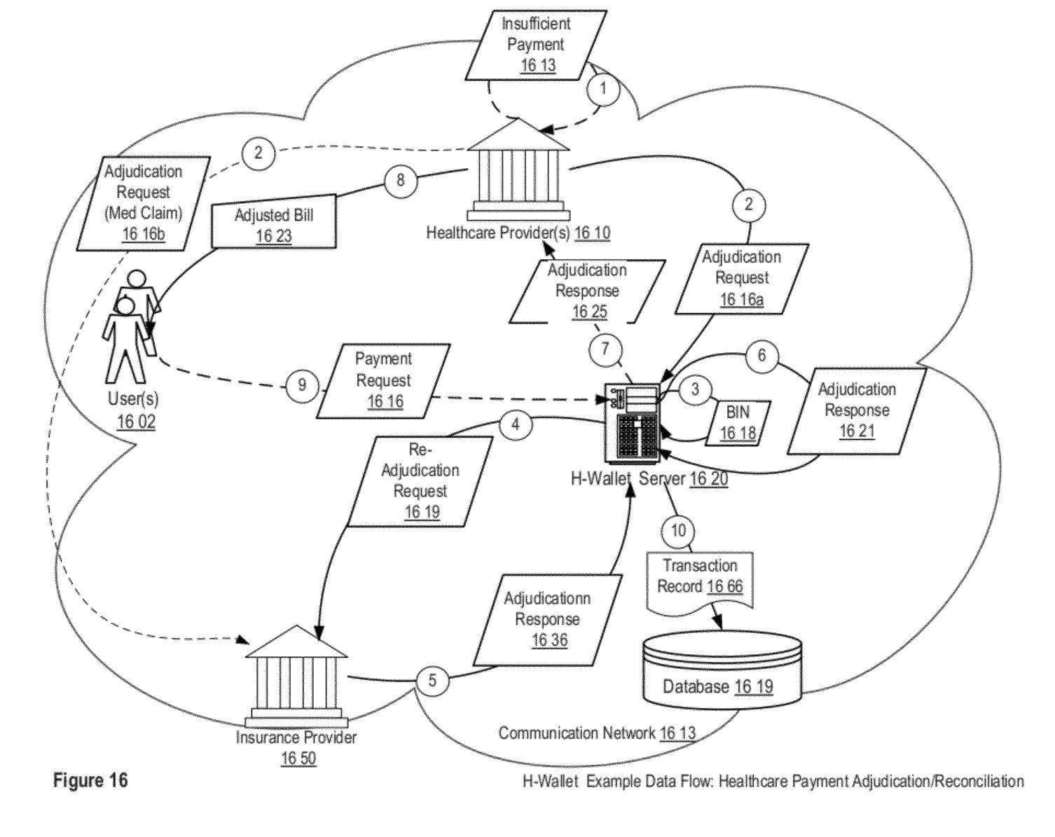

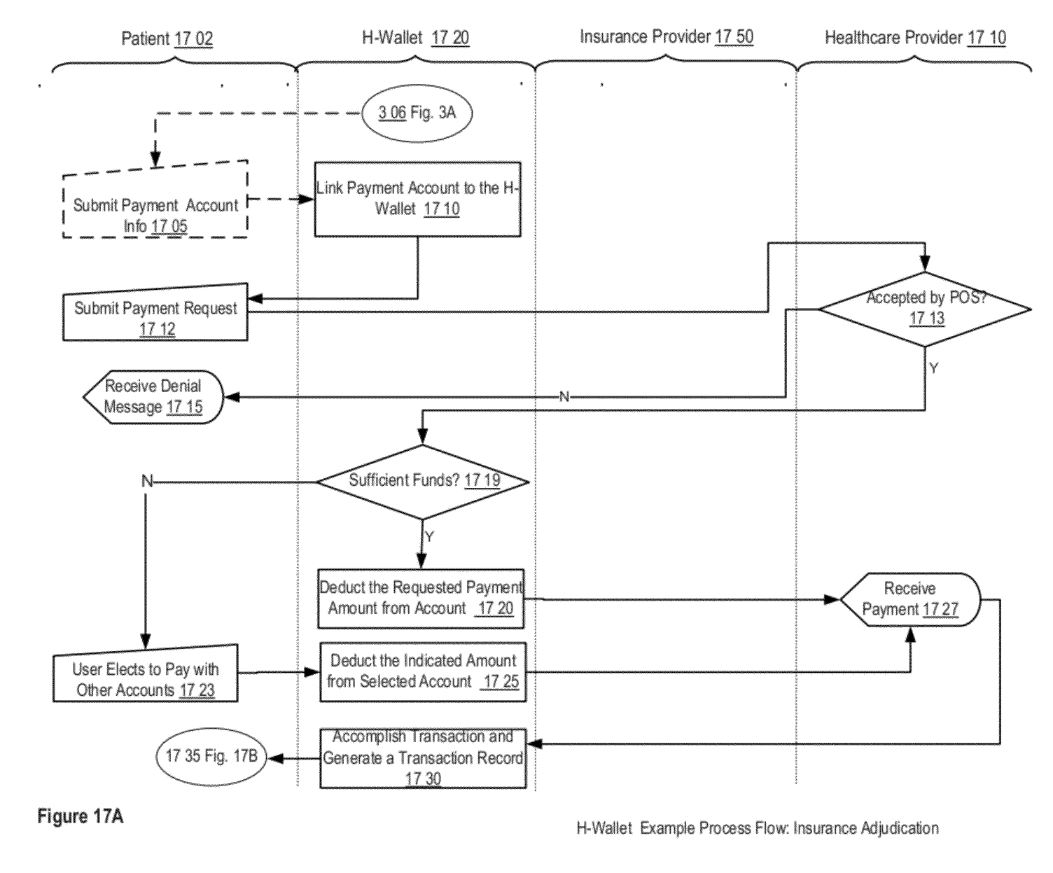

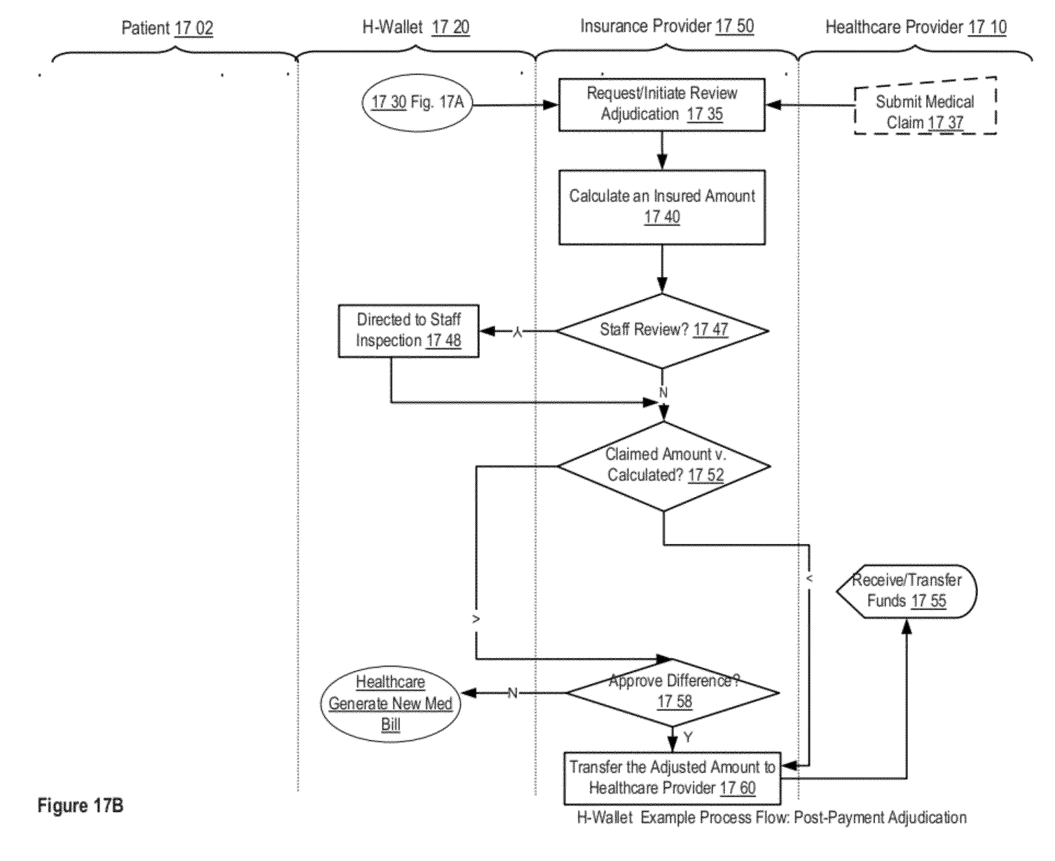

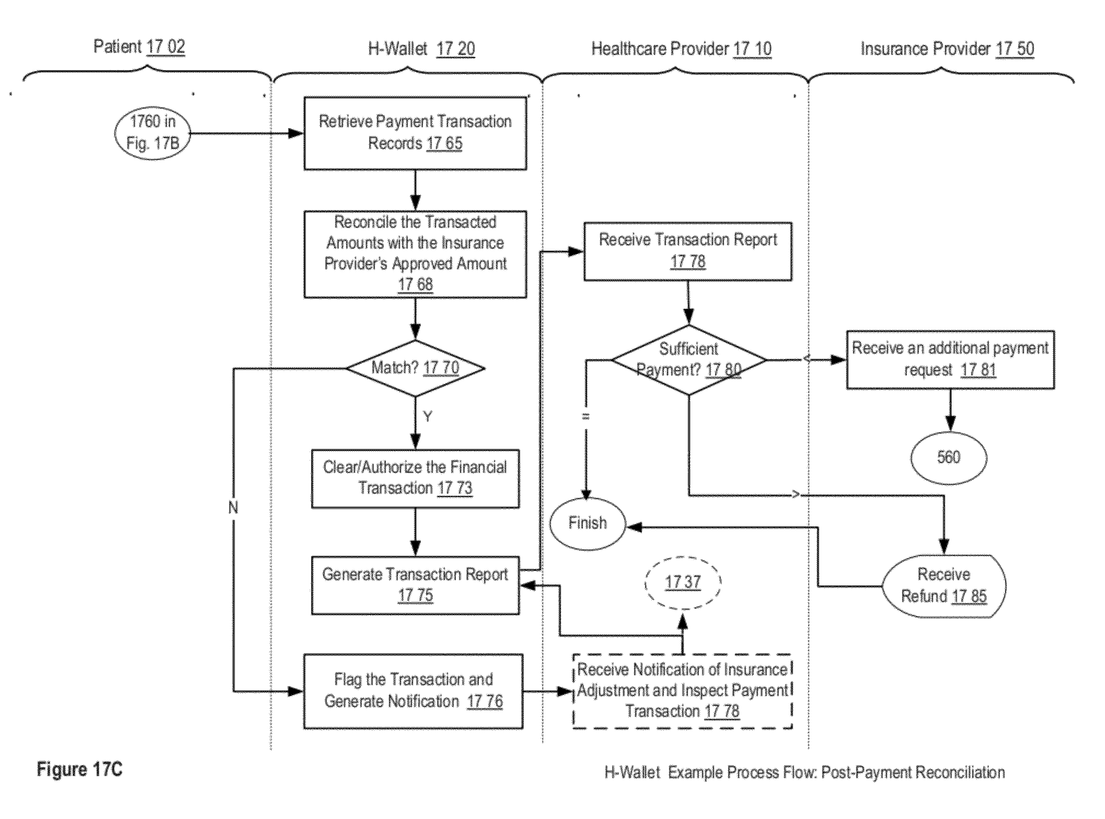

The insurance provider 250 may review and verify the requested insurance payment. For example, the insurance provider may assess the medical claim of the requested insured amount based on local annual income, economic indicators, market price, living expenses, and/or the like. In one implementation, the insurance provider 250 may send an insurance payment authorization response 236 back to the H-Wallet to authorize the payment. In another implementation, the insurance provider 250 may approve a payment amount which may not equate the requested amount, and subject to further adjudication and reconciliation afterwards, e.g., as discussed in FIGS. 16-17C.

Upon reviewing and approving the requested insured amount, the insurance provider 250 may provide a response 236 to the payment authorization request 219, either to approve an entirety or a part of the requested insurance payment, or to reject the payment request when the received medical claim is not eligible. For example, the insurance provider 250 may verify whether the estimated insured amount in the payment request 219 matches the user's insurance coverage program, whether the user's year-to-date insurance payment has exceeded a maximum amount if there is any, whether the user's employment and/or insurance program is in good standing, and/or the like.

In one implementation, the insurance provider may generate a HTTPS POST message to make an authorization response 236 in the form of data formatted according to the XML. Below is an example HTTP(S) POST message including an XML-formatted message of the authorization response 236 for the H-Wallet:

```
POST /AuthorizationResponse.php HTTP/1.1
Host: www.H-Wallet.com
Content-Type: Application/XML
Content-Length: 718
<?XML version = “1.0” encoding = “UTF-8”?>
<AuthorizationResponse>
<Time> 17:42:40 </Time>
<Date> 09-09-2015 </Date>
<User>
    <UserName> John Smith </UserName>
    <UserID> JS0000 </UserID>
    <Password> 0000 </Password>
    <PasswordQ>
        <Question1> Where were you born </Question1>
        <Answer1> New York </Answer>
        ...
    </PasswordQ>
    ...
</User>
<Insurance>
    <InsuranceID> BB0008PPO </InsuranceID>
    <GroupID> 123456789 </GroupID>
    <InsuranceType> Regular </InsuranceType>
    <InsuranceCoverage>
        <ProcedureCode1> 60% </ProcedureCode1>
        <ProcedureCode2> 60% </ProcedureCode2>
        ...
  </Insurance>
    ...
<Procedure>
    <ProcedureCode> Sur-Knee-Left </ProcedureCode>
    <ProcedureDate> 09-09-2011 </ProcedureDate>
    <ProviderID> SPH001 </ProviderID>
    <ProviderName> St John's Hospital </ProviderName>
    ...
</Procedure>
<RequestedAmount> 5,000.00 </RequestedAmount>
<AnnualMaximum> 6,000.00 </AnnualMaximum>
<YearToDate> 3,000.00 </YearToDate>
<Available> 3,000.00 </Available>
<ApprovedAmount> 3,000.00 </ApprovedAmount>
<Status> Good </Status>
...
</AuthorizationResponse >
```

In the above example, as the user “John Smith” has an insurance policy that cap the yearly insurance payment to be “$6,000.00” and the user has already received “$3,000.00” payment year to date. Therefore, the insurance provider may approve an amount capped by the remaining permitted insurance payment as “$3,000.00.”

Upon receiving the insurance payment authorization 136, the H-Wallet may process the insurance payment 134, and may subject the payment to adjudication, as further illustrated in FIGS. 17A-17B.

In one implementation, the H-Wallet may retrieve bank routing information 221 (e.g., the insurance bank information, etc.) and generate a fund transfer request 226 to transfer the approved insurance amount. For example, the H-Wallet may send the fund transfer request 136 to a bank 260 (e.g., the insurance bank, etc.), which may take a form similar to the format in compliance with electronic fund transfers (EFT), and in some embodiments, it may be directly made to the healthcare provider via a third party bank, e.g., absent the direction of the H-Wallet server. In another implementation, the H-Wallet server 220 may be integrated with a payment network, e.g., VisaNet, etc., which may facilitate the payment processing. In one implementation, the H-Wallet server 220 may debit the approved insurance amount from the insurance provider's account and credit to the healthcare provider 210. For example, the H-Wallet server may generate a HTTPS post for money transfer, wherein the HTTPS POST message 226 may take a form similar to the following:

```
POST /FundTransfer.php HTTP/1.1
Host: www.H-Wallet.com
Content-Type: Application/XML
Content-Length: 718
<?XML version = “1.0” encoding = “UTF-8”?>
<FundTransfer>
    <Time> 15:39:30 </Time>
    <Date> 09-09-2015 </Date>
    <Payor>
        <ID> BL009 </ID>
        <Name> Blue Cross </Name>
        <IssuerID> BOA001 </IssuerID>
        <AccountNo> 0000 0000 0000 0000 </AccountNO>
        <Routing> 111111111 </Routing>
        ...
    </Payor>
    <Payee>
        <ID> SHP009 </ID>
        <Name> St John's Hospital </Name>
        <AccountNo> 00000224 </AccountNO>
        <Routing> 1234555 </Routing>
        ...
    </Payee>
    <Amount> 3000.00 </Amount>
    ...
</FundTransfer>
```

For another example, the fund transfer message may take a form similar to the Visa Single Message System (SMS) format, Visa Original Credit Transaction (OCT) r format, and/or the like. The healthcare provider 210 may then received a fund transfer 228 from the insurance bank 260.

In one implementation, the H-Wallet server 220 may generate a transaction record 266 for the insurance payment in the database 219. For example, the H-Wallet may generate a database record. Below is an example of the transaction record 266 for the H-Wallet server:

```
POST /TransactionRecord.php HTTP/1.1
Host: 00.001.00.00
Content-Type: Application/XML
Content-Length: 718
<?XML version =“1.0” encoding = “UTF-8”?>
<Transaction>
    <TransactionID> 000000 </TransactionID>
    <TransactionDate> 09-09-2015 </TransactionDate>
    <RequestTime> 19:30:27 </RequestTime>
    <ReceiptTime> 19:31:56 </ReceiptTime>
    <User>
    <UserName> John Smith </UserName>
    <UserID> JS0000 </UserID>
    <AccountNo> 0000 0000 0000 </AccountNo>
    <Password> 0000 </Password>
    <PasswordQ>
        <Question1> Where were you born </Question1>
        <Answer1> New York </Answer>
        ...
    </PasswordQ>
    ...
    </User>
    <TotalAmount> 12,000.00 </TotalAmount>
    <Insured> 5,000.00 </Insured>
    <PatientResp> 7,000.00 </PatientResp>
    <ApprovedInsured> 3,000.00 </ApprovedInsured>
    <TransferLog>
        <Transfer1>
            <Amount> 3,000.00 </Amount>
            <Payor> Blue Cross </Payor>
            <Payee> St John's Hospital </Payee>
            <Status> Verified </Status>
            ...
        </Transfer1>
        ...
    </TransferLog>
...
</Transaction>
```

In another implementation, the database 219 may be a relational database responsive to Structured Query Language (“SQL”) commands. The H-Wallet server may execute a hypertext preprocessor (“PHP”) script including SQL commands to query the database for user, transaction data, and/or the like. An example PHP/SQL command listing, illustrating substantive aspects of storing a transaction record 266 in the database:

<?PHP
header(‘Content-Type: text/plain’);
mysql_connect(″202.155.66.130”,$DBserver,$password);
// access database server
mysql_select(″TRANSACTIONS.SQL″); // select database to append
mysql_query(“INSERT INTO Transactions (transaction_id,
transaction_date, requested_time, receipt_time,
user_id, user_name, user_password, account_no,
total_amount, insured_amount, patient_copay, approved_insured,
transfer_log, payee_id, payor_id, transfer_amount ...)
VALUES ($transaction_id$, $transaction_date$, $requested_time$,
$receipt_time$, $user_id$, $user_name$, $user_password$,
$account_no$, $total_amount$, $insured_amount$, $patient_copay$,
$approved_insured$, $transfer_log$, $payee_id$,
$payor_id$, $transfer_amount$ ...); //
add data to table in database
mysql_close(″TRANSACTIONS.SQL″); // close connection to database
?>

In one implementation, the H-Wallet may access and retrieve information from one or more online databases 219. Some databases contain a rule for a payment made towards the balance due bill for the healthcare provided by the healthcare worker to the user. By way of example, and not by way of limitation, a database can contain a negative wealth impacting (e.g., deduction, liability, insurance, debt, tax, negative interests, and/or other wealth reducing factor) rule pertaining to payment to the healthcare provider for the healthcare to the user. Another database can contains an insurance rule pertaining to payment for the healthcare to the user. Other online databases accessible by the H-Wallet to retrieve information can contain data specific to the user and an insured entity financially responsible for the user, as well as currency balances in each of one or more accounts respectively issued by an issuer.

In one implementation, the information retrieved by the H-Wallet from the online databases is processed by an optimization algorithm that operates on the rules in the retrieved information. The H-Wallet may derive a recommendation that includes a currency payment amount to pay against the balance due bill respectively from each said currency balance of the one or more accounts issued by respective issuers. The recommendation is rendered on the web enabled mobile computing device for approval by the user. If the recommendation is approved, the enabled mobile computing device transmits the recommendation to the POS. In one implementation, the POS may transmit the recommendation for authorization processing of each currency payment amount to pay against the balance due bill respectively from each currency balance of each account as provided by the recommendation. In a further implementation, the H-Wallet may substantially maximize currency payments pay against the balance due bill, as well as substantially minimize out-of-pocket payments pay against the balance due bill.

FIG. 2B provides a data block diagram illustrating data flow between healthcare payment entities (H-Wallet server, user and affiliated entities) for user co-pay within embodiments of the H-Wallet. Within various embodiments, as shown in FIG. 2B, one or more user(s) (patient(s)) 202, H-Wallet server 220, H-Wallet database(s) 219, healthcare provider(s) 210, a healthcare sponsor 270, insurance bank 280, and/or the like are shown to interact via various communication networks 213 to facilitate healthcare user payment.

Continuing on with user 202 receiving a medical bill 215 form the healthcare provider 210 (e.g., as discussed in FIG. 2A), in response to the received medical bill, e.g., at the POS terminal at the healthcare provider 110, the patient 202 may submit a medical payment request 217 to an acquirer, which may forward the payment request to the H-Wallet server 220 for processing. For example, the user may submit card information at the POS terminal. For another example, the user may initiate an electronic wallet payment via NFC handshake (e.g., as shown in FIG. 1A), and selects a payment account via his wallet. In one implementation, the wallet account may comprise any credit card account, debit account, investment account, alternative payment account, loyalty points account, and/or the like. In a further implementation, the user may have added restricted use accounts with the H-Wallet accounts, such as Flexible Savings Accounts (FSA), one or more Health Savings Accounts (HSA), one or more government insurance programs (i.e., Medicare or Medicaid), various private insurance rules, various other restricted use accounts such as employment benefit plans or employee pharmacy benefit plans, and income deduction rules, and/or the like. Further implementations of restricted use account wallet enrollment are discussed in FIG. 2C.

Within embodiments, the user may select one or more accounts for payment, and enter an amount to be charged with each account. For example, the user may select an account FSA and enter an amount of “1,000.00” and another credit card account with an entered amount of “6,000.00.”

In one implementation, the payment request 217 may comprise information such as user profile information, user insurance information, user pre-loaded account information, medical bill information, and/or the like. For example, in one implementation, a POS terminal processing the user payment request may generate a HTTPS POST message including information of the payment request 217 in the form of data formatted according to the XML. Below is an example HTTP(S) POST message including an XML-formatted message for the H-Wallet server:

```
POST /PaymentRequst.php HTTP/1.1
Host: www.Hospital.com
Content-Type: Application/XML
Content-Length: 718
<?XML version = “1.0” encoding = “UTF-8”?>
<PaymentRequest>
    <Time> 15:30:30 </Time>
    <Date> 09-09-2014 </Date>
    <User>
    <UserName> John Smith </UserName>
    <UserWalletID> JS0000 </UserID>
    ...
    </User>
    <Wallet>
        <WalletID> HW-JS-0001 </WalletID>
        <WalletToken> 8943243 </WalletToken>
        <Payment1>
            <Account> FSA </Account>
            <AccountNo>
            <Amount> 1000.00 </Amount>
        </Payment>
        <Payment2>
            <Account> Bank Of America Visa Card </Account>
            <AccountNo> 0000 0000 0000 0000 </AccountNo>
            <Amount> 6000.00 </Amount>
        ...
    </Wallet>
    ...
</PaymentRequest>
```

Upon receiving the payment request message 217 from the user, the H-Wallet server 220 may retrieve wallet information 231 of the user (e.g., account no and user ID, as shown in the payment request 217). For each selected account indicated in the payment request 217, the H-Wallet server 220 may query for a routing destination 232 for the account. For example, when the user selects “FSA” account, the H-Wallet server 220 may select the routing destination 232 to be the FSA administer/sponsor 270 of the user.

In one implementation, the H-Wallet server 220 may generate and route a payment request 233 to the healthcare sponsor 270. For example, the healthcare sponsor 270 may comprise a restricted use account sponsor, e.g., a FSA/HSA administer, an employer who sponsored employer benefit programs for its employees, a government agency (e.g., Medicare, Medicaid, etc.). In one implementation, the H-Wallet server 220 may generate separate payment request messages to different routing destinations. In the above example payment request 217, when the user has selected a FSA payment account and a credit card payment, the H-Wallet server 220 may generate a payment request message 233 routed to a FSA administering entity (270), and a payment request message to a user's issuing bank of the credit card account.

Upon receiving a payment request 233, the healthcare sponsor 270 may retrieve rules to generate verification messages 234 of the payment request. For example, the verification message 234 may indicate whether the requested payment complies with account requirement, whether the requested payment amount has exceeded the maximum amount, and/or the like. For example, the healthcare sponsor entity 270 may generate a HTTPS POST message including a verification message 234 in the form of data formatted according to the XML. Below is an example HTTP(S) POST message including an XML-formatted verification message 234:

```
POST /FSAverification.php HTTP/1.1
Host: www.FSA.com
Content-Type: Application/XML
Content-Length: 718
<?XML version = “1.0” encoding = “UTF-8”?>
<FSAverification>
    <Time> 15:30:56 </Time>
    <Date> 09-09-2015 </Date>
    <User>
    <UserName> John Smith </UserName>
    <UserWalletID> JS0000 </UserID>
    ...
    </User>
    <AccountStatus>
        <AccountType> FSA </AccountType>
        <AccountNo> 123456 </AccountNo>
        <Amount> 1000.00 </Amount>
        <Balance> 2000.00 </Balance>
        ...
    </AccountStatus>
    <HealthcareService>
        <ProviderID> SHP009 </ProviderID>
        <ProcedureCode> KS-001 </ProcedureCode>
        <Coverage> OK </Coverage>
        ...
    </HealthcareService>
    <Status> Approve </Status>
    ...
</Verification>
```

In the above example, the FSA administer program 270 verifies that the user's healthcare service code is eligible for FSA reimbursement, and does not exceed the available balance in the account. As such, the FSA administer program 270 may approve the payment, and generate a fund transfer request 235 to the sponsor bank 280. For example, the fund transfer message may take a form similar to message 226 in FIG. 2B, which may trigger a fund transfer 237 from the FSA account to the healthcare provider 210.

In one implementation, the healthcare sponsor 270 may verify the payment in real time, or a nearly real time manner. In other implementations, the healthcare sponsor 270 may receive and process payment requests 233 in batch files. In further implementations, the H-Wallet server 220 may perform an eligibility pre-check if the user submitted account comprises a negative income wealth impactor account (e.g., FSA, HSA, etc) and various rules may be applied to the payment request based on the type of the account.

In one implementation, the H-Wallet server 220 may generate a transaction record 266b for the insurance payment in the database 219. For example, below is an example XML-formatted message of the transaction record 238 for the H-Wallet server:

```
POST /TransactionRecord.php HTTP/1.1
Host: 00.001.00.00
Content-Type: Application/XML
Content-Length: 718
<?XML version = “1.0” encoding = “UTF-8”?>
<Transaction>
    <TransactionID> 000002 </TransactionID>
    <TransactionDate> 09-09-2015 </TransactionDate>
    <RequestTime> 19:30:27 </RequestTime>
    <ReceiptTime> 19:48:56 </ReceiptTime>
    <User>
    <UserName> John Smith </UserName>
    <UserID> JS0000 </UserID>
    <Password> 0000 </Password>
    <PasswordQ>
        <Question1> Where were you born </Question1>
        <Answer1> New York </Answer>
        ...
    </PasswordQ>
    ...
    </User>
    <PaymentType> FSA </PaymentType>
    <Status> Approved </Status>
    <TransferLog>
        <Transfer1>
            <Amount> 1,000.00 </Amount>
            <Payor> FSA administration </Payor>
            <PayorAccount> 123456 </PayorAccount>
            <Payee> St John's Hospital </Payee>
            <Status> Verified </Status>
            ...
        </Transfer1>
        ...
    </TransferLog>
...
</Transaction>
```

In another implementation, the H-Wallet server may execute a hypertext preprocessor (“PHP”) script including SQL commands to query the database for user, transaction data, and/or the like. An example PHP/SQL command listing, illustrating substantive aspects of storing a transaction record 266 in the database:

<?PHP
header(‘Content-Type: text/plain’);
mysql_connect(″202.155.66.130”,$DBserver,$password);
// access database server
mysql_select(″TRANSACTIONS.SQL″); // select database to append
mysql_query(“INSERT INTO Transactions (transaction_id,
transaction_date, requested_time, receipt_time, user_id,
user_name, user_password, account_no, total_amount,
account_type, patient_copay, approved_insured, transfer_log,
payee_id, payor_id, transfer_amount ...)
VALUES ($transaction_id$, $transaction_date$, $requested_time$,
$receipt_time$, $user_id$, $user_name$, $user_password$,
$account_no$, $total_amount$, $insured_amount$, $account_type$,
$approved_insured$, $transfer_log$, $payee_id$,
$payor_id$, $transfer_amount$ ...); //
add data to table in database
mysql_close(″TRANSACTIONS.SQL″); // close connection to database
?>

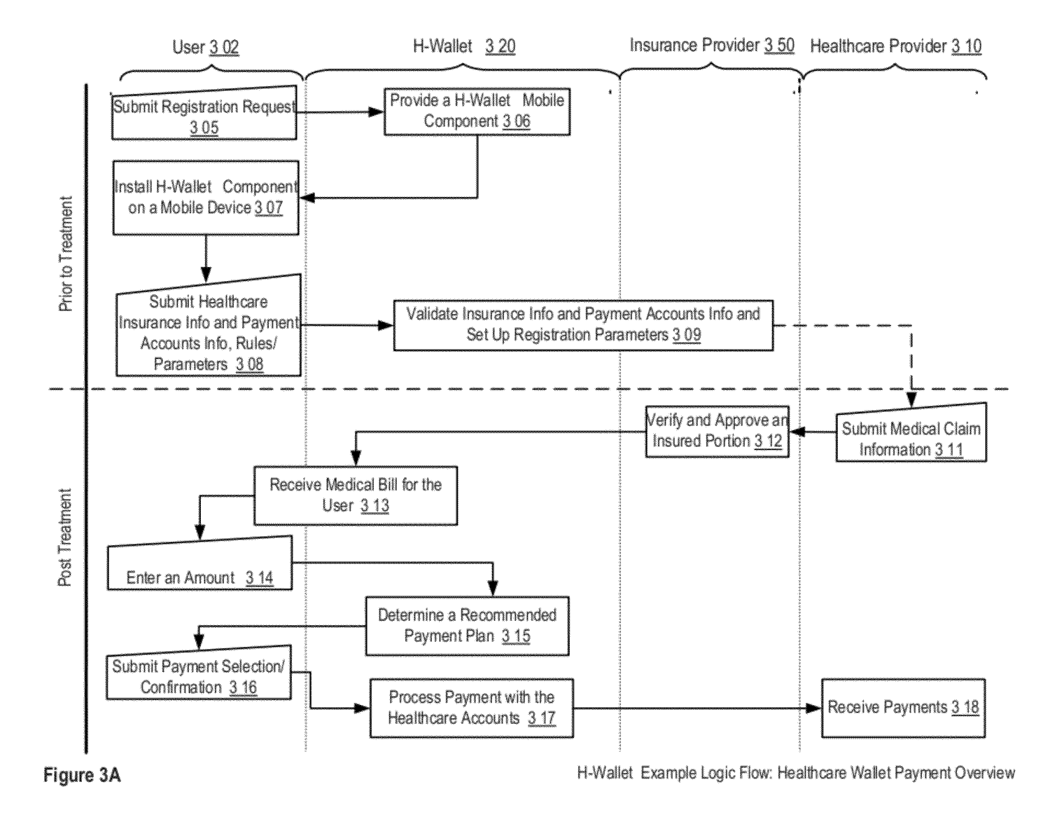

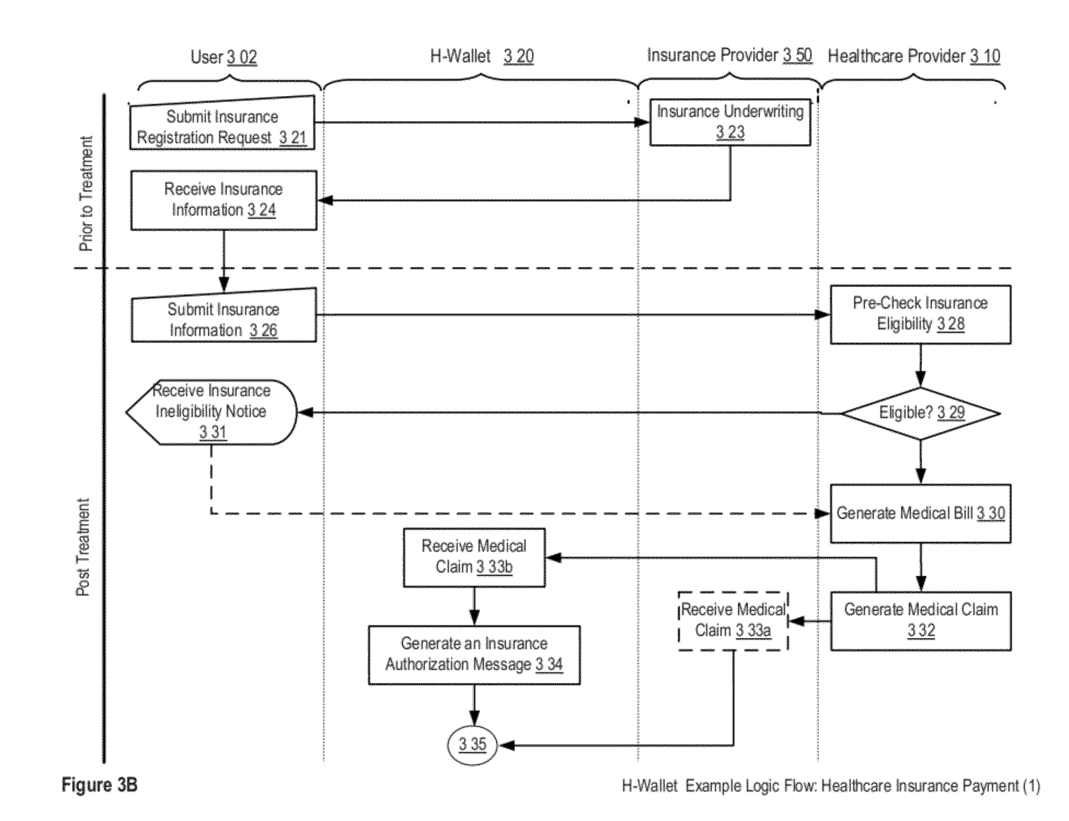

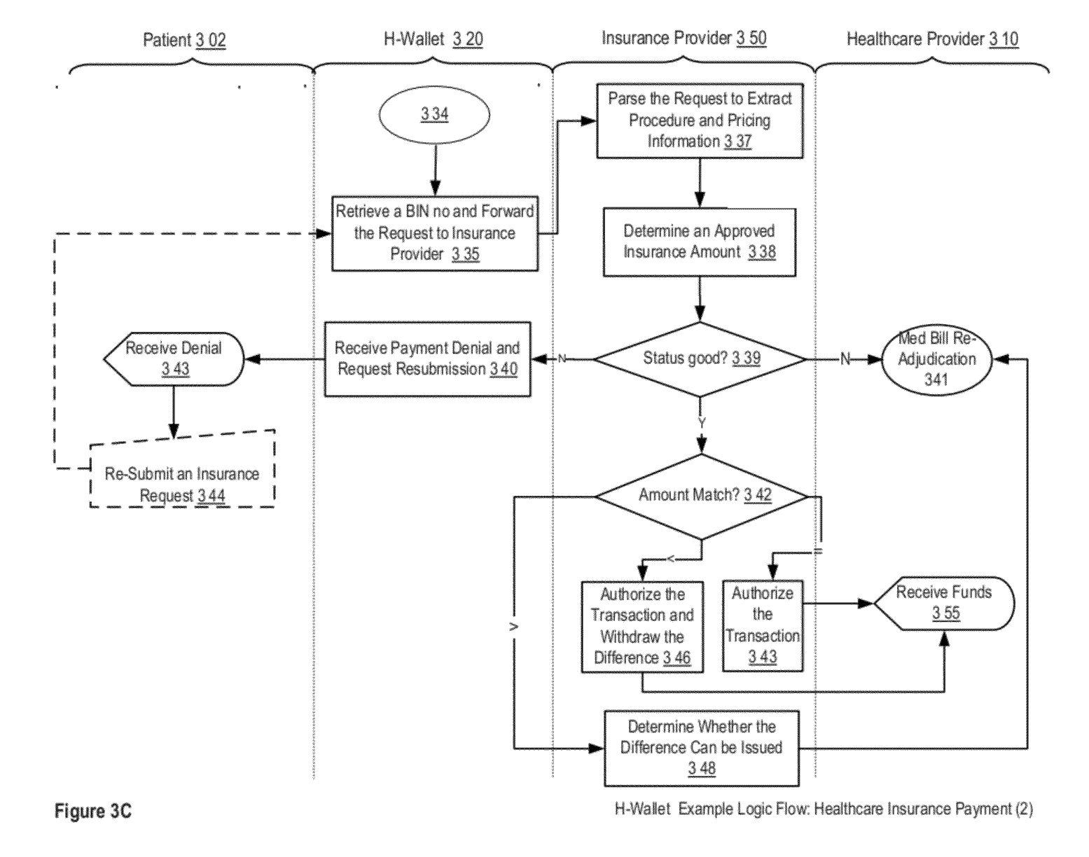

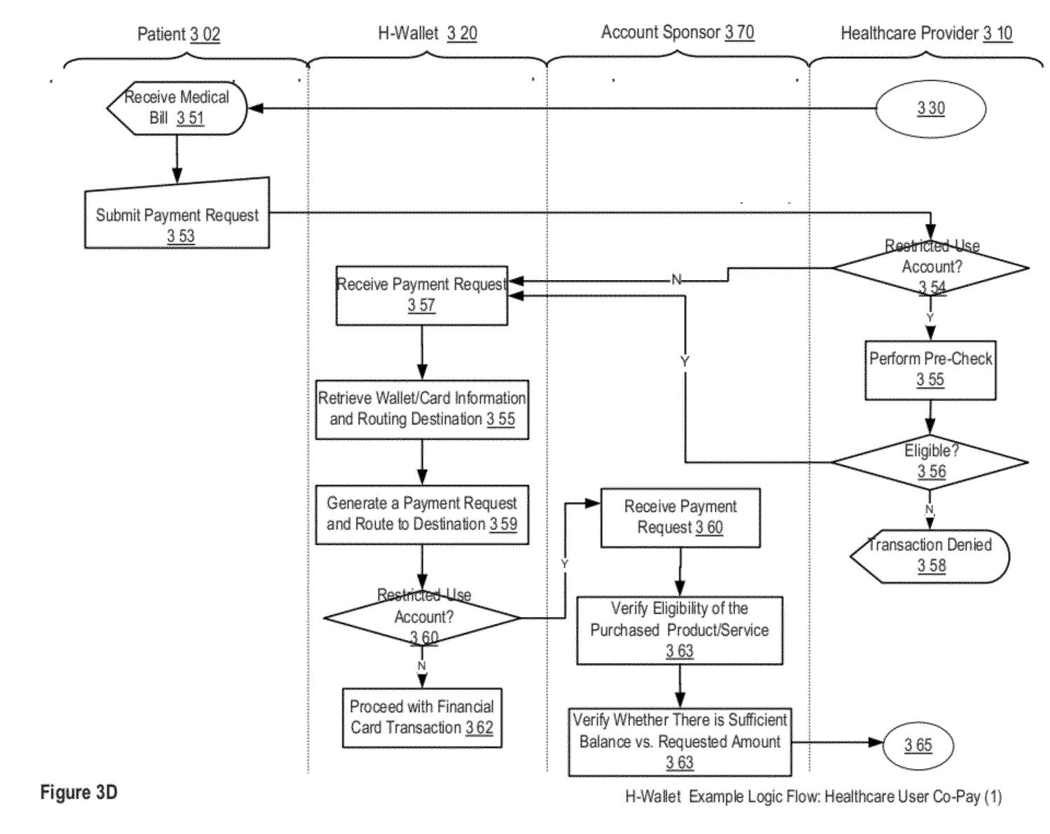

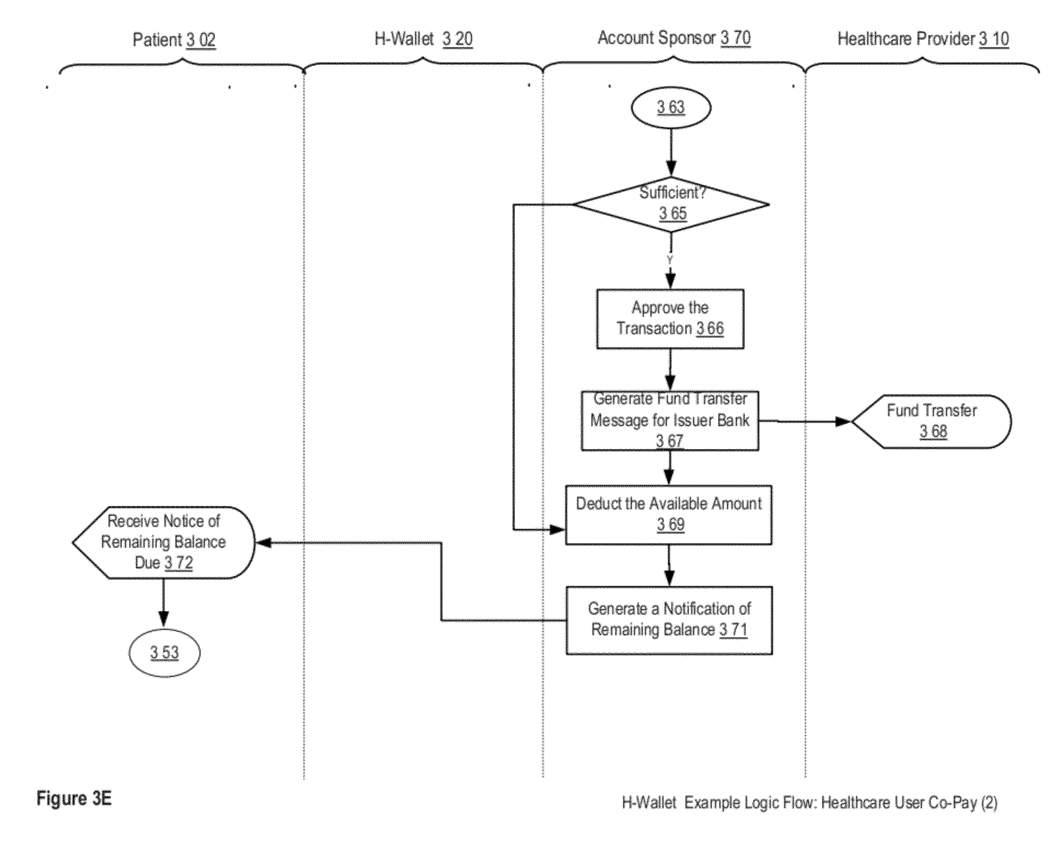

FIG. 3A provides a logic flow diagram illustrating healthcare wallet payment within embodiments of the H-Wallet. Within implementations, the user 302 may register to the H-Wallet 320 prior to utilizing the H-Wallet payment service after healthcare treatment.

In one embodiment, the user 302 may submit a request 305 for registration with the H-Wallet, e.g., via an email, a text message, a telephonic phone call to customer service, and/or the like. The H-Wallet may then provide a H-Wallet mobile component 306 to the user. For example, the H-Wallet may provide an indication, a link, etc. for downloading a mobile payment application to the user's mobile device, via which the user may register one or more multi-purpose accounts with the H-Wallet and process healthcare claims and payments in real-time.

In one embodiment, the user 302 may download and install the H-Wallet component on a mobile device 307, e.g., an Apple iPhone, etc. In further implementation, the H-Wallet may comprise a web portal, feature sets in a cloud, downloaded indicia from a cloud, and/or the like.

The user 302 may then register with the H-Wallet via the installed H-Wallet component, by submitting healthcare insurance information and setting up payment accounts 308. For example, in one implementation, the user 302 may enroll restricted use accounts into their wallet for healthcare user payment. The restricted use rules may include those for one or more HSA/FSA, one or more government insurance programs (i.e., Medicare or Medicaid), various private insurance restricted use rules, various other restricted use accounts such as employment benefit plans or employee pharmacy benefit plans, and income deduction rules.

For example, the user may associate his FSA/HSA accounts with the H-Wallet. For another example, the user may be presented rule choices within agreement and IRS policies, and set up their rules and parameters for usage of their FSA/HSA payment accounts. For example, the user may set up a rule such that any medical purchase less than $100.00 until the end of the year will be paid by his FSA account.

In one embodiment, the H-Wallet may provide default settings and rules for the user via a user interface, e.g., the mobile component installed on the user's mobile device. In another embodiment, the user may configure a variety of parameters. In the above example, the user may edit the balancing amount of an account, the end date, the rules, and/or the like.

In one embodiment, upon receiving user provided registration data and related parameters and spending rules, the H-Wallet may validate the insurance information with the insurance provider 150, and set up spending rules associated with the user's H-Wallet account 309 to complete the registration. In another implementation, the H-Wallet 120 may register the user's mobile device for security, such as, via a hardware ID, MAC address, and/or the like.

In one embodiment, after the user is present at a healthcare provider for medical services, the healthcare provider 310 may submit medical claim information 311 to an insurance provider 350 at checkout, wherein the insurance provider may approve an insured portion 312 based on the user's insurance policy. In one implementation, the user may send a payment file (e.g., via text message, email, etc.) to the H-Wallet, including the amount of patient responsibility, NPI, plan membership, SSN, etc. The H-Wallet may then verify the submitted user data with verify against the healthcare registration record. If the record matches, the H-Wallet may generate a “please pay an amount $100.00” message and send to the user.

In one implementation, the healthcare provider 310 may send the remaining balance of the medical bill to the H-Wallet for user payment processing. In another implementation, the user 302 may received a medical bill, e.g., at a mobile device, etc., in real-time at checkout, and enter the amount due 314 into his mobile device for H-Wallet.

In one implementation, the H-Wallet 320 may determine a recommended payment plan 315 to the user based on the remaining amount in the user's registered payment accounts with H-Wallet (e.g., based on the transaction nature, user's GPS location, etc.), and prompt the user to select a payment method 316. Upon receiving a confirmation of payment selection, the H-Wallet may process payment with the healthcare accounts 317, and the healthcare provider may send confirmation of payment 318.

FIGS. 3B-3C provides a logic flow diagram illustrating healthcare insurance payment within embodiments of the H-Wallet. Within embodiment, prior to receiving healthcare treatment, a user 302 may submit insurance registration request 321, e.g., to purchase an insurance program, etc. The insurance provider 350 may underwrite the insurance policy for the user 323, and store the information (e.g., see 204 in FIG. 2A) in a database, and send the insurance information 324 to the user, e.g., an insurance card, an insurance electronic entry in the user's electronic wallet, and/or the like.

In one embodiment, upon receiving medical services, the user 302 may submit insurance information 326 to healthcare provider 310, e.g., by presenting his insurance card to a representative at a checkout desk. The healthcare provider 310 may pre-check the insurance eligibility 328, such as whether the healthcare provider is in network, whether the insurance term has expired, and/or the like. If it is not eligible (e.g., expired insurance term, healthcare provider out-of-network, etc.), the user may receive an insurance ineligibility notice 331. Otherwise, the healthcare provider 310 may generate a medical bill 330, including an estimated insured amount. For example, if the insurance provider has a standard coverage list for a procedure, e.g., 40% for a root canal therapy at an in-network dental provider, etc., the healthcare provider may calculate an estimated insured amount by multiplying the total amount with 40%.

Alternatively, the healthcare provider 310 may generate a medical claim 332 to the insurance provider for adjudication 333a, e.g., to provide an approved insurance payment amount. In one implementation, the medical claim may be sent to the H-Wallet server 333b, which may generate an insurance authorization message 334 (e.g., see 219 in FIG. 2A).

Continuing on with FIG. 3C, the H-Wallet may retrieve a BIN number from the medical claim and determine a routing destination based on the BIN number; and forward the authorization request to the insurance provider 335. Upon receiving the authorization/adjudication request, the insurance provider 350 may parse the request to extract procedure and pricing information 337, and determine an approved insurance amount 338. For example, the insurance provider may assess the procedure, and determine whether the healthcare provider provided pricing is reasonable based on a variety of factors, such as, but not limited to local living expenses, market price, economic indicator, pricing information of peer healthcare providers in the same area, average income, and/or the like.

In one implementation, the insurance provider may further verify whether the user's insurance account is in good standing 339. For example, if it is an employer benefit account, the insurance provider may verify the user's employment with the sponsor (e.g., the employer) is in good standing.

In one implementation, if the insurance account is no longer eligible for the user, the H-Wallet may receive a payment denial message and be prompted to re-submit insurance information 340. The H-Wallet may then provide the denial message to the user 343, who may elect to re-submit an insurance verification request 344. Alternatively, the healthcare provider may be notified of the ineligibility of the insurance, and may adjust the medical bill 341.

Upon verification at 339, the insurance provider 350 may compare the claimed amount (e.g., the insured amount field in the medical claim message 216 in FIG. 2A) with the insurance assessed amount (e.g., at 338) 342. If the approved amount meets with the claimed amount, the insurance provider 350 may authorize a transaction of the medical claim 343 (and withdraw the difference if the insurance approved amount is greater than the claimed 346), and the healthcare provider may received the claimed amount 355. Otherwise, if the insurance assessed amount is less than the requested claim, the insurance provider may re-assess the claim to determine whether to approve the difference 348, e.g., to start a re-adjudication process 341.

FIGS. 3D-3E provides a logic flow diagram illustrating healthcare user payment within embodiments of the H-Wallet. Within embodiments, upon receiving a medical bill 351 from a healthcare provider 310, the user 302 may submit a payment request 353, e.g., by swiping a prepaid card at the healthcare provider checkout registry, by operate a mobile wallet, and/or the like. In one implementation, the healthcare provider may determine whether the user submitted payment account is a restricted use account (e.g., a FSA, HSA, LOC, etc.), and/or a sponsor administered account (e.g., Medicare, Medicaid, employment benefit account, etc.) 354. If so, the healthcare provider may perform a pre-check 355 to determine whether it is applicable based on the purchased procedure/product code. For example, a user may not engage his FSA account to pay for cosmetic products, as the product code is not in a FSA eligible category. If not eligible, the transaction may be denied 358 at the healthcare provider.

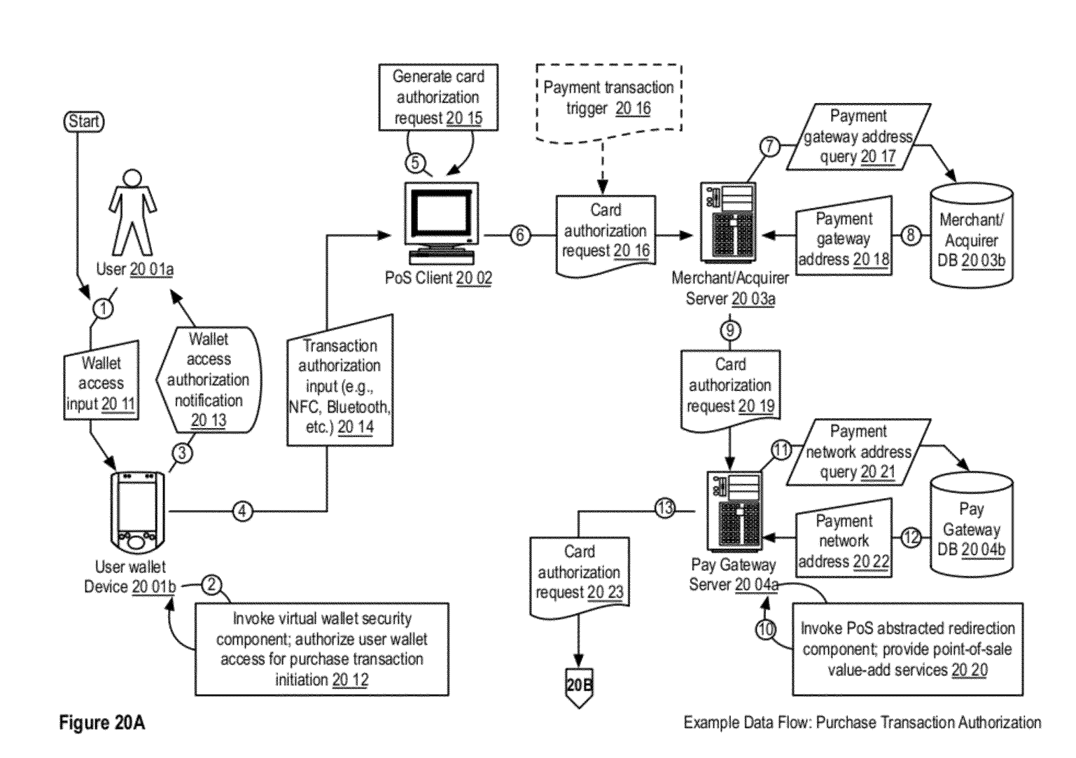

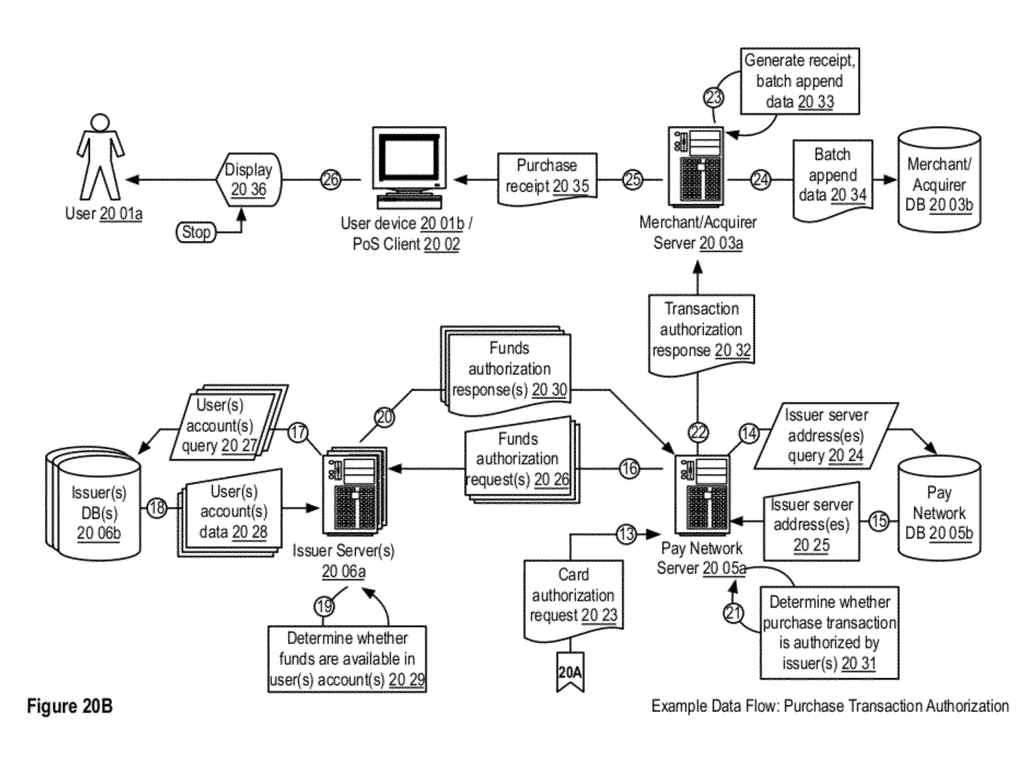

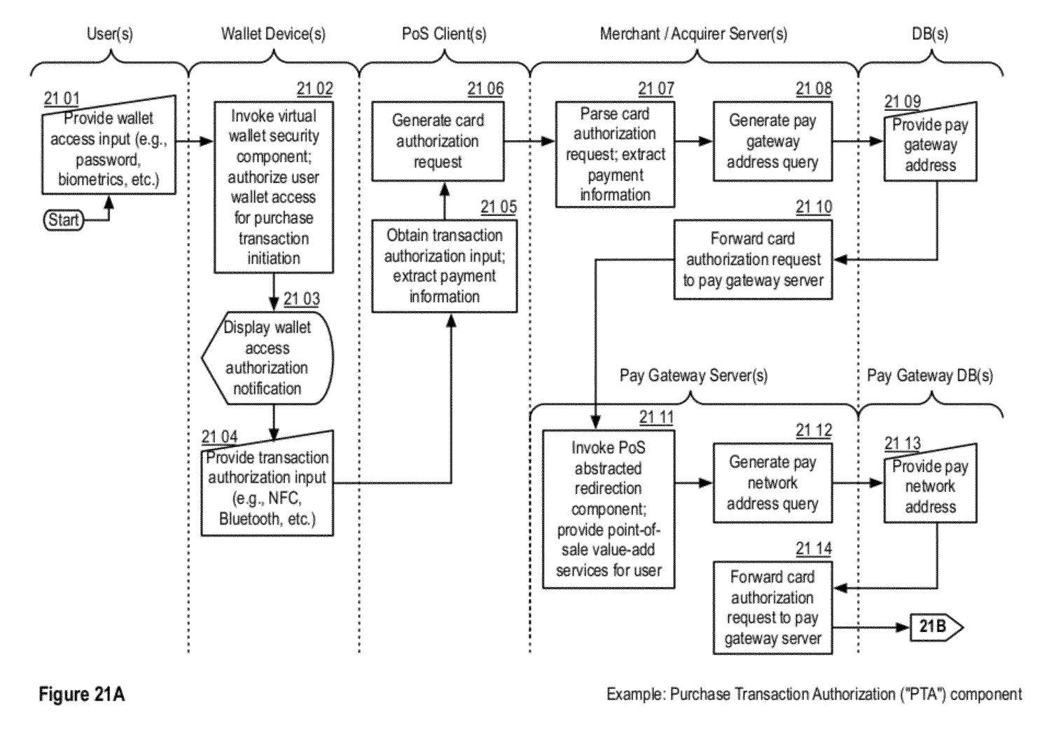

If eligible, the H-Wallet may receive the payment request 357 including user's account information (e.g., via a healthcare card, an electronic wallet, etc.). The H-Wallet may retrieve the user's wallet/card information and a routing destination 355, and generate a payment request (e.g., 233 in FIG. 2B) for the routing destination 359. If the user submitted payment account is not a restricted use account 360, e.g., a bank account, etc., the H-Wallet may proceed with financial card transaction, e.g., as further discussed in FIGS. 20A-23B.

If it is a restricted use account, the H-Wallet may send the payment request to the account sponsor 360, e.g., a FSA/HSA/LOC account manager, Medicare/Medicaid management, employer benefit account manager, and/or the like. The account sponsor 370 may verify eligibility of the purchased product/service 363, and verify whether there is sufficient balance in the user's account for the requested payment amount 363.

Continuing on with FIG. 3E, if there is sufficient funds 365, the account sponsor 370 may approve the transaction 366, and generate a fund transfer message for an issuer bank 367, which may be processed in a similar manner as discussed in FIGS. 20A-23B. The approved amount may be deducted from the user account 369 and the healthcare provider may receive payment 368. Alternatively, if there are insufficient funds in the account, the account manager may elect to approve a payment of the available amount in the account 369.

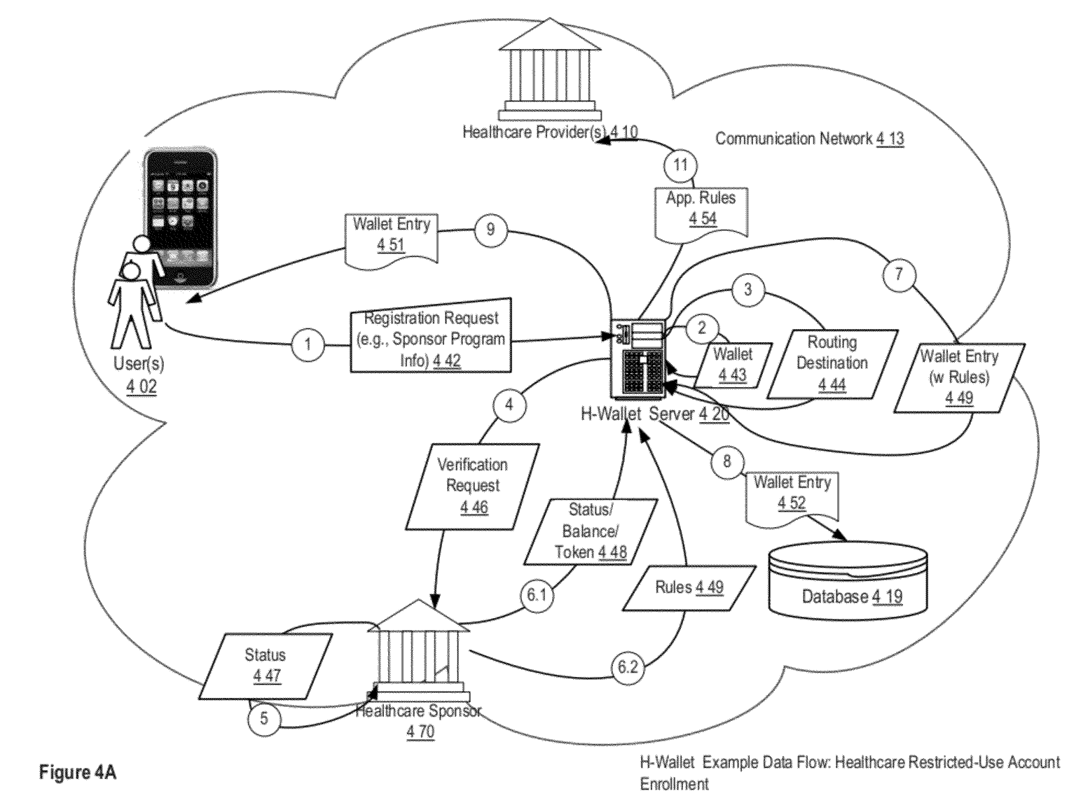

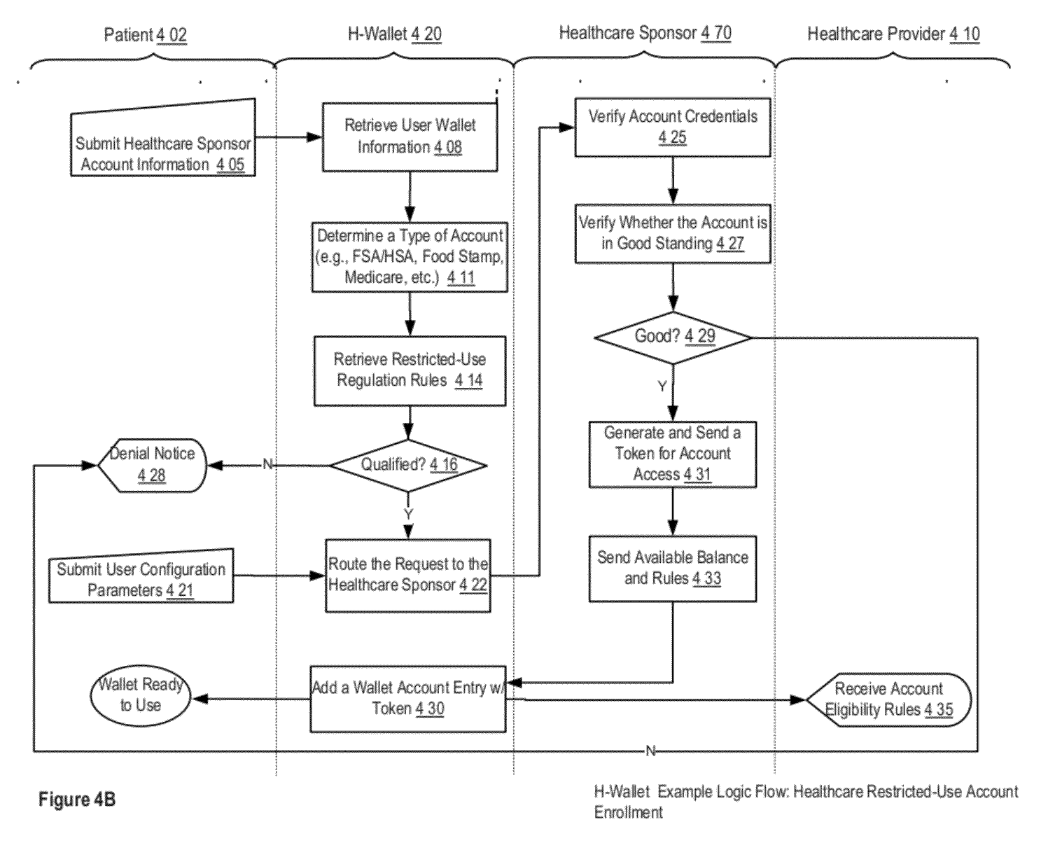

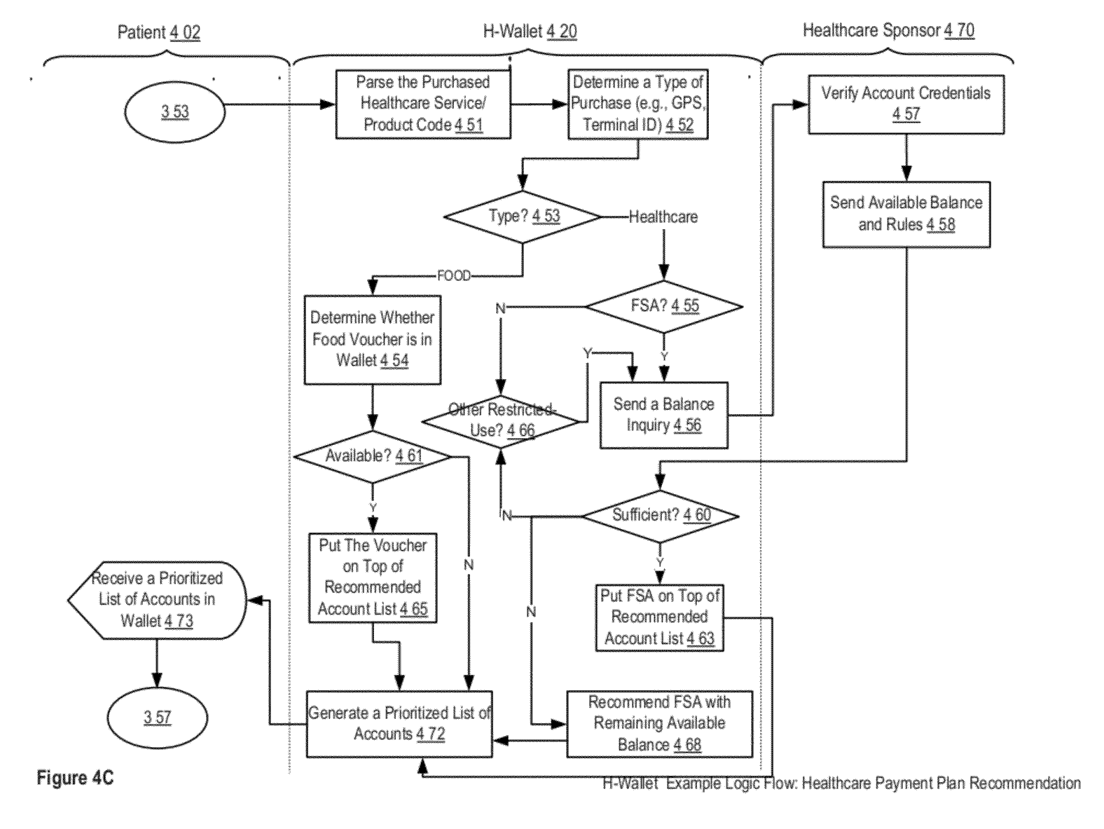

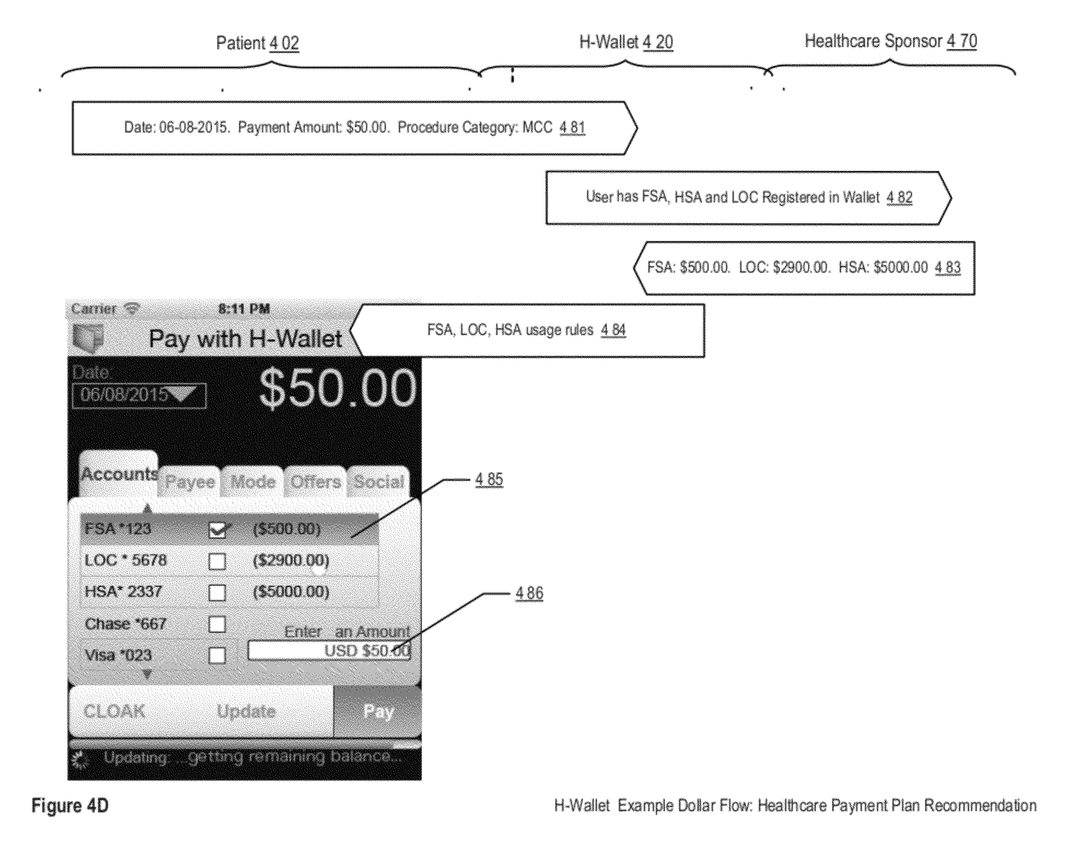

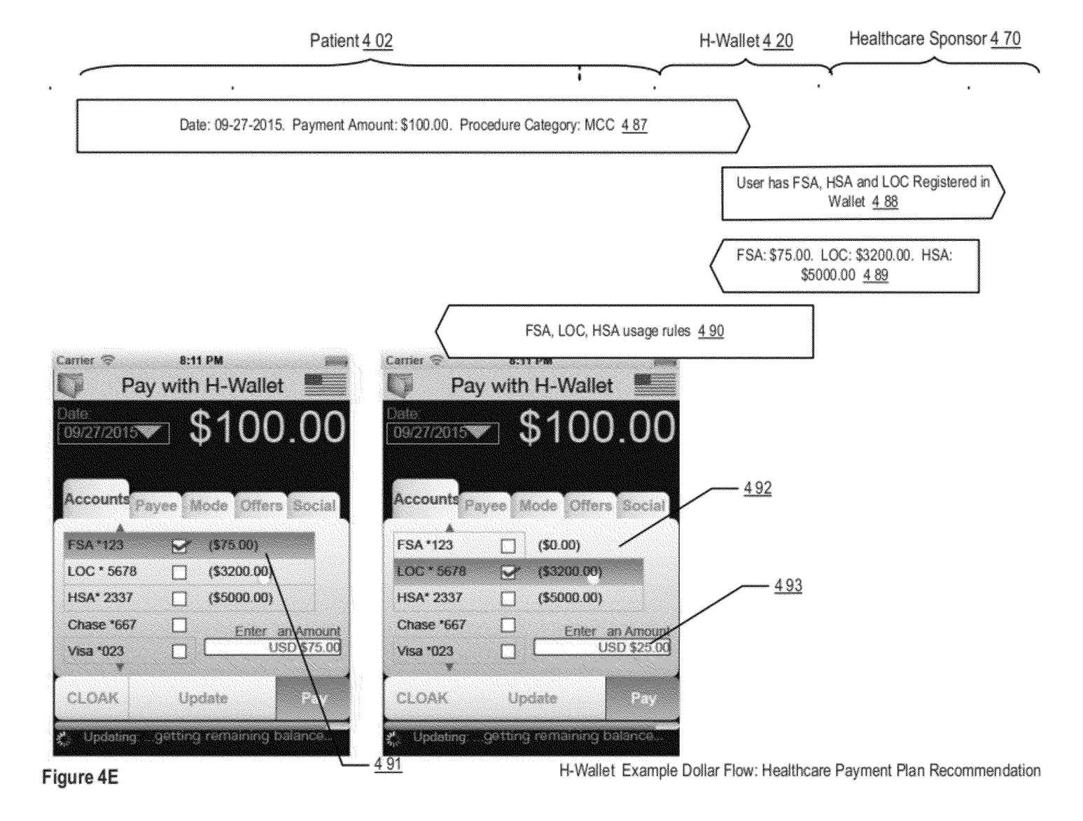

Upon the transaction, the account sponsor 370 may generate a notification of the remaining balance 371 and send it to the user 372. In one implementation, the balance updates may be performed periodically (e.g., weekly, bi-weekly, etc.), as further discussed in FIG. 4B.

FIGS. 4A-4B provide example flows illustrating user healthcare mobile wallet within embodiments of the H-Wallet. In one implementation, a user may download and install a H-Wallet mobile wallet component on a smart phone (e.g., an Apple iPhone, a BlackBerry, a Google Android, a Samsung Galaxy, etc.) or other portable web-enabled computing device. Integration of the electronic wallet reduces the number of network transactions and messages that fulfill healthcare payment approval and procurement of healthcare product and services. In this way, with the reduction of network communications, the number of transactions that may be processed per day is increased, i.e., processing efficiency is improved.

Within implementations, the mobile wallet application may be used by a user who is presented with a request to pay for healthcare service charges. When so used by the user, the mobile wallet component makes a recommendation of which the user's account to offers the greatest advantage to the user when used to pay for healthcare service charges. The mobile wallet component provides a real time decision tool for the user to choose one or more healthcare accounts from which to withdraw currency or other funds in order to pay for a healthcare service. To assist the user in making the right choice, the mobile wallet component is programmed to access local restricted use and regulatory business rules for healthcare services. The mobile wallet component is programmed to access: (i) user-specific data and (ii) balances held by the user in multiple payment accounts issued to the user who is financially responsible for the healthcare service charges. The mobile wallet component is further programmed to apply the restricted use and regulatory business rules to the online data (i.e., user-specific data and balances) in order to make a recommendation to the user as to which of the user's payment accounts be use in paying for the healthcare service charges. The user may adopt, or over ride, the mobile wallet component's recommendations. Thereafter, the user's smart phone may then be used at a healthcare service providers POS to make contactless payments from each of the user's account as were recommended by the mobile wallet component.

In one implementation, the mobile wallet component may have online access to various information for processing against the restricted use and regulatory business rules. For instance, local negative wealth impacting rules may provide various incentives and penalties as are applicable to: (a) a FSA; (b) a HSA; (c) Government Insurance (e.g.; Medicare); (d) Private Insurance; (e) Other Restricted use Accounts (e.g.; employee benefits plans); (f) Income deduction rules; (g) etc.

In one implementation, the mobile wallet component may have online access to various information for processing against insurance payment coverage rules. For instance, insurance payment coverage rules may provide various incentives and penalties as are applicable to: (a) a portion of the healthcare provided by the healthcare provider to the user that are and are not covered and thus will and will not be paid for via insurance coverage; (b) specific spending limit rules for the healthcare provider and health provided by same; (c) annual and life-time limits for spending: (i) by-the person; and (ii) by-the insurance policy; (d) limitations on the type and quantity of healthcare goods and/or services type, including but not limited to: (i) pharmacy; (ii) vision; (iii) dental, (iv) psychological; (v) substance abuse rehabilitation; (vi) etc.; (e) limitation on payments payment to a certain type of merchant, including but not limited to: (i) ‘big-box’ retailer; (ii) pharmacy retailer; (iii) physician sale of goods and services; (iv) etc.; (f) co-payments by insurance vehicle type; (g) etc.

In one implementation, the mobile wallet component may have online access to currency balances available for use, and respective calendar dates of availability, to pay the balance due bill for the healthcare provided by the healthcare provider. For instance, these accounts may include: (a) a Flexible Savings Account (FSA), where data retrieved may include a current currency balance, a date by which all funds in FSA must be spent; (b) a Health Savings Account (HSA), where data retrieved may include a liquid asset balance and a non-liquid asset balance (e.g.; stocks, mutual funds, Certificates of Deposit, etc.), and an amount charged for a commission to trade an illiquid asset for a liquid asset that may be used to pay the balance due bill from the healthcare provider; (c) a remaining deductible contribution amount to a healthcare-relates account amount for a specific year; (d) a government insurance prepaid account; (e) a private insurance deductible information; (e) other restricted use accounts (e.g.; employee benefits plans); (f) non-restricted use payment accounts (e.g.; credit, debit, prepaid accounts) including information for these accounts such as loyalty points and awards having currency equivalents that may be made available for payment against the balance due bill and award thresholds for such loyalty points and awards. The mobile wallet component may also have online access to a prediction as to the likely income and local financial bracket of the user for year in which the healthcare provider's balance billing is due.

In still another implementation, a healthcare provider provides healthcare services (e.g., medical treatment, etc.) and/or products (e.g., prescription drugs, etc.) to a user. One or more insurance carriers are queried by the healthcare provider to obtain payment for the healthcare provided by the healthcare provider to the user. When the insurance carriers have not paid, or are unlikely to pay, for the healthcare, then the healthcare provider calculates a balance due bill for which the user is financially responsible. A Point of Service terminal (POS) transmits the balance due bill to the user's smart phone. The smart phone executes a mobile wallet component to perform real time online access to various databases. This real time access obtains business rules and user data sufficient for the mobile wallet component to derive a recommendation as to which the user's accounts will provide the greatest advantage to the user when used to pay for healthcare service charges, both goods and services, of the balance due bill. The user's smart phone may then send a transmission to the healthcare provider's POS as a contactless payment from each of the user's recommended accounts. For each account in the recommendation: (i) the healthcare provider's POS sends the user's proposed payment amount to an acquirer for the healthcare provider; (ii) the acquirer sends an authorization request for the amount to a transaction handler (i.e., VisaNet) who sends the authorization request to the corresponding issuer of the user's account. Note that, in addition to the VisaNet network provided by Visa Inc., other networks (such as Discover and American Express) may be used to accept healthcare service payment transactions. Moreover, other payment options may also be made, such as ACH or online bill pay, each of which could be facilitated by either the foregoing implementations or by being routed to another payment portal; and (iii) the issuer sends an authorization response back to the transaction handler who sends the authorization response back to the healthcare provider's acquirer. Assuming that the healthcare provider's payment is authorized by the issuer, the smart phone receives an electronic acknowledgement of payment from each of the issuers 8 for each of the accounts. Clearing and settlement will then follow for each account selected by the user to pay the healthcare provider.

In the foregoing implementation, the derivation of the recommendation may rely on an application of mathematical (quantitative) techniques to make a healthcare payment decision recommendation. To do so, the user's financial and insurance penalties and incentives are defined and modeled as a set of mathematical equations. Data that is also made available for the derivation are currency balances, and dates as to availability of same, in one or more accounts to which the user has access for payment of the balance due bill. The equations are subjected to computer analysis to yield an optimized solution as to those user's accounts that will provide the greatest advantage to the user when used to pay for healthcare service charges, both goods and services, as defined in the balance due bill from the healthcare provider. Optimizing the solution may requires one or more iterations to test against various circumstances and situations until the optimized solution is found for making the recommendation. The set of mathematical equations may apply any of several different approaches, including but not limited to dynamic and linear programming, as well as forecasting and simulation techniques such as the Monte Carlo method.

FIG. 4A provides a data block diagram illustrating data flow between healthcare payment entities (H-Wallet server, user and affiliated entities) for H-Wallet account management within embodiments of the H-Wallet. Within various embodiments, as shown in FIG. 4A, one or more user(s) (patient(s)) 402, H-Wallet server 420, H-Wallet database(s) 419, healthcare provider(s) 410, a healthcare sponsor 470, and/or the like are shown to interact via various communication networks 413 to facilitate H-Wallet account management.

Within embodiments, the H-Wallet server 420, or a healthcare sponsor 470 may act as a BIN sponsor. For example, the user 402 may submit healthcare benefit program information 442 to the H-Wallet server 420 in order to add a healthcare benefit account (e.g., FSA/HSA, LOC, Medicare, Medicaid, employee benefit program, etc.) to the electronic wallet. For example, in one implementation, the user may fill in an online application form, may call up a wallet management agent, may send a request via instant messages, emails, and/or the like. In another implementation, the user may be provided the option to register with H-Wallet service when the user enrolls in a healthcare benefit program. For example, an XML-formatted user registration request including user information 442 may take a form similar to the following:

```
POST /RegistrationRequest.php HTTP/1.1
Host: 64.255.64.00
Content-Type: Application/XML
Content-Length: 718
<?XML version = “1.0” encoding = “UTF-8”?>
<RegistrationRequest[is this the same as Sponsor Program Info?
That's what the figure shows it as... I think one or the other is off?]>
<Time> 17:42:40 </Time>
<Date> 09-01-2014 </Date>
<RequestType> Add Account </RequestType>
<RequestID> JS09012011 </RequestID>
<User>
  <UserName> John Smith </UserName>
  <WalletID> JS0000 </UserID>
  <Password> 0000 </Password>
  <PasswordQ>
    <Question1> Where were you born </Question1>
    <Answer1> New York </Answer1>
    ...
  </PasswordQ>
  <Phone>
    <Cell> 000-000-0000 </Cell>
    <Day> 111-111-1111 </Day>
  ...
  </Phone>
  <Address>
    <Line1> 122 Apple Ave </Line1>
    <City> Big City </City>
    <State> CA </State>
    <ZipCode> 99920 </Zipcode>
  </Address>
  ...
</User>
<Account>
  <AccountType> FSA </AccountType>
  <AccountNo> 123456 </AccountNo>
  <BIN> FSA-00133 </BIN>
  ...
</Account>
...
</RegistrationRequest>
```

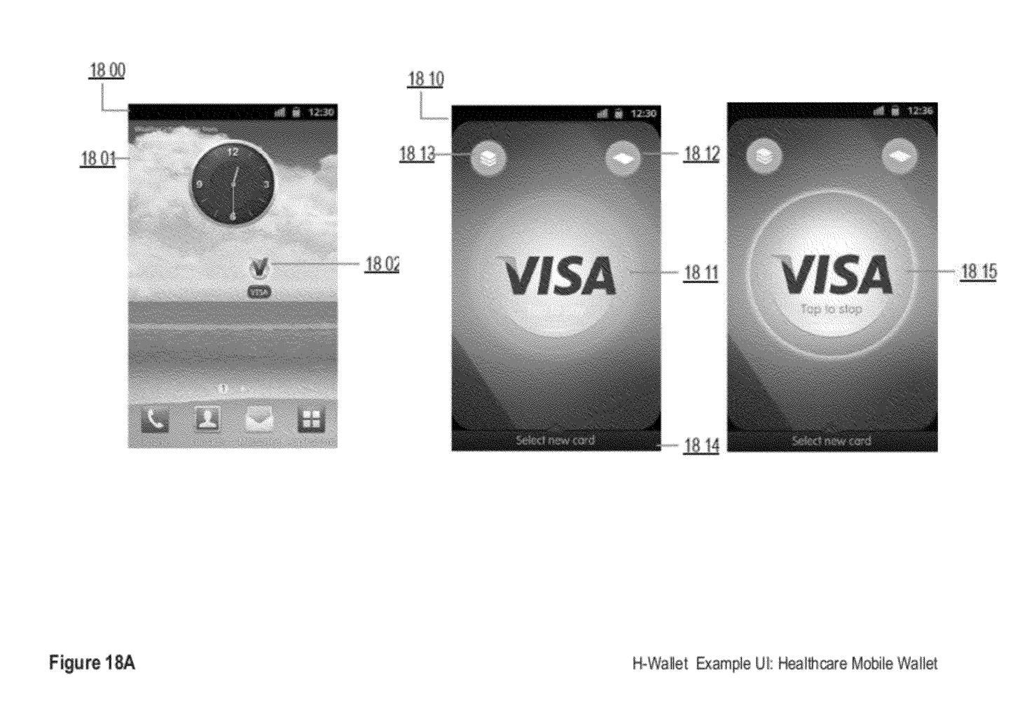

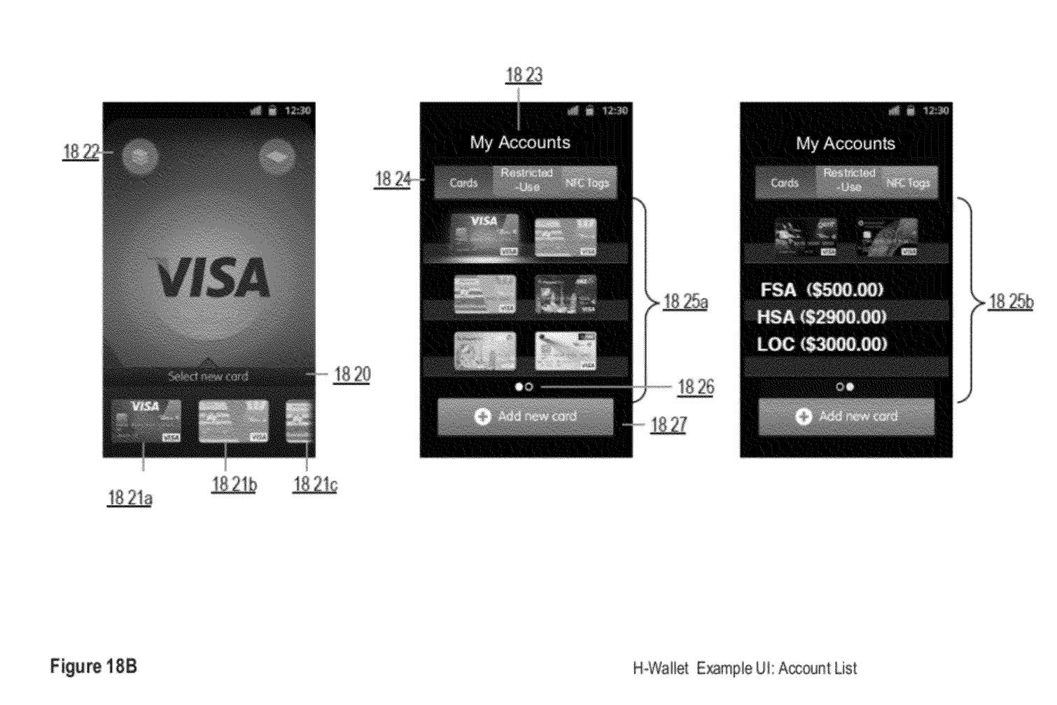

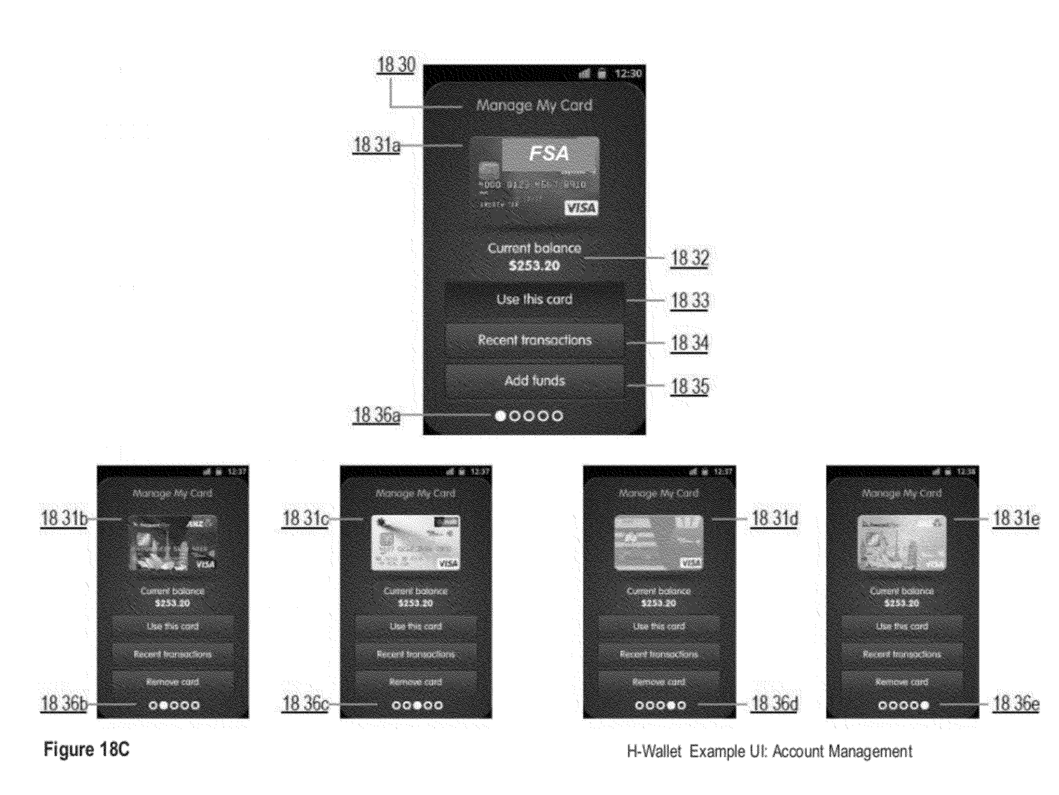

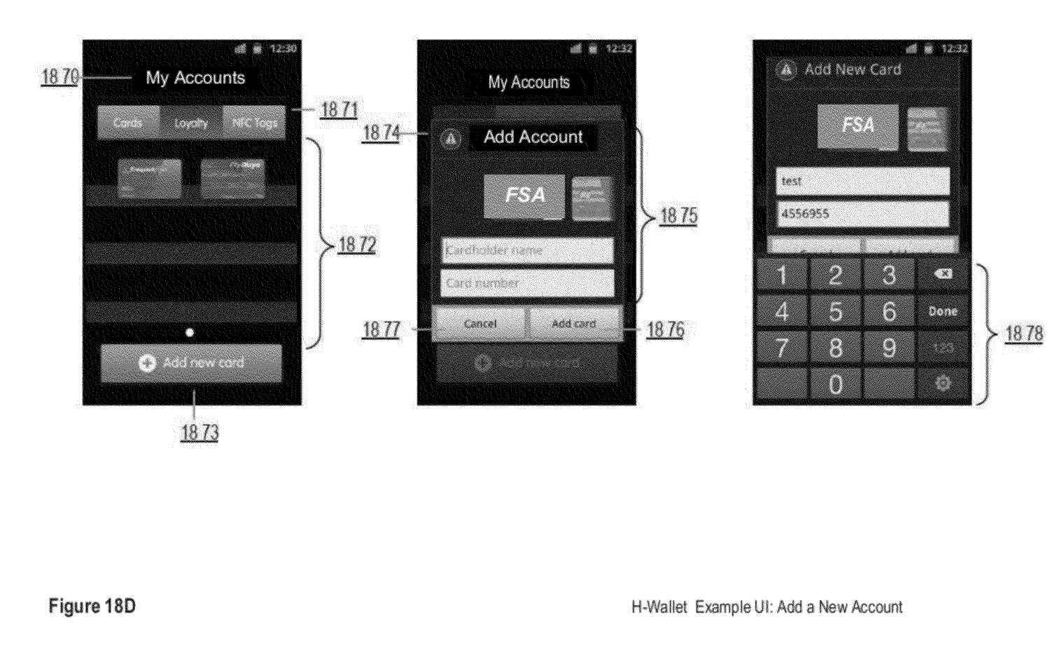

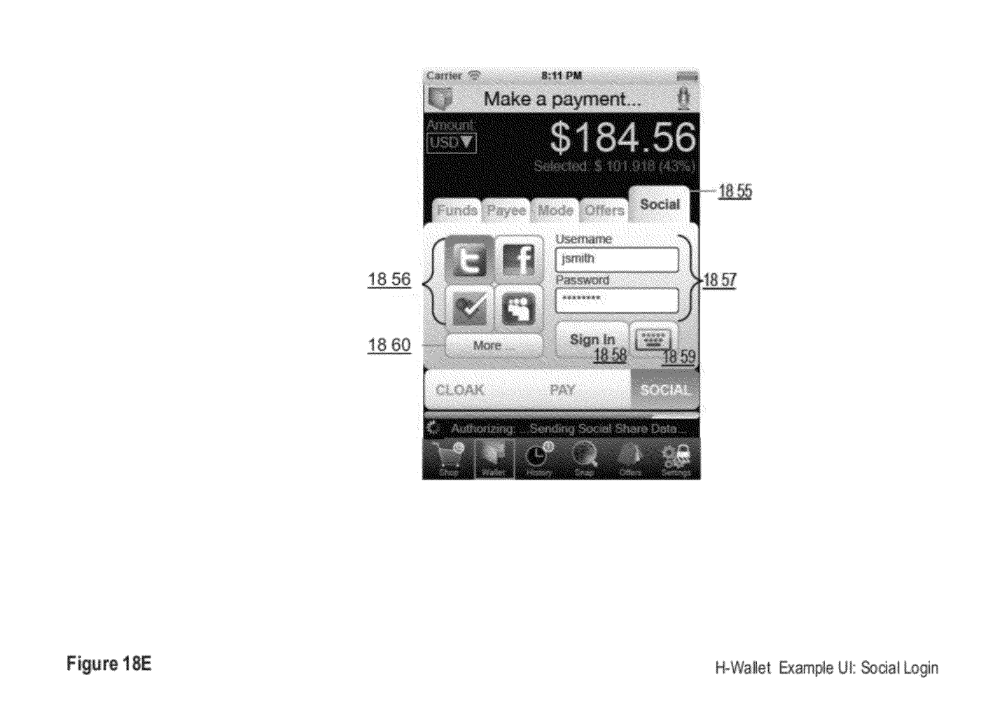

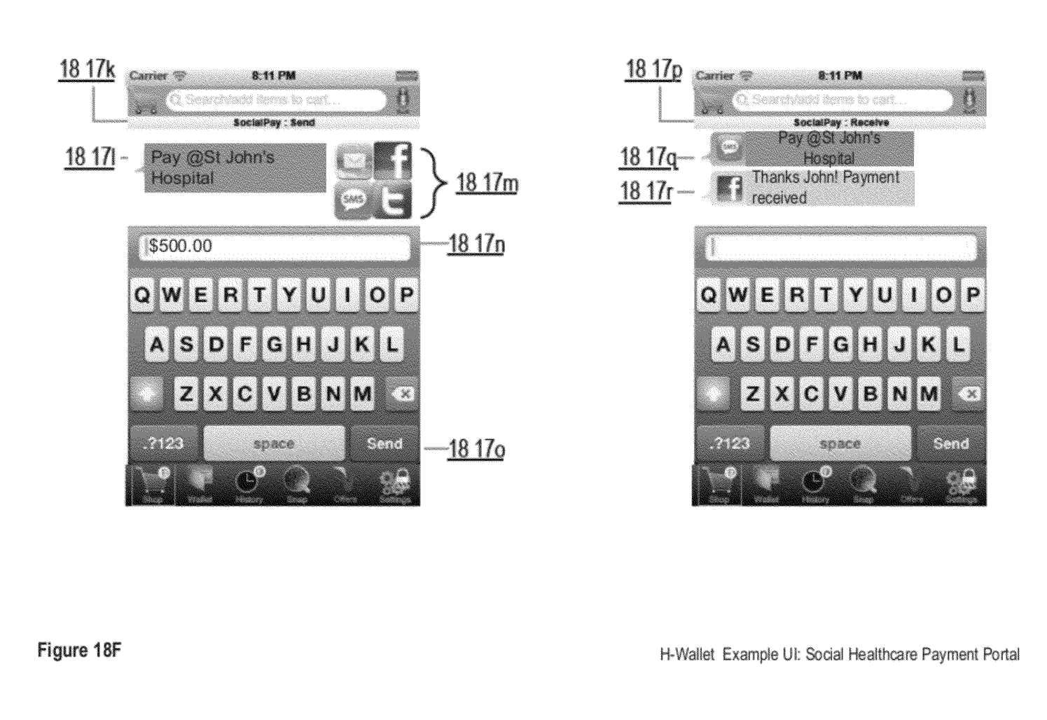

In one implementation, the H-Wallet may provide virtual prepaid card including a card number without sending physical magnetic cards, e.g., an electronic mobile wallet entry 451 for the user to download and instantiate on his mobile wallet (e.g., see healthcare wallet in FIGS. 18A-19B). For example, in further implementations, an additional wallet may be created for general spends.

In further implementations, funds on the additional healthcare wallet account may be separately loaded by the user. For example, fund loading to a FSA/HSA account may be performed by the user setting aside a portion of his income. In another implementation, the user may select a “back-up” account (e.g., a credit card account, a debit account, etc.) as a default account for user co-pay if payment request via the selected healthcare benefit account is denied by the healthcare sponsor 470, e.g., an ineligible healthcare service, etc.

In one implementation, the H-Wallet server 420 may retrieve the user's wallet information 443, and determine a routing destination 444 of the added account from the healthcare benefit program information 442, to generate a verification request 446 to the healthcare sponsor entity 470. For example, the verification request 446 may comprise information fields similar to that of the user submitted healthcare benefit account information 442. Below is an example HTTP(S) POST message including an XML-formatted message of the account access/verification request message 446:

```
POST /AccessRequest.php HTTP/1.1
Host: www.H-Wallet.com
Content-Type: Application/XML
Content-Length: 718
<?XML version = “1.0” encoding = “UTF-8”?>
<AccessRequest>
    <Time> 17:42:52 </Time>
    <Date> 09-09-2014 </Date>
    <RegistrationID> JS09012011 </RegistrationID>
    <Account>
    <AccountType> FSA </AccountType>
    <AccountNo> 123456 </AccountNo>
    <BIN> FSA-00133 </BIN>
    ...
    </Account>
  ...
    <User>
      <UserName> John Smith </UserName>
      <UserID> JS0000 </UserID>
      <AccountNo> 0000 0000 0000 </AccountNo>
      <Password> 0000 </Password>
      <Question1> Where were you born </Question1>
      <Answer1> New York </Answer1>
      </Password>
      ...
    </user>
    ...
</AccessRequest>
```

Within implementations, the healthcare sponsor entity 470 may verify the credentials and authorize the access request from H-Wallet. For example, the healthcare sponsor 470 may determine whether user credentials, confirmation, etc. are received to indicate authorization from account owner, whether the benefit sponsor allows the access, etc. In one implementation, the healthcare sponsor 470 may provisionally make a small amount deposit into the account that H-Wallet attempts to link to, e.g., $0.65, etc., and request the user to enter the numeric value of the deposit to prove authorization. For example, the user may receive confirmation request via email, instant messaging, phone calls, text messages, wallet notices, and/or the like, to provide the deposited numeric value. For another example, the healthcare sponsor 470 may contact a healthcare benefit program sponsor (e.g., a government agency representative, an employer, etc.) to verify the account access request 446.

In one implementation, the healthcare sponsor entity 470 may verify the status 447 of the healthcare benefit account, and may send a status including the currently available balance 448 to the H-Wallet server. For example, the healthcare sponsor entity 470 may generate a HTTPS POST message including an XML-formatted status message 448 may take a form similar to the following:

```
POST /FSAstatus.php HTTP/1.1
Host: 64.255.64.00
Content-Type: Application/XML
Content-Length: 718
<?XML version = “1.0” encoding = “UTF-8”?>
<FSAstatus>
<Time> 17:45:40 </Time>
<Date> 09-01-2014 </Date>
<User>
  <UserName> John Smith </UserName>
  <WalletID> JS0000 </UserID>
  <Password> 0000 </Password>
  ...
</User>
<Account>
  <AccountType> FSA </AccountType>
  <AccountNo> 123456 </AccountNo>
  <BIN> FSA-00133 </BIN>
  <Token> %%\hat{ }&SDSADFWF </Token>
  <Balance> 3000.00 </Balance>
  <LastUpdate> 17:45:00 </LastUpdate>
  ...
</Account>
<Rule>
  <Maximum> 3000.00 </Maximum>
  <ClearancePeriod> 24 hrs </ClearancePeriod>
  <Term>
    <StartDate> 01-01-2015 </StartDate>
    <EndDate> 12-31-2015 </EndDate>
    ...
  </Term>
  <ProcedureList>
    <Code1> 000 </Code1>
    <Code2> ... </Code2>
  </ProcedureList>
...
</Rule>
...
</FSAstatus>
```

Within implementations, the H-Wallet server 420 may constantly, periodically, and/or intermittently send inquiries to the healthcare benefit sponsor entity 470 for available balance updates.

In one implementation, upon verifying with the healthcare sponsor entity 470, the H-Wallet server 420 may generate an additional entry 449 on the user's electronic wallet 443, wherein the entry may comprise the added account information, user verification information, healthcare benefit account rules, and/or the like that may prompt the user to provide additional payment method into the electronic wallet. In one implementation, the H-Wallet mobile wallet entry 449 including the payment account entry, may take a form similar to the following XML-formatted data message:

```
<H-Walletentry>
  <UserName> John Smith </UserName>
  <UserID> JS0000 </UserID>
  <UserContactNo> 000 000 0000 </UserContactNo>
  <Password> 0000 </Password>
  <PasswordQ>
    <Question1> Where were you born </Question1>
    <Answer1> New York </Answer>
    ...
  </PasswordQ>
  <Account>
    <AccountType> FSA </AccountType>
    <AccountNo> 123456 </AccountNo>
    <BIN> FSA-00133 </BIN>
    <Token> %%\hat{ }&SDSADFWF </Token>
    <Balance> 3000.00 </Balance>
    <LastUpdate> 17:45:00 </LastUpdate>
  ...
  </Account>
  <Rule>
    <Maximum> 3000.00 </Maximum>
    <ClearancePeriod> 24 hrs </ClearancePeriod>
    <Term>
    <StartDate> 01-01-2015 </StartDate>
    <EndDate> 12-31-2015 </EndDate>
    ...
    </Term>
    <ProcedureList>
    <Code1> 000 </Code1>
    <Code2> ... </Code2>
    </ProcedureList>
  ...
  </Rule>
  <Certificate>
    <UserToken> fdsjreiorrgr8t9340548 </UserToken>
    </DigitalCertificate> rfsfsuifuisduifu </DigitalCertificate>
    <Hash> 00000 </Hash>
    ...
  </Certificate>
...
</H-Walletentry>
```

In further implementation, the new wallet account entry 451 may be provided to the user wallet, e.g., the user may view a newly added “FSA” account into his wallet, and the account record 452 may be saved at the database 419. For example, the H-Wallet server may execute a hypertext preprocessor (“PHP”) script including SQL commands to query the database for wallet account data, and/or the like. An example PHP/SQL command listing, illustrating substantive aspects of storing a wallet account entry 452 in the database:

<?PHP
header(‘Content-Type: text/plain’);
mysql_connect(″202.155.66.130”,$DBserver,$password); // access
database server
mysql_select(″WALLET_ENTRY.SQL″); // select database to append
mysql_query(“INSERT INTO Wallet_Entry (user_id, user_name,
user_password, user_contact, user_passwordQ, account_type,
account_no, account_BIN, account_token, account_balance,
Account_lastupdate, rule_maximum, clear_period, start_date,
end_date,..., certificate ...)
VALUES ($user_id$, $user_name$, $user_password$, $user_contact$,
$user_passwordQ$, $account_type$, $account_no$, $account_BIN$,
$account_token$, $account_balance$, $Account_lastupdate$,
$rule_maximum$, $clear_period$, $start_date$, $end_date$,...,
$certificate$ ...) //
add data to table in database
mysql_close(″Wallet_Entry.SQL″); // close connection to database
?>

In one implementation, the associated applicability rules 454 may be provided to a list of healthcare providers 410 for pre-check purposes. For example, the H-Wallet server 420 may provide the applicability rule to healthcare providers within a range of zip codes based on the user's location, and/or the like. For example, the H-Wallet server may generate a HTTPS POST message including an XML-formatted applicability rules message 454, which may take a form similar to the following:

```
POST /Rules.php HTTP/1.1
Host: 64.255.64.00
Content-Type: Application/XML
Content-Length: 718
<?XML version = “1.0” encoding = “UTF-8”?>
<Rules>
<Time> 17:45:55 </Time>
<Date> 09-05-2014 </Date>
<AccountType> FSA </AccountType>
<AccountSponsor> FSA-PPA </AccountSponsor>
<ApplicableMerchant>
  <MerchantCode1> MC0001 </MerchantCode1>
  <MerchantCode2> ... </MerchantCode2>
  ...
</APplicableMerchant>
<ApplicableProducts>
  <ProductCode1> PA001 </ProductCode1>
  <ProductCode2> ... </ProductCode2>
  ...
</APplicableProducts>
<Procedures>
  <ProcedureCode1> KH0938 </ProcedureCode1>
  ...
</Procedures>
...
</Rule>
```

In the above example, the H-Wallet may provide a list of applicable healthcare providers, products, procedures and/or the like, which are applicable for FSA account usage, to a healthcare provider. In further implementations, a user may configure user submitted rules for account usage, as further discussed in FIGS. 4B, 4D and 4E.

FIG. 4B provides a logic flow diagram illustrating H-Wallet restricted use account enrollment within embodiments of the H-Wallet. Within embodiments, a user 402 may submit a healthcare sponsor account information 405 (e.g., a FSA/HSA/LOC account number, Medicare/Medicaid insurance ID, and/or the like), and wallet information. The H-Wallet 420 may retrieve user wallet information 408, and determine a type of the account (e.g., FSA/HSA, food stamp, Medicare/Medicaid, unemployment benefit, etc.) 411. The H-Wallet may retrieve restricted use regulation rules 414, and determine whether it is qualified for enrollment with the wallet 416, e.g., whether the regulatory policy permits the enrollment. If not, the user may receive a denial notice 428. If yes, the H-Wallet may route the enrollment request to the healthcare sponsor 422 for verification 422.

In one implementation, the healthcare sponsor 470 may verify the account credentials 425, user profile, account status 427, and/or the like. If the account is in good standing 429, the healthcare sponsor may generate and send a token for account access 431 to the H-Wallet, and the most recent balance information and account rules 433 to the H-Wallet. For example, in one implementation, the account rules may include a list of procedure/product code and/or merchant code (MCC) applicable for the account usage.

In one implementation, the H-Wallet may store the security token and add a wallet entry 430 to the wallet “my account” list (e.g., 1870 in FIG. 18D), and the enrolled account is ready to use with wallet payment.

FIG. 4C provides a logic flow diagram illustrating H-Wallet restricted use payment plan recommendation within embodiments of the H-Wallet. Within embodiments, continuing on with receiving user payment request at 353 in FIG. 3D, the H-Wallet may parse the purchased healthcare service/product code 451 to determine a type of the purchase 452. In further implementations, the H-Wallet 420 may determine the purchase type based on the GPS information, terminal ID, and/or the like. For example, the user's location at a physician's office may suggest a healthcare purchase, but a location at a grocery store may suggest food purchase, e.g., 453.

In one implementation, if the product code and/or terminal ID shows the purchased product comprises food, the H-Wallet may determine whether food voucher is enrolled in the wallet 454. If there is a food stamp account 461, the H-Wallet may put the food stamp/voucher account on top of a recommended account list 465.

In another implementation, if the product code and/or terminal ID shows a healthcare purchase, the H-Wallet may determine a recommended plan based on user specified rules. For example, if the user prefers to pay with FSA, the H-Wallet may determine whether there is FSA 455 enrolled in the wallet. If yes, the H-Wallet may send a balance inquiry 456 to the healthcare sponsor 470, which may verify the account credentials (e.g., a token, etc.) 457 and return the available balance 458. The H-Wallet may proceed to determine whether there is sufficient balance 460. If yes, the H-Wallet may put FSA on top of a recommended account list 463. If not, the H-Wallet, may recommend FSA with the remaining available balance 468. The H-Wallet may query for other enrolled restricted use accounts 466 in a similar manner.

In one implementation, the H-Wallet may generate a prioritized list of accounts 472 and presented to the user 473 in the wallet payment page, e.g., as illustrated in FIGS. 4D-4E.

FIGS. 4D-4E provides a dollar amount payment flow illustrating H-Wallet account recommendation within embodiments of the H-Wallet. In one implementation, a user may set up accounts and spending rules for the enrolled restricted use accounts, e.g., at 421 in FIG. 4B. For example, the H-Wallet rules may be illustrated in one example in the following table:

| | |
|---|---|
| Primary Account: | Flexible Spending Account (FSA) |
| Balance: | $500.00 |
| End Date: | Dec. 31, 2015 |
| Rules: | 1. Only use for medical MCC |
| | 2. Use for purchases less than $100.00 |
| | until Oct. 01, 2015 |
| | 3. After Oct. 01, 2015, use available |
| | balance for all medical MCC purchases. |
| Second Account: | Health Savings Account (HSA) |
| Balance: | $5000.00 |
| Rules: | 1. Use for medical MCC |
| | 2. Use for purchases greater than 2000.00 |
| | 3. Use as tertiary fund for medical MCC |
| | purchases |
| Third Account: | Revolving Line of Credit (LOC) |
| Credit Line: | $5000.00 |
| Rules: | 1. Use for any MCC |
| | 2. Use for purchases greater than $100 but |
| | less than $2000.00 |
| | 3. Use as secondary account for medical |
| | purchase |

For example, as shown in FIG. 4D, if a user 402 goes to a primary care physician on Jun. 8, 2015, i.e., more than half a year to the end date to his FSA, and a medical bill indicates a co-pay amount of $50.00 (e.g., at 481), the user may enter $50.00 into the H-Wallet mobile application and indicate it is medical purchase. Upon verifying the eligibility of medical purchase, the H-Wallet 420 may retrieve applicable healthcare restricted use accounts, and determine the user has his FSA, HSA and LOC accounts enrolled 482. The H-Wallet may then update the balance information of each account with the account sponsors 470, e.g., see also 448 in FIG. 4A.

In one implementation, the H-Wallet may assess the rules in the above example, and provide a screen of options showing the remaining balances in the three accounts 484, e.g., ranked as FSA ($500.00), LOC ($2900.00), HSA ($5000.00). In one implementation, the H-Wallet may list the available accounts in a prioritized order based on the spending rules, showing the balance of each account 485. It should be noted that although mobile user interface elements are depicted, web, desktop and other interfaces are contemplated for all the user interfaces throughout the disclosure. In this example, although LOC is the third account after the HSA, LOC is listed prior to HSA as the rule specifies LOC is applied as secondary account for medical purchase. In one implementation, the H-Wallet may put a default dollar amount as $50.00 (e.g., 486) for payment, or the user may change it by type a different amount.

For another example, as shown in FIG. 4E, if the user 402 goes to a physical therapist at Sep. 27, 2015, i.e., approximately three months to the end date of FSA, and the patient's responsibility is $100.00, the user may enter $100.00 into the H-Wallet mobile component and confirm it is medical purchase 487. In FIG. 4E, the user may press a “pay” button and enter an amount and type of purchase 493. The H-Wallet 420 may retrieve applicable healthcare restricted use accounts, and determine the user has his FSA, HSA and LOC accounts enrolled 488. The H-Wallet may then update the balance information of each account with the account sponsors 489, e.g., see also 448 in FIG. 4A, responded by listing the remaining balances, e.g., FSA ($75.00), LOC ($3200.00), and HSA ($5000.00), etc. In this case, even if the FSA has insufficient funds, it is on top of the prioritized list because it will expire at the end of the year. As the remaining balance in FSA is insufficient to cover the amount due, the user may split the amount by selecting FSA to pay $75.00 491 and LOC to pay the remaining $100−$75=$25. For example, after paying $75.00 with FSA, the FSA account may have an updated balance of 0.00 492. The user may elect to pay the remaining $25.00 493 with the LOC account. The H-Wallet may send a report summary to the user including the updated remaining balance of the accounts after payment, and/or the like.

For another example, if the user received a surgery on Sep. 30, 2015, i.e., approximately three months to the end date of FSA, and received a medical bill of $2000.00, but the current accounts have available balances of LOC ($3000.00), FSA (0), HSA ($5000.00). In this case, the user may elect to select HSA for the payment.

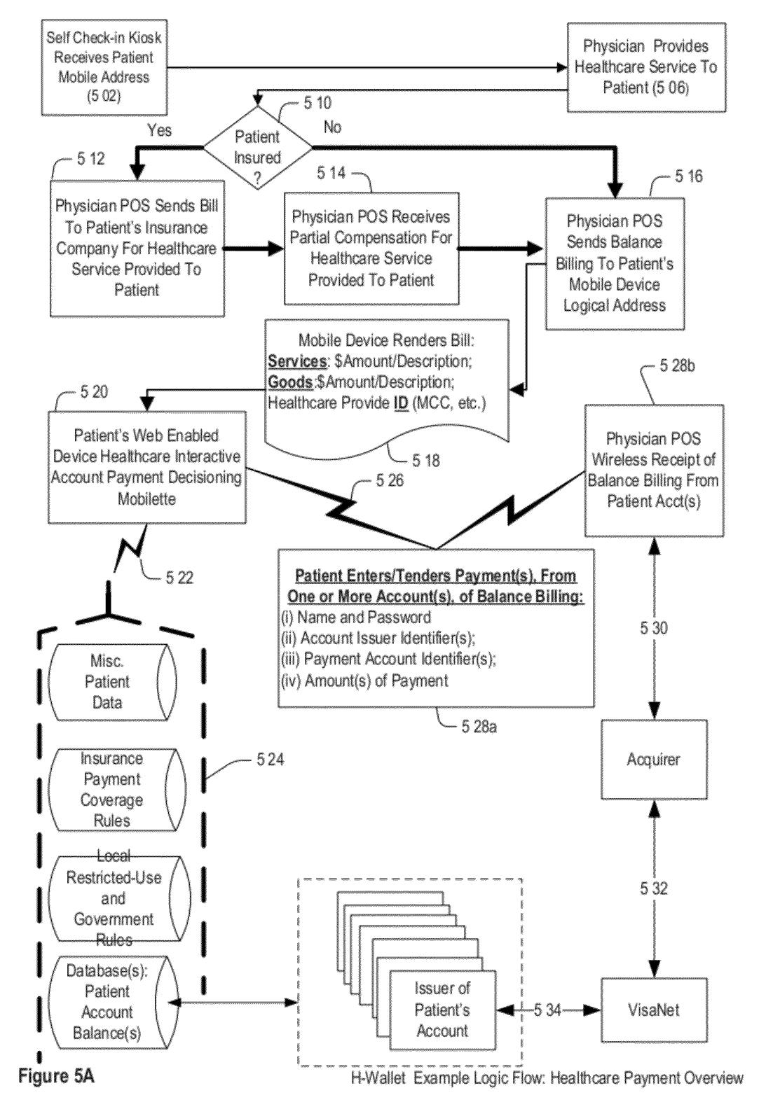

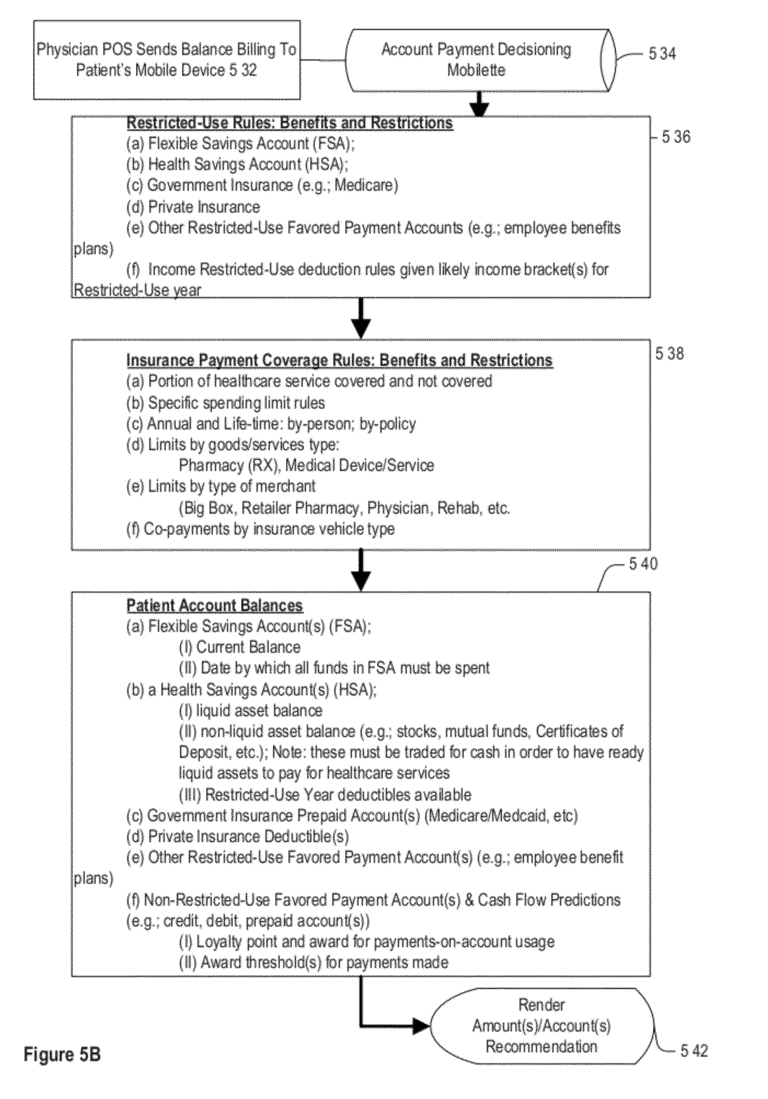

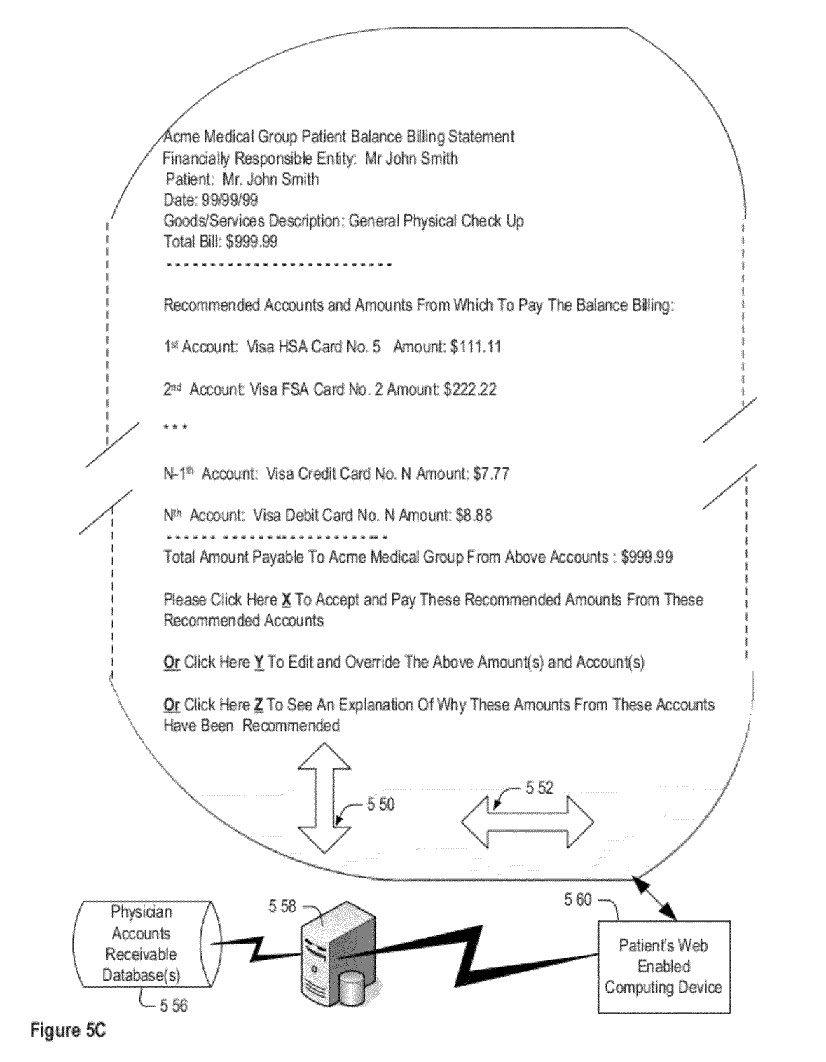

FIGS. 5A-5C provide exemplary diagrams illustrating patient-physician terminal interaction for healthcare payment within embodiments of the H-Wallet. FIG. 5A provides a logic flow diagram illustrating processing healthcare payment within embodiments of the H-Wallet. In one embodiment, the payment being made by the user is optimized for the user's benefit with respect to considerations of insurance, governmental taxation, and user data so that an optimized payment scheme to be made to satisfy a bill from the healthcare provider for the healthcare.

In one embodiment, a user may check in at a kiosk at a healthcare provider's office 502, e.g., a POS registry a hospital, a clinic, and/or the like. The physician or other healthcare provider may provide healthcare service to the user 506. In one embodiment, the physician's office determines whether or not the user is insured 510. If the user is insured, then process moves to step 512. Otherwise, the process moves to step 516.

In one implementation, the physician's Point Of Service terminal (POS) may send a bill to the user's insurance company for the healthcare that was provided to the user. For example, the healthcare provider may send the medical bill directly to an insurance provider via mail, email, instant message, and/or the like. For another example, the healthcare provider may submit information related to the medical bill

In one embodiment, at step 514, the physician's point of service terminal receives partial compensation from the user's insurance company for the healthcare that was provided to the user. At step 516, the physician's point of service terminal sends a balance due billing to the user's mobile device, for instance, to an email address or as a text message by use of the user's cellular telephone number.

In one embodiment, at step 518, the mobile device renders to the user a description of the bill as received for the balance due billing from the physician. The rendered bill, shown in step number 518, shows the amount due, the description of the goods and/or services of the healthcare provided to the user by the healthcare provider, and a Merchant Commodity Code (MCC) of the physician or healthcare provider. At step 520 the user's web-enabled device executes an application, which may also perform the rendering at step 518, where a decisioning process takes place in order to satisfy the bill rendered at step 518.

In one embodiment, the user may obtain and install a mobile application which determines payment accounts in order to pay the bill shown in step 518. To make the determination, the mobile application draws upon one or more online databases to which it has access. Arrow 522 shows online access to a plurality of databases 524. These databases include a database having miscellaneous data for the user, a database for insurance payment coverage rules, a database for local and government rules, and one or more databases showing various account balances that have been issued by issuers to the user that have credit or currency available to satisfy the bill shown in step 518. Various rules for incentives and penalties are contained within in the databases as seen at block 524. For instance, available balances for Medicare Part D provisions can be shown as being available to satisfy the bill in step 518.

The various databases can also include considerations for government insurance, pharmacy benefits, employer healthcare considerations, employer pharmacy benefit plans, employer or government subsidizing of healthcare goods and services, and incentives or penalties to use accounts according to code provisions as provided by various business rules. The available deductibles and required deductibles for each of the one or more benefit plans can be found in one or more databases seen at reference numeral 524, as well as various co-pay requirements, healthcare spending limits, and various restricted use currency amounts. Various forfeiture rules, such as are applicable to FSA can also be found in databases 524. The relative merits of using an HSA, with its restricted use deposit benefits, as well as the ability to grow its balance in terms of both compounding interest and the probability of a rise in the values of various equity holdings, are also taken into consideration. The various user account balances maintained by the databases of block 524 can be assessed via one or more issuers of the respective user accounts as seen at 534. Each issuer is an issuer to an account of the user, who is an account holder on that account that was issued by the issuer.

After the mobile application seen at process 520 receives information, business rules, and data via communication seen at arrow 522, the process 520 calculates a recommendation of one or more accounts having respective one or more amounts to be paid from each account. This recommendation will provide the most favorable tax, cost, and benefits to the user by using the amounts and respective accounts, while also minimized penalties for such use. The mobile applications recommendations are rendered on the mobile device at step 528a. The rendering on the web-enabled mobile device may also guard access such as by prompting for, and validating, a user name and the password to enable making withdrawals from respective accounts for respective amounts suggested by process 520. Each account can be identified by a nickname or identifier, and the nickname will be listed along with the amount that is recommended to be paid from that account toward the balance due billing shown at block 518.

For example, in one implementation, a Visa debit or credit account or a prepaid card may be suggested and identified by a nickname (i.e., a partial account number) along with an amount to be paid from that account. The user has the option to accept or reject the recommendation made as rendered on the web-enabled mobile device at step 528a. If the user decides to reject the payment recommendation, an override can be submitted by the user to change the account and/or amounts and to make effective the changes or to amend the recommendations as to the amounts to be paid from various accounts by the user to the physician. This payment is seen in step 528b where the physician's POS receives a wireless communication from the user's web-enabled mobile device. This wireless communication will contain data that reflects each account and each corresponding amount to be paid from each account to satisfy the balance due billing shown at step 518.

In one embodiment, at arrows 530 and 532, the physician communicates with its acquirer and with a transaction handler (i.e., VisaNet) to send an authorization request for each payment for each account that is designated by the wireless communication from the web-enabled mobile device to the physician's POS. The authorization request is sent from VisaNet via communication 534 to the issuer of each account from which a payment is to be made. Each issuer, respectively, sends an authorization response to the authorization request back to VisaNet, which is in turn sent from VisaNet to the physician's acquirer as shown by communication arrow 532, and from there to the physician's acquirer via communication arrow 530 back to the physician's POS. Once the physician's POS has received an authorization response for the payment from each account, then the physician may deem that the bill, as shown in block 518, has been satisfied. Thereafter, the physician's office, with its acquirer, will initiate a clearing and settlement process for each authorized payment from each account that was used to satisfy the balance due billing seen at block 518.

FIG. 5B provides a flow diagram illustrating alternative embodiments of H-Wallet. A physician has a point of service terminal that sends balance due billing to the patient's web-enabled mobile device 532, and access to information and data interactively between various online databases and the mobile application executing on a patient's web-enabled mobile device 534. Block 536 shows access to retrieve various restricted use rules and benefits that can be input and considered to make a recommendation as to a payment which should be made from one or more accounts. In further implementations, income financial brackets for the patient's year may also be taken into consideration in arriving at a recommendation.

In one embodiment, considerations are also input through various online databases to show insurance payment coverage rules 538. These business rules can include: (i) that portion of healthcare services that are covered or not covered for a healthcare service that is rendered by a physician to a patient; (ii) various specific spending rule limits and forfeiture rules, various annual and lifetime co-payment and maximum insurance payments by the person and/or by the policy, various limits for various goods and services which may or may not be reimbursable under insurance including pharmacy, vision, and dental payments to respective healthcare service providers; (iii) insurance coverage for various types of merchants that are available as benefits and restriction of benefits including big box retailers, retail pharmacy organizations, physician-owned organizations, rehabilitation organizations, various public and private hospitals, as well as various private preferred providers for respective insurance plans; and (iv) copayments that are available for each of several different insurance vehicles.

In one embodiment, the various patient account balances may be retrieved to determine availability of currency or funds to pay the balance due bill received from the healthcare provider 540. These accounts can be assessed by online communication with the respective issuers to determine account balances. By way of example, these balances can include: (i) a balance for one or more Flexible Savings Accounts (FSA), including a current balance and the date by which all funds in each FSA account must be spent; (ii) one or more health savings accounts (HSA) including a liquid asset balance, a non-liquid asset balance that can including stocks, mutual funds, certificates of deposit, etc. In that some equities must be traded for cash in order to have access to liquid assets to satisfy the healthcare provider's balance due bill, the retrieved information can include various requirements for selling stock or other securities, including commission charges, which information can be taken into consideration by the decisioning application in making the recommendation; (iii) balances for government insurance prepaid accounts, such as Medicare and Medicaid; (iv) private insurance deductibles outstanding and yet to be paid; (v) other restricted use accounts that are available to satisfy the healthcare provider's balance due bill, such as employee benefit plans; (vi) non-restricted use accounts and likely cash flow predictions for in each one of those accounts, such as credit available in credit cards, cash available in debit card accounts, cash available on prepaid card accounts, as well as any currency that is available by converting loyalty points for each one of these accounts so that the loyalty points can be used as currency toward balance due billing payments. Also available are calculations made by the mobile application of award thresholds if a payment is made so as to thereby realize more loyalty points that can then be converted into currency to satisfy the healthcare provider's balance due billing.

The various inputs and data that are retrieved are subjected to various calculations as derived from steps 536 through 540 so that the mobile application can make a recommendation as to each account 542, and each amount to be paid from each account, that will be in the patient's best interest to pay a balance due billing received by the web-enabled mobile device from the patient's physician or other healthcare provider via a point of service terminal.

FIG. 5C shows an exemplary screen shot of a display terminal within embodiments of the H-Wallet. In one implementation, a horizontal and vertical icon is rendered on the screen so that a user can navigate to view vertical and horizontal portions of the display screen, as indicated by icons 550, 552. Screen shot shows the total balance due from the physician as well as each of the accounts 1 through N, and respective amounts to be paid from accounts 1 through N, as recommended by the mobile application to satisfy the healthcare provider's balance due billing. As shown in display screen, the patient can accept the recommended payments from each recommended account by clicking in one location. Alternatively, the patient can edit the respective accounts and their respective payments from each account, by ‘clicking’ on an icon at another location. As a third option, the user can ‘click on’ an icon to receive a rendering of an explanation on display screen as to why the recommendations from each account for each amount was recommended. The explanation will give the patient an understanding upon which the patient can base an approval, modification, or rejection of the recommended payments from each account.

Once the recommendations are accepted, the process taken place as shown in steps 556 through 560, where the patient's web-enabled mobile device transmits to the physician's point of service terminal a communication that describes the payment to be made from each account. An e-commerce server, shown at block 558, processes each payment from each account as is described in FIG. 5B through the issuer processer, the acquirer processer, and the transaction handler (VisaNet) for a clearing and settlement process by which the physician's accounts receivable satisfied as to the balance due payment made by the patient, as shown in block 556.

In one implementation, the patient may operate a web-enabled mobile computing device that can be executing a World Wide Web browser, or other special purpose software, in order to access databases.

In one implementation, the H-Wallet may allow the patient to view specifics of the balance due billing that the physician is charging the patient, as well as funds for payment of the balance due billing. The patient can provide information to the web-enabled mobile device in order to gain access to financial information stored by each issuer that issued an account to the patient. To access financial information for the patient, a name and password can be required. Once supplied by the patient, financial information can be sent and retrieved. This information can include account issuer identifiers (e.g.; account numbers), the name of the issuer who issued the account numbers, and any amounts that the financially responsible person wishes to pay on balance due billing to the doctor. Specifics of a bill that the patient can view may include: (i) the healthcare organization name that provided healthcare services to the patient, (ii) the name of the physician who treated the patient, (iii) the name of the person who is financially responsible for the patient, (iv) the name of the patient, (v) the date the services were provided by the doctor to the patient, (vi) a description of the healthcare goods and/or services that were rendered to the patient by the doctor, (vii) any amounts paid by the insurance company for the foregoing healthcare goods and services, and (viii) any balance due by the person who is financially responsible for the patient to the healthcare organization.

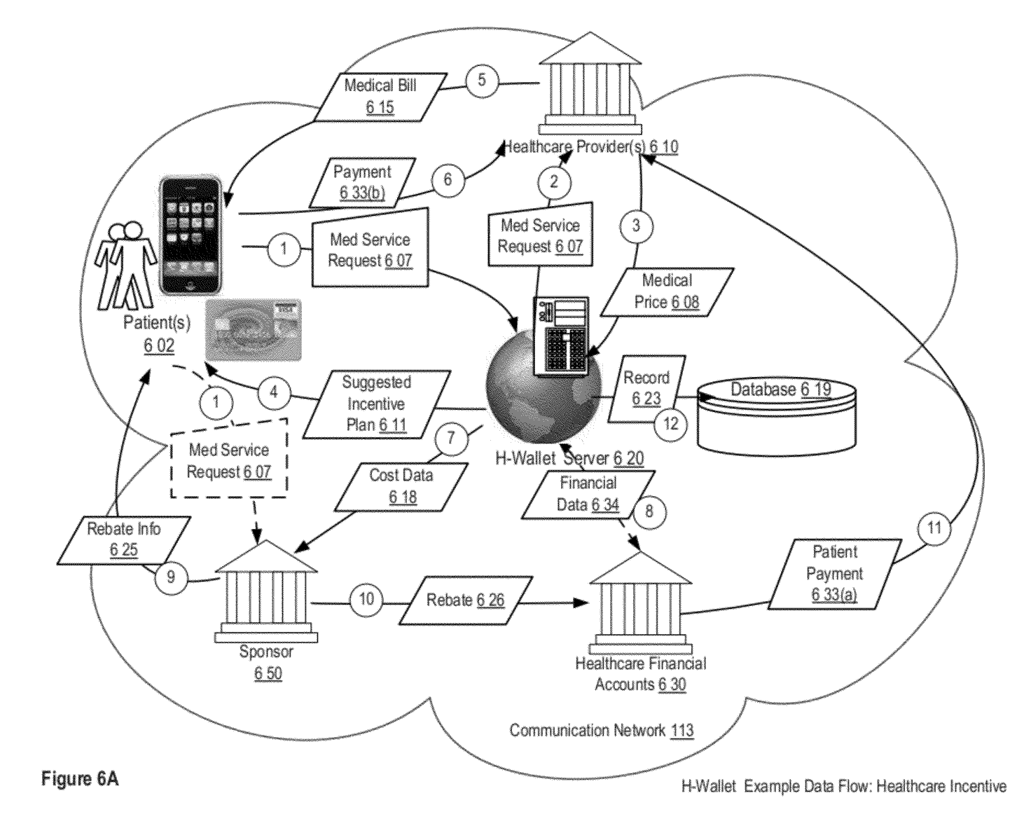

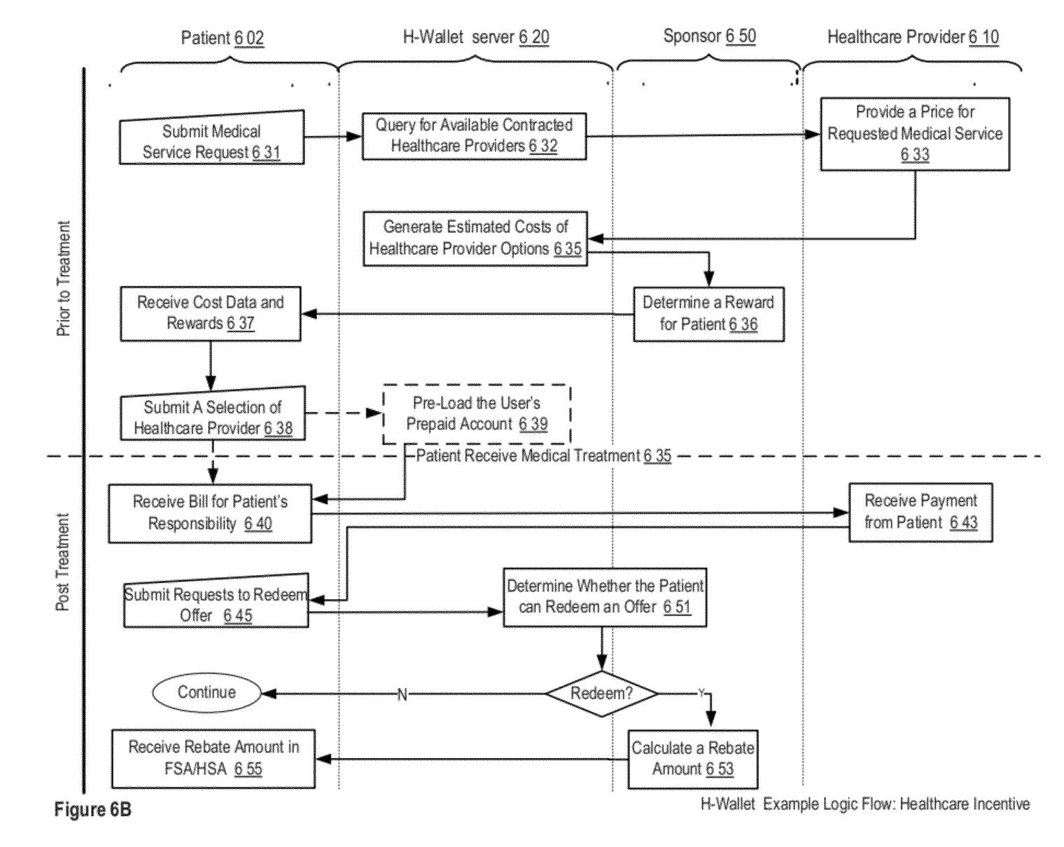

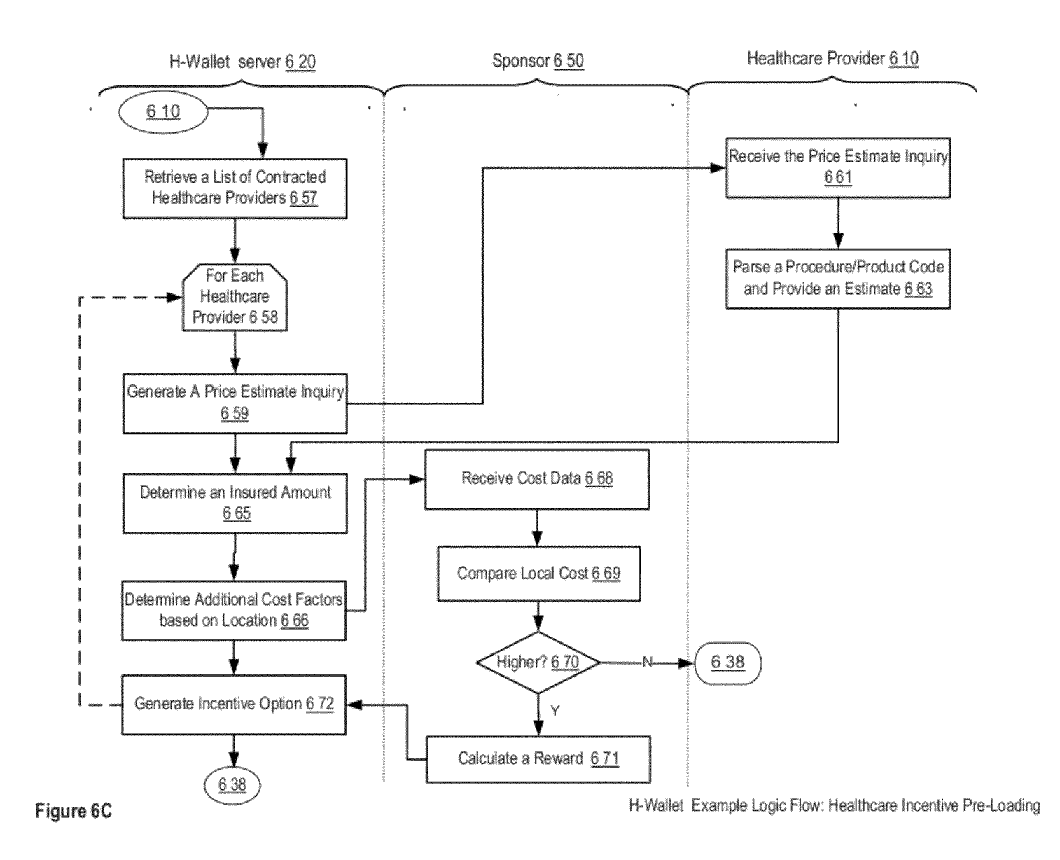

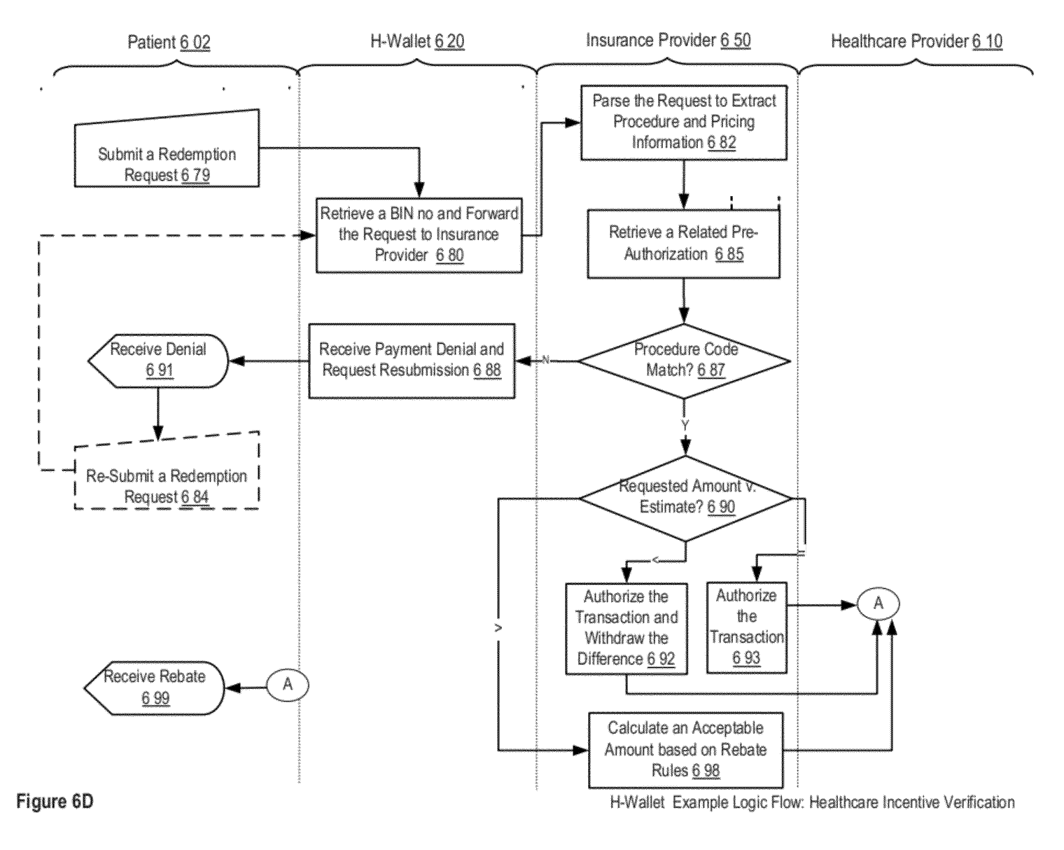

FIGS. 6A-6D provide logic/data flow diagrams illustrating healthcare incentive embodiment of the H-Wallet. In one implementation, the H-Wallet may provide a healthcare incentive platform which facilitates a patient to compare and shop healthcare services globally to obtain benefits under an incentive program. In one embodiment, the H-Wallet may provide a web application that drives an employer self-insurance program, which may provide a financial healthcare benefit to an employee's by use of a prepaid card. The self-insurance program may require that the employee, in need of a healthcare procedure, agrees to a predetermined ‘medical tourism’ treatment being offered offshore by a low cost medical services provider who can provide the needed healthcare procedure to the employee.

In one embodiment, a patient may establish a FSA with his H-Wallet sponsor (e.g., his employer, insurance company, etc.), and receive offers/rewards of medical services from the H-Wallet. For example, if the patient needs a hip replacement surgery, the H-Wallet may query for both contracted domestic healthcare providers and international healthcare providers, and provide the patient a list of estimated costs for available healthcare providers to the patient and the H-Wallet sponsor. The patient may receive an offer/reward from his H-Wallet sponsor, who may partially rebate the patient's medical expenses to the patient if the patient elects to receive medical service at an international healthcare provider at lower cost.

For example, a patient may have a high-deductible health plan, including a balance of $2500.00 in his FSA, prior to an 80/20 co-insurance plan which may cover the remaining balance of a medical bill. The patient's H-Wallet sponsor may offer to rebate the patient 10% of the saved cost of medical procedures, up to the amount of the deductible ($2500.00). If the patient needs a hip replacement surgery, the H-Wallet may provide two options among the contracted health providers, e.g., $60,000 total cost at a local hospital in the U.S., and $10,000 total cost in a contracted hospital in Thailand. If the patient elects to receive the surgery in Thailand, the H-Wallet will need to pay $8,000 instead of the $48,000 as in the U.S. alternative, and thus can save $40,000. The patient may also save $10,000 amount for the patient's responsibility. In this case, the H-Wallet sponsor may rebate the patient a full amount of $2500.00 in the form of a prepaid FSA or contribution to the patient's prepaid HSA, as the 10% of the saved cost $40,000 for the sponsor has exceeds the full amount of the patient's deductible.

In one embodiment, the H-Wallet may provide a vehicle associated with the patient's medical payment accounts, e.g., FSA, HSA, etc. For example, the H-Wallet may issue a magstripe card for the patient, who may swipe the card at a point of sale (POS) registry at a healthcare provider to pay. For another example, the patient may operate a mobile device (e.g., a smart phone, etc.) to download and install a H-Wallet mobile application, which may facilitate the patient to receive real-time electronic bill from the H-Wallet after treatment.

Integration of the mobile wallet reduces the number of network transactions and messages that fulfill healthcare payment approval and procurement of healthcare product and services. It reduces the number of communication messages required to facilitate the healthcare incentive rebate/rewards redemption by associating healthcare incentive rebate/rewards eligible healthcare providers with insurance approved healthcare procedures.

FIG. 6A shows a block diagram illustrating data flows between MBC-Platform server and affiliated entities within various embodiments of the H-Wallet. Within various embodiments, one or more patient(s) 602, H-Wallet server 620, H-Wallet database(s) 619, healthcare provider(s) 610, healthcare financial account(s) 630, and H-Wallet sponsor(s) 650 are shown to interact via various communication networks 613.

Within various embodiments, the patient 602 may include a wide variety of different communications devices and technologies within embodiments of H-Wallet operation. For example, in one embodiment, the patient 602 may include, but are not limited to, terminal computers, work stations, servers, cellular telephony handsets, smart phones, PDAs, and/or the like. In one embodiment, the H-Wallet server 620 may be equipped at a terminal computer of the patient 102. In another embodiment, the H-Wallet server 620 may be a remote server which is accessed by the user 602 via a communication network 613, such as, but not limited to local area network (LAN), in-house intranet, the Internet, and/or the like. In a further implementation, the H-Wallet merchant 616 may be integrated with a user 602 at a computer terminal.

In one embodiment, the patient 602 may submit a medical service request 607 to the H-Wallet server 620. The medical service request 607 may include information such as, but not limited to a type of the medical service, desired date of medical service, medical insurance information, patient profile information, and/or the like. For example, an example XML implementation of the medical service request 607 may take a form similar to:

```
POST /MedRequest.php HTTP/1.1
Host: www.H-Wallet.com
Content-Type: Application/XML
Content-Length: 718
<?XML version = “1.0” encoding = “UTF-8”?>
<MedRequest>
<User>
  <UserID> 123456789 </UserID>
  <UserName>John Smith </UserName>
  </UserAddress> 111 White road </UserAddress>
  ...
  </UserDeviceID>11111111 </UserDeviceID>
  ...
  <UserSponsor>
    <SponsorType>Employer</SponsorType>
    <SponsorID> dsadsd</SponsorID>
    </SponsorRules>
      </PaidHoliday>
        ...
      </PaidHoliday>
      <Rebate>
      ...
      </Rebate>
    ...
    </SponsorRules>
  ...
  </Sponsor>
  <UserInsurance>
    <InsurnaceID> 66666 </InsurnaceID>
    <InsuranceName> all dental plan </InsurnaceName>
  ...
</User>
  <Procedure>
    <ProcedureCode> HP003 </ProcedureCode>
        <MCC> ... </MCC>
    <HealthProvider>
      <ProviderID> ... </ProviderID>
    ...
    <HealthProvider>
...
</MedRequest>
```

The H-Wallet server 620 may then query a list of contracted healthcare providers 610, including both domestic and international, for medical service availability. In one implementation, a healthcare provider 610 may submit a proposed service plan, including a date for the medical service, a price estimate 608 of the medical procedure, and/or the like.

Upon receiving availability information from healthcare providers, the H-Wallet server 620 may evaluate an estimated cost 610 associated with each available healthcare provider 600, and provide it to the patient. For example, the estimated costs may include an amount of the actual patient's responsibility, deductible based on the insurance plan, sponsor's responsibility, and/or the like. For another example, for an international healthcare provider, the estimated costs may include a price of the medical service, an estimated period of time for stay before and after the procedure is performed, travel expenses, and/or the like. For a further implementation, the H-Wallet may send costs data 618 to the sponsor 650 to determine how many paid days off the patient his employer is willing offer, negative wealth impacts (e.g., deduction, liability, insurance, debt, tax, negative interests, and/or other wealth reducing factor) for offshore treatment, and/or the like. For example, an example XML implementation of the costs data 618 may take a form similar to:

```
POST /MedRequest.php HTTP/1.1
Host: www.H-Wallet.com
Content-Type: Application/XML
Content-Length: 718
<?XML version = “1.0” encoding = “UTF-8”?>
<Cost>
  <UserID> 123456789 </UserID>
  <UserName>John Smith </UserName>
  ...
  <MedPlanID> HP003</MedPlanID>
  <ProviderID> 444555 </ProviderID>
  ...
  <CostItem1>
    <CostType> MCC </CostType>
    <Amount> $7,800.00 </Amount>
    ...
  </CostItem1>
  <CostItem2>
    <CostType> Travel </CostType>
    <Amount> $2000.00 </Amount>
    ...
  </CostIem2>
    ...
</Cost>
```

In one embodiment, after receiving the medical service, the healthcare provider 610 may send a medical bill 615 to the patient 602, e.g., via an electronic message to a smart phone, a H-Wallet card, and/or the like. The patient may then make payments 633b to the healthcare provider 610. In one implementation, the patient may user his H-Wallet card to load his healthcare financial accounts 630, and pay the medical bill at least partially by the funds drawn from the financial accounts 633(a).

For example, in one implementation, an example XML implementation of the medical bill 615 may take a form similar to:

```
POST /MedBill.php HTTP/1.1
Host: www.H-Wallet.com
Content-Type: Application/XML
Content-Length: 718
<?XML version = “1.0” encoding = “UTF-8”?>
<MedBill>
<User>
  <UserID> 123456789 </UserID>
  <UserName>John Smith </UserName>
  </UserAddress> 111 White road </UserAddress>
  ...
  </UserDeviceID>11111111 </UserDeviceID>
  ...
  <UserSponsor>
    <SponsorType>Employer</SponsorType>
    <SponsorID> dsadsd</SponsorID>
    </SponsorRules>
      </PaidHoliday>
        ...
      </PaidHoliday>
      <Rebate>
      ...
      </Rebate>
    ...
    </SponsorRules>
  ...
  </Sponsor>
  <UserInsurance>
    <InsurnaceID> 66666 </InsurnaceID>
    <InsuranceName> all dental plan </InsurnaceName>
  ...
</User>
<Procedure>
  <ProcedureCode>
    HP0003 </ProcedureCode>
  <ProcedureDate>
    00/00/0000
  </ProcedureDate>
  <ProviderID>
    International00008
  </ProviderID>
  <ProviderName> National Hospital Thailand </ProviderName>
  ...
</Procedure>
<BillSummary>
  <TotalAmount> 10,000.00 </TotalAmount>
  <Insured> 8,000.00 </Insured>
  <PatientResp> 2,000.00 </PatientResp>
  <AmountDue> 2,000.00 </AmountDue>
  ...
</BillSummary>
</MedBill>
```

For another example, in one implementation, an example XML implementation of the patient payment 633a may take a form similar to:

```
POST /Payment.php HTTP/1.1
Host: www.H-Wallet.com
Content-Type: Application/XML
Content-Length: 718
<?XML version = “1.0” encoding = “UTF-8”?>
<Payment>
  <UserID> 123456789 </UserID>
  <UserName>John Smith </UserName>
  ...
  <MedPlanID> HP003</MedPlanID>
  <ProviderID> 444555 </ProviderID>
  </UserDeviceID> 11111111 </UserDeviceID>
<Procedure>
  <ProcedureCode> HP0003 </ProcedureCode>
  <ProcedureDate> 09-09-2015 </ProcedureDate>
  <ProviderID> International00008 </ProviderID>
  <ProviderName> National Hospital Thailand </ProviderName>
  ...
</Procedure>
<MedBill>
  <BillID> 00000222 <//BillID>
  <TotalAmount> 10,000.00 </TotalAmount>
  <Insured> 8,000.00 </Insured>
  <PatientResp> 2,000.00 </PatientResp>
  <AmountDue> 2,000.00 </AmountDue>
  ...
</MedBill>
<PaymentTime> 09:00 00/00/0000 </PaymentTime>
<PaymentAccount> FSA 00000 </PaymentAccount>
<Amount> 2,000.00 </Amount>
<Status> cleared </Status>
...
</Payment>
```

In one embodiment, the H-Wallet sponsor 650 may evaluate the transaction and provide rebate information 625 to the patient if the patient is deemed qualified for a rebate. For example, the sponsor, such as the patient's employer, and/or the like, may contribute a rebate amount to the patient's healthcare financial accounts 630, e.g., FSA, HSA, etc. For example, an example XML implementation of the rebate information 625 may take a form similar to the following:

```
POST /Rebate.php HTTP/1.1
Host: www.H-Wallet.com
Content-Type: Application/XML
Content-Length: 718
<?XML version = “1.0” encoding = “UTF-8”?>
<Rebate>
  <UserID> 123456789
  </UserID>
  <SponsorID> 888999 </SponsorID>
  <ProviderID> Thai0009 </ProviderID>
  <MedBillID> 667777 </MedBillID>
  <MedPlanID> 44444 </MedPlanID>
  ...
  <Payment> $10,000 </Payment>
  <SavedCost> $40,000 </SavedCost>
  <RebateRate> 0.1 </RebateRate>
  <RebateMax> $2,500 </RebateMax>
  <RebateAmount> $2,500 </RebateAmount>
  ...
</Rebate>
```

In one embodiment, the H-Wallet server 620 may receive financial data 634 from the healthcare financial accounts 630, e.g., remaining balance, transaction payment, etc. In one implementation, the H-Wallet server 620 may also communicate with a H-Wallet database 619 to store and/or retrieve healthcare payment/claim record 623. In some embodiments, a H-Wallet server 620 may be integrated with a local H-Wallet database 619. In other embodiments, a H-Wallet server 620 may access a remote H-Wallet database 619 via the communication network 613. The H-Wallet server 620 may send the information to the database 619 for storage, such as, but not limited to user account information, order record information 625, payment record information 623, and/or the like.

In one embodiment, the H-Wallet server 620 may establish data records of registered users, healthcare providers, sponsors, past transactions 623 for storage in a database 619. For example, an exemplary XML formatted user record 623 may take a form similar to the following:

```
POST /Payment.php HTTP/1.1
Host: www.H-Wallet.com
Content-Type: Application/XML
Content-Length: 718
<?XML version = “1.0” encoding = “UTF-8”?>
<User>
  <UserID> 123456789 </UserID>
  <UserName>John Smith </UserName>
  </UserAddress> 111 White road </UserAddress>
  ...
  </UserDeviceID>11111111 </UserDeviceID>
  ...
  <UserSponsor>
    <SponsorType> Employer</SponsorType>
    <SponsorID> dsadsd</SponsorID>
    </SponsorRules>
      </PaidHoliday>
        ...
      </PaidHoliday>
      <Rebate>
      ...
      </Rebate>
    ...
    </SponsorRules>
  ...
  </Sponsor>
  <UserInsurance>
    <InsurnaceID> 66666 </InsurnaceID>
    <InsuranceName> all dental plan </InsurnaceName>
  ...
  <UserAccount>
    <Account1>
      <AccountName> Employee FSA </AccountName>
      <AccountNumber>
        ...
      </AccountNumber>
      <AccountMax> 2000.00 </AccountMax>
      ...
    </Account1>
  ...
</User>
```

In another implementation, the H-Wallet server may execute a hypertext preprocessor (“PHP”) script including SQL commands to query the database for provider information, transaction data, and/or the like. An example PHP/SQL command listing, illustrating substantive aspects of storing a user record 623 in the database:

<?PHP
header(‘Content-Type: text/plain’);
mysql_connect(″202.155.66.130”,$DBserver,$password); // access
database server
mysql_select(″USERS.SQL″); // select database to append
mysql_query(“INSERT INTO USERS (user_id, user_name,
user_address, user_ssponsor, user_insurance, user_account ...)
VALUES ($user_id$, $user_name$, $user_address$, $user_ssponsor$,
$user_insurance$, $user_account$ ...) ; //
add data to table in database
mysql_close(″PROVIDERS.SQL″); // close connection to database
?>

FIG. 6B provides a logic flow diagram illustrating processing healthcare payment within embodiments of the H-Wallet. In one embodiment, a patient may register with the H-Wallet by providing his personal profile information (e.g., name, address, employer, insurance plan, personal income, etc.), healthcare payment information (e.g., FSA, HSA, etc.), medical history information, and/or the like to the H-Wallet server 620. For example, the H-Wallet may provide a web-based registration form for the patient to fill in and register. For another example, the patient may register with the H-Wallet at his employer, healthcare provider, insurance company, and/or the like, by filling in an application form.

In one embodiment, a H-Wallet sponsor 650 may register with the H-Wallet server 620. For example, the sponsor 650 may be an employer sponsoring the employees' H-Wallet rewards, an unemployment fund, an insurance provider, and/or the like. In one implementation, the sponsor 650 may provide a rebate policy, paid vacation policy, employer insurance program, and/or the like to the H-Wallet server 620.

In one embodiment, a patient may submit a medical service request 631, e.g., a hip replacement surgery, etc. to the H-Wallet 620 for scheduling and evaluation. For example, the patient may call a H-Wallet representative, a sponsor program representative. For another example, the patient may submit medical service request including a description of the desired healthcare procedure/products via text messages, e-mails, instant messages, and/or the like. In a further implementation, the patient may enter the medical service request information via a web-based portal.

The H-Wallet server 620 may query a list of contracted healthcare providers 632 for eligible providers who may provide the requested healthcare service, both domestic and international, wherein the available healthcare provider may provide a price estimate for the requested medical service 633. For example, in one implementation, a hip replacement surgery in the local county hospital in U.S. may cost $60,000, while the same surgery in the national hospital in Thailand may cost $40,000. For another example, a cosmetic surgery at a private clinic in New York City may cost $6,000, while the same may cost $4,000 in El Paso, Tex.

In one embodiment, the H-Wallet may generate estimated costs of healthcare provider options 635, based on which the sponsor 650 may determine a reward for the patient 625. The cost data may include estimated cost of travel expenses from the user's location to a suggested healthcare provider.

For example, the H-Wallet may provide a list of options to the patient via a web application, which may determine available domestic healthcare providers for the hip replacement surgery based on the patient's geographic location, and calculate the domestic cost for the hip replacement surgery (e.g.; $60,000). The H-Wallet may further calculate the employee out-of-pocket cost (e.g.; $4000 deductible) using the standard company's medical insurance, and the employer's costs for the domestic cost of the surgery.

For another example, the patient may be offered the option of traveling to a different place for the needed hip replacement surgery. The savings realized by the sponsor/employer through the employee's choice of an offshore preferred healthcare provider may be used to fund an incentive to the employee. In this case, the employee may have little or no out-of-pocket cost while still receiving the needed healthcare service. In one implementation, the H-Wallet may determine offshore healthcare providers for the medical procedure, and their respective locations in different countries, as well as fringe benefits, perquisites (e.g.; perks), etc. provided to medical tourists, calculate the difference between domestic providers and the cost assessed by each offshore healthcare provider along and offsets provided by any supplemental insurance covering the employee. The H-Wallet may then retrieve a previously stored sponsor reward/offer policy record, based on which the H-Wallet may make an offer of a loaded prepaid account to the employee 639, which covers the employee's medical and travel costs plus other financial incentives such paid days off and negative wealth impact payments for funds deemed to be compensation. In one implementation, upon the employee/patient making a binding commitment to an offered medical tourism option, the H-Wallet may activate an issued prepaid account in the employee's name, and load the prepaid account with the agreed funds, and initiate a medical services contract with the selected offshore preferred healthcare provider in the name of the employee in accordance with terms and conditions arranged by prior agreement between the employer and the selected offshore preferred healthcare provider.

In an alternative implementation for international healthcare providers, the sponsor/employer may load a prepaid card in an amount equal to or exceeding: the employee's deductible requirement for a high-deductible insurance plan; or the cost required to be paid by the employee from the employee's Flexible Saving Account (FSA) or Health Savings Account (HSA).

In a further embodiment, while querying for available healthcare providers 632, the H-Wallet may receive bids from international medical providers to provide the requested medical service (e.g., the hip replacement), wherein the H-Wallet may apply a series of pre-established business rules to select eligible international medical providers. For example, the H-Wallet may rank the non-local healthcare providers by distance, price, reputation rating, and/or the like.

In one implementation, the H-Wallet may derive revenue from the international healthcare tourism option through the employee's spend on the amount loaded to the prepaid card.

In alternative implementations, the H-Wallet may determine an agreed rebate amount to the user after the user has obtained healthcare service from a recommended healthcare provider. The user may pay for the healthcare service, travel expenses, and submit a request for redemption of rewards. For example, in one implementation, the rewards may be a flat fee amount provided by the sponsor. For another example, the rewards may comprise a percentage (e.g., 5%) of user co-pay plus additional travel expenses amount, subject to adjustment.

In one embodiment, upon receiving cost data and rewards 630, the patient may submit a selection of the healthcare providers 633, and subsequently receive the medical treatment 635 with the provider. For example, if the patient selects an international healthcare provider, the patient may travel overseas to receive the medical procedure, wherein the H-Wallet may provide a travel itinerary for the patient.

In one embodiment, after the procedure is completed, the patient may receive a medical bill indicating patient's responsibility 640. The patient may user his prepaid FSA/HSA card to pay the amount to the healthcare provider 643. In another implementation, the patient may operate a mobile device registered with H-Wallet to draw funds from his FSA/HSA to fulfill the payment.

In one embodiment, the patient may submit a request to the H-Wallet to redeem an offer 645. For example, if the H-Wallet indicated a 10% rebate for saved cost for international healthcare option at 637, and the patient selects international healthcare, the patient may requests for rebate. The H-Wallet, and/or the sponsor may determine whether the patient can redeem the offer 651. For example, the H-Wallet may verify whether the patient receives healthcare service at a contracted international healthcare provider, and/or the like. For another example, the H-Wallet may verify the date of the procedure to see whether it falls in a pre-specified time frame to avoid fraudulent claims. For another example, the sponsor may verify the employment status of the patient, qualification for the rebate offer, and/or the like. In one embodiment, the sponsor may calculate a rebate amount 653, and contribute the amount to patient's FSA/HSA account 655.

In a further implementation, the H-Wallet may issue an international prepaid card for the patient's use during a medical tourism period. The international prepaid card may also be in the form of a e-wallet type card. In one implementation, the H-Wallet may receive a full amount of expenses for the patient's medical tourism, including both a medical procedure cost, and travel cost. The H-Wallet may determine a reasonable amount of travel cost to include in the total cost of the medical tourism package. For example, the H-Wallet may associate multiple wallets or multiple pools of sum with the patient's medical tourism, such as an entertainment pool, a transportation pool, and/or the like. The H-Wallet may provide $500 in trip credits, and then each one of those pools or funds is restricted by types of MCCs.

FIG. 6C provides a logic flow diagram illustrating healthcare incentive pre-authorization within embodiments of the H-Wallet. Within embodiments, upon receiving an indication of healthcare service request from the user at 610, the H-Wallet server 620 may retrieve a list of contracted healthcare providers 657. For example, the H-Wallet may query based on a procedure code to obtain a list of healthcare providers that are capable of providing the indicated procedure.

For each healthcare provider 658, the H-Wallet may generate a price estimate inquiry 659 (e.g., 607 in FIG. 6A) 659 to the healthcare provider 610. Upon receiving the inquiry 661, the healthcare provider may parse the request and obtain the procedure/product code to generate a cost estimate from its pricing list 663.

In one implementation, the H-Wallet may calculate an insured amount 665 based on the healthcare provider provided estimate 665. For example, in one implementation, if the healthcare provider provides an estimate of $6,000.00, and H-Wallet may retrieve the insurance information associated with the user showing a 40% coverage. The H-Wallet may provide an insurance estimate of $2,400.00. In further implementations, the H-Wallet may calculate sponsored amounts from various sponsoring programs, such as an employer-administered program, a government-administered program such as unemployment insurance, and/or the like.

In one implementation, the H-Wallet may determine additional cost factors based on the location 666 of the healthcare provider 610, e.g., flight expenses, hotel expenses, meals, and/or the like, and add the additional cost with the medical service cost to the sponsor 650. Upon receiving the cost estimate 668, the sponsor may calculate a reward 670. In one implementation, the sponsor 620 may compare the received estimated cost with local cost (e.g., the cost incurred if the user receives service at a local hospital) 669. For example, if an estimated cost of a knee surgery at a contracted private clinic in Toronto costs $50,000, and flight and living reimbursement are estimated to be $2000.00 for a ten day period of stay in Toronto, the total cost may be $52,000.00. If the user currently resides in San Francisco, Calif., and a contracted hospital in San Francisco may provide a knee surgery at the listing price of $54000.00, the sponsor may not need to recommend the user to travel to Toronto for the surgery.

When the received costs data is higher than local cost 670, the sponsor may discard the healthcare provider and proceed with the next 638. If not, the sponsor may calculate a reward amount 671. For example, the reward amount may be calculated based on the difference between the estimated cost with the healthcare provider and an estimated local cost. The following table explains in one example the calculation of rewards.

| | St John's Hospital | Local |
|---|---|---|
| Cost Estimate | in Ottawa | Hospital |
| Procedure Price | 4,000.00 | 8,000.00 |
| Sponsor Coverage | 30% | 40% |
| Sponsor Coverage Amount | 1,200.00 | 3,200.00 |
| User Copay | 2,800.00 | 4,800.00 |
| Travel Allowances | 2,000.00 | 0 |
| User Total Expenses | 4,800.00 | 4,800.00 |
| Rewards | 1,000.00 | 0 |
| Sponsor Responsible Total | 2,200.00 | 3,200.00 |

In the above example, the sponsor may provide a $1000.00 reward to the user so that the user may eventually pay for the service at an amount of $4800-$1000=$3,800.00, versus the $4,800.00 co-pay amount if the user elects to receive service locally, therefore giving the user an incentive to take the H-Wallet provided option of “St John's Hospital in Ottawa.” In alternative embodiments, the sponsor may set up a rewards rule such that the sponsor may compensate the user a certain amount of rebate, subject to adjudication, as further illustrated in FIG. 6D.

FIG. 6D provides a logic flow diagram illustrating healthcare incentive adjudication/redemption within embodiments of the H-Wallet. In one implementation, as the H-Wallet may pre-load the user's prepaid account with a reward amount 639, the H-Wallet may review and verify the expenses of the pre-loaded funds, e.g., whether it is used for the scheduled procedure, whether it is used at the agreed healthcare provider, etc. In another implementation, when the user has paid for the service during the treatment, and may seek for rebate, the H-Wallet may verify whether the requested rebate amount is eligible.

Within embodiments, upon receiving healthcare service from a healthcare incentive sponsored healthcare provider, the user 602 may submit a redemption request 679. For example, in one implementation, the user may fill out a web based application form. For another example, the user may submit a transaction record indicating the payment performed with the healthcare provider via his wallet. In one implementation, the redemption request may comprise date and time of the service, total charged amount, user payment receipt, and/or the like.

In one implementation, the H-Wallet may retrieve a BIN number from the request and determine a healthcare incentive sponsor (e.g., an insurance provider, etc.) based on the BIN, and forward the request to the insurance provider for verification 680. The insurance provider may parse the request to extract information such as the related authorization ID, procedure code, requested payment amount 682, and/or the like. The H-Wallet may retrieve a related pre-authorization record based on the pre-authorization ID 685, and determine whether the procedure code included in the redemption request matches with the procedure code submitted to the sponsor prior to the procedure 687. If the procedure code does not match, e.g., the procedure code in the payment request indicates a “knee surgery” but the procedure information submitted to the sponsor indicates a “vascular surgery,” the insurance provider may deny the payment and the H-Wallet may request the user to verify the request and/or resubmit the request 688.

In another implementation, the H-Wallet may direct the payment request to an inspection unit for fraud alert investigation. In one implementation, upon receiving a denial 691, the user may re-submit the redemption request 684 to restart the process.

In another embodiment, if the procedure code matches 687, the insurance provider may proceed to check whether the requested rebate amount matches an estimated rebate amount (e.g., see 611 in FIG. 6A) 690. In one implementation, if the two amounts match strictly, the insurance provider may authorize a rebate amount transfer to the user 693, and the user 602 may receive a payment in his wallet. For example, the user may elect to select an account (e.g., FSA, HSA, etc.) to deposit the rebate payment.

In another implementation, when the two amounts do not match, the insurance provider may permit a tolerance level of difference, or may require further verification to approve the transaction having a different insured amount. For example, in one implementation, if the requested redemption amount is less than the estimated rebate amount, the insurance provider may authorize the transaction and withdraw the surplus amount 692. In another implementation, if the requested rebate amount is greater than the estimated rebate amount, the insurance provider may determine whether the additional amount can be issued 693. Rules may apply tolerances for any number of field values, which may include estimated cost, procedure subject matter/category, date and time for the service/procedure performed, medication/procedure type, and/or the like.

For example, the insurance provider may apply tolerance rules to compare information in the suggested incentive plan (e.g., see 618 in FIG. 6A) prior to the procedure and the actual costs accrued on the day of healthcare procedure, as illustrated in the exemplary example below:

| | | Suggested | Actual Cost | Tolerance | |
|---|---|---|---|---|---|
| | | Estimate | Incurred | Level | Status |
| User | Name | John Smith | John Smith | 1~2% | Approve |
| | DoB | Dec. 12, 1960 | Dec. 12, 1960 | 0% | Approve |
| | SSN | 111-00-0001 | 111-00-0001 | 0% | Approve |
| | . . . | . . . | . . . | . . . | . . . |
| Procedure | | Surgery | Surgery | 5~10% | Approve |
| Category | | | | | |
| Procedure | | KS0001 | KS0001 | 1~2% | Approve |
| Code | | | | | |
| Procedure | | Local X rays | General X rays | 5-10% | Further |
| description | | scan and left | scan and left | | inspection |
| | | Knee Surgery | knee surgery | | |
| Provider | | St John's | St John's | 0 | Approve |
| | | Hospital | Hospital | | |
| City | | Ottawa | Ottawa | 0 | Approve |
| . . . | | . . . | . . . | . . . | . . . |
| Date | | Sept. 09, 2011 | Sept. 10, 2011 | ±58 hours | Approve |
| Cost | Total | 12,000.00 | 12,456.32 | ±5% | Approve |
| | Insured | 5,000.00 | 7,600.00 | NA | −2,600 |
| | Co-Pay | 7,000.00 | 5,456.32 | ~5% | Approve |
| | | . . . | . . . | . . . | . . . |
| | Flight | 2,000 | 2,400 | ~5% | Approve |
| | | | | | 2000 |
| | hotel | 1,000 | 989.23 | ~5% | Approve |

In the above example, the tolerance levels of difference between information in the estimated incentive plan prior to the procedure and the actual payment request on the day of healthcare procedure may vary. For example, the user information may have a strict tolerance level such that the user profile should be consistent to prevent identity theft and fraudulent medical clams. The insurance provider may allow some tolerance level in the difference of procedural code, date of service, so that flexibility may be allowed in the procedure treatment. In case significant inconsistency is captured in the procedure description, e.g., “general X rays” performed versus “local X rays” as scheduled, the insurance provider may direct the payment request to further inspection instead of real time approval.

In another example, the H-Wallet may consider an additional insurance payment to be a negative factor against the rebate amount. If the incentive plan indicates a $5,000.00 insurance payment, but the insurance provider eventually pays an amount of $7,600.00, the insurance provider may re-calculate an acceptable amount based on rebate rules 698, e.g., providing a lower or zero rebate amount to the user. In one implementation, the insurance provider may set a maximum cap for the insurance payment amount, so that if the actual incurred insurance amount exceeds the maximum, the user may not receive a rebate amount.

In one implementation, the user may receive a rebate amount 699, e.g., at his healthcare wallet.

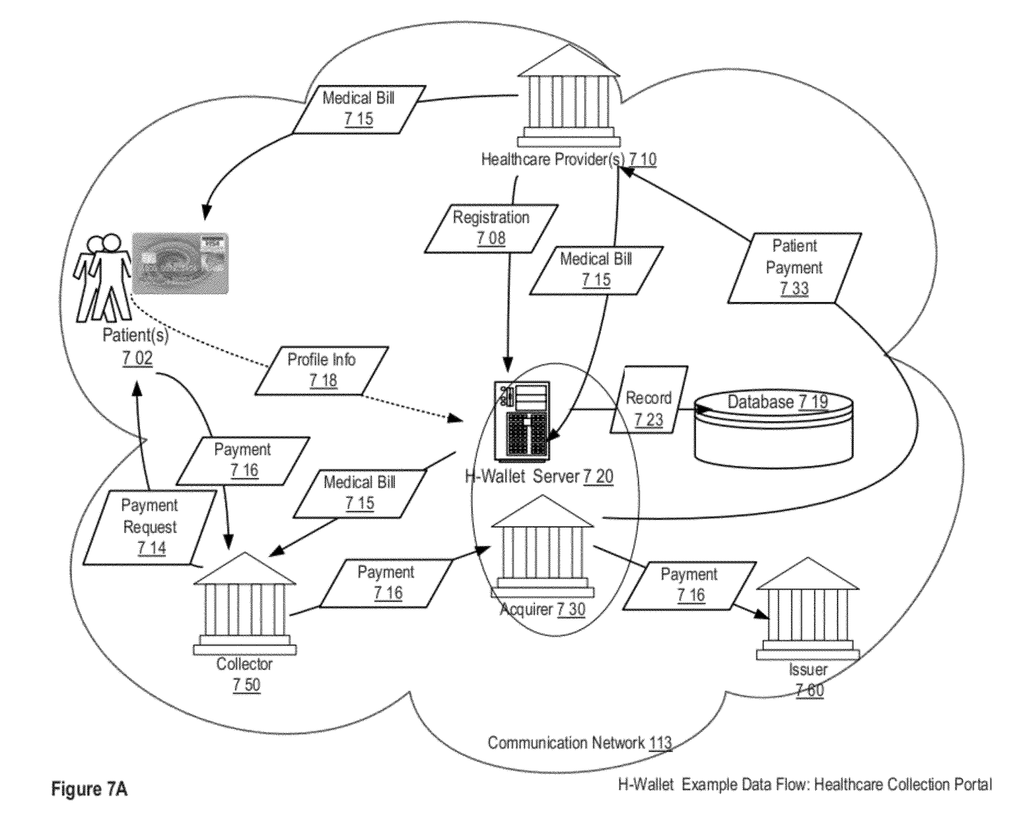

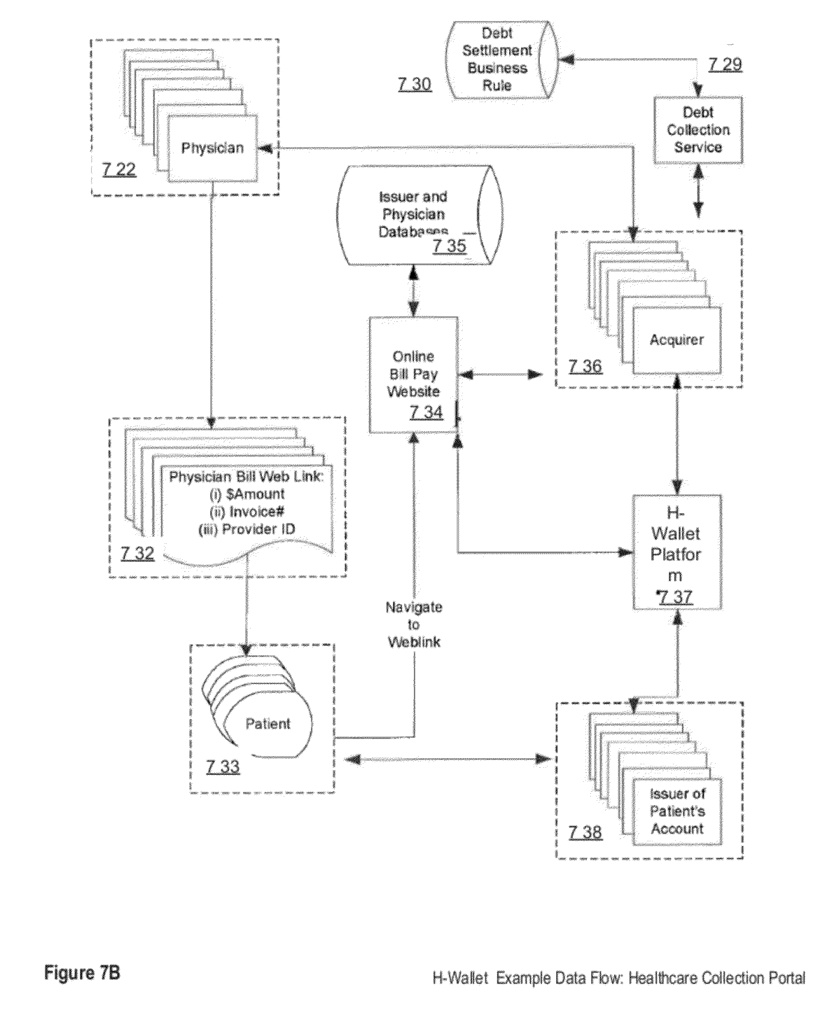

FIG. 7A-15 provide data/logic flow diagrams illustrating aspects of H-Wallet healthcare bill collection within embodiments of the H-Wallet. The H-Wallet may provide a healthcare payment platform which facilitates healthcare providers to collect payments from patients by creating electronic transactions which link to a unique bill or office visit and may be electronically reconciled with the provider's patient billing system.

In one embodiment, the H-Wallet may host a consumer payments service that may be accessible to registered medical services providers, such as, but not limited to physicians, hospitals, dentist, and/or the like, whose information may be established by a national provider directory. Patients may access H-Wallet via a H-Wallet website, phone calls, and/or the like, to uniquely identify a healthcare provider to perform payment.

In one embodiment, the H-Wallet may provide a payment user interface, such as a web site and a phone service, and/or the like. Providers may enroll to accept transactions through this payment service. In one implementation, H-Wallet may create a provider (merchant) directory that uniquely identifies participating providers. For example, the provider may provide registration information including demographic information about the practice along with data such as the NPI (National Provider ID).

In one embodiment, the H-Wallet may partner with an acquirer to accept the transactions and the H-Wallet transactions may be passed to the issuer. The unique information that identifies which patient and/or bill was being paid could be provided to the merchant either as a value in the H-Wallet authorization message or could be passed separately in an electronic file to the merchant for reconciliation with the patient account system.

For example, a patient may get an electronic bill after a physician has treated the patient. The bill includes a Web hyperlink that embeds a unique identifier of the physician who as previously registered with the H-Wallet online bill payment service. The patient may use a computer to navigate to the H-Wallet online bill payment service by clicking on the Web hyperlink that embeds the physician's unique identifier. The Patient may then input a payment amount a H-Wallet account on a web page that corresponds to the Web hyperlink. The H-Wallet online bill payment service derives the Physician's acquirer from the web link and then sends the patient's payment information to the physician's acquirer who forwards an authorization request to an the H-Wallet server, which may then forward the authorization request to the patient's issuer. The issuer sends an authorization response to H-Wallet who, in turn, forwards the authorization response to the physician's acquirer. Assuming that the patient's payment is authorized, the physician's acquirer proceeds with clearing and settlement of the payment from the patient to the physician.

In a further implementation, the H-Wallet may allow the patient, in real time, to make a partial or compromised payment of the physician's bill through a debt collection service that used business rules to collect as much revenue as possible from patients, in real time, while minimizing the amount of patient write offs.

In a further implementation, the H-Wallet may allow physicians, and other healthcare service providers, to outsource collection of account receivables to the H-Wallet platform for those patients who pay on a branded account (e.g., Visa, etc.), while permitting patients to use any such branded card to pay their healthcare bills.

In one implementation, the H-Wallet bill payment service is complaint with HIPAA regulations because a patient registry may not be needed and no sensitive data is collected by the H-Wallet online bill payment service. The information collected by the H-Wallet bill payment service includes the web link, the amount paid, and the Visa account of person who is paying the bill.

In one implementation, the H-Wallet social portal reduces the number of network transactions and messages that fulfill payment approval and procurement of product and services, by providing a common space for the various parties to review and obtain requisite information asynchronously. Such an access-controlled (e.g., see FIGS. 19C and 19D) social network information portal allows for central sharing of asynchronously provided information. As such, by providing a central shared space for such information, the H-Wallet reduces the number of processing cycles for processing payments and health transactions, reduces network bandwidth, reduces and/or eliminates much duplicated network messaging that would otherwise be required to send in synchronized messages to all parties involved in the transaction. In another implementation, integration of the electronic wallet reduces the number of network transactions and messages that fulfill healthcare payment approval and procurement of healthcare product and services. It should be noted that obtaining all such information asynchronously via network efficient messaging may make such information available on demand directly from the H-Wallet later when payment determinations are needed. As such, this may further reduce network traffic and increase processing efficiency. In one embodiment, such information may also be scheduled for asynchronous provisioning via batch, cron job, and/or the like at off peek data transfer times, thereby providing data load balancing and improving overall H-Wallet efficiency. FIG. 7A shows a block diagram illustrating data flows between H-Wallet server and affiliated entities within various embodiments of the H-Wallet. Within various embodiments, one or more patient(s) 702, H-Wallet server 720, H-Wallet acquirer 730, H-Wallet database(s) 719, H-Wallet collector 750, healthcare provider(s) 710, H-Wallet issuer 760 are shown to interact via various communication networks 713.

Within various embodiments, the patient 702 may include a wide variety of different communications devices and technologies within embodiments of H-Wallet operation. For example, in one embodiment, the patient 702 may include, but are not limited to, terminal computers, work stations, servers, cellular telephony handsets, smart phones, PDAs, and/or the like. In one embodiment, the H-Wallet server 720 may be integrated with the H-Wallet acquirer 730. In another embodiment, the H-Wallet server 720 may be a remote server which is accessed by the acquirer 730 via a communication network 713, such as, but not limited to local area network (LAN), in-house intranet, the Internet, and/or the like.

In one embodiment, the patient 702 may register with the H-Wallet server 720 by submitting profile information 718. For example, the profile information may include patient name, patient address, patient medical history, and/or the like. In a further implementation, the profile information 718 may include patient payment information, such as credit card number, PayPal account, and/or the like.

In another embodiment, the healthcare provider (merchant) 710 may register with H-Wallet server 720 to participate in the H-Wallet service by submitting registration information 708. Such registration information 708 may include information such as provider name, provider address, provider contact, provider service range, provider pricing information, and/or the like.

In one implementation, the H-Wallet service may establish a provider directory for record 723 based on the registration information submitted by the providers. For example, in one implementation, an example XML implementation of a provider record may take a form similar to:

```
POST /Provider.php HTTP/1.1
Host: www.H-Wallet.com
Content-Type: Application/XML
Content-Length: 718
<?XML version = “1.0” encoding = “UTF-8”?>
<Provider>
  <ProviderID> XXXXXX </ProviderID>
  <ProviderName> Joe's Dental </ProviderName>
  <ProviderAddress> 733 King St </ProviderAddress>
  <ProviderZipCode> 00000 </ProviderZipCode>
  <ProviderType> Dental </ProviderType>
  <ProvierPractice>
      <Practice1> General Dentistry </Practice1>
      <Practice2> Cosmetic Dentistry </Practice2>
      ...
  </ProviderPractice>
  </ProviderNetwork>
    <Network1> Guardian </Network1>
    <Network2> PHC </Network2>
    ...
  </ProviderNetwork>
  ...
</Provider>
```

In another implementation, the H-Wallet server may execute a hypertext preprocessor (“PHP”) script including SQL commands to query the database for provider information, transaction data, and/or the like. An example PHP/SQL command listing, illustrating substantive aspects of storing a provider record 723 in the database:

<?PHP
header(‘Content-Type: text/plain’);
mysql_connect(″202.155.66.130”,$DBserver,$password); // access
database server
mysql_select(″PROVIDERS.SQL″); // select database to append
mysql_query(“INSERT INTO Providers (provider_id, provider_name,
provider_address, provider_zipcode, provider_type, provider_practice,
provider_network ...)
VALUES ($provider_id$, $provider_name$, $provider_address$,
$provider_zipcode$, $provider_type$, $provider_practice$,
$provider_network$ ...) ; //
add data to table in database
mysql_close (″PROVIDERS.SQL″) ; // close connection to database
?>

In one embodiment, the healthcare provider 700 may generate a medical bill 715 associated with a patient 702, and send it to the patient. For example, the medical bill may indicate an amount due for the patient, information on the procedure performed, a hyperlink for H-Wallet payment, and/or the like.

In another implementation, the healthcare provider may also send the medical bill 715 to the H-Wallet server 720 for authentication. For example, the H-Wallet may verify the payment amount based on the received medical bill when a patient is using H-Wallet service to pay a healthcare provider. In a further implementation the H-Wallet may send the medical bill and user information 715 to a collector 750.

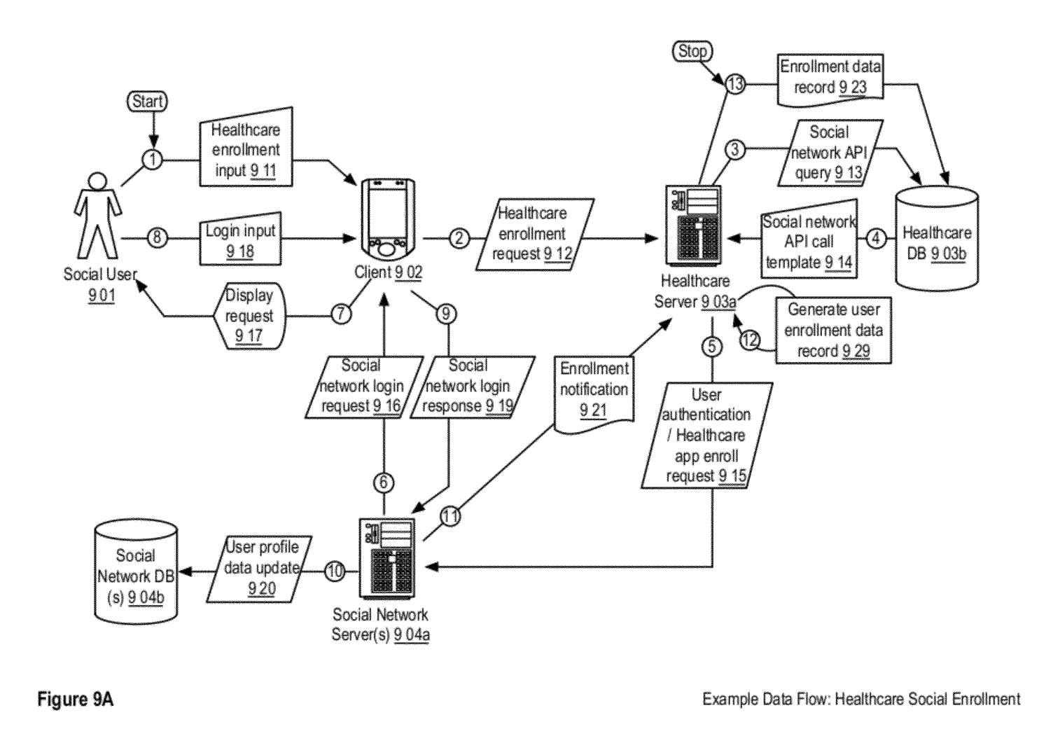

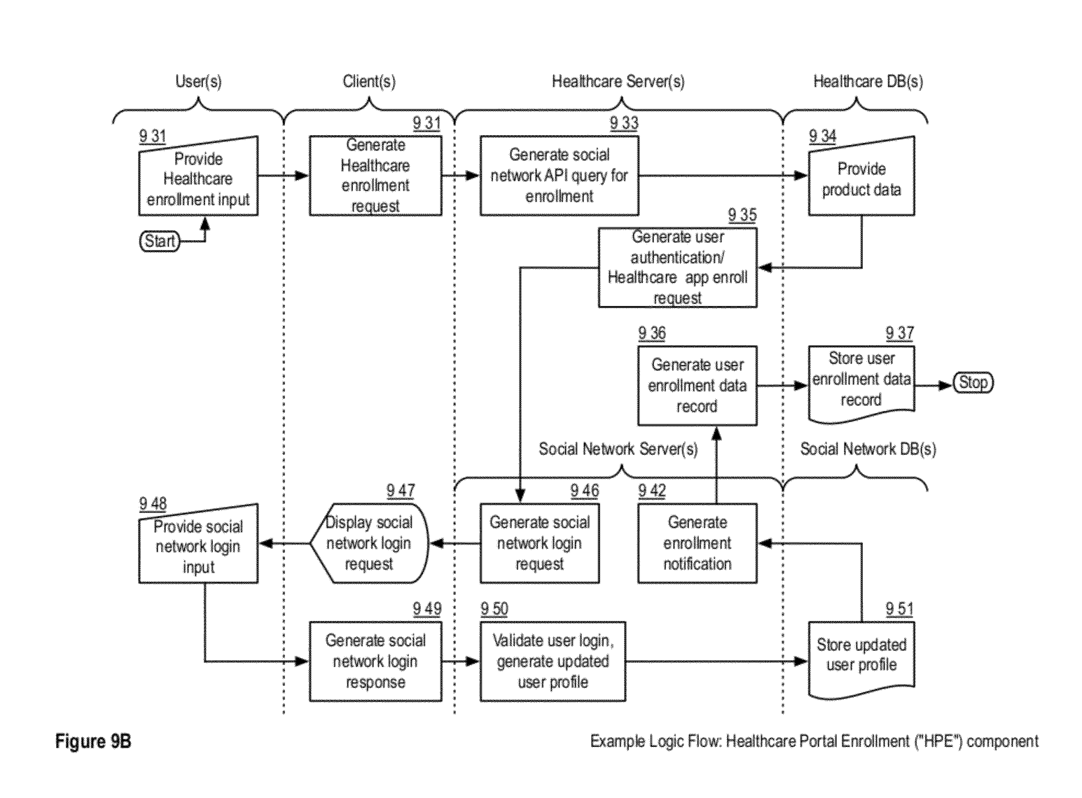

In one implementation, the collector 750 may comprise a collection portal, which may be integrated with a social media platform, such as but not limited to Facebook, Twitter, LinkedIn, Google+, Tumblr, and/or the like. In one implementation, the H-Wallet may set up medical payment collection messages on behalf of the healthcare provider via the social media platform. Further implementations of data message flows between the H-Wallet and a social media platform are discussed in FIG. 9A. In further implementations, the collector 750 may comprise a calling center, etc.

In one embodiment, a patient may receive a payment request 714 from the collector 750, e.g., via email, text messages, mail, phone calls, and/or the like. In one implementation, the collector may be a third party collector. In an alternative implementation, the collector may be integrated with the H-Wallet platform. For example, the H-Wallet platform may comprise an automatic dialing system to dial a patient for payment. For another example, the H-Wallet platform may comprise a web-server that send automatic emails to the patient.

The patient 702 may then submit payment 716 to the collector 750 by submitting payment information online, or via a phone call, and/or the like. The payment 716 may then be forwarded to the H-Wallet acquirer 730 and/or the server 720.

In one embodiment, the H-Wallet may process the patient payment 733 with a financial network, and transfer the funds of the payment to the healthcare 6 provider 710. In another implementation, the H-Wallet may forward the payment information 716 to an issuer 760 (e.g., the payment card issuer, etc.) for authentication.

In one implementation, the H-Wallet server 720 may also communicate with a H-Wallet database 719 to store and/or retrieve data, such as but not limited to healthcare payment record, provider directory, and/or the like. In some embodiments, a H-Wallet server 720 may be integrated with a local H-Wallet database 719. In other embodiments, a H-Wallet server 720 may access a remote H-Wallet database 719 via the communication network 713. The H-Wallet server 720 may send the information to the database 719 for storage, such as, but not limited to user account information, order record information, payment record information 716, and/or the like.

FIG. 7B provides a logic flow diagram illustrating embodiments of the H-Wallet. In one embodiment, physicians 722 may register with an H-Wallet an online bill pay service 732 and receive a unique identifier. The H-Wallet an online bill pay service 734 is in communication with issuers 738 of account issued to patients 733, H-Wallet 737, and acquirers 736 for the physicians 722.

In one implementation, physician 722 may send an electronic bill (e-bill) for healthcare services to a patient 733. The bill 202 includes a web navigation hyperlink. The web navigation hyperlink uniquely corresponds to the bill 732 for the health care services. The web navigation link encodes an unique identifier for the physician 722 of the patient 733.

When the patient 733 ‘clicks’ on the web link in the e-bill 732, the computer navigates to the H-Wallet an online bill pay service 734. The H-Wallet online bill pay service 734 is in communication with the issuers 738, H-Wallet 737, and the acquirers 736. The patient 733 may input an amount to pay on the bill, and any Visa account number issued by any financial institution to the patient by an issuer 738. Thus, the patient may not have to go each physician's web site to pay each physician's bill. The H-Wallet online bill pay service 734 uses the web link received from the patient 733 to look up the acquirer 736 for the physician 722. The Visa-hosted online bill pay service 734 may send the patient's proposed payment amount to the acquirer 736 for the physician. The acquirer 736 sends an authorization request for the amount to H-Wallet who sends the authorization request to the issuer 738 of the patient's Visa account. The issuer sends an authorization response back to H-Wallet who sends the authorization response back to the physician's acquirer 736. Assuming that the patient's payment is authorized by the issuer, normal clearing and settlement will follow.

In one implementation, if the patient 722 offers to pay less than the full amount currency of the invoice, the acquirer 736 may, in real time, use a debt collection service 729 to settle outstanding the patient's debt that is owed to the physician 722. The debt collection service 729, which uses business rules in real time to collect and compromise debts by: (i) setting up reoccurring payment from the patient 733 to the physician 722 until the bill is paid-in-full; (ii) allowing the patient to pay less than the full amount of the bill as a settlement or payment-in-full amount; (iii) allowing the patient 733 to received special terms for payment of the bill; or (iv) making other special terms and conditions for payment of the bill. The business rules are optimized so that as to collect as much revenue as possible from patients 733, in real time, while minimizing the amount of patient write offs. Once a debt collection agreement has been made binding with the patient 733 for payment of the bill from the physician 722, regular authorization, clearing/settlement proceeds.

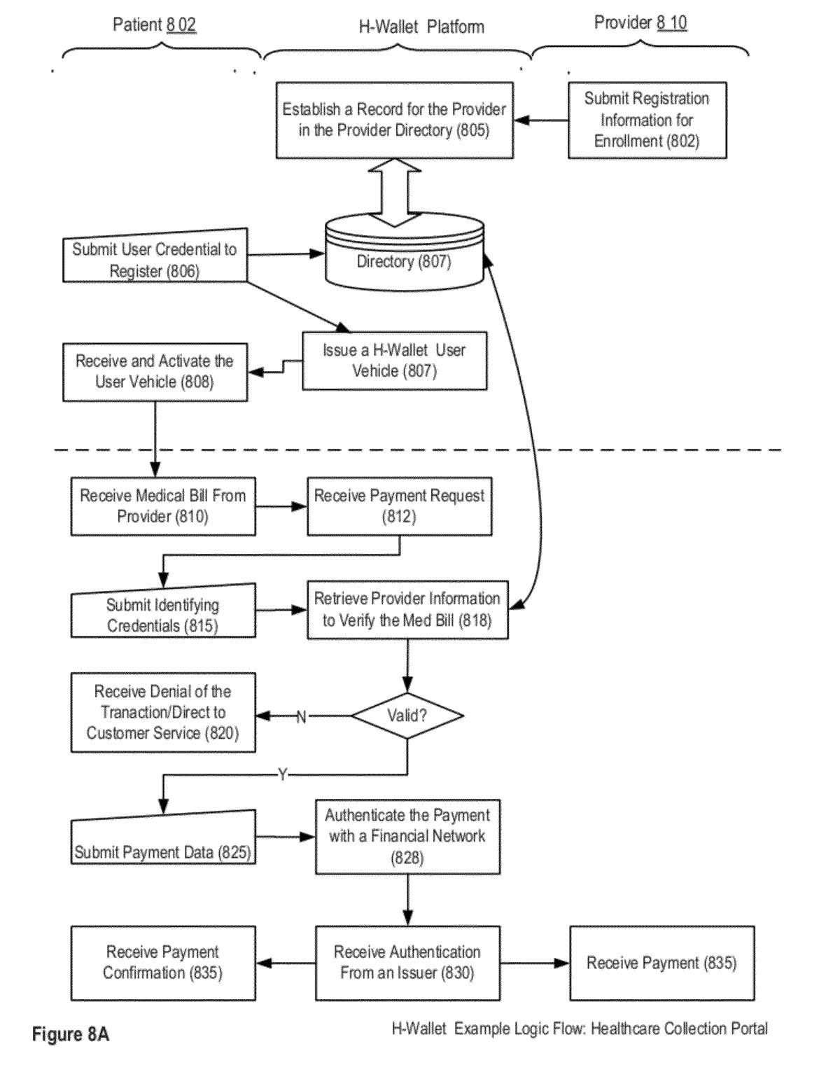

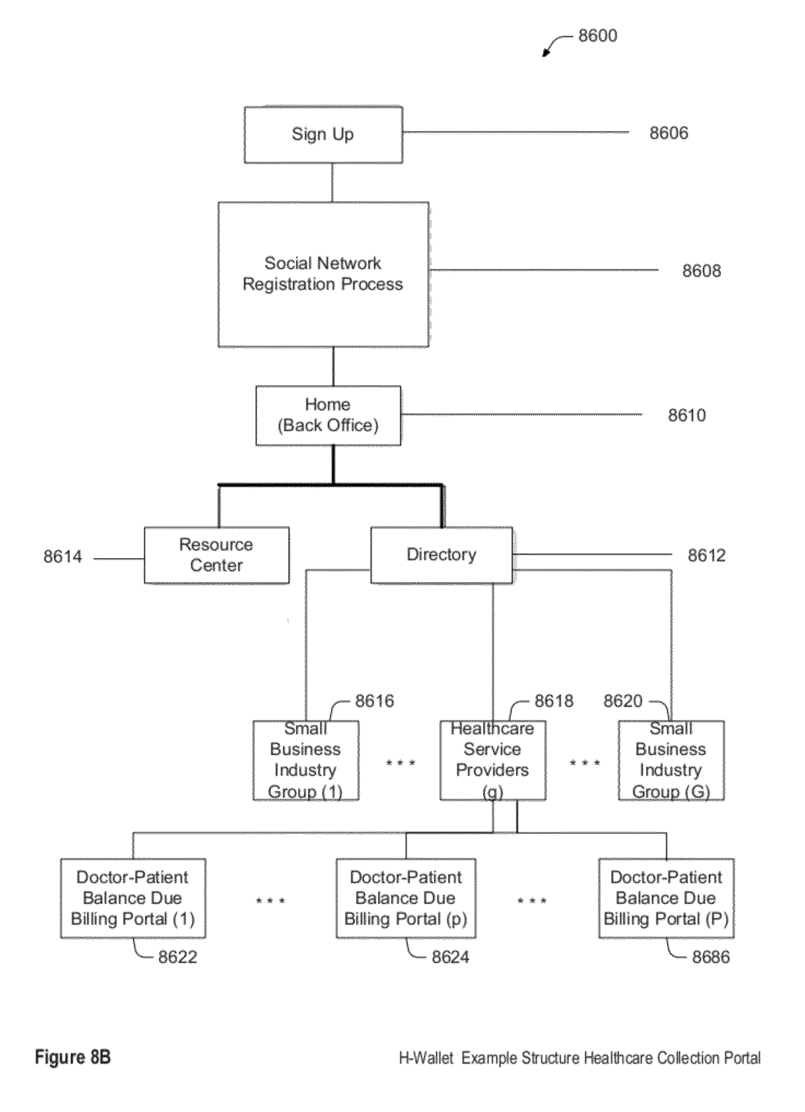

FIG. 8A provides a logic flow diagram illustrating alternative embodiments of the H-Wallet. In one embodiment, a healthcare provider may submit a registration request and information to the H-Wallet platform to enroll 820. For example, in one implementation, providers may enroll in the service on the Internet or through a phone enrollment system where they complete the service and acquiring agreement. At the time of enrollment, the provider may provide information about their practice that may uniquely identify the provider practice and may allow the H-Wallet to positively verify a bill. The H-Wallet platform may establish a record for the provider in the provider directory 807, e.g., at 805.

In a further implementation, the H-Wallet may provide options for the patient to conduct a one-time full-amount payment, or split the amount due into multiple payments based on the registration information. For example, a provider may register with a H-Wallet and specify rules that “payment amount more than $200.00” may be split into several scheduled payments. Then the H-Wallet may provide options for the user to schedule multiple payments with the provider if the amount is greater than 200.

Following enrollment in the service, the provider may update their patient materials, such as bills, payment policy documents, phone service, patient education materials, etc, to incorporate information with regard to the H-Wallet service.

In one embodiment, a patient may submit user credentials to register 806 with the H-Wallet platform. For example, a patient may visit a H-Wallet to create an account by setting up a user name and password. Upon verifying the created account, the H-Wallet platform may issue a H-Wallet user vehicle 807 for the patient. For example, the H-Wallet may issue a payment card, a electronic wallet account, and/or the like. The patient may then receive and activate the user vehicle 808 prior to use it for H-Wallet service.

In one embodiment, the patient may receive a bill from his healthcare provider 810. The medical bill may include information on how the patient can pay-by-phone or pay-online using the service. For example, in one implementation, the patient may call the H-Wallet and go through a series of prompts to identify the provider they are trying to access. For another example, the patient may visit the web address provided with the bill and enter a set of data that would allow the consumer to uniquely identify the healthcare provide they are trying to pay

In one implementation, when the H-Wallet receives a payment request 812 from the patient via Internet, and/or from a phone call, the H-Wallet may request the patient to submit identifying credentials 815, e.g., H-Wallet account, patient name, medical bill ID, and/or the like. The H-Wallet may then retrieve provider information from the directory 807 to verify the medical bill 818. For example, the H-Wallet may form a query to verify whether the indicated provider is registered with H-Wallet. For another example, the H-Wallet may examine whether the indicated medical bill matches with the stored information of the provider, and/or the like.

If the H-Wallet determines the medical bill is invalid, e.g., the indicated provider is a dental clinic but charges for oncology consultation, and/or the like, the H-Wallet may send a denial of transaction to the user via the web, or the phone call, and direct the patient to customer service 820. If it is valid, the patient may be requested to submit their payment card number, information on the visit they want to pay for and the amount they want to pay 825.

In a further implementation, the H-Wallet may retrieve specified payment rules with the identified provider. For example, if the provider has specified for any amount greater than 200.00, the patient may perform recurred payments (up to 4), the H-Wallet may then prompt the patient to select an option of multiple payments and schedule the payments.

The H-Wallet may authenticate the payment with a financial network 828. For example, transaction may pass from the H-Wallet server through the acquirer to the payment card issuer (e.g., the patient's bank) for authorization 830. Upon approval, the patient receives a confirmation number 835, and the provider may receive payment 835 into the bank account of the provider.

FIG. 8B provides a block diagram depicting an exemplary application map 8600 of a social networking environment for the facilitation of balance billing collections by healthcare service providers. A sign-up function 8606 of map 8600 provides small businesses an entry point for having a social media page in the social network, via a registration process seen at block 8608. Block 8610 provides a back office concept that enable networking between the registered small businesses that are users of a social network. Block 8612 of map 8600 enables registered small businesses to gain access to a directory home where users can conduct searches for other registered small businesses 8616 through 8620, and can access small business operational content resources through block 8686.

Each small business in a healthcare service provider category is seen at reference numeral 8618 and indexed as Healthcare Service Provider (g), where ‘g’ is an integer having a value from 1 to G. Within category 8618 are doctor-patient portals 8622 through 8626 which are indexed as Doctor-Patient Balance Due Billing Portal (p), where ‘p’ is an integer having a value from 1 to P. Portals 8622-8626 are each a doctor-patient balance due billing portal (p) that can be used by Healthcare Service Provider (g) 8618 to collect account receivables in accordance with implementations discussed herein. Those of skill in the art will recognize that the examples of the components illustrated by FIG. 86 are not a limitation, but can include additional components.

FIGS. 9A-12B provide data/logic flow diagrams illustrating H-Wallet payment via social media portals within embodiments of the H-Wallet. In one implementation, upon receiving a medical bill and/or a payment reminder via a social media platform, the H-Wallet may facilitate a user to proceed to pay with an electronic wallet account from the social media platform. Within implementations, various parties of healthcare payment transactions, such as an insurance provider, a patient, a healthcare provider, and/or the like, may act as a social user at a social media platform, and initiate a transaction on the social media platform. For example, an insurance provider may pay an approved insured amount to a healthcare provider; a patient may initiate co-pay to a healthcare provider, and/or the like.

FIG. 9A shows a data flow diagram illustrating an example H-Wallet enrollment procedure in some embodiments of the H-Wallet. In some embodiments, a user, e.g., 901, may desire to enroll in H-Wallet. The user may communicate with a H-Wallet server, e.g., 903a, via a client such as, but not limited to: a personal computer, mobile device, television, point-of-sale terminal, kiosk, ATM, and/or the like (e.g., 902). For example, the user may provide user input, e.g., H-Wallet enrollment input 911, into the client indicating the user's desire to enroll in social network authenticated purchase payment. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like.

In some implementations, using the user's input, the client may generate a H-Wallet enrollment request, e.g., 912, and provide the enrollment request to the H-Wallet server 903a. For example, the client may provide a HTTP(S) POST message including data formatted according to the XML. Below is an example HTTP(S) POST message including an XML-formatted enrollment request for the H-Wallet server:

```
POST /enroll.php HTTP/1.1
Host: www.socialpay.com
Content-Type: Application/XML
Content-Length: 484
<?XML version = “1.0” encoding = “UTF-8”?>
<enrollment_request>
    <request_ID>4NFU4RG94</request_ID>
    <timestamp>2011-02-22 15:22:43</timestamp>
    <user_ID>john.q.public@facebook.com</user_ID>
    <wallet_account_ID>7865493028712345</wallet_account_ID>
    <client_details>
        <client_IP>192.168.23.126</client_IP>
        <client_type>smartphone</client_type>
        <client_model>HTC Hero</client_model>
        <OS>Android 9.2</OS>
        <app_installed_flag>true</app_installed_flag>
    </client_details>
</enrollment_request>
```

In some embodiments, the H-Wallet server may obtain the enrollment request from the client, and extract the user's payment detail (e.g., XML data) from the enrollment request. For example, the H-Wallet server may utilize a parser such as the example parsers described below in the discussion with reference to FIG. 27. In some implementations, the H-Wallet server may query, e.g., 913, a H-Wallet database, e.g., 903b, to obtain a social network request template, e.g., 914, to process the enrollment request. The social network request template may include instructions, data, login URL, login API call template and/or the like for facilitating social network authentication. For example, the database may be a relational database responsive to Structured Query Language (“SQL”) commands. The merchant server may execute a hypertext preprocessor (“PHP”) script including SQL commands to query the database for product data. An example PHP/SQL command listing, illustrating substantive aspects of querying the database, e.g., 914-215, is provided below:

<?PHP
header(‘Content-Type: text/plain’);
mysql_connect(“254.93.179.112”,$DBserver,$password); // access
database server
mysql_select_db(“SOCIALPAY.SQL”); // select database table to
search
//create query
$query = “SELECT template FROM EnrollTable WHERE network
LIKE ‘%’ $socialnet”;
$result = mysql_query($query); // perform the search query
mysql_close(“SOCIALAUTH.SQL”); // close database access
?>

In some implementations, the H-Wallet server may redirect the client to a social network server, e.g., 904a, by providing a HTTP(S) REDIRECT 300 message, similar to the example below:

```
HTTP/1.1 300 Multiple Choices
Location: https://www.facebook.com/dialog/oauth?client_id=
snpa_app_ID&redirect_uri=
www.paynetwork.com/enroll.php
<html>
    <head><title>300 Multiple Choices</title></head>
    <body><h1>Multiple Choices</h1></body>
</html>
```

In some implementations, the H-Wallet server may provide information extracted from the H-Wallet enrollment request to the social network server as part of a user authentication/H-Wallet app enroll request, e.g., 915. For example, the H-Wallet server may provide a HTTP(S) POST message to the social network server, similar to the example below:

```
POST /authenticate_enroll.php HTTP/1.1
Host: www.socialnet.com
Content-Type: Application/XML
Content-Length: 484
<?XML version = “1.0” encoding = “UTF-8”?>
<enrollment_request>
    <request_ID>4NFU4RG94</request_ID>
    <timestamp>2011-02-22 15:22:43</timestamp>
    <user_ID>john.q.public@facebook.com</user_ID>
    <wallet_account_ID>7865493028712345</wallet_account_ID>
    <client_details>
        <client_IP>192.168.23.126</client_IP>
        <client_type>smartphone</client_type>
        <client_model>HTC Hero</client_model>
        <OS>Android 9.2</OS>
        <app_installed_flag>true</app_installed_flag>
    </client_details>
</enrollment_request>
```

In some implementations, the social network server may provide a social network login request, e.g., 916, to the client. For example, the social network server may provide a HTML input form to the client. The client may display, e.g., 917, the login form for the user. In some implementations, the user may provide login input into the client, e.g., 918, and the client may generate a social network login response, e.g., 919, for the social network server. In some implementations, the social network server may authenticate the login credentials of the user, and upon doing so, update the profile of the user to indicate the user's enrollment in the H-Wallet system. For example, in a social networking service such as Facebook®, the social network server may provide permission to a H-Wallet third-party developer app to access the user's information stored within the social network. In some embodiments, such enrollment may allow a virtual wallet application installed on a user device of to access the user's social profile information stored within the social network. Upon authentication, the social network server may generate an updated data record for the user, e.g., 920, and provide an enrollment notification, e.g., 921, to the H-Wallet server. For example, the social network server may provide a HTTP(S) POST message similar to the example below:

```
POST /enrollnotification.php HTTP/1.1
Host: www.socialpay.com
Content-Type: Application/XML
Content-Length: 1306
<?XML version = “1.0” encoding = “UTF-8”?>
<enroll_notification>
        <request_ID>4NFU4RG94</request_ID>
        <timestamp>2011-02-22 15:22:43</timestamp>
        <result>enrolled</result>
</enroll_notification>
```

Upon receiving notification of enrollment from the social network server, the H-Wallet server may generate, e.g., 922, a user enrollment data record, and store the enrollment data record in a H-Wallet database, e.g., 923, to complete enrollment. In some implementations, the enrollment data record may include the information from the enrollment notification 921.

FIG. 9B shows a logic flow diagram illustrating example aspects of H-Wallet enrollment in some embodiments of the H-Wallet, e.g., a H-Wallet Enrollment (“HCE”) component. In some embodiments, a user may desire to enroll in H-Wallet. The user may provide user input, e.g., H-Wallet enrollment input 931, into the client indicating the user's desire to enroll in social network authenticated purchase payment. In some implementations, using the user's input, the client may generate a H-Wallet enrollment request, e.g., 932, and provide the enrollment request to the H-Wallet server. In some embodiments, the H-Wallet server may obtain the enrollment request from the client, and extract the user's payment detail (e.g., XML data) from the enrollment request. For example, the H-Wallet server may utilize a parser. In some implementations, the H-Wallet server may query, e.g., 933, a H-Wallet database to obtain a social network request template to process the enrollment request. The social network request template may include instructions, data, login URL, login API call template and/or the like for facilitating social network authentication. In some implementations, the H-Wallet server may redirect the client to a social network server. In some implementations, the H-Wallet server may provide information extracted from the H-Wallet enrollment request to the social network server as part of a user authentication/H-Wallet app enroll request, e.g., 935. In some implementations, the social network server may provide a social network login request, e.g., 946, to the client. For example, the social network server may provide a HTML input form to the client. The client may display, e.g., 947, the login form for the user. In some implementations, the user may provide login input into the client, e.g., 948, and the client may generate a social network login response, e.g., 949, for the social network server. In some implementations, the social network server may authenticate the login credentials of the user, and upon doing so, update the profile of the user to indicate the user's enrollment in the H-Wallet system. For example, in a social networking service such as Facebook®, the social network server may provide permission to a H-Wallet third-party developer app to access the user's information stored within the social network. In some embodiments, such enrollment may allow a virtual wallet application installed on a user device of to access the user's social profile information stored within the social network. Upon authentication, the social network server may generate an updated data record for the user, e.g., 950-951, and provide an enrollment notification, e.g., 942 to the H-Wallet server. Upon receiving notification of enrollment from the social network server, the H-Wallet server may generate, e.g., 936, a user enrollment data record, and store the enrollment data record in a H-Wallet database, e.g., 937, to complete enrollment. In some implementations, the enrollment data record may include the information from the enrollment notification.

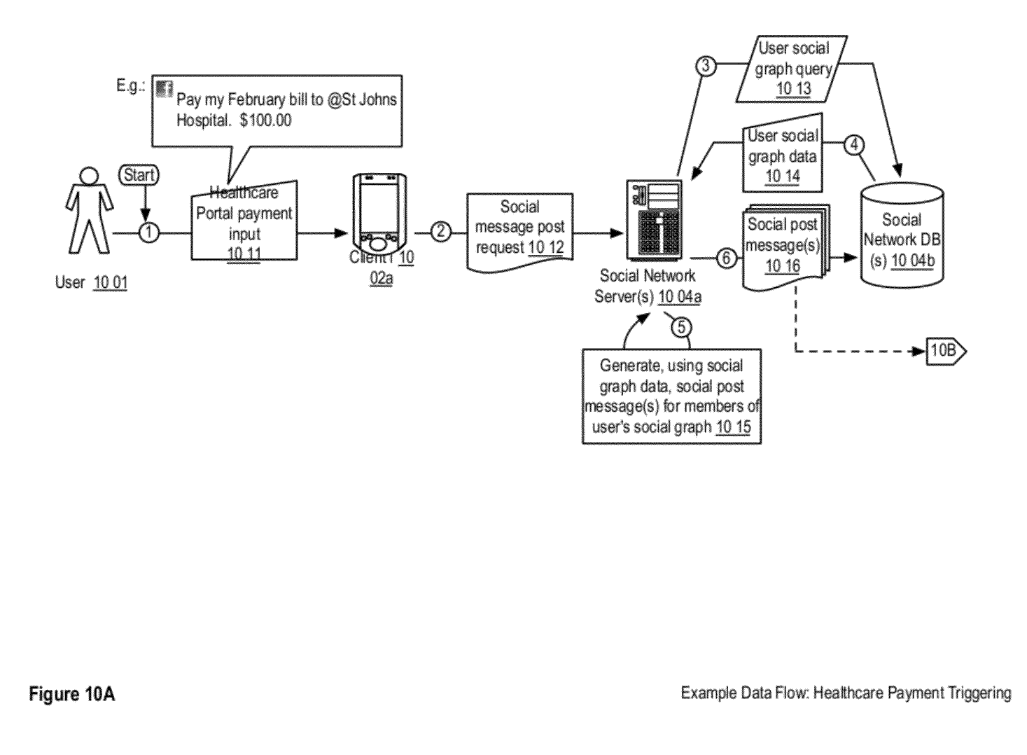

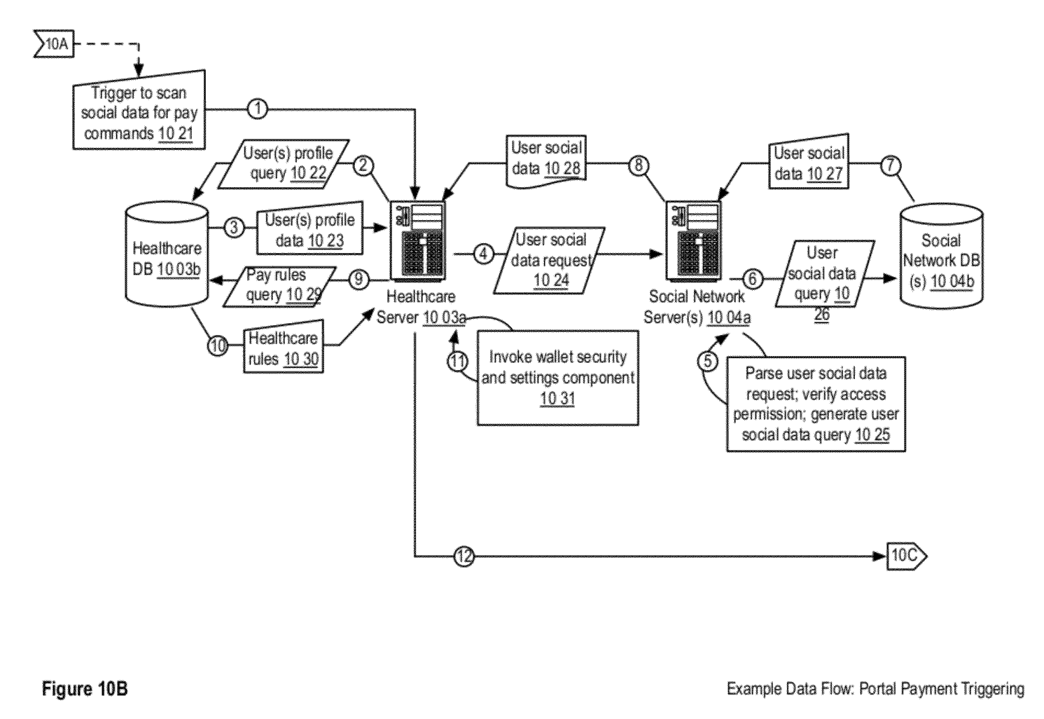

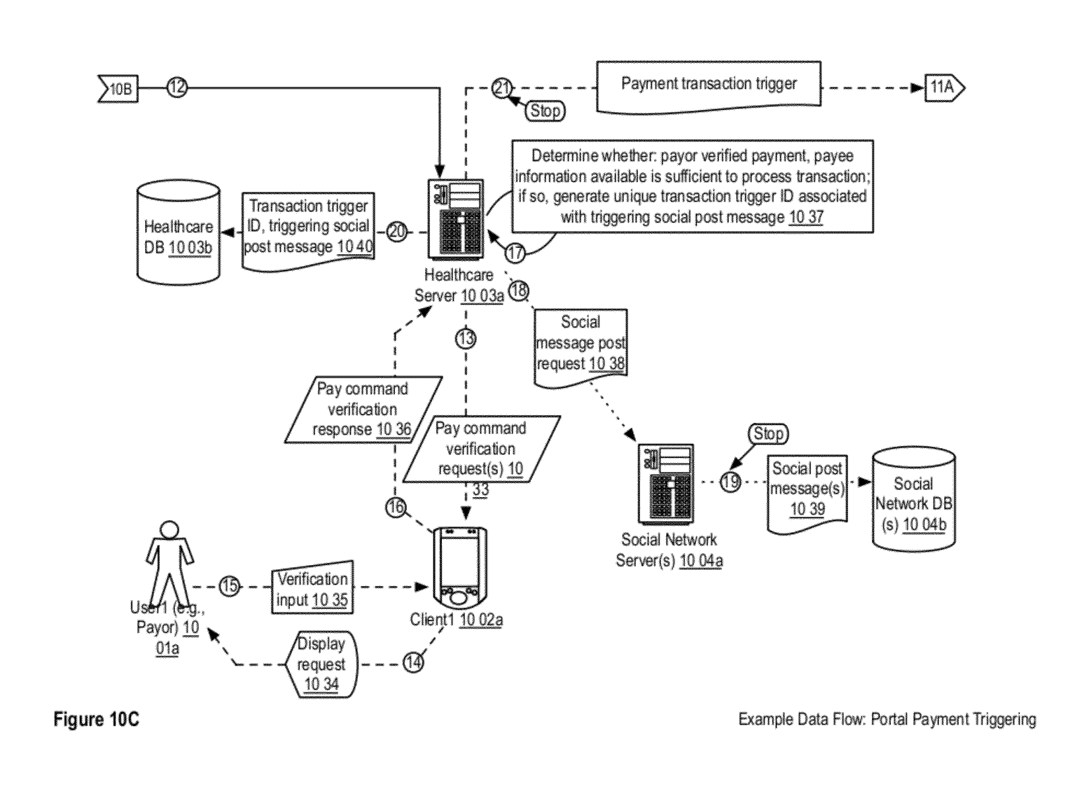

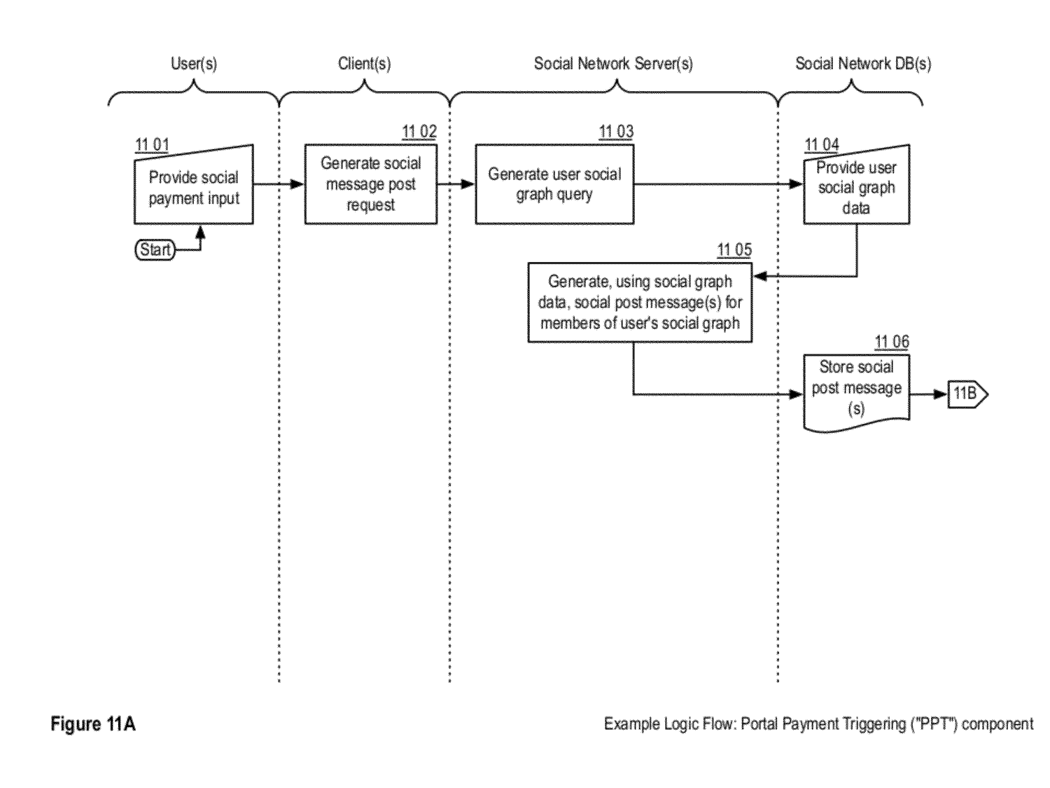

FIGS. 10A-C show data flow diagrams illustrating an example H-Wallet payment triggering procedure in some embodiments of the H-Wallet. With reference to FIG. 10A, in some embodiments, a user, e.g., user1 1001a, may desire to provide or request funds from another (e.g., a user, a participating merchant, etc.). The user may communicate with a healthcare collection portal server, e.g., 1003a, via a client (clients 1002a) such as, but not limited to: a personal computer, mobile device, television, point-of-sale terminal, kiosk, ATM, and/or the like. For example, the user may provide H-Wallet payment input loll, into the client indicating the user's desire to provide or request funds from another, e.g., to pay a user's healthcare bill to a healthcare provider who may have an account with the social media platform, etc. In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In response, the client may provide a social message post request 1012 to the social network server. In some implementations, a virtual wallet application executing on the client may provide the user with an easy-to-use interface to generate and send the social message post request. In alternate implementations, the user may utilize other applications to provide the social message post request. For example, the client may provide a social message post request to the social network server as a HTTP(S) POST message including XML-formatted data. An example listing of a social message post request 1012, substantially in the form of a HTTP(S) POST message including XML-formatted data, is provided below:

```
POST /socialpost.php HTTP/1.1
Host: www.socialnetwork.com
Content-Type: Application/XML
Content-Length: 310
<?XML version = “1.0” encoding = “UTF-8”?>
<message_post_request>
    <request_ID>value</request_ID>
    <timestamp>2011-02-02 03:04:05</timestamp>
    <sender_id>jfdoe@facebook.com</sender_id>
    <receiver_id>johnqp@facebook.com</receiver_id>
    <message>$25 @johnqp #thanksforagreattimelastnite</message>
</message_post_request>
```

The user may have signed up for numerous wallets. The message 1012 may be sent be sent from the user 1002a (e.g., the patient, etc.) to a second user (e.g., a healthcare provider, etc.) via the social network 1004a. H-Wallet may later append various messages and/or send additional various messages that will appear to the target user to have been sent by user1 1001a. As an example, here the H-Wallet determined (determination and parsing as described further below, e.g., FIGS. 6, 9 and 10 et al.) that user2 does not have a wallet into which they may redeem payment. As such H-Wallet upon parsing and determination may append a message to allow the receiving user to sign up for a wallet and thus obtain the payment from users; in this example, H-Wallet appended “signup at visa.com/wallet to redeem this payment.” It should be noted that various wallets may be employed and/or offered; for example, a social network may itself offer a wallet and as such another message of “signup at twitter.com/wallet to redeem this payment” may be appended. In another embodiment, H-Wallet itself may host an e-wallet and as such the following message may be appended “signup at socialpay.com/wallet to redeem this payment.” In one example, the H-Wallet server may use login credentials provided by a user to automatically simultaneously and permanently be logged in reading every social message/post entered by the user from other client programs and in addition received messages that are sent to the user by other users. As such, H-Wallet may parse all transactions send by the user and/or received messages that were directed to the user and determine which messages are directed to make person to person payments. In another embodiment, this type of interception parsing may be employed at the social network servers instead of at the H-Wallet servers. In yet another embodiment, both the H-Wallet server and the social network server may do this type of interception parsing, the details of which are described further below (e.g., FIGS. 6, 9 and 10 et al.). It should be noted when this type of interception parsing is ongoing, which will be all the time unless a user specifically requests the cessation of such interception parsing, when the H-Wallet server and/or other servers intercept messages and parse them and determine, e.g., they are triggers for payments, those servers may go on to process the parsed message triggering payment and other activities. For example, if the target user does not have an e-wallet account, upon look up and determination by the server, then the server may send a message in addition to the social message POST request 1012, where the additional message will provide details for where the target user may sign up and create an e-wallet account and redeem payment provided to them by another user/system. If H-Wallet, instead, determines that the target user is already enrolled in an e-wallet, it may initiate and then facilitate the transfer of payment from the first user to the target user's account without further messaging or interaction (e.g., it may also require the target user to accept such payments, in which case it can send a second message to the target user asking them to reply to H-Wallet saying yes to effectuate payment before such funds are delivered to the target user's e-wallet account).

In another embodiment, a Healthcare collection portal post message may be for an item. In such a sense, it may become a social gift message. For example, the message may be substantially in the form of a HTTP(S) POST message including XML-formatted data, is provided below:

```
POST /socialpost.php HTTP/1.1
Host: www.socialnetwork.com
Content-Type: Application/XML
Content-Length: 310
<?XML version = “1.0” encoding = “UTF-8”?>
<message_post_request>
        <message_link_label>iPad</message_link_label >
    <message_link_label_address>http:store.apple.com/
    ?itemquery?ipad_32GB_WiFi_white
</message_link_label_address>
        <request_ID>value</request_ID>
        <store_login>jfdoe@mac.com</store_login>
        <store_pass>abc123</store_pass>
        <store_wallet_account>Apple Store
ID123</store_wallet_account>
    <timestamp>2011-02-02 03:04:05</timestamp>
    <sender_id>jfdoe@facebook.com</sender_id>
    <receiver_id>johnqp@facebook.com</receiver_id>
    <message>iPad @johnqp #christmasgift</message>
</message_post_request>
```

In such an example, the user may post a link to an item (e.g., drag and drop a link for a product into their social messaging application which will translate and/or include both the link label (e.g., iPad) and the address for the item (e.g., http:store.apple.com/?itemquery?ipad_{—}32GB_WiFi_white) identifying the product skew at the merchant. Healthcare collection portal may then see if the user's wallet has an account with that merchant and provide login credentials to affect a purchase through the merchant and identify shipping addresses from the target user. In another embodiment, the gifting user may be prompted for login information, which may then be passed along to Healthcare collection portal to affect the purchase.

In some embodiments, the social network server 1004a may query its social network database for a social graph of the user, e.g., 1013. For example, the social network server may issue PHP/SQL commands to query a database table for social graph data associated with the user. An example user social graph query 1013, substantially in the form of PHP/SQL commands, is provided below:

<?PHP
header(‘Content-Type: text/plain’);
mysql_connect(“254.93.179.112”,$DBserver,$password); // access
database server
mysql_select_db(“H-Wallet_DB.SQL”); // select database table to
search
//create query
$query = “SELECT friend_name friend_type friend_weight
message_params_list
messaging_restrictions FROM SocialGraphTable WHERE user
LIKE ‘%’ $user_id”;
$result = mysql_query($query); // perform the search query
mysql_close(“H-Wallet_DB.SQL”); // close database access
?>

In some embodiments, the social network database may provide the requested social graph data in response, e.g., 1014. Using the social graph data, the social network server may generate message(s) as appropriate for the user and/or members of the user's social graph, e.g., 1015, and store the messages 1016 for the user and/or social graph members.

With reference to FIG. 10B, in some embodiments, such posting of social messages may trigger H-Wallet actions. For example, a healthcare collection portal server 1003a may be triggered to scan the social data for pay commands. In embodiments where every social post message originates from the virtual wallet application of a user, the H-Wallet may optionally obtain the pay commands from the virtual wallet applications, and skip scanning the social networks for pay commands associated with the user. In embodiments where a user is allowed to issue pay commands from any device (even those not linked to the user's virtual wallet), the H-Wallet may periodically, or even continuously scan the social networks for pay commands, e.g., 1021. In embodiments where the H-Wallet scans the social networks, the H-Wallet server may query a H-Wallet database for a profile of the user. For example, the H-Wallet server may request a user ID and password for the social networks that the user provided to the H-Wallet server during the enrollment phase (see, e.g., FIGS. 9A-9B). For example, the H-Wallet server may issue PHP/SQL commands to query a database table for user profile data. An example user profile data query 1022, substantially in the form of PHP/SQL commands, is provided below:

<?PHP
header(‘Content-Type: text/plain’);
mysql_connect(“254.93.179.112”,$DBserver,$password); // access
database server
mysql_select_db(“H-Wallet_DB.SQL”); // select database table to
search
//create query
$query = “SELECT network_id network_name network_api
user_login user_pass FROM
UsersTable WHERE userid LIKE ‘%’ $user_id”;
$result = mysql_query($query); // perform the search query
mysql_close(“H-Wallet_DB.SQL”); // close database access
?>

In response, the H-Wallet database may provide the requested information, e.g., 1023. In some embodiments, the H-Wallet server may provide a user social data request 1024 to the social network server. An example listing of commands to issue a user social data request 1024, substantially in the form of PHP commands, is provided below:

<?PHP
header(‘Content-Type: text/plain’);
// Obtain user ID(s) of friends of the logged-in user
$friends =
json_decode(file_get_contents(‘https://graph.facebook.com/
me/friends?access
token=’$cookie[‘oauth_access_token’]), true);
$friend_ids = array_keys($friends);
// Obtain message feed associated with the profile of the logged-in user
$feed =
json_decode(file_get_contents(‘https:llgraph.facebook.com/me/
feed?access_token=’$cookie
[‘oauth_access_token’]), true);
// Obtain messages by the user's friends
$result = mysql_query(‘SELECT * FROM content WHERE uid
IN (‘ .implode($friend_ids,
‘,’) . ’)’);
$friend_content = array( );
while ($row = mysql_fetch_assoc($result))
$friend_content [ ] $row;
?>

The user may have signed up for numerous wallets. The message 1012, 1024 may be sent be sent from the user 1002a to a second user via the social network 1004a. In this example, user1 1001 sent a payment of a medical bill to a healthcare provider “St John's Hospital.” H-Wallet may later append various messages and/or send additional various messages, which will appear to the target user to have been sent by user1 1001a. As an example, here the H-Wallet determined that user2 does not have a wallet into which they may redeem payment. As such H-Wallet upon parsing and determination may append a message to allow the receiving user to sign up for a wallet and thus obtain the payment from user1; in this example, H-Wallet appended “signup at visa.com/wallet to redeem this payment.” It should be noted that various wallets may be employed and/or offered; for example, a social network may itself offer a wallet and as such another message of “signup at twitter.com/wallet to redeem this payment” may be appended. In another embodiment, H-Wallet itself may host an e-wallet and as such the following message may be appended “signup at socialpay.com/wallet to redeem this payment.” In one example, the H-Wallet server may use login credentials provided by a user to automatically simultaneously and permanently be logged in reading every social message/post entered by the user from other client programs and in addition received messages that are sent to the user by other users. As such, H-Wallet may parse all transactions send by the user and/or received messages that were directed to the user and determine which messages are directed to make person to person/entity payments. In another embodiment, this type of interception parsing may be employed at the social network servers instead of at the H-Wallet servers. In yet another embodiment, both the H-Wallet server and the social network server may do this type of interception parsing, the details of which are described further below. It should be noted when this type of interception parsing is ongoing, which will be all the time unless a user specifically requests the cessation of such interception parsing, when the H-Wallet server and/or other servers intercept messages and parse them and determine, e.g., they are triggers for payments, those servers may go on to process the parsed message triggering payment and other activities. For example, if the target user does not have an e-wallet account, upon look up and determination by the server, then the server may send a message in addition to the social message POST request 1012, 1024, where the additional message will provide details for where the target user may sign up and create an e-wallet account and redeem payment provided to them by another user/system. If H-Wallet, instead, determines that the target user is already enrolled in an e-wallet, it may initiate and then facilitate the transfer of payment from the first user to the target user's account without further messaging or interaction (e.g., it may also require the target user to accept such payments, in which case it can send a second message to the target user asking them to reply to H-Wallet saying yes to effectuate payment before such funds are delivered to the target user's e-wallet account).

In some embodiments, the social network server may query, e.g., 1026, it social network database 1004b for social data results falling within the scope of the request. In response to the query, the database may provide social data, e.g., 1027. The social network server may return the social data obtained from the databases, e.g., 1028, to the H-Wallet server. An example listing of user social data 1028, substantially in the form of JavaScript Object Notation (JSON)-formatted data, is provided below:

| [ “data”: [ | |
|---|---|
| | { “name”: “John Smith”, |
| | “id”: “483722”}, |
| | { “name”: “St John's Hospital”, |
| | “id”: “86S743”}, |
| ] } | |

In some embodiments, the H-Wallet server may query the H-Wallet database for H-Wallet rules, e.g., 1029. For example, the H-Wallet server may issue PHP/SQL commands to query a database table (such as FIG. 27, Healthcare collection portal Rules 2719q) for the H-Wallet rules 1030. An example pay rules query 1029, substantially in the form of PHP/SQL commands, is provided below:

<?PHP
header(‘Content-Type: text/plain’);
mysql_connect(“254.93.179.112”,$DBserver,$password); // access
database server
mysql_select_db(“H-Wallet_DB.SQL”); // select database table to
search
//create query
$query = “SELECT rule_id rule_type rule_description
rule_priority rule_source FROM H-
WalletRulesTable WHERE rule_type LIKE pay_rules”;
$result = mysql_query($query); // perform the search query
mysql_close(“H-Wallet_DB.SQL”); // close database access
?>

In some embodiments, the H-Wallet server may process the user social data using the H-Wallet rules to identify pay commands, pay requests, merchant offers, and/or like content of the user social data. In some embodiments, rules may be provided by the H-Wallet to ensure the privacy and security of the user's social data and virtual wallet. As another example, the rules may include procedures to detect fraudulent transaction attempts, and request user verification before proceeding, or cancel the transaction request entirely. In some embodiments, the H-Wallet server may utilize a wallet security and settings component, such as the example WSS 600 component described further below in the discussion with reference to FIGS. 12A-B.

With reference to FIG. 10C, in some embodiments, the H-Wallet server may optionally determine that, based on processing of the rules, user verification is needed to process a transaction indicated in a pay command. For example, if the rules processing indicated that there is a probability of the pay command being an attempt at a fraudulent transaction attempt, the H-Wallet server may determine that the user must be contacted for payment verification before the transaction can be processed. In such scenarios, the H-Wallet server may provide a pay command verification request 1033 to the client, which the client may display, e.g., 1034, to the user. For example, the H-Wallet server may provide a pay command verification request to the client 1002a as a HTTP(S) POST message including XML-formatted data. An example listing of a pay command verification request 1033, substantially in the form of a HTTP(S) POST message including XML-formatted data, is provided below:

```
POST /verifyrequest.php HTTP/1.1
Host: www.client.com
Content-Type: Application/XML
Content-Length: 256
<?XML version = “1.0” encoding = “UTF-8”?>
<verify_request>
    <transaction_ID>AE1234</transaction_ID>
    <timestamp>2011-02-02 03:04:05</timestamp>
    <amount>50000 vpts</amount>
    <message_string>5000000 vpts @jfdoe #thx</message_string>
</verify_request>
```

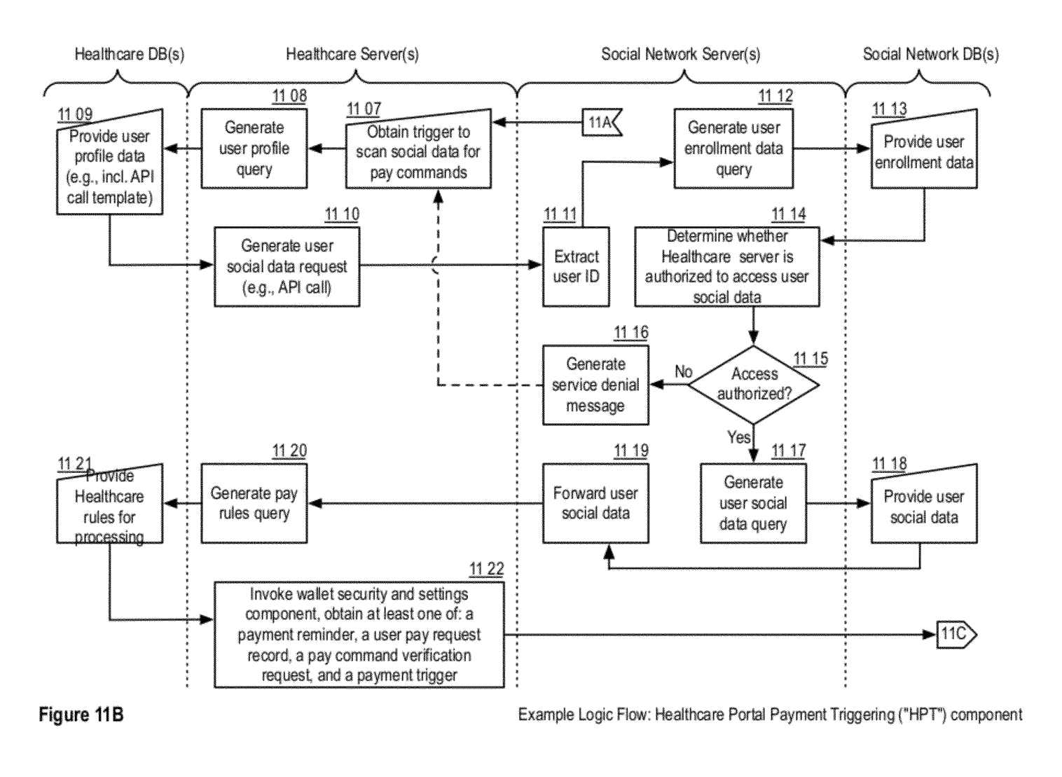

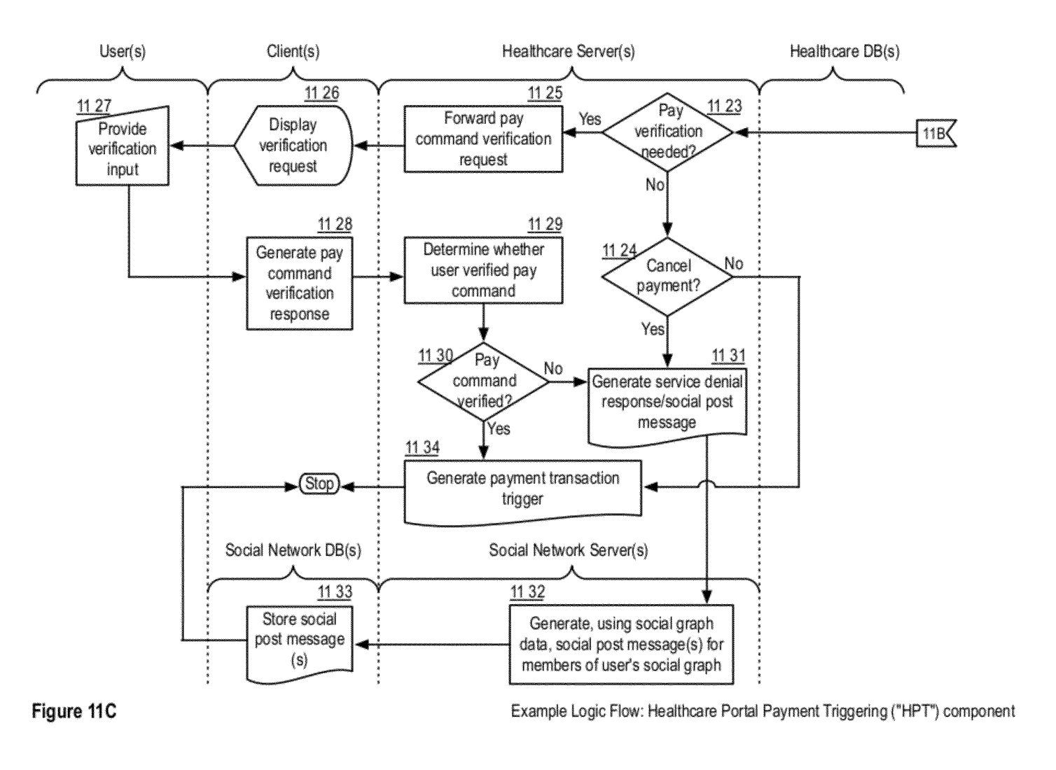

In some embodiments, the user may provide a verification input 1035 into the client, which may provide a pay command verification response to the H-Wallet server. The H-Wallet server may determine whether the payor-verified payment, whether payee information available is sufficient to process the transaction, and/or the like. In scenarios where sufficient payee information is unavailable, the H-Wallet server may optionally provide a social post message 1038 to a social networking service associated with the potential payee requesting the payee to enroll in H-Wallet service (e.g., using the H-Wallet enrollment component described above in the discussion with reference to FIGS. 9A-9B), which the social network server may post 1039 for the payee. If all the requirements are met for processing the transaction, the H-Wallet server may generate a unique transaction trigger associated with the triggering social post message, e.g., 1037, and store a transaction trigger ID, triggering social post message, etc., for recordkeeping or analytics purposes, e.g., 1040. The H-Wallet server may provide the transaction trigger to trigger a purchase transaction 1041, e.g., via a purchase transaction authorization such as the example H-Wallet Payment Triggering component described below in the discussion with reference to FIGS. 11A-11C.

FIGS. 11A-C show logic flow diagrams illustrating example aspects of H-Wallet payment triggering in some embodiments of the H-Wallet, e.g., a H-Wallet Payment Triggering (“HPT”) component. With reference to FIG. 11A, in some embodiments, a user may desire to provide or request funds from another (e.g., a user, a participating merchant, etc.). The user may communicate with a social network server via a client. For example, the user may provide H-Wallet payment input 1101, into the client indicating the user's desire to provide or request funds from another. In response, the client may generate and provide a social message post request 1102 to the social network server. In some implementations, a virtual wallet application executing on the client may provide the user with an easy-to-use interface to generate and send the social message post request. In alternate implementations, the user may utilize other applications to provide the social message post request. In some embodiments, the social network server may query its social network database for a social graph of the user, e.g., 1103. In response, the social network database may provide the requested social graph data, e.g., 1104. Using the social graph data, the social network server may generate message(s) as appropriate for the user and/or members of the user's social graph, e.g., 1105, and store the messages 1106 for the user and/or social graph members.

With reference to FIG. 11B, in some embodiments, such posting of social messages may trigger H-Wallet actions. For example, a healthcare collection portal server may be triggered to scan the social data for pay commands, e.g., 1107. In embodiments where every social post message originates from the virtual wallet application of a user, the H-Wallet may optionally obtain the pay commands from the virtual wallet applications, and skip scanning the social networks for pay commands associated with the user. In embodiments where a user is allowed to issue pay commands from any device (even those not linked to the user's virtual wallet), the H-Wallet may periodically, or even continuously scan the social networks for pay commands. In embodiments where the H-Wallet scans the social networks, the healthcare collection portal server may query a healthcare collection portal database for a profile of the user, 1108. For example, the healthcare collection portal server may request a user ID and password for the social networks that the user provided to the healthcare collection portal server during the enrollment phase (see, e.g., FIGS. 9A-9B). In response, the healthcare collection portal database may provide the requested information, e.g., 1109. In some embodiments, the healthcare collection portal server may generate provide a user social data request 1110 to the social network server.

In some embodiments, the social network server may extract a user ID from the user social data request, e.g., 1111. The social network server may query, e.g., 1112, it social network database to determine whether the user is enrolled in H-Wallet with the social network (e.g., “did the user allow the H-Wallet Facebook® app to access user data?”). In response, the social network database may provide user enrollment data relating to H-Wallet. The social network server may determine whether the user is enrolled, and thus whether the healthcare collection portal server is authorized to access the user social data, 1114. If the social network server determines that the healthcare collection portal server is not authorized, 1115, option “No,” it may generate a service denial message, 1116, and provide the message to the healthcare collection portal server. If the social network server determines that the healthcare collection portal server is authorized to access the user social data, 1115, option “Yes,” the social network server may generate a user social data query 1117, and provide it to the social network database. In response, the social network database may provide the user social data requested, 1118. The social network server may provide the user social data 1119 to the healthcare collection portal server.

In some embodiments, the healthcare collection portal server may query the healthcare collection portal database for healthcare collection portal rules, e.g., 1120-521. In some embodiments, the healthcare collection portal server may process the user social data using the healthcare collection portal rules to identify pay commands, pay requests, merchant offers, and/or like content of the user social data, 1122. In some embodiments, rules may be provided by the H-Wallet to ensure the privacy and security of the user's social data and virtual wallet. As another example, the rules may include procedures to detect fraudulent transaction attempts, and request user verification before proceeding, or cancel the transaction request entirely. In some embodiments, the healthcare collection portal server may utilize a wallet security and settings component, such as the example WSS 600 component described further below in the discussion with reference to FIGS. 6A-B.

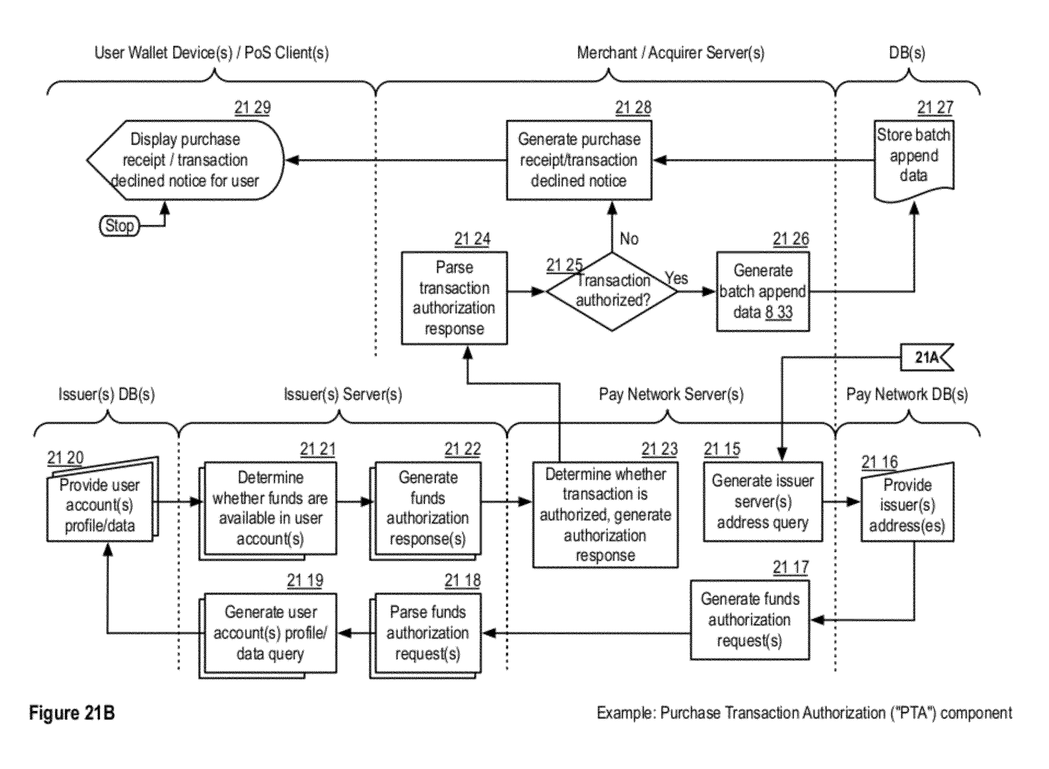

With reference to FIG. 11C, in some embodiments, the healthcare collection portal server may optionally determine that, based on processing of the rules, user verification is needed to process a transaction indicated in a pay command, 1123, option “Yes.” For example, if the rules processing indicated that there is a probability of the pay command being an attempt at a fraudulent transaction attempt, the healthcare collection portal server may determine that the user must be contacted for payment verification before the transaction can be processed. In such scenarios, the healthcare collection portal server may provide a pay command verification request 1125 to the client, which the client may display, e.g., 1126, to the user. In some embodiments, the user may provide a verification input 1127 into the client, which may provide a pay command verification response to the healthcare collection portal server, 1128. The healthcare collection portal server may determine whether the payor verified payment, whether payee information available is sufficient to process the transaction, and/or the like, 1129. In scenarios where sufficient payee information is unavailable or the payor needs to be contacted for payment verification, 1130, option “No,” the healthcare collection portal server may optionally provide a social post message 1131 to a social networking service associated with the potential payee/payor requesting the payee to enroll in healthcare collection portal service (e.g., using the HPE 300 component described above in the discussion with reference to FIGS. 9A-9B) or provide verification, which the social network server may post 1132-533 for the payee. If all the requirements are met for processing the transaction, 1130, option “Yes,” the healthcare collection portal server may generate a unique transaction trigger associated with the triggering social post message, e.g., 1134, and may optionally store a transaction trigger ID, triggering social post message, etc., for recordkeeping or analytics purposes. The healthcare collection portal server may provide the transaction trigger to trigger a purchase transaction, e.g., via a purchase transaction authorization such as the example PTA component described below in the discussion with reference to FIGS. 20A-21B.

FIGS. 12A-B show logic flow diagrams illustrating example aspects of implementing wallet security and settings in some embodiments of the H-Wallet, e.g., a Something (“WSS”) component. In some embodiments, the healthcare collection portal server may process the user social data using the healthcare collection portal rules to identify pay commands, pay requests, merchant offers, and/or like content of the user social data. In some embodiments, rules may be provided by the H-Wallet to ensure the privacy and security of the user's social data and virtual wallet. As another example, the rules may include procedures to detect fraudulent transaction attempts, and request user verification before proceeding, or cancel the transaction request entirely.

Accordingly, with reference to FIG. 12A, in some embodiments, the H-Wallet may obtain a trigger to process a user's social data, 1201. The H-Wallet may obtain user and/or user social graph member social data, as well as pay command rules and templates (e.g., for identifying standard pay commands), 1202. The H-Wallet may parse the obtained user social data in preparation for rules processing, 1203. For example, the H-Wallet may utilize parsers such as the example parsers described below in the discussion with reference to FIG. 27. The H-Wallet may select a pay command rule/template for processing. The H-Wallet may search through the parsed user social data, e.g., in a sequential manner, for the selected pay command, 1212, and determine whether the pay command is present in the user social data, 1213. It should be noted that in an alternative embodiment such parsing and processing may occur continuously and in real time through interception parsing where H-Wallet is logged into a user social account (e.g., with a user's provided login credentials) and as such receiving every post made by the user and other clients and receiving every message directed to the user and parsing such messages in real time as they occur. If the pay command is identified, 1214, option “Yes,” the H-Wallet may place the identified pay command string, an identification of the rule/template, the actual listing of the rule/template, and/or the like in a queue for further processing, 1215. The H-Wallet may perform such a procedure until the entirety of the user's social data has been searched through (see 1216). In some embodiments, the H-Wallet may perform the above procedure for all available rules/templates, to identify all the pay command strings included in the user social data (see 1217).

In some embodiments, the H-Wallet may process each pay command identified from the user social data, 1220. For example, the H-Wallet may select a pay command string from the queue and its associated template/identification rule, 1221. Using the rule/template and pay command string, the H-Wallet may determine whether the string represents a request for payment, or an order to pay, 1223. If the pay command string represents a request for payment (e.g., “dear @jsmith, you owe @StJohn'sHospital $500.00 bucks #cashflowblues”), 1224, option “Yes,” the H-Wallet may determine whether the user for whom the WSS component is executing is the requested payor, or the payee, 1225. If the user has been requested to pay, 1226, option “Yes,” the H-Wallet may add a payment reminder to the user wallet account, 1227. Otherwise, the H-Wallet may generate a user pay request record including the pay command details, 1228, and store the pay request record in the user's wallet account for recordkeeping purposes or future analytics processing, 1229.

With reference to FIG. 12B, in some embodiments, the H-Wallet may extract an identification of a payor and payee in the transaction, 1231. The H-Wallet may query a database for payee account data for payment processing, 1232. If the payee data available is insufficient, 1233, option “Yes,” the H-Wallet may generate a social post message to the payee's social network account 1234, requesting that the payee either enroll in the H-Wallet (if not already), or provide additional information so that the H-Wallet may process the transaction. The H-Wallet may provide 1235 the social post message to the social networking service associated with the payee. If sufficient payee information is available, 1233, option “No,” the H-Wallet may query the payor's wallet account for security rules associated with utilizing the virtual wallet account, 1236. The H-Wallet may select a wallet security rule, 1237, and process the security rule using the pay command string as input data, 1238. Based on the processing, the H-Wallet may determine whether the pay command passes the security rule, or instead poses a security risk to the user wallet. If the security rule is not passed, 1240, option “No,” the H-Wallet may determine whether verification from the user can salvage the pay command string, 1241. If the H-Wallet determines that the risk is too great, the H-Wallet may directly terminate the transaction and remove the pay command string from the processing queue. Otherwise (641, option “Yes”), the H-Wallet may generate a pay command verification request for the user, 1242, and provide the pay command verification request as an output of the component, 1243. If all security rules are passed for the pay command string, 1244, option “No,” the H-Wallet may generate a transaction trigger with a trigger ID (such as a card authorization request), and provide the transaction trigger for payment processing.

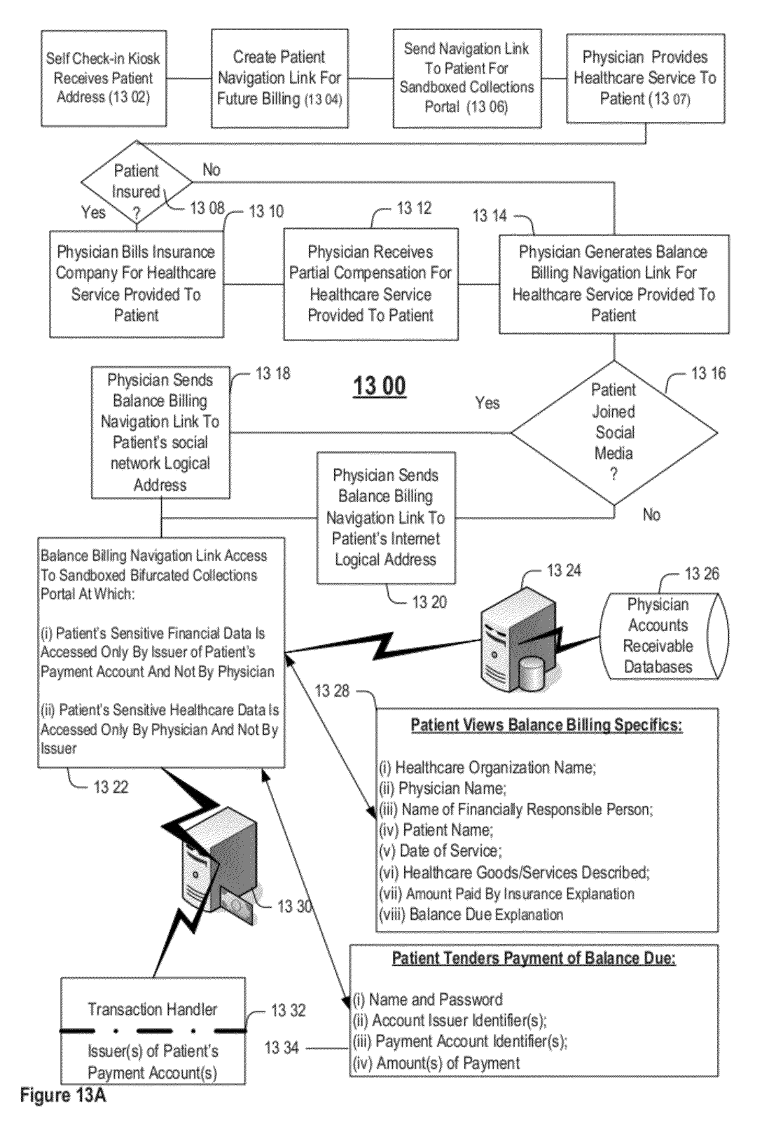

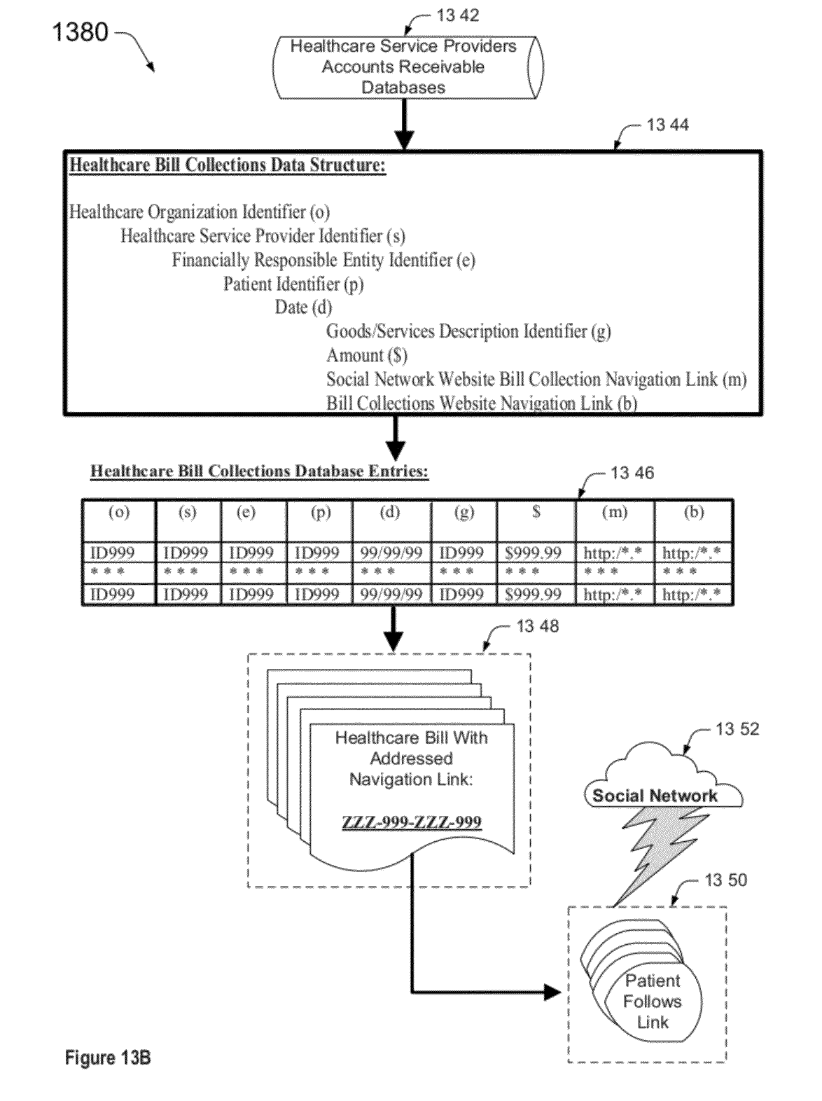

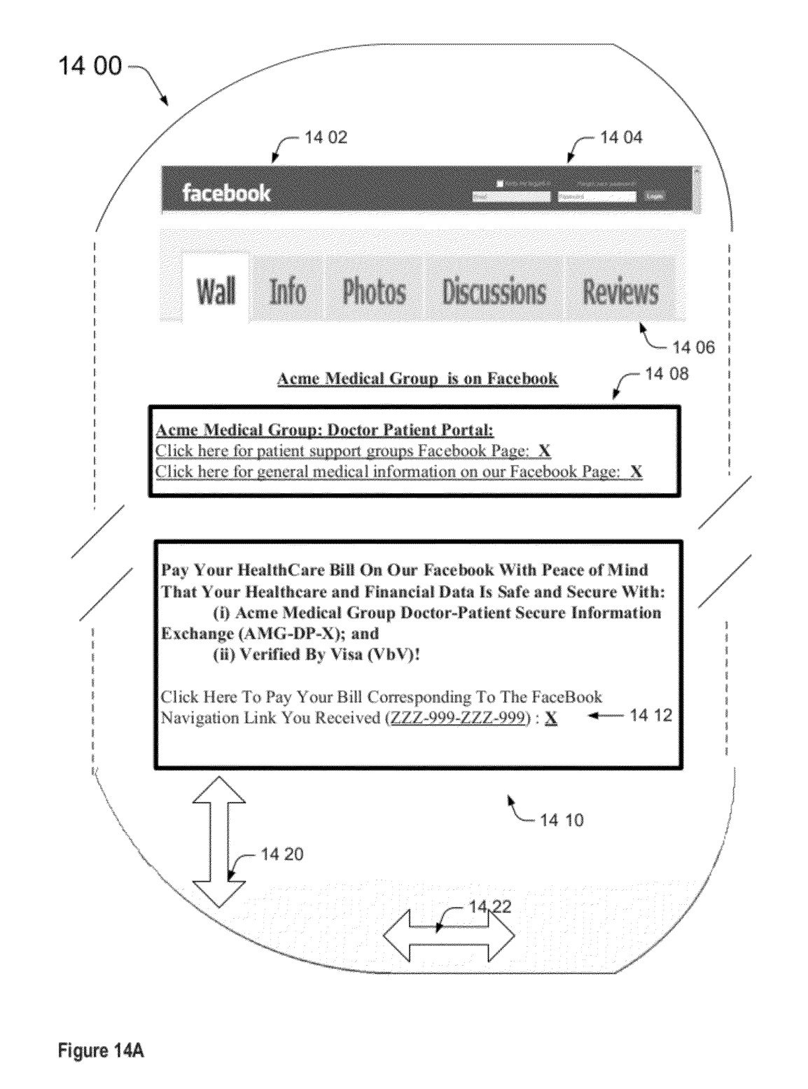

FIG. 13A provides shows a flow chart depicting an exemplary method 1300 for a healthcare service provider, such as a physician, to collect accounts receivables from patients (or agents thereof) to whom the physician had provided healthcare services. Method 1300 begins at step 1302 where a patient uses kiosk in a physician's office to check in upon arrival. The kiosk receives insurance, financial, and contact address information from the patient and/or an agent who is financially responsible for the patient. At step 1304 of method 1300, a navigation link is created using information received at the kiosk. The navigation link will direct electronic correspondence to the patient using the contact address information received from the patient at the kiosk. At step 1306, the navigation link is sent to a logical address for the patient. Upon receipt, the patient can use the navigation link with a computing device to access a portal for the physician. The physician's port may be a social networking site such as a FaceBook page. For instance, the navigation link can be received from the physician by the patient along with the physician's invitation to join the physician's FaceBook page as a ‘friend’ of the physician, where the FaceBook page is a type of social network doctor-patient portal. For example, the doctor's FaceBook page may allow the patient to dialogue with the physician as well as other patients in one or more patient support groups. Thus, in response to the doctor's invitation, the patient joins the physician's FaceBook doctor-patient portal.

Alternatively, a web site for the physician may be the portal for the physician. Whether the navigation link gives the patient access to a social networking site or to the physician's website, the portal can be used as a user interface at which the patient can pay the physician's bill for healthcare services.

At step 1307, the physician provides healthcare services to the patient. At step 1308 of method 1300, an inquiry is made as to whether or not the patient has insurance to cover the healthcare services to be provided by the physician to the patient. If not, then method 1300 moves to step 1314. If the patient does have healthcare insurance coverage, the physician bills the insurance company for the patient's healthcare services provided by the physician. At step 1312, the physician receives partial compensation for the healthcare services provided by the patient, where the compensation is received from the patient's insurance company. At step 1314, the physician generates a bill of the balance due, also known as ‘balance billing’. A balanced billing navigation link is created so as to be directly associated with the healthcare services that the doctor provided to the patient. In this case, the navigation link will contain one or more addresses sufficient to navigate to a logical location where identifications can be made of those goods or services that the physician provided on a date certain to the patient. The navigation link may also be directly associated with the person or entity who is financially responsible for the balance due portion of the healthcare services provided to the patient. Also associated with the navigation link may be any healthcare organization that the healthcare service provider is associated with that is ultimately responsible for collecting the balance due billing from the patient or from the person financially responsible for the patient.

At step 116 of method 1300, an inquiry is made as to whether or not the patient joined the social network (e.g.; accepted the physician's FaceBook ‘friend’ invitation) that the doctor had previously invited the patient to join. Whether or not the patient had joined the social network organization at the invitation of the doctor, a navigation link generated at step 114 will be sent to the patient. If the patient joined the social network, then the navigation link will be sent to the patient's logical address in the social network. If, however, the patient did not join the doctor's social network, then the navigational link will be sent to the patient's Internet logical address at step 1320 of method 1300. In an alternative implementation, the patient may have accepted the physician's FaceBook ‘friend’ invitation, but specifically requests that the navigational link be sent to a different Internet logical address. This optional address can be presented as a default, based on whether or not the patient joined the social network, although the patient will be allowed to change the Internet logical address to which the navigational link will be sent. At step 1322 of method 100, the patient uses a web enabled computing device in order to follow the navigational link received either at the patient's social network web page or via the patient's Internet logical address, such as e-mail, text message received over a cellular telephony network, etc.

In step 1322, the patient is operating the computer computing device that is executing a World Wide Web browser, or other special purpose software, in order to access two (2) different server systems. These server systems include a data base server 1324 which has access to one or more of the physician's accounts receivable databases 1326, and includes an e-commerce server 1330 which has access to an issuer 1332 of an account issued by the issuer 1332 to the person financially responsible for the patient payment. The browser operated by the patient (or agent thereof) at step 1322 will simultaneously be communicating with servers 1324, 1330. Sensitive information accessed can be communicated to the browser being operated by the patient at step 1322. The browser, or other software operated by the client at step 1322, will keep information sent to and received from servers 1324, 1330 separated. As such, the patient's input of a healthcare password will cause the client to operate the browser so as to view all relevant healthcare information, for instance as seen in reference numeral 1328 of FIG. 13, yet without communicating these data to the patient's financial services provider (e.g.; the patient's issuer). This user interface function can be accomplished, for example, by use of a separate daughter windows to which each server respectively serves and receives content. Again, the software facilitates the servers 1324, 1330 communicating to the respective daughter windows at the appropriate times for the benefit of the patient operating the web-enabled computer device at step 1322. By way of example, server 1324 can access database 1326 so that the patient can view specifics of the balance due billing that the physician is charging the patient. This information passed from database 1326 through server 1324 can include (i) the healthcare organization name that provided healthcare services to the patient, (ii) the name of the physician who treated the patient, (iii) the name of the person who is financially responsible for the patient, (iv) the name of the patient, (v) the date the services were provided by the doctor to the patient, (vi) a description of the healthcare goods and/or services that were rendered to the patient by the doctor, (vii) any amounts paid by the insurance company for the foregoing healthcare goods and services, and (viii) any balance due by the person who is financially responsible for the patient to the healthcare organization.

As seen at reference numerals 1322 and 1334, the patient can provide information to gain access to financial information stored by the issuer 1332 that issued the account to the patient and/or by the transaction handler 1332 that handles transactions conducted on the account. To access financial information for the patient, a name and password is required, as seen in reference numeral 1334. Once supplied by the patient while operating the browser at step 1322, financial information can be sent and retrieved. This information can include account issuer identifiers (e.g.; account numbers), the name of the issuer who issued the account numbers, and any amounts that the financially responsible person wishes to pay on balance due billing to the doctor.

Step 1322 of method 1300 demonstrates how a portal, accessed by the patient's use of a navigational link, can be used to access data for balance billing that is assessed by a physician who provided healthcare services to the patient. The portal provides a ‘sandbox’ security environment where the patient's healthcare and financial data are kept separate. Thus, the balance billing navigation link gives access to a sandboxed bifurcated collections portal for a healthcare service provider at which: (i) the patient's sensitive financial data is accessed only by an issuer of a patient's payment account and not by the physician; and (ii) the patient's sensitive healthcare data is accessed only by the physician and not by the issuer.

FIG. 13B shows a flow chart depicting an exemplary method 1380 within embodiments of the H-Wallet. At step 1342, a database of healthcare service providers facilitate the storage of information about balance due billing for one or more healthcare service organizations. These balance due billings, stated otherwise, include accounts receivable owed to the healthcare service provider organizations. In the table at step 1344, these data are organized into a hierarchal, table structure as depicted. As such, a healthcare service organization is indexed by (o) and includes multiple healthcare service provider identifiers indexed by (s) By way of example, the healthcare service provider identifier can be a National Provider Identifier (NPI).

In the table at step 1344, balance billing can be indexed by (s) and can include one or more financially responsible entity identifiers indexed by (e). For example, a financially responsible entity identifier can identify a financially responsible father for two (5) minor children who are patients of a physician. Thus, each such financially responsible entity includes one or more patient identifiers indexed by (p). Each patient (p) represents a person who was treated on one or more dates indexed by (d). On each date (d), one or more goods or services were supplied to the patient (p) as indexed by (g). An amount due for such services or goods is indicated by the index ‘$’ and a navigation link is provided by which the patient (p) can access the balance due billing records in order to make the foregoing payments.

The navigation link for the index (m) can be to a social network, such as a doctor-patient portal FaceBook page. The navigation link for the index (n) can be an Internet address for a doctor-patient portal, such as a physician's website. Indices (m) and/or (n) can be sent to a logical address on the Internet for a patient, or a person/entity who is financially responsible person for the patient. These navigation links can be addressed, for instance, with a text message to a cellular telephone, to an e-mail address, etc. Upon receipt, the patient can use a web enabled computing device to follow the navigation link to an area within a portal where the patient can review and pay for those goods and services for which the patient has a balance due to a healthcare service provider.

As can be seen at step 1346 of method 1380, a data structure of row and columns represents balance due billings for one or more healthcare service providers. Each row represents a balance billing for a patient, and the columns for each row are identified by indices (o), (s), (e), (p), (d), (g), ($), (m), and (n) as discussed above.

At block 1348 of method 1380, a separate healthcare balance due bill will be addressed so as to include a navigational link that is formed and corresponds to each row of the data entries seen in step 1346. At block 1350 of method 1380, a plurality of display screens are seen, where each display screen corresponds to an instance where a patient who has been treated by a healthcare service provide can make a payment towards a balance due billing to the healthcare service provider. Each such screen corresponds to a portal that is accessed by the patient by way of following a corresponding navigational link identified in block 1348.

A cloud environment at block 1352 of method 1380 represents a social network that is placed in communication with the patient who follows a navigation link (e.g.; ZZZ-999-ZZZ-999) corresponding to a balance due billing to a healthcare service provider. Block 212 illustrates the social network into which a portal is provided so as to give access to the patient by way of following the navigational link identified in block 1348.

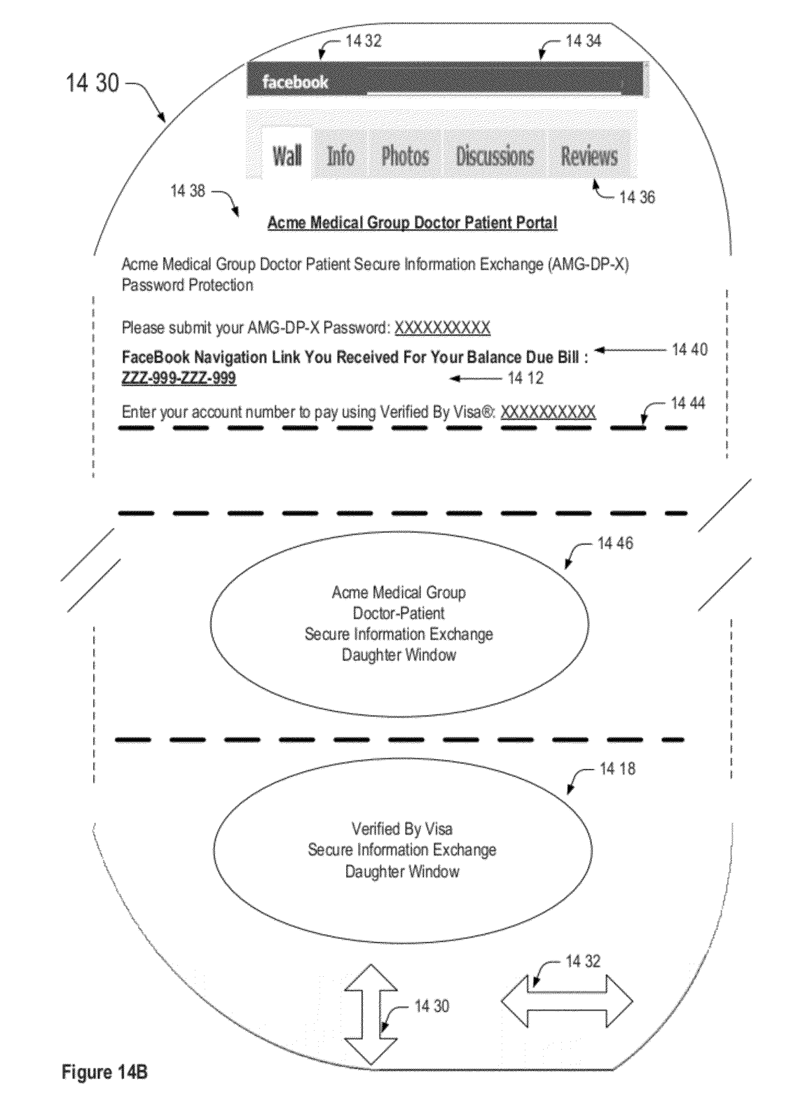

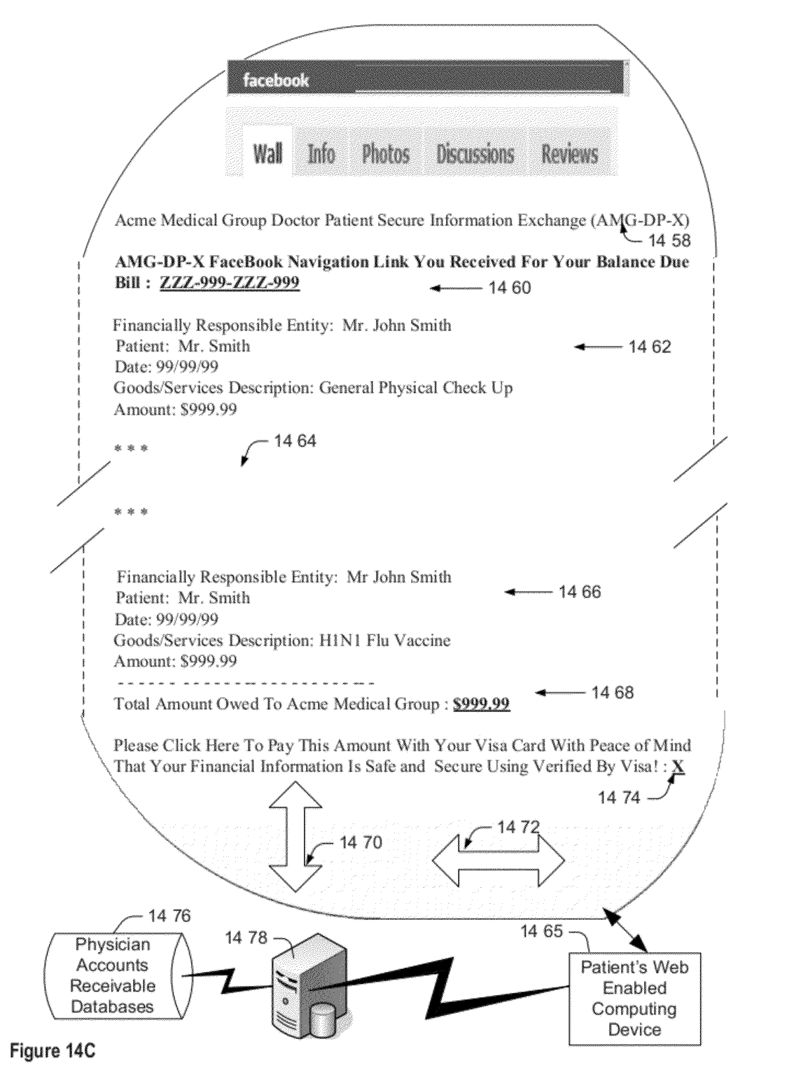

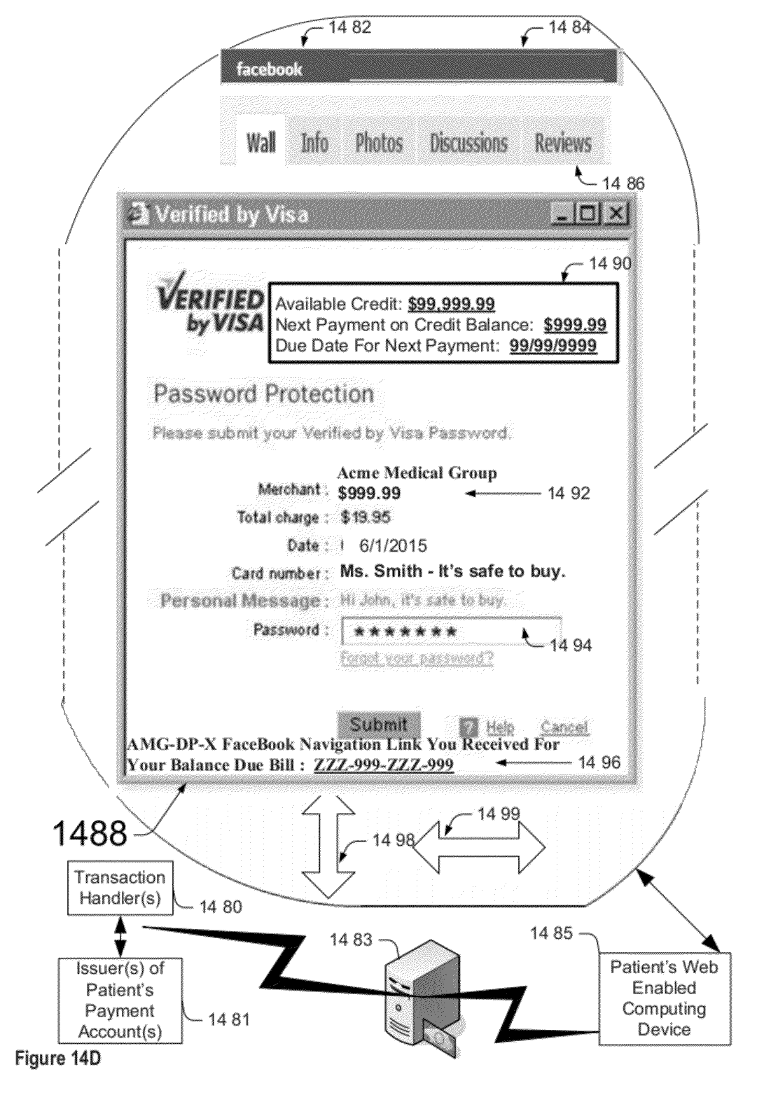

FIG. 14A represents an exemplary display screen 1400. The display screen 1400 is a FaceBook page, as identified at reference no. 1402. Display screen 1400 is the FaceBook page that is displayed when a navigation link that was previously received by a patient is followed. By way of example, FIG. 14 shows a navigation link 1408 being sent to the patient 210 so that the patient can follow the navigation link in order to submit payment for a healthcare service rendered to the patient by the healthcare service provider (or agent thereof) that sent the navigation link to patient 210.

As shown in FIG. 14A at reference number 1404 of display screen 1400, the patient is solicited to sign in to their FaceBook account using a user name and password. Typical of FaceBook pages, there is a marquee seen at reference no. 1406, which includes these icon activation tabs: “Wall”, “Info. “Photos”, “Discussions”, and “Reviews”. At reference no. 1408 of FIG. 14A, an indicator identifies the FaceBook page as being for the Acme Medical Group. Various icons are supplied by the Acme Medical Group for use by a patient to facilitate a doctor/patient portal. At reference no. 1408, one such icon can be activated by a patient to enter a patient support group for the Acme Medical Group. Another icon shows that, when activated by a patient browsing this FaceBook page, general medical information can be retrieved.

At block 1410 of display screen 1400, an icon indicates that a patient of the Acme Medical Group can pay their healthcare balance due bill by using a FaceBook application. The balance due bill that can be paid by the patient is the bill that is associated with the navigation link that was previously received by a patient which the patient activated in order to navigate to display screen 1400. Stated otherwise, the navigation link “ZZZ-999-ZZZ-999” seen at reference number 1412 was electronically sent to and received by the patient. The patient followed the navigation link “ZZZ-999-ZZZ-999” in order to initiate payment of a balance due from display screen 1400, where display screen 1400 is pre-populated with a rendering of the navigation link “ZZZ-999-ZZZ-999”, and where the navigation link “ZZZ-999-ZZZ-999” is associated with the healthcare service rendered to the patient by the healthcare service provider (or agent thereof) that sent the navigation link to the patient.

Reference numeral 1412 of display screen 1400 in box 1410 shows an icon that can be activated in order to initiate payment of the balance due bill associated with the navigation link “ZZZ-999-ZZZ-999”. Activation of icon 1412 will navigate to a rendering of a display screen 400 seen in FIG. 4. The patient is also informed by display screen 1400 that a secure information exchange will be ensured for healthcare data as well as financial data. Navigational icons 1420 and 1422 provide, respectively, vertical and horizontal navigation across the real estate for display screen 1400.

FIG. 14B shows an exemplary display screen 1430 which indicates another FaceBook page of the Acme Medical Group that is a doctor-patient portal as seen at reference no. 1438. Marquees, typical of FaceBook, are seen at reference no. 1432, 1434 and 1436. At reference no. 1440 of display screen 1430, a password is solicited from a patient in order to view the patient's sensitive healthcare related information maintained by Acme Medical Group (or agent thereof) to be displayed in daughter window 1446. At reference no. 1412, display screen 1430 is pre-populated with a rendering of the navigation link “ZZZ-999-ZZZ-999”, where the navigation link “ZZZ-999-ZZZ-999” is associated with the healthcare service rendered to the patient by the healthcare service provider (or agent thereof) that sent the navigation link to the patient. Again, the navigation link “ZZZ-999-ZZZ-999” is associated with a balance due bill that is owed by the patient to the Acme Medical Group.

At reference numeral 1444, the patient is solicited for an identifier for an account upon which a transaction to pay the balance due bill is to be conducted. The identifier, typically an account number, will have been issued to the patient by a financial institution (e.g.; an issuer), and represents the account that the patient will use to pay the balance due bill that is associated with the navigation link “ZZZ-999-ZZZ-999”. The accessed patient's sensitive financial information will be displayed in daughter window 1466 once access criteria has been satisfied, as explained below, for the Verified By Visa® service operated by Visa Inc. Reference nos. 1430 and 14322 show icons which, respectively, facilitate vertical and horizontal navigation display screen 1430.

While daughter windows 1446 and 1418 can be used to display the patient's sensitive information, these daughter windows can also be used to receive input from the patient for electronic transmission, respectively, to the Acme Medical Group and the financial institution (or agent thereof) that issued the patient an account that the patient will use to pay the balance due bill that is associated with the navigation link “ZZZ-999-ZZZ-999”. However, information rendered within, or received from, the patient in daughter window 1446 will not be sent to the patient's financial institution (or agent thereof). Similarly, information rendered within, or received from, the patient in daughter window 1419 will not be sent to the Acme Medical Group (or agent thereof).

FIG. 14C shows an exemplary view of daughter window 1446 as was depicted in FIG. 14B within embodiments of the H-Wallet. Daughter window 1446 shows patient information through a FaceBook page of the Acme Medical Group doctor-patient portal. This portal provides secure Acme Medical Group Doctor-Patient information eXchange (AMG-DP-X), as represented at reference no. 1478. Reference no. 1460 shows a line that is rendered so as to be pre-populated with the FaceBook Navigation Link that was received and followed by the patient in order to pay the Acme Medical Group balance due bill, namely navigation link “ZZZ-999-ZZZ-999”. This navigation link is associated with the balance due bill for the goods and services seen at reference numerals 1462, 1464 to 1466.

Reference no. 1462 shows a good or service for which there is a balance due bill for the patient. The entry is associated with a navigational link that was sent to the patient by the healthcare service provider organization or agent thereof. It is this navigational link that allows the patient to navigate to, access, and view daughter window 1466 upon successful entering of verified access information (e.g. a correct password).

A series of balance due billings for goods and services provided to the patient are seen at reference no. 1464 by way of ellipses to indicate a plurality thereof. At reference no. 1466, a final balance due billing item is illustrated. By way of example, billing entries, each showing a balance due bill item, are seen at reference nos. 1462 through 1466. The entry at reference no. 1462 is for a financially responsible person “Mr. John Smith”, where the patient to whom healthcare services were provided is “Mr. Smith”, where the date that the services were rendered to Mr. Pourfallah as a patient on the date of 99/99/cc99, where the goods or services provided to the patient Mr. Pourfallah are identified as a “General Physical Check-up”, and the where balance due for such services was “$999.99”. At reference no. 1468, the total balance due to Acme Medical Group is shown. The total balance due is a summary of all the amounts seen at entries 1462 through 1466.

At reference no. 1474 of display screen of daughter window 1466, the patient is invited to pay the amount shown in reference no. 1468 by use of a Visa card using the Verified By Visa® system. An icon is provided at reference no. 1462 for activating the Verified By Visa® system function. Note that, at reference no. 1465, the daughter window is displayed on the patient's web enabled computing device. The web enabled computing device 1465 is a communication with a database server 1478 which is in communication with a physician's accounts receivable database 1476.

FIG. 14D shows an exemplary view of daughter window 1418 shown in FIG. 14B within embodiments of the H-Wallet. FIG. 14D shows a portion of a FaceBook page for the Acme Medical Group as indicated by reference nos. 1482-1484. The exploded view for daughter window 1418 shows the Verified By Visa® splash screen. Reference no. 1496 shows a line that is rendered so as to be pre-populated with the FaceBook Navigation Link that was received and followed by the patient in order to pay the Acme Medical Group balance due bill, namely navigation link “ZZZ-999-ZZZ-999”. This navigation link is associated with the balance due bill for the goods and services seen in FIG. 14A at reference numerals 1408-1412. In use, the operator of a web enabled computing device 1485 is invited to enter a password at reference numeral 1494. The password is communicated to the patient's financial institution that issued a Visa account to the patient, where the patient entered an account number corresponding to the Visa account at reference numeral 1444 of display screen 1430 in FIG. 14B. If the password is authenticated, then sensitive financial information can be retrieved from the financial information for rendering at an output box 1492 as explained below.

The patient can enter at reference numeral 1492 an amount to pay, such as at total charge of $999.99 for a balance due bill that is owed by the patient to the Acme Medical Group. This total charge will be assessed to the Visa account that was issued to the patient by an issuer, where the account was entered at reference numeral 1444 of FIG. 14B. By way of example, the payment is being made to Acme Medical Group in the amount of $999.99 for the date of Sep. 11, 2015, where an account number identified by the card number seen in the exploded window ends in the digits “9010”.

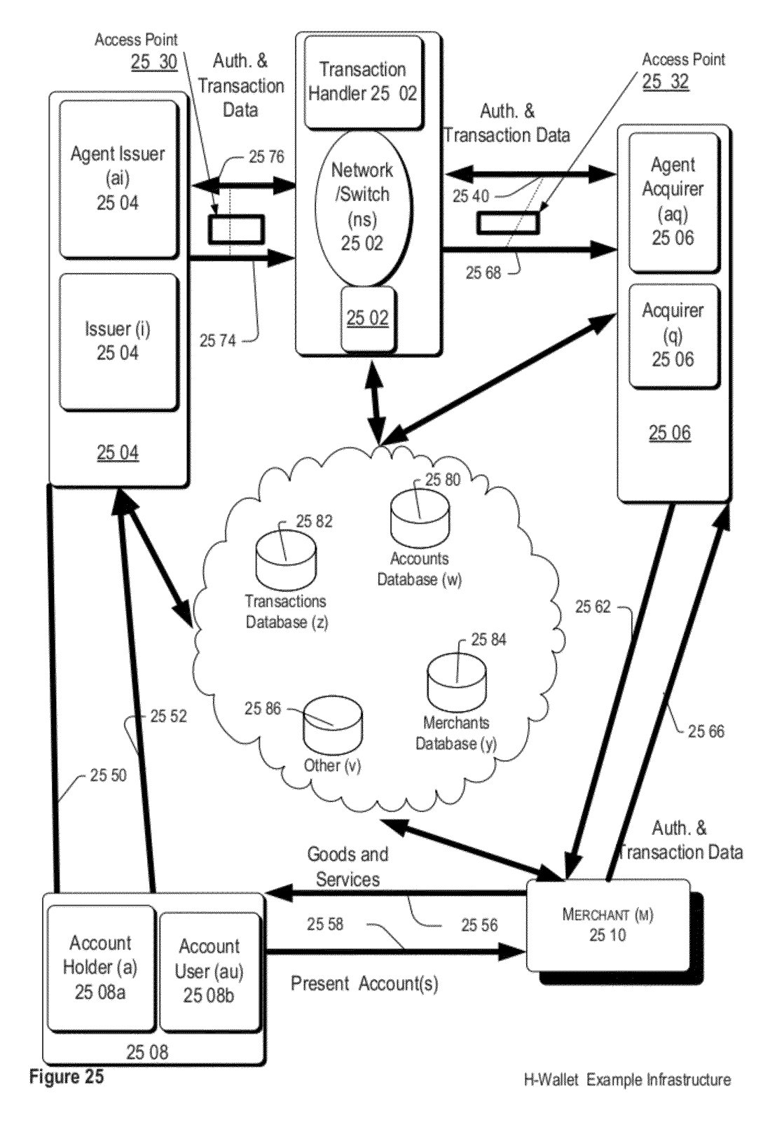

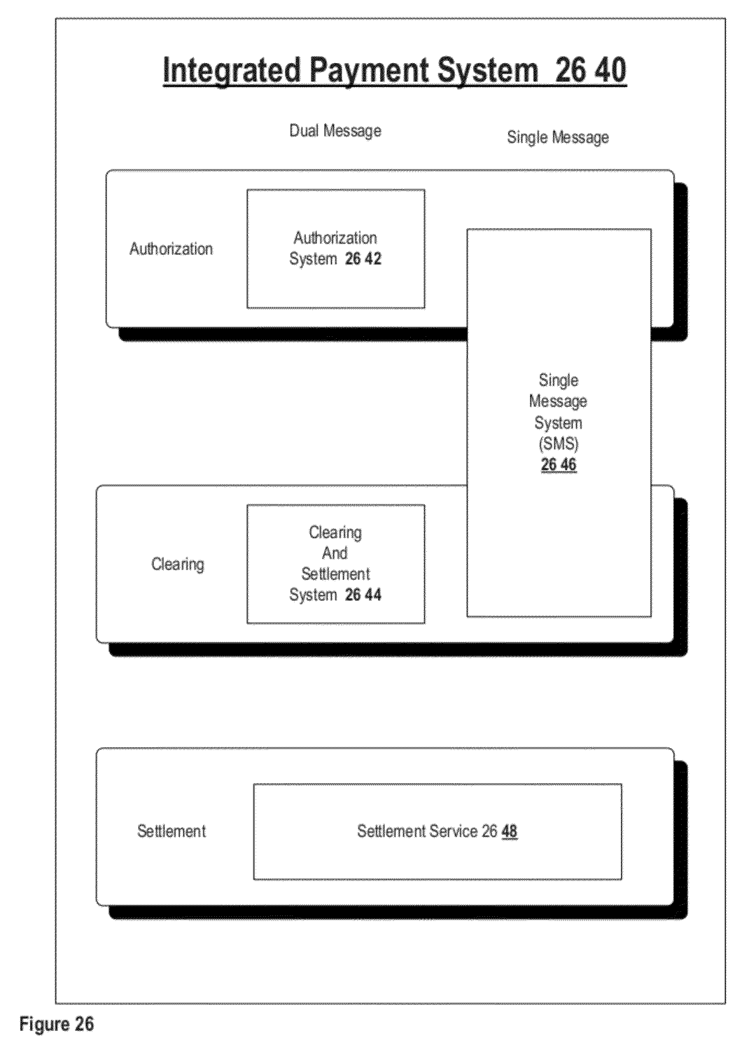

Financial information may be retrieved from the patient's financial institution and rendered on display screen at 1490, such as the available balance of the account, the amount that is due for the next payment on a credit balance of the account, and the due date for next payment on the account. A personal message is also supplied on the daughter window 1492, which is “Ms. Pourfallah—it's safe to buy.” The password entered by the patient at entry field 1494 provides a proper authorization of the payment of $999.99 at entry field 1492 from the account identified by an account number ending in the digits ‘9010’ which was provided at entry field 1444 in FIG. 14B. A submit button icon is operated by the operator of the computing device 1485 in order to affect payment of the total charges, such initiating authorization, clearing, and settlement processes in an open system for a payment processing system as are discussed below with respect to FIGS. 25-26. Following proper authorization to use the account number ending in the digits ‘9010’, the patient (or agent thereof) can receive an electronic message at a corresponding logical address, where the message includes an acknowledgement corresponding to an authorization to pay the currency amount from the account for the transaction.

As seen in FIG. 14D, the daughter window 1488 is displayed upon the patient's web enabled computing device 1485. The computing device 1485 is a communication with e-commerce server 183. E-commerce server 1483 is in communication with the issuer 1481 of the Visa account being used to pay a balance due and/or the transaction handler 1480 that will handle the transaction to pay the Acme Medical Group. E-commerce server 1483 may be in communication with one or more issuers 1481 corresponding to one or more accounts, each of which can be used to pay all or part of the balance due to the Acme Medical Group.

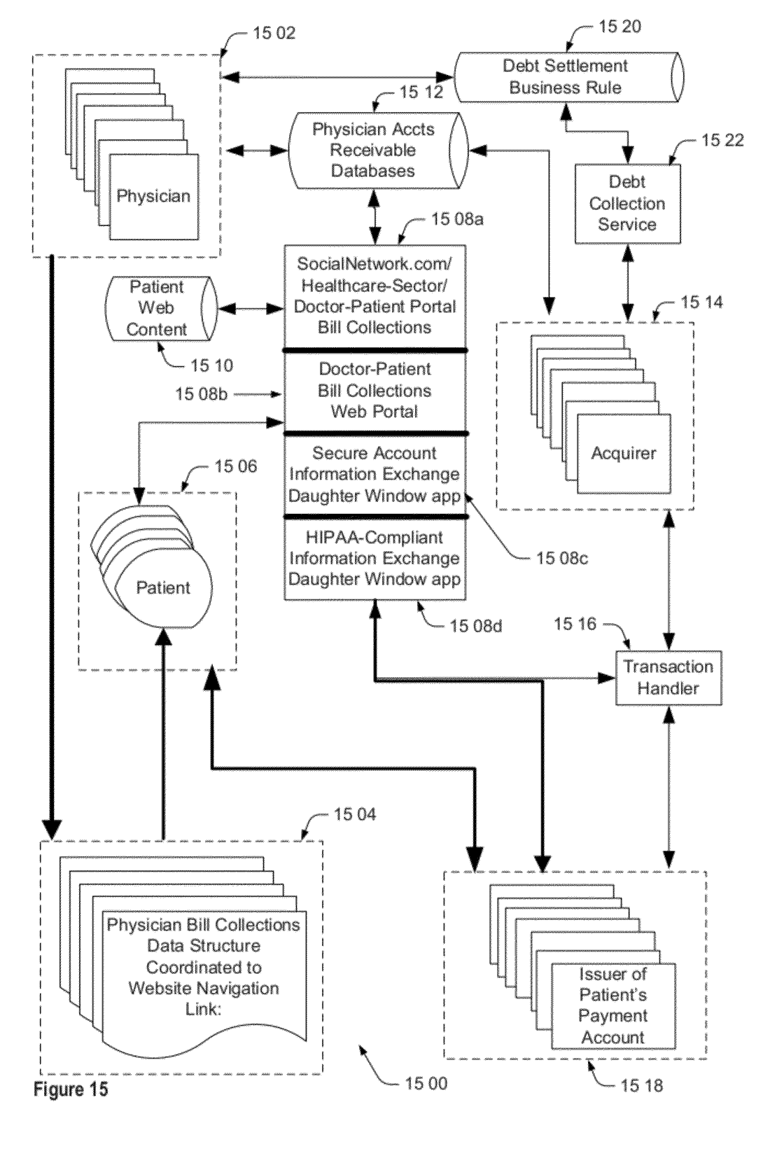

FIG. 15 shows a flow chart depicting an exemplary method 1500 in yet another implementation by which a physician may collect accounts receivable on balance due bills from patients to whom the physician has provided healthcare services. Method 1500 provides a way for physicians to collect their respective balance due bills from their respective patients. At step 1502 of method 1500, each physician communicates balance due billing to a physician's accounts receivable database, where one or more of such databases is seen at reference no. 1512. Additionally, each physician generates bill collection entries for each respective patient that has a balance due with the physician. Each amount of a balance due for a patient that is owed to a physician has a corresponding navigational link that is generated. This navigational link provides the dual functions of: (i) providing a logical address to which the navigational link is to be sent; and (ii) providing a corresponding link to a portal that has access to those goods and services provided by the doctor to the patient, where the patient can review an itemization of those goods and services that were provided by the doctor to the patient. To obtain such access and review, the patient operates a web enabled computing device to follow a navigational link that has been sent to the patient.

Navigational links, represented at reference no. 1504, are sent to the respective patients for display upon a web enabled computing device at step 1506. As seen at reference nos. 1508A-1008D, the patient can use a web enabled computing device to navigate, using the respective navigational links, to doctor-patient portal. The portal can be a social network page or a web site. The portal gives the patient access to a virtual space at which the doctor's bills can be reviewed. Additionally, the navigational links facilitate access to a bill collection web portal.

Reference no. 1508a shows a social network site that can be navigated by using a navigation link received by the patient. The social network site 1508a provides a doctor-patient portal at which web content derived from database 1510 can be reviewed by each patient who navigates to the doctor-patient portal located at the social network page for the doctor. At reference no. 1508b, it is shown that the patient can begin to pay bills owed to the doctor upon navigation to, and access by the patient to, the doctor-patient bill collection web portal. At reference no. 1508c, it is shown that a secured agent facilitates the flow of information to a daughter window on a patient's display device being operated for the purpose of browsing to the doctor-patient bill collection web portal. Similarly, at reference no. 1508d, a Health Insurance Portability and Accountability Act (HIPAA) compliant information change daughter window is provided on the display screen of the web enabled computing device being operated by the patient or agent thereof. The information or content in the daughter window corresponding to reference no. 1508b can be supplied by an issuer of an account to the patient. Also, the information or content displayed in a daughter window corresponding to reference no. 1508c can be derived from a physician's account receivable database 1512, also seen in FIG. 15. The patient can operate a web enabled computer (e.g.; a client) which executes a browser in order to pay each bill owed to each doctor using the processes represented at reference nos. 1508a-1008d.

Upon submission of a payment by the patient, the doctor's acquirer is notified by way of an authorization request message as is shown at reference no. 1514. The acquirer, in turn, forwards the authorization request message to a transaction handler at reference no. 1516. The transaction handler at reference no. 1516 forwards the authorization request message to the issuer at reference no. 1518. In turn, depending upon sufficiency of funds available in the account being offered by the patient to pay the doctor's bill, or available credit in the account, the issuer 1518 sends an authorization response message to transaction handler 1516. Transaction handler 1516 forwards the authorization response message to the acquirer 1514. The acquirer 1514, thereafter, facilitates clearing and settlement of the authorized payment. To facilitate reconciliation of a payment-in-full made by a patient against the doctor's accounts receivable data, the payment browser should recognize the amount that is approved and link the payment amount back to the Physician's Account Receivable database 1512. As such, the payment can be acknowledged by the doctor's practice management system, the bill will no longer be aged, and the bill can be removed from the doctor's accounts receivable data.

In the event that a patient offers less than the full amount of the balance due billing, a physician 1502 may provide debt settlement business rules 1520 which are stored in a database for the purpose of a debt collection service 1522. As such, business rules can be provided by the doctor for collecting less than the full amount due of a bill that a patient has received, where the patient follows a navigational link received from the doctor in order to view the bill from the doctor. These debt settlement business rules, which can be applied in real time, can compromise the balance due bill by way of an accord and satisfaction or other way payment mechanism, such as by the doctor making a loan of the balance due that can be paid off by the patient making one or more payments over time.

In addition to the VisaNet network provided by Visa Inc., other networks (Discover and American Express) can be used to accept healthcare service payment transactions. Moreover, other payment options can also be made, such as ACH or online bill pay, each of which could be facilitated by either the foregoing implementations or by being routed to another payment portal.

FIG. 16 provides a data flow diagram illustrating healthcare payment adjudication within implementations of the H-Wallet. Within various embodiments, the healthcare provider 1610 may send an adjudication request including a medical claim 1616b to an insurance provider 1650 to generate a pricing estimate of a healthcare service, e.g., upon receiving insurance information from the user (e.g., see 212 in FIG. 2A). In one implementation, the medical claim message 1616b may comprise a XML-formatted message in a similar form to 216 in FIG. 2A.

In an alternative implementation, the healthcare provider 1610 may generate a medical bill based on estimated insured amount, but upon the insurance provider's evaluation (e.g., 236 in FIG. 2A), the insurance provider may not agree to pay the estimated amount. For example, a dental office may generate an estimated insured amount to be $500.00 and user co-pay amount of $500.00 for a root canal therapy; upon adjudication, the insurance provider which may evaluate based on the location of the dental office, local annual income, and/or the like, may agree to pay an amount of $400.00. Thus the dental office may have insufficient payment 1613 from the insurance provider 1650, and may submit a re-adjudication request 1616a to the insurance provider 1650.

In one implementation, the healthcare provider may submit the adjudication request 1616a to the insurance provider 1650 without passing through the H-Wallet server 1620. In an alternative implementation, the adjudication request 1616a may be sent to the H-Wallet server 1620, e.g., the healthcare provider may submit the request via a H-Wallet web portal. For example, the healthcare provider may generate a HTTPS POST message to the H-Wallet server 1620 including an XML-formatted adjudication request message 1620 which may take a form similar to:

```
POST /AdjudicationRequest.php HTTP/1.1
Host: www.Hospital.com
Content-Type: Application/XML
Content-Length: 873
<?XML version = “1.0” encoding = “UTF-8”?>
<AjudicationRequest>
<User>
        <UserName> John Smith </UserName>
        <UserID> JS0000 </UserID>
        ...
</User>
<Insurance>
        <InsuranceID> BB0008PPO </Insurance>
        <GroupID> 123456789 </GroupID>
        <InsuranceType> Regular </InsuranceType>
        <InsuranceCoverage>
            <ProcedureCode1> 60% </ProcedureCode1>
            <ProcedureCode2> 60% </ProcedureCode2>
        </InsuranceCoverage>
        <BIN> 0009203920390 </BIN>
            ...
    </Insurance>
  ...
  <Time> 19:20:23 </Time>
  <Date> 09-21-2015 </Date>
<Claim>
        <Procedure>
        <ProcedureCode> Sur-Knee-Left </ProcedureCode>
        <ProcedureDate> 09-09-2015 </ProcedureDate>
        <ProviderID> SPH001 </ProviderID>
        <ProviderName> St John's Hospital </ProviderName>
        ...
        </Procedure>
        <TotalAmount> 12,000.00 </TotalAmount>
        <EstimatedInsured> 5,000.00 </EstimatedInsured>
        <PatientResp> 7,000.00 </PatientResp>
        ...
</Claim>
<AdjudicationAmount>
        <InsuranceAmountApproved> 3,000.00
        <InsuranceAMountApproved>
        <ApprovalDate> 09-10-2015 </ApprovalDate>
        <RequestedAmount> 2,000.00 </RequestedAmount>
        ...
<AdjudicationAmount>
...
</AdjudicationRequest>
```

In one implementation, the H-Wallet server 1620 may obtain a BIN number 1618 from the received adjudication request 1616a, based on which the H-Wallet may route the request to the insurance provider. In one implementation, the H-Wallet server 1620 may generate a re-adjudication request 1619 and route the message to the insurance provider 1650 based on the BIN-based routing destination, e.g., in a similar manner as shown at 221 in FIG. 2A. In one implementation, the re-adjudication request 1619 may comprise an XML-formatted message in a similar form to the adjudication request 1616a.

In one implementation, the insurance provider 1650 may send an adjudication response 1636 to determine whether the requested insured payment amount can be approved, and the response 1621 may be send back to the healthcare provider at 1625. For example, the adjudication response 1636/1621/1625 may take a similar form to the payment authorization message 236 in FIG. 2A.

Upon receiving the adjudication decision 1625, the healthcare provider 1610 may determine whether the insurance amount has been approved. If not, an adjusted bill 1623 may be generated and sent to the user. For example, when the healthcare provider estimated an insured amount of $5,000.00 but the insurance provider only agrees to pay an amount of $3,000.00, the healthcare provider may adjust the user co-pay bill to reflect the amount of $2000.00.

For example, in one implementation, an exemplary XML implementation of the adjusted bill 1623 may take a form similar to:

```
POST /MedBill.php HTTP/1.1
Host: www.hospital.com
Content-Type: Application/XML
Content-Length: 892
<?XML version = “1.0” encoding = “UTF-8”?>
<AdjustedBill>
        <BillID> MD 0000123 </BillID>
        <BillDate> 09-21-2015 </BillDate>
        <BillTimeStamp> 14:23:56 </BillTimeStamp>
        <FIrstBillCOde> 0543 </FirstBillCode>
        <BillCode> 0547 </BillCode>
        <Patient>
        <UserID> 123456789 </UserID>
        <UserName> John Smith </UserName>
        ...
        </Patient>
        ...
        <Procedure>
        <ProcedureCode> Sur-Knee-Left </ProcedureCode>
        <ProcedureDate> 09-09-2011 </ProcedureDate>
        <ProviderID> SPH001 </ProviderID>
        <ProviderName> St John's Hospital </ProviderName>
        ...
        </Procedure>
<BillSummary>
        <TotalAmount> 12,000.00 </TotalAmount>
        <EstimatedInsured> 5,000.00 </EstimatedInsured>
        <ActualInsured> 3,000.00 </ActualInsured>
        <PaymentDate> 09-15-2015 </PaymentDate>
        <PatientResp> 9,000.00 </PatientResp>
        <UserPaymentMade> 1,000.00 </UserPaymentMade>
        <AmountDue> 8,000.00 </AmountDue>
        ...
</BillSummary>
...
</AjustedBill>
```

In one implementation, upon receiving the adjusted bill, the user 1602 may submit a payment request 1616, e.g., via his healthcare mobile wallet, to the H-Wallet server 1620, which may be processed in a similar manner as shown in FIG. 402B. In one implementation, the H-Wallet may generate a transaction record 1666 summarizing the adjudication, which may take a form similar to 266 in FIG. 2A.

FIG. 17A provides a logic flow diagram illustrating insurance payment adjudication within embodiments of the H-Wallet. Within embodiments, the H-Wallet may facilitate adjudication between the insurance provider 1750 and healthcare provider 1710.

As shown in FIG. 17A, continuing on with 306 in FIG. 3A, a user 1702 may submit payment account information 1705, e.g., a FSA/HSA/LOC account number, wherein the H-Wallet 1720 may link the payment accounts 1710 to the H-Wallet (e.g., see also FIGS. 4A-4C).

On the day of the scheduled procedure, the user may submit a payment request 1712, e.g., by swiping his prepaid card or engage his mobile wallet, etc. The healthcare provider may determine whether the prepaid card is acceptable at the POS terminal 1713, e.g., whether the POS terminal has participated into the H-Wallet payment service. If not, the user may receive a denial message 1715. If accepted by the POS 1713, the H-Wallet may determine whether there is sufficient amount of funds in the user submitted account 1719. For example, in one implementation, the H-Wallet may send balance inquiry to the user's enrolled healthcare accounts, such as FSA, HSA, LOC etc., e.g., see FIG. 4B.

If yes, the H-Wallet may deduct the requested payment amount from the user account 1720 and transfer the requested payment amount to the healthcare provider 1727. In another implementation, when there are insufficient funds in the user healthcare account, the user may elect to split the payment and pay with other accounts For example, the user may select other linked accounts from his mobile wallet to proceed with payment (e.g., as shown in FIG. 4E). In one implementation, the H-Wallet may process the payment request and deduct the indicated amount from user selected accounts 1725.

Upon completing the fund transfers from the user to the healthcare provider, the H-Wallet may generate a transaction record 1730 (e.g., see 166 in FIG. 231B).

Continuing on with FIG. 17B, adjudication may be initiated and/or requested 1735 by the insurance provider and/or the healthcare provider. For example, in one implementation, the healthcare provider may not receive sufficient payment and may submit a medical claim 1737 to the insurance provider for review and adjudication to see whether the insurance provider authorized payment to the user has covered the requested medical claim. For another example, upon receiving a medical claim prior to any user payment, the insurance provider may request to assess the claimed amount.

In one implementation, the insurance provider may calculate an insured amount 1740 based on the location of the healthcare provider, e.g., market price, living expenses, average income, and/or the like. The insurance may further determine whether the medical claim and/or the calculated insured amount shall be directed for staff review 1747, which may inspect whether the claims are in compliance of regulatory requirements 1748.

In one implementation, the insurance provider may compare the claimed amount (e.g., the estimated amount from the healthcare provider) with the calculated amount 1752. If the calculated amount meets with the requested claim, the insurance provider may transfer the amount to the healthcare provider 1755-1760. Otherwise, if the calculated amount is less than the requested claim, the insurance provider may re-assess the claim to determine whether to approve the difference 1758. If not, an adjusted medical bill may be generated by the healthcare provider (e.g., see 1623 in FIG. 16).

FIG. 17C provides a logic flow diagram illustrating post-payment reconciliation between the insurance provider and the healthcare provider within embodiments of the H-Wallet. Within implementations, H-Wallet may reconcile the insurance provider approved insured amount payment with the actual transacted amount made from the insurance provider to the healthcare provider. Part of the reconciliation process may be reflected in and combined with the adjudication discussed in FIGS. 17A-17B.

Alternatively, as shown in FIG. 17C, the H-Wallet may retrieve a financial transaction record to verify whether a healthcare provider has received a payment for insured amount matching up with the approved amount by insurance provider (e.g., at 1740 in FIG. 17B). Within implementations, the H-Wallet may retrieve payment transaction records 1765 (e.g., 266 in FIG. 2A), and reconcile the transacted amount with the insurance provider's approved amount and/or approved adjusted amount (e.g., see 1758 at FIG. 17B) 1768. If the two amounts match 1770, the H-Wallet may clear the transaction 1773 and generate a transaction reconciliation report 1775. Otherwise, if the amounts do not match 1770, the H-Wallet may flag the transaction for further inspection 1776. For example, when the insurance provider approved amount is $3,000.00 (e.g., as indicated in an authorization response 236 in FIG. 2A; 1636 in FIG. 16), but the transaction record shows a fund transfer of only $2,500.00 was transacted from the insurance provider to the healthcare provider, the H-Wallet may automatically determine the difference as $500.00, and send a notification to the parties (e.g., the insurance provider 1750 and healthcare provider 1710) indicating the difference.

In further implementations, the H-Wallet may generate a transaction report 1775 to the healthcare provider including the reconciliation status of the transaction for further inspection of the payment transaction 1778. In one implementation, the healthcare provider may determine whether sufficient insurance payment has been made based on the report 1780. For example, when the transacted amount equals the insurance provider authorized insured amount as indicated in message 236 in FIG. 2A, the H-Wallet may finish the reconciliation process. In another implementation, when the transacted amount is less than the insurance provider authorized insured amount, the healthcare provider may generate an additional payment request 1781 to the insurance provider, which may in turn re-process the payment claim, e.g., in a similar manner starting at 1735 in FIG. 17B. In another implementation, the transacted amount is greater than the insurance provider authorized insured amount, the healthcare provider no may provide a refund to the insurance provider 1785.

In further embodiments, the H-Wallet may be deployed in a variety of scenarios in similar manners, such as, but not limited to employee benefits administration and related payment processing, pharmaceutical drug sampling, direct to consumer programs, government administered healthcare/benefit programs, bill payment/recurring payments by patients/employees to benefit service providers, and/or the like. For example, the H-Wallet may process and reconcile data for a government administered healthcare/benefit program with actual transacted amount from the government sponsor, and/or the like. In further implementations, the H-Wallet may be deployed for drug sample, vaccine purchases, and/or the like.

FIGS. 18A-18F provide exemplary mobile wallet UIs illustrating wallet account within embodiments of the H-Wallet. With reference to FIG. 18A, in some embodiments, a mobile device 1800 of the user may present a graphical user interface (GUI) 1801 (e.g., a home screen) including a GUI element 1802 to start up a virtual wallet application (e.g., an Apple® iPhone/iPad app, Google Android application, Windows® Mobile application, etc.). For example, the icon 1802 may indicate the wallet is enabled with H-Wallet service and the wallet has registered a H-Wallet prepaid account.

In some embodiments, when a user activates the GUI element 1801 of FIG. 18A, the mobile device may provide a virtual mobile wallet application interface 1810. In some embodiments, the application interface may include a GUI element 1811 to initiate a payment communication (e.g., transmitting a credit/debit/prepaid card number via NFC/Bluetooth/cellular communication). In some embodiments, the mobile device may utilize default values for the payment information (e.g., credit/debit/prepaid card information) and communication mode (e.g., NFC). In alternate embodiments, the user may be able to modify the payment information prior to communicating with a PoS terminal to initiate the payment transaction. For example, a GUI element 1814 may provide a mechanism to modify payment information without leaving the “tap to pay” screen provided by application interface 1810 (see, e.g., elements 1820-221 of FIG. 18B). As another example, a GUI element 1813 may, when activated by the user, present the user an application interface wherein the user may make more detailed adjustments to aspects of the payment mechanism (e.g., card utilized, anonymization/security preferences, etc.). In some embodiments, the user may be able to quickly revert to utilizing default payment settings by activating a GUI element 1812. In some embodiments, the user may be able to stop a communication of payment information that is in progress by activating a GUI element 1815 (“tap to stop”) that the application interface presents during the communication of payment information.

With reference to FIG. 18B, in some embodiments, the user may activate a GUI element 1820 when operating the virtual mobile wallet application in a payment activation application interface to obtain a menu of card selection options 1821a-c. For example, the user may add a H-Wallet prepaid account 1821a to the wallet upon obtaining a card number. The user may activate any of the card selection options to quickly modify the payment information utilized in the communication to trigger the payment transaction. In some embodiments, the user may activate GUI element 1822 to obtain an application interface 1823 (“my accounts”) for a more detailed view, from which the user can make selections of payment options. For example, the wallet accounts 1823 may include a tab for the user's enrolled restricted use accounts. For example, a GUI element 1824 may describe types of payment options (e.g., payment cards, loyalty cards, NFC tags, etc.) available to the user. The specific payment options may be depicted in GUI elements 1825a-b. In some embodiments, the GUI elements 1825a-b may be arranged as a column browser, with multiple columns (see 1826). In some embodiments, the interface may provide a GUI element 1827 that the user can activate to add a new payment option to the existing payment options displayed in the GUI elements 1825a-b. For example, as shown at 1825b, the H-Wallet may list the user's FSA, HSA, LOC accounts enrolled in the wallet with its balance information.

With reference to FIG. 18C, in some embodiments, activating a GUI element corresponding to a payment options may provide a detailed view of the payment option, e.g., 1830 (“manage my card”). The view may include a graphical view 1831a of the payment option, providing information including, without limitation: card payment processor (e.g., “Visa”), card number, payment mechanism (e.g., “Visa payWave”), cardholder name, expiration date, and/or the like. The view may also include indications of information such as, without limitation: a current balance 1832, a maximum payment amount currently permissible using the card, a date on which a balance payment is due, and/or the like. The view may include a GUI element 1833 that the user can activate to utilize the payment option in the purchase transaction initiation. In some embodiments, the view may include a GUI element 1834 that the user can activate to view recent purchase transactions initiated using the payment option currently being displayed in 1831a (e.g., a FSA account, etc.). The view may also include a GUI element 1835 that the user can activate to add funds to the payment option currently being displayed in 1831a. In some embodiments, the payment options may be arranged within a column browser interface, such that user can scan through the various payment options (e.g., 1831b-e) by swiping a touchscreen of the mobile device (see 1836a). As the user scans through the payment options, GUI element 1836b-e may modify to indicate the user's position within the column browser interface.

With reference to FIG. 18D, the user may be able to view a record of recent transactions 1840 initiated using a payment option (e.g., by activating GUI element 1834 of FIG. 18C). In the recent transactions view 1840, the user may be provided with a record listing 1845, including information on a time of a purchase transaction (“when” 1841), a description of the transaction (“what” 1842), an amount of the transaction (“amount” 1843), and a location of the transaction (“where” 1844). The user may be able to scroll through a long list of recent transactions by activating a GUI element 1846 (“view more”). In some embodiments, the user may activate a GUI element 1847 to obtain a view of transactions placed on a geographical map, so that the user may understand better where each of the user's transactions originate.

With reference to FIG. 18E, in one embodiment, the social tab 1855 may facilitate integration of the wallet application with social channels 1856. In one implementation, a user may select one or more social channels 1856 and may sign in to the selected social channel from the wallet application by providing to the wallet application the social channel user name and password 1857 and signing in 1858. The user may then use the social button 1859 to send or receive money through the integrated social channels. In a further implementation, the user may send social share data such as purchase information or links through integrated social channels. In another embodiment, the user supplied login credentials may allow H-Wallet to engage in interception parsing.

With reference to FIG. 18F, the user may be provided with a screen 1817k where the user can enter an amount to pay “St John's Hospital,” as well as add other text to provide the payee with context for the payment transaction 18171. The user can choose modes (e.g., SMS, email, social networking) via which the receipt “St John's Hospital” may be contacted via graphical user interface elements, 1817m. As the user types, the text entered may be provided for review within a GUI element 1817n. When the user has completed entering in the necessary information, the user can press the send button 18170 to send the social message to St John's Hospital. If St John's Hospital also has a virtual wallet application, St John's Hospital may be able to review 1817p healthcare collection portal message within the app, or directly at the website of the social network (e.g., for Twitter™, Facebook®, etc.). Messages may be aggregated from the various social networks and other sources (e.g., SMS, email). The method of redemption appropriate for each messaging mode may be indicated along with the healthcare collection portal message. In the illustration in FIG. 18F, the SMS 1817q St John's Hospital received indicates that St John's Hospital can redeem the $5 obtained via SMS by replying to the SMS and entering the hash tag value ‘#1234’. In the same illustration, St John's Hospital has also received a message 1817r via social media.

FIGS. 19A-19B provide exemplary mobile wallet UIs illustrating making a payment within embodiments of the HPP-Platform. With reference to FIG. 19A, in another embodiment, a user may select the bills 1916 option. Upon selecting the bills 1916 option, the user interface may display a list of bills and/or receipts 1916a-h from one or more merchants. Next to each of the bills, additional information such as date of visit, whether items from multiple stores are present, last bill payment date, auto-payment, number of items, and/or the like may be displayed. In one example, the wallet shop bill 1916a dated Jan. 20, 2015 may be selected. The wallet shop bill selection may display a user interface that provides a variety of information regarding the selected bill. For example, the user interface may display a list of items 1916k purchased, <<916i>>, >, a total number of items and the corresponding value. For example, as shown at 1916a, the user may elect to pay for a bill for “Knee Surgery” 1916a performed at Jan. 20, 2015, which comprises details of the healthcare treatment performed for the user 1916k.

A user may now select any of the items and select buy again to add purchase the items. The user may also refresh offers 1916j to clear any invalid offers from last time and/or search for new offers that may be applicable for the current purchase. As shown in FIG. 19A, a user may select two items for repeat purchase. Upon addition, a message 19161 may be displayed to confirm the addition of the two items, which makes the total number of items in the cart 14.

In some implementations, the HPP-Platform wallet may provide the H-Wallet with the GPS location of the user. Based on the GPS location of the user, the H-Wallet may determine the context of the user (e.g., whether the user is in a store, doctor's office, hospital, postal service office, etc.). Based on the context, the user app may present the appropriate fields to the user, from which the user may select fields and/or field values to send as part of the purchase order transmission. For example, a user may go to doctor's office and desire to pay the co-pay for doctor's appointment. In addition to basic transactional information such as account number and name, the app may provide the user the ability to select to transfer medical records, health information, which may be provided to the medical provider, insurance company, as well as the transaction processor to reconcile payments between the parties. In some implementations, the records may be sent in a Health Insurance Portability and Accountability Act (HIPAA)-compliant data format and encrypted, and only the recipients who are authorized to view such records may have appropriate decryption keys to decrypt and view the private user information.

With reference to FIG. 19B, in one embodiment, the wallet mobile application may provide a user with a number of options for paying for a transaction via the wallet mode Error! Reference source not found. 10. In one implementation, an example user interface 1911 for making a payment is shown. The user interface may clearly identify the amount 1912 and the currency Error! Reference source not found. 13 for the transaction. The amount may be the amount payable and the currency may include real currencies such as dollars and euros, as well as virtual currencies such as reward points. The amount of the transaction 1914 may also be prominently displayed on the user interface. The user may select the funds tab 1916 to select one or more forms of payment 1917, which may include various credit, debit, gift, rewards and/or prepaid cards. The user may also have the option of paying, wholly or in part, with reward points. For example, the graphical indicator 1918 on the user interface shows the number of points available, the graphical indicator 1919 shows the number of points to be used towards the amount due 234.56 and the equivalent 1920 of the number of points in a selected currency (USD, for example).

In one implementation, the user may combine funds from multiple sources to pay for the transaction. The amount 1919 displayed on the user interface may provide an indication of the amount of total funds covered so far by the selected forms of payment (e.g., Discover card and rewards points). The user may choose another form of payment or adjust the amount to be debited from one or more forms of payment until the amount 1919 matches the amount payable 1914. Once the amounts to be debited from one or more forms of payment are finalized by the user, payment authorization may begin.

In one implementation, the user may select a secure authorization of the transaction by selecting the cloak button 1922 to effectively cloak or anonymize some (e.g., pre-configured) or all identifying information such that when the user selects pay button 1921, the transaction authorization is conducted in a secure and anonymous manner. In another implementation, the user may select the pay button 1921 which may use standard authorization techniques for transaction processing. In yet another implementation, when the user selects the social button 1923, a message regarding the transaction may be communicated to one of more social networks (set up by the user) which may post or announce the purchase transaction in a social forum such as a wall post or a tweet. In one implementation, the user may select a social payment processing option 1923. The indicator 1924 may show the authorizing and sending social share data in progress.

In another implementation, a restricted payment mode 1929 may be activated for certain purchase activities such as prescription purchases. The mode may be activated in accordance with rules defined by issuers, insurers, merchants, payment processor and/or other entities to facilitate processing of specialized goods and services. In this mode, the user may scroll down the list of forms of payments 1926 under the funds tab to select specialized accounts such as a flexible spending account (FSA) 1927, health savings account (HSA), and/or the like and amounts to be debited to the selected accounts. In one implementation, such restricted payment mode 1929 processing may disable social sharing of purchase information.

In one embodiment, the wallet mobile application may facilitate importing of funds via the import funds user interface 1928. For example, a user who is unemployed may obtain unemployment benefit fund 1929 via the wallet mobile application. In one implementation, the entity providing the funds may also configure rules for using the fund as shown by the processing indicator message 1930. The wallet may read and apply the rules prior, and may reject any purchases with the unemployment funds that fail to meet the criteria set by the rules. Example criteria may include, for example, merchant category code (MCC), time of transaction, location of transaction, and/or the like. As an example, a transaction with a grocery merchant having MCC 5411 may be approved, while a transaction with a bar merchant having an MCC 5813 may be refused.

FIGS. 19C-19D provide exemplary screens illustrating user social access control of healthcare information within embodiments of the H-Wallet. It should be noted that although the user interface shown is a web interface, mobile and other interfaces may be employed. In one implementation, when a user has agreed to enroll with a healthcare social payment portal via a social media platform (e.g., see FIGS. 9A-9B), the user's healthcare payment information may be incorporated into a social media activity message which may be published on the social media platform. In one implementation, the user may configure the settings of the healthcare social portal so that only authorized social contacts on the social media platform may access or view the user's published healthcare information (e.g., the user has paid a healthcare bill, the user has checked in at a healthcare provider, etc.). For example, FIG. 19A provides an example schematic user interface of H-Wallet payment portal user profile page within implementations of the H-Wallet. As shown in FIG. 19C, the H-Wallet UI may comprise a panel for the user to select items to share 1905. For example, the user may check categories of share items to publish, e.g., “Healthcare” 1908. Once the user has selected a category, the user may be prompted to select subcategories under “Healthcare,” 1908 e.g., “prescription drugs” 1908a, “physician checkup” 1908b, “dental” 1908c, “vision” 1908d, “family care” 1908e and/or the like, and/or to specify a subcategory not listed 1908f. In another implementation, the user may elect to control access to his sharing under the selected category, e.g., privacy control 1920 settings. For example, the user may elects to manually select users from his contact list 1924 to allow them to access his publication under the category “healthcare.” As shown at 1924, the user may only allow his close family members (e.g., spouse and parents, etc.) and primary family doctor to have access to his social media sharing of healthcare payment information.

In one implementation, the H-Wallet UI may show a list of the user's followers 1930, and the created interests group 1930a-530c. For example, the user may create interests groups so that each interest group may see the user's publications, news feeds with regard to share items of a category, e.g., the user may configure his interest group “invisalign fella” 1930a to have access to his share publications under the category “healthcare->dental”; but interest groups “party buddies” 1930b and “community” 1930c may not have access to the user's healthcare information from the social media feeds.

In one implementation, the H-Wallet UI may provide an overview of the user's revenue of rebate from healthcare incentive programs. For example, the user may view a total rebate revenue chart per month 1935a. For another example, the user may view a pie of total revenue by category 1935b. For a further example, the user may view a rebate revenue break-down per healthcare provider countries, regions, zipcodes, etc. For a further example, the user may view a list of rebate payment history per transaction timestamp, and/or the like.

In further implementations, the H-Wallet UI may comprise a list of followers' feedbacks 1940 when the followers have access to the published healthcare information. In one implementation, the comments made under a sharing feed with restricted access may be viewed by authorized followers specified at 1920. For example, if the user has shared a payment transaction news showing “John Smith has paid $500.00 to St John's Hospital,” and the user's wife (e.g., “Jane Smith”) and mother (“Anna Smith”) who have access to such information commented on the link (e.g., see 1940), their comments can be viewed by the user authorized followers only, e.g., by “Jane Smith,” “Anna Smith,” and “Dr. Allan Lee” at 1924.

As shown in FIG. 19D, in one implementation, the user may select an interests category from the interests category list 1941. For example, the user may select a category “healthcare” 1941a. Upon selecting the category, H-Wallet may expand the category “healthcare” 1941a with a list of subcategories, and the user may select a subcategory “dental” 1941b. Upon checking the checkbox, the user has selected to share his activities related to “dental” over a share channel.

In one implementation, the user may select what information he would like his H-Wallet publication to include. For example, if the user elects to include procedure details 1942 in the H-Wallet publication, the user may further configure parameters about the provide name 1942a, service date 1942b and/or the like.

In one implementation, for the selected category “healthcare->dental,” the user may configure social privacy settings 1945. For example, the user may select a degree of separation of H-Wallet users that can follow and see his H-Wallet publications, e.g., 1950a. For example, the user may select Facebook users within 3 degrees can view his H-Wallet publications under the category “Digital Camera.” For another example, the user may import friends from other social media platform (e.g., MySpace, Google+, etc.), email list (e.g., Gmail, etc.) and/or the like. Additionally, custom groups may be established allowing degrees of separation for such group members to be specified by the user/patient; for example, a healthcare provider 1951 may include 0 degrees of separation while a doctors 1952 group may specify 1 degree of separation allowing for direct referrals.

In this example, as shown in FIG. 19D, the user may specify a group of contacts may access his H-Wallet publications 1950b, and selects his “invisalign fella” to view his publications under “dental.” The user has also authorized his close family members and family doctor to access such healthcare social content 1924.

In one implementation, the user may further configure the content of H-Wallet publications 1950c. For example, the user may elect to only publish news feeds that he has given the highest rating (e.g., five star, etc.), paid transactions, and/or the like. In further implementations, the user may allow H-Wallet to retrieve and publish GPS information when he checks in at a healthcare provider, e.g., a dental office in the example of FIG. 19D.

FIGS. 20A-B show data flow diagrams illustrating an example purchase transaction authorization procedure in some embodiments of the H-Wallet. With reference to FIG. 20A, in some embodiments, a user, e.g., 2001a, may wish to utilize a virtual wallet account to purchase a product, service, offering, and/or the like (“product”), from a merchant via a merchant online site or in the merchant's store. The user may utilize a physical card, or a user wallet device, e.g., 2001b, to access the user's virtual wallet account. For example, the user wallet device may be a personal/laptop computer, cellular telephone, smartphone, tablet, eBook reader, netbook, gaming console, and/or the like. The user may provide a wallet access input, e.g., 2011 into the user wallet device. For example, if the user attempts to submit a healthcare payment, the user may tap on the NWI account list, and the wallet may return a list of restricted use accounts with updated balance information, e.g., see 485, 491-492 in FIGS. 4D-44E.

In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some embodiments, the user wallet device may authenticate the user based on the user's wallet access input, and provide virtual wallet features for the user.

In some embodiments, upon authenticating the user for access to virtual wallet features, the user wallet device may provide a transaction authorization input, e.g., 2014, to a point-of-sale (“PoS”) client, e.g., 2002. For example, the user wallet device may communicate with the PoS client via Bluetooth, Wi-Fi, cellular communication, one- or two-way near-field communication (“NFC”), and/or the like. In embodiments where the user utilizes a plastic card instead of the user wallet device, the user may swipe the plastic card at the PoS client to transfer information from the plastic card into the PoS client. For example, the PoS client may obtain, as transaction authorization input 2014, track 1 data from the user's plastic card (e.g., credit card, debit card, prepaid card, charge card, etc.), such as the example track 1 data provided below:

%B123456789012345\hat{ }PUBLIC/J.Q.\hat{ }99011200000000000000**901******?*
(wherein ‘123456789012345’ is the card number of ‘J.Q. Public’ and has a CVV number of
901. ‘990112’ is a service code, and *** represents decimal digits which change
randomly each time the card is used.)

In embodiments where the user utilizes a user wallet device, the user wallet device may provide payment information to the PoS client, formatted according to a data formatting protocol appropriate to the communication mechanism employed in the communication between the user wallet device and the PoS client. An example listing of transaction authorization input 2014, substantially in the form of XML-formatted data, is provided below:

<?XML version = “1.0” encoding = “UTF-8”?>
<transaction_authorization_input>

<payment_data>

<account>

<charge_priority>1</charge_priority>
<charge_ratio>40%</charge_ratio>
<account_number>123456789012345</account_number>
<account_name>John Q. Public</account_name>
<bill_add>987 Green St #456, Chicago, IL 94652</bill_add>
<ship_add>987 Green St #456, Chicago, IL 94652</ship_add>
<CVV>123</CVV>

</account>
<account>

<charge_priority>1</charge_priority>
<charge_ratio>60%</charge_ratio>
<account_number>234567890123456</account_number>
<account_name>John Q. Public</account_name>
<bill_add>987 Green St #456, Chicago, IL 94652</bill_add>
<ship_add>987 Green St #456, Chicago, IL 94652</ship_add>
<CVV>173</CVV>

</account>
<account>

<charge_priority>2</charge_priority>
<charge_ratio>100%</charge_ratio>
<account_number>345678901234567</account_number>
<account_name>John Q. Public</account_name>
<bill_add>987 Green St #456, Chicago, IL 94652</bill_add>
<ship_add>987 Green St #456, Chicago, IL 94652</ship_add>
<CVV>695</CVV>

</account>

</payment_data>
<!--optional data-->
<timestamp>2011-02-22 15:22:43</timestamp>
<expiry_lapse>00:00:30</expiry_lapse>
<secure_key>0445329070598623487956543322</secure_key>
<alerts_track_flag>TRUE</alerts_track_flag>
<wallet_device_details>

<device_IP>192.168.23.126</client_IP>
<device_type>smartphone</client_type>
<device_model>HTC Hero</client_model>
<OS>Android 2.2</OS>
<wallet_app_installed_flag>true</wallet_app_installed_flag>

</wallet_device_details>

</transaction_authorization_input>

In some embodiments, the PoS client may generate a card authorization request, e.g., 2015, using the obtained transaction authorization input from the user wallet device, and/or product/checkout data. An example listing of a card authorization request 2015, substantially in the form of a HTTP(S) POST message including XML-formatted data, is provided below:

POST /authorizationrequests.php HTTP/1.1
Host: www.acquirer.com
Content-Type: Application/XML
Content-Length: 1306
<?XML version = “1.0” encoding = “UTF-8”?>
<card_authorization_request>

<session_ID>4NFU4RG94</order_ID>
<timestamp>2011-02-22 15:22:43</timestamp>
<expiry>00:00:30</expiry>
<alerts_URL>www.merchant.com/shopcarts.php?sessionID=AEBB4356</alerts_URL>
<!--optional data-->
<user_ID>john.q.public@gmail.com</user_ID>
<PoS_{——}details>

<PoS_IP>192.168.23.126</client_IP>
<PoS_type>smartphone</client_type>
<PoS_model>HTC Hero</client_model>
<OS>Android 2.2</OS>
<app_installed_flag>true</app_installed_flag>

</PoS_details>
<purchase_details>

<num_products>1</num_products>
<product>

<product_type>book</product_type>
<product_params>

<product_title>XML for dummies</product_title>
<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</purchase_details>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>
<account_params>

<account_name>John Q. Public</account_name>
<account_type>credit</account_type>
<account_num>123456789012345</account_num>
<billing_address>123 Green St., Norman, OK 98765</billing_address>
<phone>123-456-7809</phone>
<sign>/jqp/</sign>
<confirm_type>email</confirm_type>
<contact_info>john.q.public@gmail.com</contact_info>

</account_params>
<shipping_info>

<shipping_adress>same as billing</shipping_address>
<ship_type>expedited</ship_type>
<ship_carrier>FedEx</ship_carrier>
<ship_account>123-45-678</ship_account>
<tracking_flag>true</tracking_flag>
<sign_flag>false</sign_flag>

</shipping_info>

</card_authorization_request>

In some embodiments, the card authorization request generated by the user device may include a minimum of information to process the purchase transaction. For example, this may improve the efficiency of communicating the purchase transaction request, and may also advantageously improve the privacy protections provided to the user and/or merchant. For example, in some embodiments, the card authorization request may include at least a session ID for the user's shopping session with the merchant. The session ID may be utilized by any component and/or entity having the appropriate access authority to access a secure site on the merchant server to obtain alerts, reminders, and/or other data about the transaction(s) within that shopping session between the user and the merchant. In some embodiments, the PoS client may provide the generated card authorization request to the merchant server, e.g., 2016. The merchant server may forward the card authorization request to a pay gateway server, e.g., 2004a, for routing the card authorization request to the appropriate payment network for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the merchant server may query a database, e.g., merchant/acquirer database 2003b, for a network address of the payment gateway server, for example by using a portion of a user payment card number, or a user ID (such as an email address) as a keyword for the database query. For example, the merchant server may issue PHP/SQL commands to query a database table (such as FIG. 27, Pay Gateways 2719h) for a URL of the pay gateway server. An example payment gateway address query 2017, substantially in the form of PHP/SQL commands, is provided below:

<?PHP
header(′Content-Type: text/plain′);
mysql_connect(“254.93.179.112”,$DBserver,$password); // access
database server
mysql_select_db(“H-Wallet_DB.SQL”); // select database table to search
//create query
$query = “SELECT paygate_id paygate_address paygate_URL
paygate_name FROM
PayGatewayTable WHERE card_num LIKE ′%′ $cardnum”;
$result = mysql_query($query); // perform the search query
mysql_close(“H-Wallet_DB.SQL”); // close database access
?>

In response, the merchant/acquirer database may provide the requested payment gateway address, e.g., 2018. The merchant server may forward the card authorization request to the pay gateway server using the provided address, e.g., 2019. In some embodiments, upon receiving the card authorization request from the merchant server, the pay gateway server may invoke a component to provide one or more services associated with purchase transaction authorization. For example, the pay gateway server may invoke components for fraud prevention, loyalty and/or rewards, and/or other services for which the user-merchant combination is authorized. The pay gateway server may forward the card authorization request to a healthcare collection portal server, e.g., 2005a, for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the pay gateway server may query a database, e.g., pay gateway database 2004b, for a network address of the payment network server, for example by using a portion of a user payment card number, or a user ID (such as an email address) as a keyword for the database query. For example, the pay gateway server may issue PHP/SQL commands to query a database table (such as FIG. 27, Pay Gateways 2719h) for a URL of the healthcare collection portal server. An example payment network address query 2021, substantially in the form of PHP/SQL commands, is provided below:

<?PHP
header(′Content-Type: text/plain′);
mysql_connect(“254.93.179.112”,$DBserver,$password); // access
database server
mysql_select_db(“H-Wallet_DB.SQL”); // select database table to search
//create query
$query = “SELECT payNET_id payNET_address payNET_URL
payNET_name FROM PayGatewayTable
WHERE card_num LIKE ′%′ $cardnum”;
$result = mysql_query($query); // perform the search query
mysql_close(“H-Wallet_DB.SQL”); // close database access
?>

In response, the payment gateway database may provide the requested payment network address, e.g., 2022. The pay gateway server may forward the card authorization request to the healthcare collection portal server using the provided address, e.g., 2023.

With reference to FIG. 20B, in some embodiments, the healthcare collection portal server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer.

In some embodiments, the healthcare collection portal server may generate a query, e.g., 2024, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s), e.g., 2006a, of the issuer(s) may maintain details of the user's account(s). In some embodiments, a database, e.g., healthcare collection portal database 2005b, may store details of the issuer server(s) associated with the issuer(s). In some embodiments, the healthcare collection portal server may query a database, e.g., healthcare collection portal database 2005b, for a network address of the issuer(s) server(s), for example by using a portion of a user payment card number, or a user ID (such as an email address) as a keyword for the database query. For example, the merchant server may issue PHP/SQL commands to query a database table (such as FIG. 27, Issuers 27190 for network address(es) of the issuer(s) server(s). An example issuer server address(es) query 2024, substantially in the form of PHP/SQL commands, is provided below:

<?PHP
header(′Content-Type: text/plain′);
mysql_connect(“254.93.179.112”,$DBserver,$password); // access
database server
mysql_select_db(“H-Wallet_DB.SQL”); // select database table to search
//create query
$query = “SELECT issuer_id issuer_address issuer_URL
issuer_name FROM IssuersTable
WHERE card_num LIKE ′%′ $cardnum”;
$result = mysql_query($query); // perform the search query
mysql_close(“H-Wallet_DB.SQL”); // close database access
?>

In response to obtaining the issuer server query, e.g., 2024, the healthcare collection portal database may provide, e.g., 2025, the requested issuer server data to the healthcare collection portal server. In some embodiments, the healthcare collection portal server may utilize the issuer server data to generate funds authorization request(s), e.g., 2026, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. An example listing of a funds authorization request 2026, substantially in the form of a HTTP(S) POST message including XML-formatted data, is provided below:

POST /fundsauthorizationrequest.php HTTP/1.1
Host: www.issuer.com
Content-Type: Application/XML
Content-Length: 624
<?XML version = “1.0” encoding = “UTF-8”?>
<funds_authorization_request>

<query_ID>VNEI39FK</query_ID>
<timestamp>2011-02-22 15:22:44</timestamp>
<transaction_cost>$22.61</transaction_cost>
<account_params>

<account_type>checking</account_type>
<account_num>1234567890123456</account_num>

</account_params>
<!--optional parameters-->
<purchase_summary>

<num_products>1</num_products>
<product>

<product_summary>Book - XML for dummies</product_summary>
<product_quantity>1</product_quantity?

</product>

</purchase_summary>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>

</funds_authorization_request>

In some embodiments, an issuer server may parse the authorization request(s), and based on the request details may query a database, e.g., user profile database 2006b, for data associated with an account linked to the user. For example, the merchant server may issue PHP/SQL commands to query a database table (such as FIG. 27, Accounts 2719d) for user account(s) data. An example user account(s) query 2027, substantially in the form of PHP/SQL commands, is provided below:

<?PHP
header(′Content-Type: text/plain′);
mysql_connect(“254.93.179.112”,$DBserver,$password); // access
database server
mysql_select_db(“H-Wallet_DB.SQL”); // select database table to search
//create query
$query = “SELECT issuer user_id user_name user_balance
account_type FROM AccountsTable
WHERE account_num LIKE ′%′ $accountnum”;
$result = mysql_query($query); // perform the search query
mysql_close(“H-Wallet_DB.SQL”); // close database access
?>

In some embodiments, on obtaining the user account(s) data, e.g., 2028, the issuer server may determine whether the user can pay for the transaction using funds available in the account, 2029. For example, the issuer server may determine whether the user has a sufficient balance remaining in the account, sufficient credit associated with the account, and/or the like. Based on the determination, the issuer server(s) may provide a funds authorization response, e.g., 2030, to the healthcare collection portal server. For example, the issuer server(s) may provide a HTTP(S) POST message similar to the examples above. In some embodiments, if at least one issuer server determines that the user cannot pay for the transaction using the funds available in the account, the healthcare collection portal server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the healthcare collection portal server may abort the authorization process, and provide an “authorization fail” message to the merchant server, user device and/or client.

In some embodiments, the healthcare collection portal server may obtain the funds authorization response including a notification of successful authorization, and parse the message to extract authorization details. Upon determining that the user possesses sufficient funds for the transaction, e.g., 2031, the healthcare collection portal server may invoke a component to provide value-add services for the user.

In some embodiments, the healthcare collection portal server may generate a transaction data record from the authorization request and/or authorization response, and store the details of the transaction and authorization relating to the transaction in a transactions database. For example, the healthcare collection portal server may issue PHP/SQL commands to store the data to a database table (such as FIG. 27, Transactions 2719i). An example transaction store command, substantially in the form of PHP/SQL commands, is provided below:

<?PHP
header(′Content-Type: text/plain′);
mysql_connect(″254.92.185.103”,$DBserver,$password); // access database server
mysql_select(″H-Wallet_DB.SQL″); // select database to append
mysql_query(“INSERT INTO TransactionsTable (PurchasesTable (timestamp,
purchase_summary_list, num_products, product_summary, product_quantity,
transaction_cost, account_params_list, account_name, account_type, account_num,
billing_addres, zipcode, phone, sign, merchant_params_list, merchant_id, merchant_name,
merchant_auth_key)
VALUES (time( ), $purchase_summary_list, $num_products, $product_summary,
$product_quantity, $transaction_cost, $account_params_list, $account_name,
$account_type, $account_num, $billing_addres, $zipcode, $phone, $sign,
$merchant_params_list, $merchant_id, $merchant_name, $merchant_auth_key)”); // add
data to table in database
mysql_close(″H-Wallet_DB.SQL″); // close connection to database
?>

In some embodiments, the healthcare collection portal server may forward a transaction authorization response, e.g., 2032, to the user wallet device, PoS client, and/or merchant server. The merchant may obtain the transaction authorization response, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 2033, and store the XML data file, e.g., 2034, in a database, e.g., merchant database 404. For example, a batch XML data file may be structured similar to the example XML data structure template provided below:

<?XML version = “1.0” encoding = “UTF-8”?>
<merchant_data>

<merchant_id>3FBCR4INC</merchant_id>
<merchant_name>Books & Things, Inc.</merchant_name>
<merchant_auth_key>1NNF484MCP59CHB27365</merchant_auth_key>
<account_number>123456789</account_number>

</merchant_data>
<transaction_data>

<transaction 1>

...

</transaction 1>
<transaction 2>

...

</transaction 2>

.
.
.

<transaction n>

...

</transaction n>

</transaction_data>

In some embodiments, the server may also generate a purchase receipt, e.g., 2033, and provide the purchase receipt to the client, e.g., 2035. The client may render and display, e.g., 2036, the purchase receipt for the user. In some embodiments, the user's wallet device may also provide a notification of successful authorization to the user. For example, the PoS client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

FIGS. 21A-B show logic flow diagrams illustrating example aspects of purchase transaction authorization in some embodiments of the H-Wallet, e.g., a Purchase Transaction Authorization (“PTA”) component. With reference to FIG. 321A, in some embodiments, a user may wish to utilize a virtual wallet account to purchase a product, service, offering, and/or the like (“product”), from a merchant via a merchant online site or in the merchant's store. The user may utilize a physical card, or a user wallet device to access the user's virtual wallet account. For example, the user wallet device may be a personal/laptop computer, cellular telephone, smartphone, tablet, eBook reader, netbook, gaming console, and/or the like. The user may provide a wallet access input, e.g., 2101, into the user wallet device. In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some embodiments, the user wallet device may authenticate the user based on the user's wallet access input, and provide virtual wallet features for the user, e.g., 2102-2103.

In some embodiments, upon authenticating the user for access to virtual wallet features, the user wallet device may provide a transaction authorization input, e.g., 2104, to a point-of-sale (“PoS”) client. For example, the user wallet device may communicate with the PoS client via Bluetooth, Wi-Fi, cellular communication, one- or two-way near-field communication (“NFC”), and/or the like. In embodiments where the user utilizes a plastic card instead of the user wallet device, the user may swipe the plastic card at the PoS client to transfer information from the plastic card into the PoS client. In embodiments where the user utilizes a user wallet device, the user wallet device may provide payment information to the PoS client, formatted according to a data formatting protocol appropriate to the communication mechanism employed in the communication between the user wallet device and the PoS client.

In some embodiments, the PoS client may obtain the transaction authorization input, and parse the input to extract payment information from the transaction authorization input, e.g., 2105. For example, the PoS client may utilize a parser, such as the example parsers provided below in the discussion with reference to FIG. 27. The PoS client may generate a card authorization request, e.g., 2106, using the obtained transaction authorization input from the user wallet device, and/or product/checkout data.

In some embodiments, the PoS client may provide the generated card authorization request to the merchant server. The merchant server may forward the card authorization request to a pay gateway server, for routing the card authorization request to the appropriate payment network for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the merchant server may query a database, e.g., 2108, for a network address of the payment gateway server, for example by using a portion of a user payment card number, or a user ID (such as an email address) as a keyword for the database query. In response, the merchant/acquirer database may provide the requested payment gateway address, e.g., 2110. The merchant server may forward the card authorization request to the pay gateway server using the provided address. In some embodiments, upon receiving the card authorization request from the merchant server, the pay gateway server may invoke a component to provide one or more service associated with purchase transaction authorization, e.g., 2111. For example, the pay gateway server may invoke components for fraud prevention (see e.g., VerifyChat, FIG. 3E), loyalty and/or rewards, and/or other services for which the user-merchant combination is authorized.

The pay gateway server may forward the card authorization request to a healthcare collection portal server for payment processing, e.g., 2114. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the pay gateway server may query a database, e.g., 2112, for a network address of the payment network server, for example by using a portion of a user payment card number, or a user ID (such as an email address) as a keyword for the database query. In response, the payment gateway database may provide the requested payment network address, e.g., 2113. The pay gateway server may forward the card authorization request to the healthcare collection portal server using the provided address, e.g., 2114.

With reference to FIG. 21B, in some embodiments, the healthcare collection portal server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer. In some embodiments, the healthcare collection portal server may generate a query, e.g., 2115, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s) of the issuer(s) may maintain details of the user's account(s). In some embodiments, a database, e.g., a healthcare collection portal database, may store details of the issuer server(s) associated with the issuer(s). In some embodiments, the healthcare collection portal server may query a database, e.g., 2115, for a network address of the issuer(s) server(s), for example by using a portion of a user payment card number, or a user ID (such as an email address) as a keyword for the database query.

In response to obtaining the issuer server query, the healthcare collection portal database may provide, e.g., 2116, the requested issuer server data to the healthcare collection portal server. In some embodiments, the healthcare collection portal server may utilize the issuer server data to generate funds authorization request(s), e.g., 2117, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. In some embodiments, an issuer server may parse the authorization request(s), e.g., 2118, and based on the request details may query a database, e.g., 2119, for data associated with an account linked to the user.

In some embodiments, on obtaining the user account(s) data, e.g., 2120, the issuer server may determine whether the user can pay for the transaction using funds available in the account, e.g., 2121. For example, the issuer server may determine whether the user has a sufficient balance remaining in the account, sufficient credit associated with the account, and/or the like. Based on the determination, the issuer server(s) may provide a funds authorization response, e.g., 2122, to the healthcare collection portal server. In some embodiments, if at least one issuer server determines that the user cannot pay for the transaction using the funds available in the account, the healthcare collection portal server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the healthcare collection portal server may abort the authorization process, and provide an “authorization fail” message to the merchant server, user device and/or client.

In some embodiments, the healthcare collection portal server may obtain the funds authorization response including a notification of successful authorization, and parse the message to extract authorization details. Upon determining that the user possesses sufficient funds for the transaction, e.g., 2123, the healthcare collection portal server may invoke a component to provide value-add services for the user, e.g., 2123.

In some embodiments, the healthcare collection portal server may forward a transaction authorization response to the user wallet device, PoS client, and/or merchant server. The merchant may parse, e.g., 2124, the transaction authorization response, and determine from it that the user possesses sufficient funds in the card account to conduct the transaction, e.g., 2125, option “Yes.” The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 2126, and store the XML data file, e.g., 2127, in a database. In some embodiments, the server may also generate a purchase receipt, e.g., 2128, and provide the purchase receipt to the client. The client may render and display, e.g., 2129, the purchase receipt for the user. In some embodiments, the user's wallet device may also provide a notification of successful authorization to the user. For example, the PoS client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

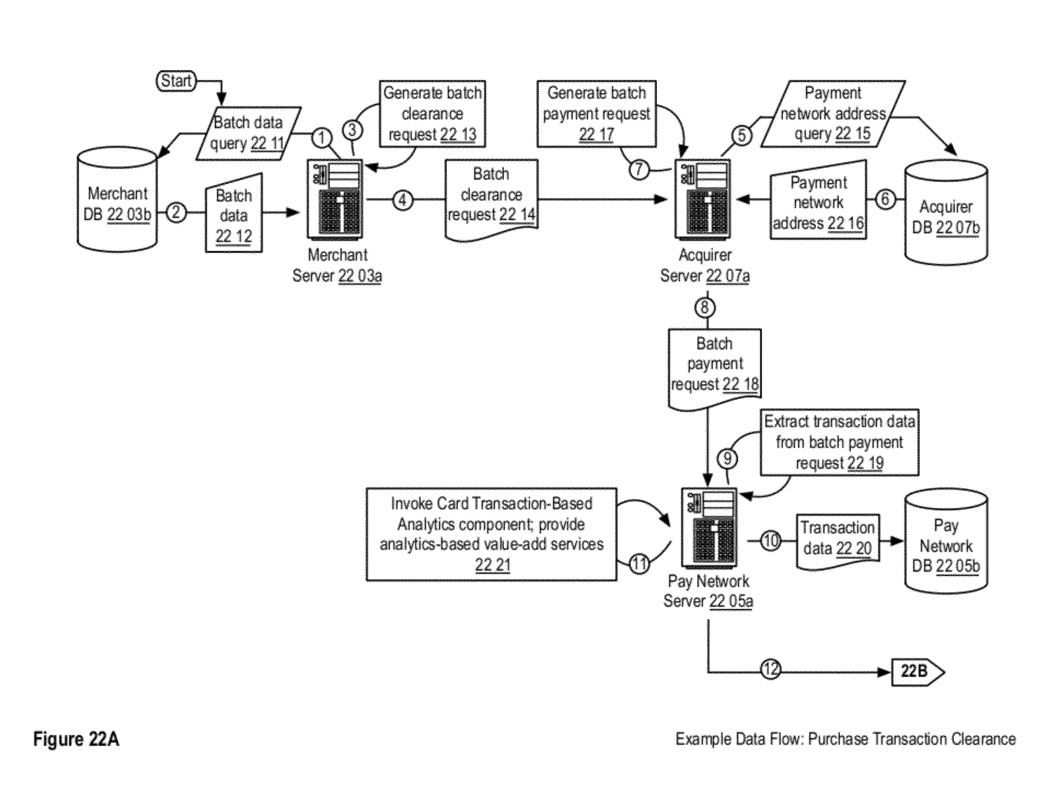

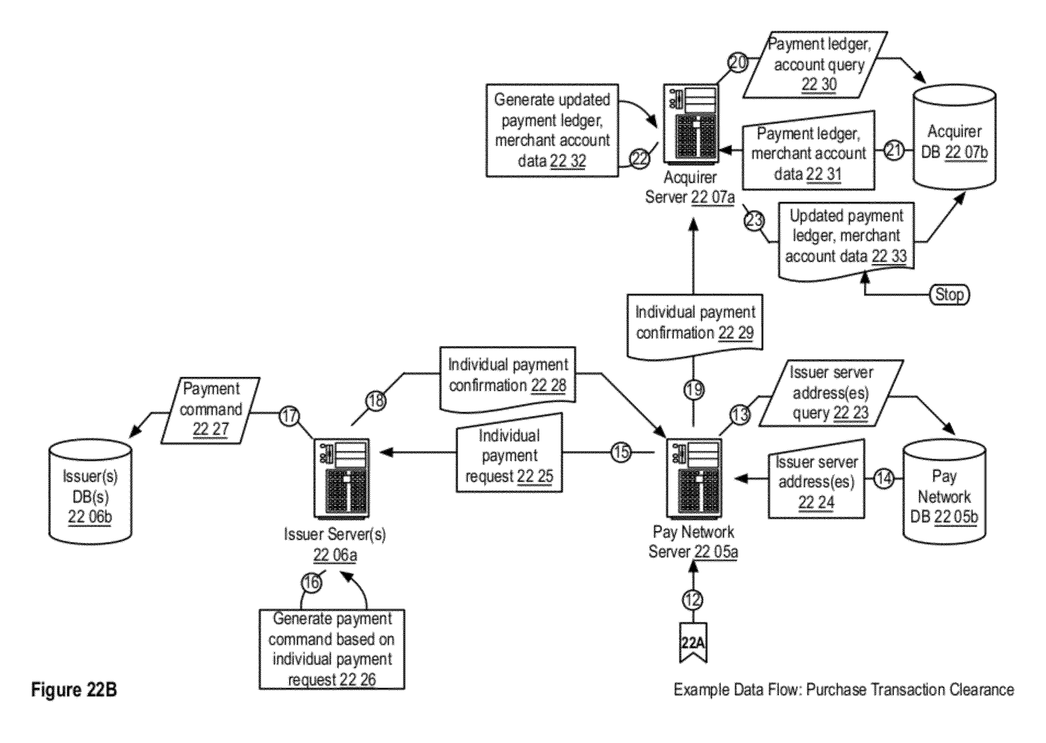

FIGS. 22A-B show data flow diagrams illustrating an example purchase transaction clearance procedure in some embodiments of the H-Wallet. With reference to FIG. 22A, in some embodiments, a merchant server, e.g., 2203a, may initiate clearance of a batch of authorized transactions. For example, the merchant server may generate a batch data request, e.g., 2211, and provide the request, to a merchant database, e.g., 2203b. For example, the merchant server may utilize PHP/SQL commands similar to the examples provided above to query a relational database. In response to the batch data request, the database may provide the requested batch data, e.g., 2212. The server may generate a batch clearance request, e.g., 2213, using the batch data obtained from the database, and provide, e.g., 2214, the batch clearance request to an acquirer server, e.g., 2207a. For example, the merchant server may provide a HTTP(S) POST message including XML-formatted batch data in the message body for the acquirer server. The acquirer server may generate, e.g., 2215, a batch payment request using the obtained batch clearance request, and provide, e.g., 2218, the batch payment request to the healthcare collection portal server, e.g., 2205a. The healthcare collection portal server may parse the batch payment request, and extract the transaction data for each transaction stored in the batch payment request, e.g., 2219. The healthcare collection portal server may store the transaction data, e.g., 2220, for each transaction in a database, e.g., healthcare collection portal database 2205b. In some embodiments, the healthcare collection portal server may invoke a component to provide value-add analytics services based on analysis of the transactions of the merchant for whom the H-Wallet is clearing purchase transactions. For example, the healthcare collection portal server may invoke a component such as the example card transaction-based analytics component discussed above with reference to FIG. Thus, in some embodiments, the healthcare collection portal server may provide analytics-based value-added services for the merchant and/or the merchant's users.

With reference to FIG. 22B, in some embodiments, for each extracted transaction, the healthcare collection portal server may query, e.g., 2223, a database, e.g., healthcare collection portal database 2205b, for an address of an issuer server. For example, the healthcare collection portal server may utilize PHP/SQL commands similar to the examples provided above. The healthcare collection portal server may generate an individual payment request, e.g., 2225, for each transaction for which it has extracted transaction data, and provide the individual payment request, e.g., 2225, to the issuer server, e.g., 2206a. For example, the healthcare collection portal server may provide an individual payment request to the issuer server(s) as a HTTP(S) POST message including XML-formatted data. An example listing of an individual payment request 2225, substantially in the form of a HTTP(S) POST message including XML-formatted data, is provided below:

POST /paymentrequest.php HTTP/1.1
Host: www.issuer.com
Content-Type: Application/XML
Content-Length: 788
<?XML version = “1.0” encoding = “UTF-8”?>
<pay_request>

<request_ID>CNI4ICNW2</request_ID>
<timestamp>2011-02-22 17:00:01</timestamp>
<pay_amount>$34.78</pay_amount>
<account_params>

<account_name>John Q. Public</account_name>
<account_type>credit</account_type>
<account_num>123456789012345</account_num>
<billing_address>123 Green St., Norman, OK 98765</billing_address>
<phone>123-456-7809</phone>
<sign>/jqp/</sign>

</account_params>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>
<purchase_summary>

<num_products>1</num_products>
<product>

<product_summary>Book - XML for dummies</product_summary>
<product_quantity>1</product_quantity?

</product>

</purchase_summary>

</pay_request>

In some embodiments, the issuer server may generate a payment command, e.g., 2227. For example, the issuer server may issue a command to deduct funds from the user's account (or add a charge to the user's credit card account). The issuer server may issue a payment command, e.g., 2227, to a database storing the user's account information, e.g., user profile database 2206b. The issuer server may provide an individual payment confirmation, e.g., 2228, to the healthcare collection portal server, which may forward, e.g., 2229, the funds transfer message to the acquirer server. An example listing of an individual payment confirmation 2228, substantially in the form of a HTTP(S) POST message including XML-formatted data, is provided below:

POST /clearance.php HTTP/1.1
Host: www.acquirer.com
Content-Type: Application/XML
Content-Length: 206
<?XML version = “1.0” encoding = “UTF-8”?>
<deposit_ack>

<request_ID>CNI4ICNW2</request_ID>
<clear_flag>true</clear_flag>
<timestamp>2011-02-22 17:00:02</timestamp>
<deposit_amount>$34.78</deposit_amount>

</deposit_ack>

In some embodiments, the acquirer server may parse the individual payment confirmation, and correlate the transaction (e.g., using the request_ID field in the example above) to the merchant. The acquirer server may then transfer the funds specified in the funds transfer message to an account of the merchant. For example, the acquirer server may query, e.g. 2230, an acquirer database 2207b for payment ledger and/or merchant account data, e.g., 2231. The acquirer server may utilize payment ledger and/or merchant account data from the acquirer database, along with the individual payment confirmation, to generate updated payment ledger and/or merchant account data, e.g., 2232. The acquirer server may then store, e.g., 2233, the updated payment ledger and/or merchant account data to the acquire database.

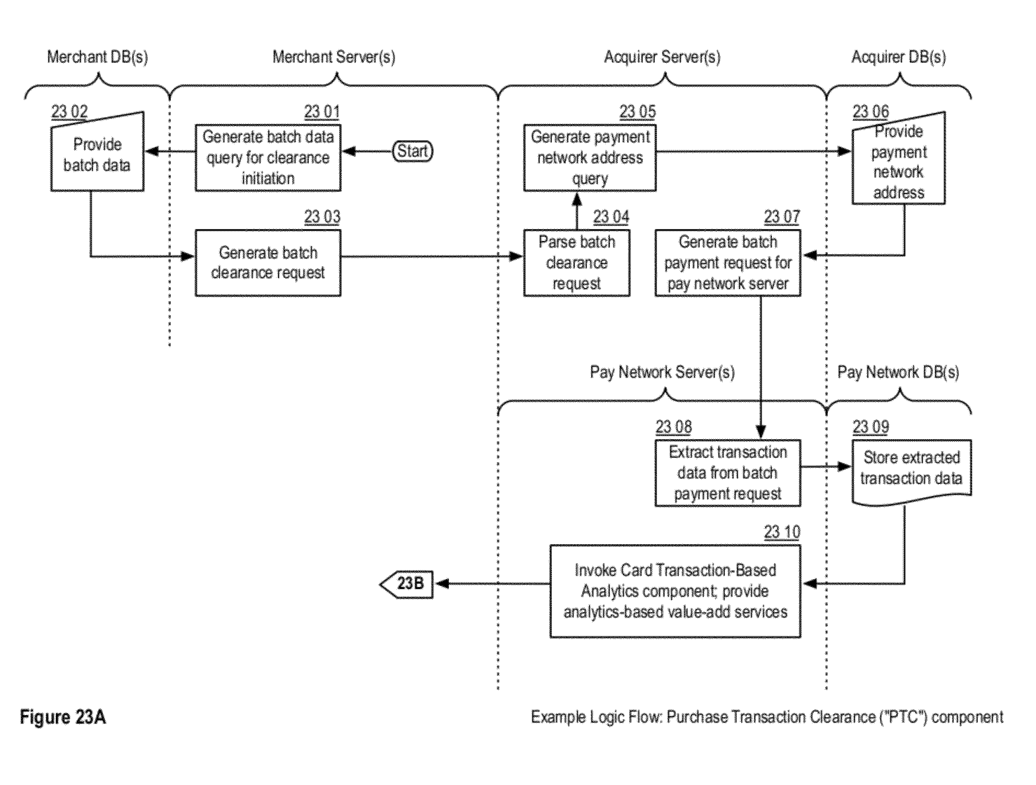

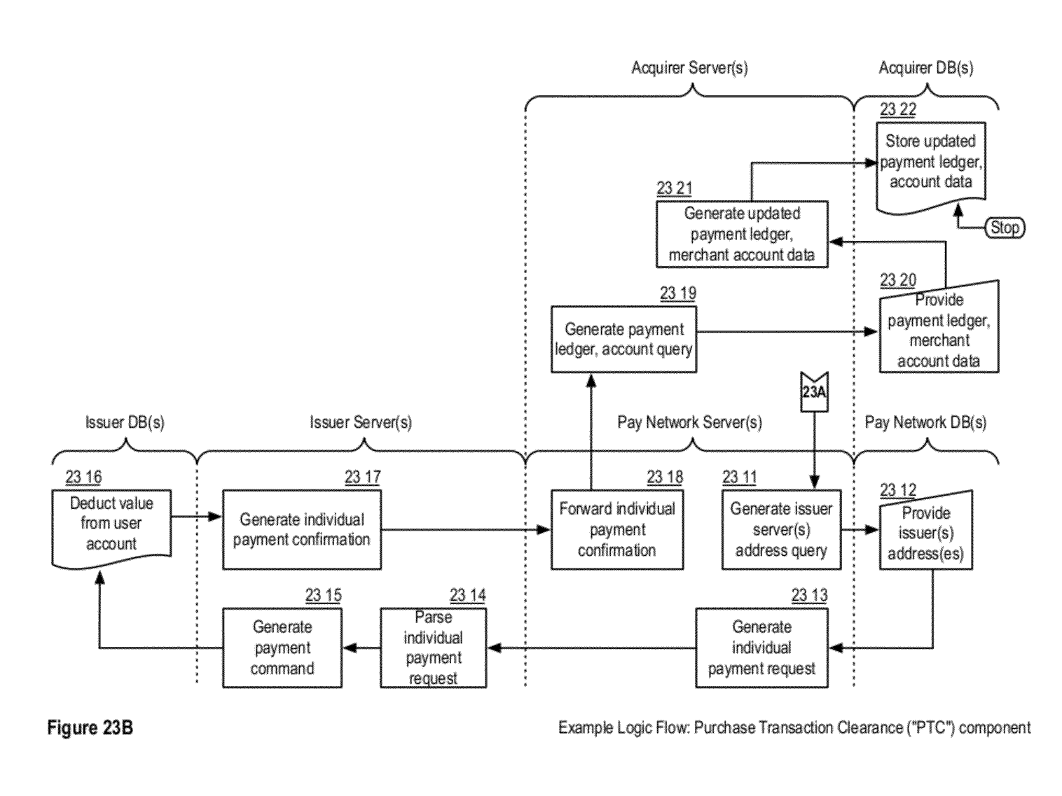

FIGS. 23A-B show logic flow diagrams illustrating example aspects of purchase transaction clearance in some embodiments of the H-Wallet, e.g., a Purchase Transaction Clearance (“PTC”) component 2300. With reference to FIG. 23A, in some embodiments, a merchant server may initiate clearance of a batch of authorized transactions. For example, the merchant server may generate a batch data request, e.g., 2301, and provide the request to a merchant database. In response to the batch data request, the database may provide the requested batch data, e.g., 2302. The server may generate a batch clearance request, e.g., 2303, using the batch data obtained from the database, and provide the batch clearance request to an acquirer server. The acquirer server may parse, e.g., 2304, the obtained batch clearance request, and generate, e.g., 2307, a batch payment request using the obtained batch clearance request to provide, the batch payment request to a healthcare collection portal server. For example, the acquirer server may query, e.g., 2305, an acquirer database for an address of a payment network server, and utilize the obtained address, e.g., 2306, to forward the generated batch payment request to the healthcare collection portal server.

The healthcare collection portal server may parse the batch payment request obtained from the acquirer server, and extract the transaction data for each transaction stored in the batch payment request, e.g., 2308. The healthcare collection portal server may store the transaction data, e.g., 2309, for each transaction in a healthcare collection portal database. In some embodiments, the healthcare collection portal server may invoke a component, e.g., 2310, to provide analytics based on the transactions of the merchant for whom purchase transaction are being cleared. For example, the healthcare collection portal server may invoke a component such as the example card transaction-based analytics component discussed above with reference to FIG. 10.

With reference to FIG. 23B, in some embodiments, for each extracted transaction, the healthcare collection portal server may query, e.g., 2311, a healthcare collection portal database for an address of an issuer server. The healthcare collection portal server may generate an individual payment request, e.g., 2313, for each transaction for which it has extracted transaction data, and provide the individual payment request to the issuer server. In some embodiments, the issuer server may parse the individual payment request, e.g., 2314, and generate a payment command, e.g., 2315, based on the parsed individual payment request. For example, the issuer server may issue a command to deduct funds from the user's account (or add a charge to the user's credit card account). The issuer server may issue a payment command, e.g., 2315, to a database storing the user's account information, e.g., a user profile database. The issuer server may provide an individual payment confirmation, e.g., 2317, to the healthcare collection portal server, which may forward, e.g., 2318, the individual payment confirmation to the acquirer server.

In some embodiments, the acquirer server may parse the individual payment confirmation, and correlate the transaction (e.g., using the request_ID field in the example above) to the merchant. The acquirer server may then transfer the funds specified in the funds transfer message to an account of the merchant. For example, the acquirer server may query, e.g. 2319, an acquirer database for payment ledger and/or merchant account data, e.g., 2320. The acquirer server may utilize payment ledger and/or merchant account data from the acquirer database, along with the individual payment confirmation, to generate updated payment ledger and/or merchant account data, e.g., 2321. The acquirer server may then store, e.g., 2322, the updated payment ledger and/or merchant account data to the acquire database.

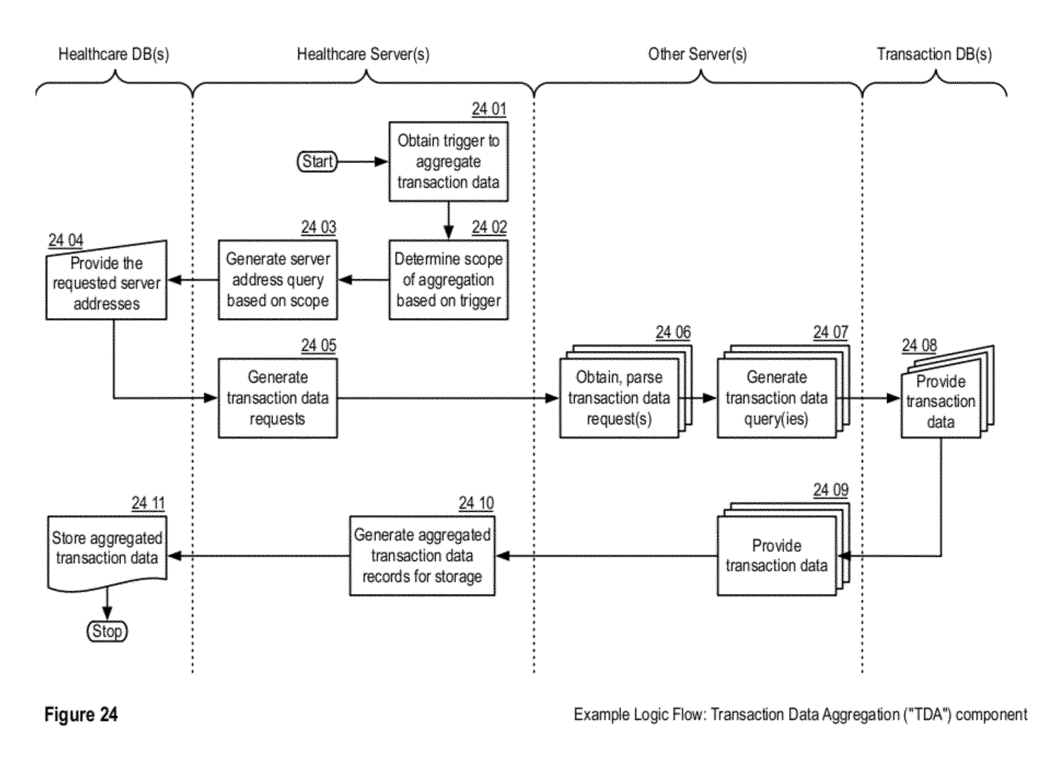

FIG. 24 shows a logic flow diagram illustrating example aspects of transaction data aggregation in some embodiments of the H-Wallet, e.g., a Transaction Data Aggregation (“TDA”) component. In some embodiments, a H-Wallet server may obtain a trigger to aggregate transaction data, e.g., 2401. For example, the server may be configured to initiate transaction data aggregation on a regular, periodic, or continuous basis. As another example, the server may be configured to initiate transaction data aggregation in real-time on-demand. The H-Wallet server may determine a scope of data aggregation desired to perform the transaction analytics, e.g., 2402. For example, the scope of data aggregation may be pre-determined. As another example, the scope of data aggregation may be determined based on a received request for analytics, in real-time. The H-Wallet server may initiate data aggregation based on the determined scope. The H-Wallet server may generate a query for addresses of servers storing transaction data within the determined scope, e.g., 2403. The H-Wallet server may query a database for addresses of other servers that may have stored transaction data within the determined scope of the data aggregation. The database may provide, e.g., 2404, a list of server addresses in response to the H-Wallet server's query. Based on the list of server addresses, the H-Wallet server may generate transaction data requests, e.g., 2405. The H-Wallet server may issue the generated transaction data requests to the other servers. The other servers may obtain and parse the transaction data requests, e.g., 2406. Based on parsing the data requests, the other servers may generate transaction data queries, e.g., 2407, and provide the transaction data queries to their transaction databases. In response to the transaction data queries, the transaction databases may provide transaction data, e.g., 2408, to the other servers. The other servers may return, e.g., 2409, the transaction data obtained from the transactions databases to the H-Wallet server making the transaction data requests. The H-Wallet server may generate aggregated transaction data records from the transaction data received from the other servers, e.g., 2410, and store the aggregated transaction data in a database, e.g., 2411.

FIG. 25 illustrates an exemplary open system payment processing network, depicting a general environment in which a merchant (m) 2510 can conduct a transaction for goods and/or services with an account user (au) or customer on an account (e.g., a prepaid account, credit account, points account, etc.) issued to an account holder (a) 2508 by an issuer (i) 2504, where the processes of paying and being paid for the transaction are coordinated by a transaction handler 2502. The transaction includes participation from different entities that are each a component of the payment processing system. As such, the open system payment processing network can be used by a patient (or agent thereof) to pay a healthcare service provider to who a balance due bill is owed as described above.

Payment processing system has a plurality of merchants 2510 that includes merchant (1) 2510 through merchant (M) 2510, where M can be up to and greater than an eight digit integer. Payment processing system has a plurality of accounts 2508 each of which is held by a corresponding account holder (1) 2508 through account holder (A) 2508, where A can be up to and greater than a ten eight digit integer.

Payment processing system includes account user (1) 2508 through account user (AU) 2508, where AU can be as large as a ten digit integer or larger. Each account user (au) may act as a customer and initiate a transaction for goods and/or services with merchant (m) 2510 using an account that has been issued by an issuer (i) 2504 to a corresponding account holder (a) 2508. Data from the transaction on the account is collected by merchant (m) and forwarded to a corresponding acquirer (a) 2506. Acquirer (a) 2506 forwards the data to transaction handler 2502 who facilitates payment for the transaction from the account issued by the issuer (i) 2504 to account holder (a) 2508.

Payment processing system has a plurality of issuers 2504. Each issuer (i) 2504 may be assisted in processing one or more transactions by a corresponding agent issuer (ai) 2504, where T can be an integer from 1 to I, where ‘ai’ can be an integer from to AI, and where I and AI can be as large as an eight digit integer or larger.

Payment processing system has a plurality of acquirers 2506. Each acquirer (q) 2506 may be assisted in processing one or more transactions by a corresponding agent acquirer (aq) 2504, where ‘q’ can be an integer from 1 to Q, where ‘aq’ can be an integer from 1 to AQ, and where Q and AQ can be as large as a eight digit integer or larger.

Payment processing system has a transaction handler 2502 to process a plurality of transactions. The transaction handler 2502 can include one or a plurality or networks and switches 2502. Each network/switch (ns) 2502 can be a mainframe computer in a geographic location different than each other network/switch (ns) 2502, where ‘ns’ is an integer from one to NS, and where NS can be as large as a four-digit integer or larger.

Dedicated communication systems 2568-2576 (e.g., private communication network(s)) facilitate communication between the transaction handler 2502 and each issuer (i) 2504 and each acquirer (a) 2506. The Internet 2512, via e-mail, the World Wide Web, cellular telephony, and/or other optional public and private communications systems, can facilitate communications using communication systems 2550-2566 among and between each issuer (i) 2504, each acquirer (a) 2506, each merchant (m) 2510, each account holder (a) 2508, and the transaction handler 2502. Alternatively and optionally, one or more dedicated communication systems 2550-2566 can facilitate respective communications between each acquirer (a) 2506 and each merchant (m) 2510, each merchant (m) and each account holder (a) 2508, and each account holder (a) 2508 and each issuer (i) 2504, respectively.

Each acquirer (q) 2506 may be assisted in processing one or more transactions by a corresponding agent acquirer (aq) 2504, where ‘q’ can be an integer from 1 to Q, where aq can be an integer from 1 to AQ, and where Q and AQ can be as large as a eight digit integer or larger.

Merchant (m) 2510 may be a person or entity that sells goods and/or services. Merchant (m) 2510 may also be, for instance, a healthcare service provider, a manufacturer, a distributor, a retailer, a load agent, a drugstore, a grocery store, a gas station, a hardware store, a supermarket, a boutique, a restaurant, or a doctor's office. In a business-to-business setting, the account holder (a) 2508 may be a second merchant making a purchase from another merchant (m) 2510. Merchant (m) 2510 may use at least one stationary and/or mobile point-of-sale terminal (POS) that can communicate with acquirer (a) 2506, transaction handler 2502, or issuer (i) 2504. Thus, the POS terminal is in operative communication with the payment processing system.

Typically, a transaction begins with account user (au) 2508 presenting a portable consumer device to merchant (m) 2510 to initiate an exchange for a good or service. The portable consumer device may be associated with an account (e.g., a monetary or reward points account) of account holder (a) 2508 that was issued to the account holder (a) 2508 by issuer (i) 2504.

The portable consumer device may be in a form factor that can be a payment card, a gift card, a smartcard, a smart media device, a payroll card, a healthcare card, a wrist band, a machine readable medium containing account information, a keychain device, such as a SPEEDPASS® device commercially available from ExxonMobil Corporation, or a supermarket discount card, a cellular phone, personal digital assistant, a pager, a security card, an access card, a wireless terminal, or a transponder. The portable consumer device may include a volatile or non-volatile memory to store information such as the account number or the name of an account holder (a) 2508.

Merchant (m) 2510 may use the POS terminal to obtain account information, such as a number of the account of the account holder (a) 2508, from the portable consumer device. The portable consumer device may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer (i) 2504 of the account corresponding to the portable consumer device. Alternatively, or in combination, the portable consumer device may communicate with issuer (i) 2504, transaction handler 2502, or acquirer (a) 2506.

Issuer (i) 2504 may authorize the transaction using transaction handler 2502. Transaction handler 2502 may also clear the transaction. Authorization includes issuer (i) 2504, or transaction handler 2502 on behalf of issuer (i) 2504, authorizing the transaction in connection with issuer (i) 2504's instructions such as through the use of business rules. The business rules could include instructions or guidelines from transaction handler 2502, account holder (a) 2508, merchant (m) 2510, acquirer (a) 2506, issuer (i) 2504, a related financial institution, or combinations thereof. Transaction handler 2502 may maintain a log or history of authorized transactions. Once approved, merchant (m) 2510 will record the authorization, allowing account user (au) 2508 to receive the good or service from merchant (m) or an agent thereof.

Merchant (m) 2510 may, at discrete periods, such as at the end of the day, submit a list of authorized transactions to acquirer (a) 2506 or other transaction related data for processing through the payment processing system. Transaction handler 2502 may compare the submitted authorized transaction list with its own log of authorized transactions. If a match is found, transaction handler 2502 may route authorization transaction amount requests from the corresponding acquirer (a) 2506 to the corresponding issuer (i) 2504 involved in each transaction. Once acquirer (a) 2506 receives the payment of the authorized transaction amount from issuer (i) 2504, acquirer (a) 2506 can forward the payment to merchant (m) 2510 less any transaction costs, such as fees for the processing of the transaction. If the transaction involves a debit or prepaid card, acquirer (a) 2506 may choose not to wait for the issuer (i) 2504 to forward the payment prior to paying merchant (m) 2510.

There may be intermittent steps in the foregoing process, some of which may occur simultaneously. For example, acquirer (a) 2506 can initiate the clearing and settling process, which can result in payment to acquirer (a) 2506 for the amount of the transaction. Acquirer (a) 2506 may request from transaction handler 2502 that the transaction be cleared and settled. Clearing includes the exchange of financial information between the issuer (i) 2504 and the acquirer (a) 2506 and settlement includes the exchange of funds. Transaction handler 2502 can provide services in connection with settlement of the transaction. The settlement of a transaction includes depositing an amount of the transaction settlement from a settlement house, such as a settlement bank, which transaction handler 2502 typically chooses, into a clearinghouse, such as a clearing bank, that acquirer (a) 2506 typically chooses. Issuer (i) 2504 deposits the same from a clearinghouse, such as a clearing bank, which issuer (i) 2504 typically chooses, into the settlement house. Thus, a typical transaction involves various entities to request, authorize, and fulfill processing the transaction.

Payment processing system will preferably have network components suitable for scaling the number and data payload size of transactions that can be authorized, cleared and settled in both real time and batch processing. These include hardware, software, data elements, and storage network devices for the same. Examples of payment processing system include those operated, at least in part, by American Express, Master Card, Discover Card, First Data Corporation, Diners Club, and Visa Inc., and agents of the foregoing.

Each network/switch (ns) 2502 can include one or more data centers for processing transactions, where each transaction can include up to 100 kilobytes of data or more. The data corresponding to the transaction can include information about the types and quantities of goods and services in the transaction, information about the account holder (a) 2508, the account user (au) 2508, the merchant (m) 2510, financial and incentive treatment(s) of the goods and services, coupons, rebates, rewards, loyalty, discounts, returns, exchanges, cash-back transactions, etc. Of course, in the case of the data corresponding to a healthcare-related transaction, the information would necessarily be limited with respect to the goods and services in the transaction as would be consistent with full regulatory compliance (e.g.; HIPAA compliance in the USA, the Personal Health Information Protection Act (PHIPA) in Canada, etc.)

By way of example, network/switch (ns) 2502 can include one or more mainframe computers (e.g., one or more IBM mainframe computers) for communications over systems 2568-2576, one or more server farms (e.g., one or more Sun UNIX Superservers), where the mainframe computers and server farms can be in diverse geographic locations.

Each issuer (i) 2504 (or agent issuer (ai) 2504 thereof) and each acquirer (a) 2506 (or agent acquirer (aq) 2506 thereof) can use one or more router/switch (e.g., Cisco routers/switches) to communicate with each network/switch (ns) 2502 via dedicated communication systems 2568-2576, respectively.

Transaction handler 2502 stores information about transactions processed through payment processing system in data warehouses such as may be incorporated as part of the plurality of networks/switches (ns) 2502. This information can be data mined. The data mining transaction research and modeling can be used for advertising, account holder and merchant loyalty incentives and rewards, fraud detection and prediction, and to develop tools to demonstrate savings and efficiencies made possible by use of the payment processing system over paying and being paid by cash, checks, or other traditional payment mechanisms.

The VisaNet® system is an example component of the transaction handler 2502 in the payment processing system. The open system payment processing network seen in FIG. 25 can be enabled via a telecommunications network that may make use of any suitable telecommunications network and may involve different hardware, different software and/or different protocols then those discussed below. FIG. 25 can be deemed to depict a global telecommunications network that supports purchase and cash transactions using any bankcard, travel and entertainment cards, and other private label and proprietary cards. The network also supports ATM transactions for other networks, transactions using paper checks, transactions using smart cards, virtual cards, and transactions using other financial instruments.

These transactions are processed through the network's authorization, clearing and settlement services. Authorization is when an issuer approves or declines a sales transaction before a purchase is finalized or cash is dispersed. Clearing is when a transaction is delivered from an acquirer to an issuer for posting to the customer's account. Settlement is the process of calculating and determining the net financial position of each member for all transactions that are cleared. The actual exchange of funds is a separate process.

Transactions can be authorized, cleared and settled as either a dual message or a single message transaction. A dual message transaction is sent twice—the first time with only information needed for an authorization decision, an again later with additional information for clearing and settlement. A single message transaction is sent once for authorization and contains clearing and settlement information as well. Typically, authorization, clearing and settlement all occur on-line.

FIG. 25 includes one or more transaction handlers 2502, access points 2530, 2532, acquirers 2506, and issuers 2504. Other entities such as payor banks and third party authorizing agents may also connect to the network through an access point. An interchange center is a data processing center that may be located anywhere in the world. In one embodiment, there are two in the United States and one each in the United Kingdom and in Japan. Each interchange center houses the computer system that performs the network transaction processing. The interchange center serves as the control point for the telecommunication facilities of the network, which comprise high speed leased lines or satellite connections based on IBM SNA protocol. Preferably, the communication lines that connect an interchange center (Transaction Handler 2502) to remote entities use dedicated high-bandwidth telephone circuits or satellite connections based on the IBM SNA-LUo communication protocol. Messages are sent over these lines using any suitable implementation of the ISO 8583 standard.

Access points 2530, 2532 are typically made up of small computer systems located at a processing center that interfaces between the center's host computer and the interchange center The access point facilitates the transmission of messages and files between the host and the interchange center supporting the authorization, clearing and settlement of transaction. Telecommunication links between the acquirer (q) 2506 and its access point 2532, and between the access point 2530 and issuer (i) 2504 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. Also, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

FIG. 26 illustrates an integrated payment system 2640 housed within an interchange center to provide on-line and off-line transaction processing within embodiments of the H-Wallet. For dual message transaction, authorization system 2642 provides authorization. Authorization system 2642 supports on-line and off-line functions, and its file includes internal systems tables, a customer database and a merchant central file. The on-line functions of system 2642 support dual message authorization processing. This processing involves routing, cardholder and card verification and stand-in processing, and other functions such as file maintenance. Off-line functions including reporting, billing, and generating recovery bulletins. Reporting includes authorization reports, exception file and advice file reports, POS reports and billing reports. A bridge from system 2642 to system 2646 makes it possible for members using system 542 to communicate with members using system 2646 and access the SMS gateways to outside networks.

Clearing and settlement system 2644 clears and settles previously authorized dual message transactions. Operating six days a week on a global basis, system 2644 collects financial and non-financial information and distributes reports between members It also calculates fees, charges and settlement totals and produces reports to help with reconciliation. A bridge forms an interchange between system 2644 processing centers and system 2646 processing centers.

Single message system 2646 processes full financial transactions. System 546 can also process dual message authorization and clearing transactions, and communicates with system 2642 using a bridge and accesses outside networks as required. System 2646 processes Visa, Plus Interlink and other card transactions. The SMS files comprise internal system tables that control system access and processing, and the cardholder database, which contains files of cardholder data used for PIN verification and stand-in processing authorization. System 2646 on-line functions perform real-time cardholder transaction processing and exception processing for authorization as well as full financial transactions. System 2646 also accumulates reconciliation and settlement totals. System 2646 off-line functions process settlement and funds transfer requests and provide settlement and activities reporting. Settlement service 548 consolidates the settlement functions of system 2644 and 2646, including Interlink, into a single service for all products and services. Clearing continues to be performed separately by system 2644 and system 2646.

### H-Wallet Controller

FIG. 27 shows a block diagram illustrating embodiments of a H-Wallet controller. In this embodiment, the H-Wallet controller 2701 may serve to aggregate, process, store, search, serve, identify, instruct, generate, match, and/or facilitate interactions with a computer through secure communication technologies, and/or other related data.

Typically, users, which may be people and/or other systems, may engage information technology systems (e.g., computers) to facilitate information processing. In turn, computers employ processors to process information; such processors 2703 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 2729 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the H-Wallet controller 2701 may be connected to and/or communicate with entities such as, but not limited to: one or more users from user input devices 2711; peripheral devices 2712; an optional cryptographic processor device 2728; and/or a communications network 2713.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The H-Wallet controller 2701 may be based on computer systems that may comprise, but are not limited to, components such as: a computer systemization 2702 connected to memory 2729.

### Computer Systemization

A computer systemization 2702 may comprise a clock 2730, central processing unit (“CPU(s)” and/or “processor(s)” (these terms are used interchangeable throughout the disclosure unless noted to the contrary)) 2703, a memory 2729 (e.g., a read only memory (ROM) 2706, a random access memory (RAM) 2705, etc.), and/or an interface bus 2707, and most frequently, although not necessarily, are all interconnected and/or communicating through a system bus 2704 on one or more (mother)board(s) 2702 having conductive and/or otherwise transportive circuit pathways through which instructions (e.g., binary encoded signals) may travel to effectuate communications, operations, storage, etc. The computer systemization may be connected to a power source 2786; e.g., optionally the power source may be internal. Optionally, a cryptographic processor 2726 and/or transceivers (e.g., ICs) 2774 may be connected to the system bus. In another embodiment, the cryptographic processor and/or transceivers may be connected as either internal and/or external peripheral devices 2712 via the interface bus I/O. In turn, the transceivers may be connected to antenna(s) 2775, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing H-Wallet controller to determine its location)); Broadcom BCM4329FKUBG transceiver chip (e.g., providing 802.11n, Bluetooth 8.1+EDR, FM, etc.); a Broadcom BCM4750IUB8 receiver chip (e.g., GPS); an Infineon Technologies X-Gold 618-PMB9800 (e.g., providing 8G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 2729 beyond the processor itself; internal memory may include, but is not limited to: fast registers, various levels of cache memory (e.g., level 1, 8, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the H-Wallet controller and beyond through various interfaces. Should processing requirements dictate a greater amount speed and/or capacity, distributed processors (e.g., Distributed H-Wallet), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the H-Wallet may be achieved by implementing a microcontroller such as CAST's R8051XC2 microcontroller; Intel's MCS 51 (i.e., 8051 microcontroller); and/or the like. Also, to implement certain features of the H-Wallet, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the H-Wallet component collection (distributed or otherwise) and/or features may be implemented via the microprocessor and/or via embedded components; e.g., via ASIC, coprocessor, DSP, FPGA, and/or the like. Alternately, some implementations of the H-Wallet may be implemented with embedded components that are configured and used to achieve a variety of features or signal processing.

Depending on the particular implementation, the embedded components may include software solutions, hardware solutions, and/or some combination of both hardware/software solutions. For example, H-Wallet features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the H-Wallet features. A hierarchy of programmable interconnects allow logic blocks to be interconnected as needed by the H-Wallet system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the H-Wallet may be developed on regular FPGAs and then migrated into a fixed version that more resembles ASIC implementations. Alternate or coordinating implementations may migrate H-Wallet controller features to a final ASIC instead of or in addition to FPGAs. Depending on the implementation all of the aforementioned embedded components and microprocessors may be considered the “CPU” and/or “processor” for the H-Wallet.

### Power Source

The power source 2786 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2786 is connected to at least one of the interconnected subsequent components of the H-Wallet thereby providing an electric current to all subsequent components. In one example, the power source 2786 is connected to the system bus component 2704. In an alternative embodiment, an outside power source 2786 is provided through a connection across the I/O 2708 interface. For example, a USB and/or IEEE 1394 connection carries both data and power across the connection and is therefore a suitable source of power.

### Interface Adapters

Interface bus(ses) 2707 may accept, connect, and/or communicate to a number of interface adapters, conventionally although not necessarily in the form of adapter cards, such as but not limited to: input output interfaces (I/O) 2708, storage interfaces 2709, network interfaces 2710, and/or the like. Optionally, cryptographic processor interfaces 2727 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2709 may accept, communicate, and/or connect to a number of storage devices such as, but not limited to: storage devices 2714, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2710 may accept, communicate, and/or connect to a communications network 2713. Through a communications network 2713, the H-Wallet controller is accessible through remote clients 2733b (e.g., computers with web browsers) by users 2733a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed H-Wallet), architectures may similarly be employed to pool, load balance, and/or otherwise increase the communicative bandwidth required by the H-Wallet controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2710 may be used to engage with various communications network types 2713. For example, multiple network interfaces may be employed to allow for the communication over broadcast, multicast, and/or unicast networks.

Input Output interfaces (I/O) 2708 may accept, communicate, and/or connect to user input devices 2711, peripheral devices 2712, cryptographic processor devices 2728, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 2711 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 2712 may be connected and/or communicate to I/O and/or other facilities of the like such as network interfaces, storage interfaces, directly to the interface bus, system bus, the CPU, and/or the like. Peripheral devices may be external, internal and/or part of the H-Wallet controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the H-Wallet controller may be embodied as an embedded, dedicated, and/or monitor-less (i.e., headless) device, wherein access would be provided over a network interface connection.

Cryptographic units such as, but not limited to, microcontrollers, processors 2726, interfaces 2727, and/or devices 2728 may be attached, and/or communicate with the H-Wallet controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 50 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 2729. However, memory is a fungible technology and resource, thus, any number of memory embodiments may be employed in lieu of or in concert with one another. It is to be understood that the H-Wallet controller and/or a computer systemization may employ various forms of memory 2729. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 2729 will include ROM 2706, RAM 2705, and a storage device 2714. A storage device 2714 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 2729 may contain a collection of program and/or database components and/or data such as, but not limited to: operating system component(s) 2715 (operating system); information server component(s) 2716 (information server); user interface component(s) 2717 (user interface); Web browser component(s) 2718 (Web browser); database(s) 2719; mail server component(s) 2721; mail client component(s) 2722; cryptographic server component(s) 2720 (cryptographic server); the H-Wallet component(s) 2735; and/or the like (i.e., collectively a component collection). These components may be stored and accessed from the storage devices and/or from storage devices accessible through an interface bus. Although non-conventional program components such as those in the component collection, typically, are stored in a local storage device 2714, they may also be loaded and/or stored in memory such as: peripheral devices, RAM, remote storage facilities through a communications network, ROM, various forms of memory, and/or the like.

### Operating System

The operating system component 2715 is an executable program component facilitating the operation of the H-Wallet controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 8000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the H-Wallet controller to communicate with other entities through a communications network 2713. Various communication protocols may be used by the H-Wallet controller as a subcarrier transport mechanism for interaction, such as, but not limited to: multicast, TCP/IP, UDP, unicast, and/or the like.

### Information Server

An information server component 2716 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the H-Wallet controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 81, and/or the like. An information server may communicate to and/or with other components in a component collection, including itself, and/or facilities of the like. Most frequently, the information server communicates with the H-Wallet database 2719, operating systems, other program components, user interfaces, Web browsers, and/or the like.

Access to the H-Wallet database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the H-Wallet. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the H-Wallet as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 8000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 2717 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2718 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the H-Wallet enabled nodes. The combined application may be nugatory on systems employing standard Web browsers.

### Mail Server

A mail server component 2721 is a stored program component that is executed by a CPU 2703. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the H-Wallet.

Access to the H-Wallet mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 2722 is a stored program component that is executed by a CPU 2703. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 2720 is a stored program component that is executed by a CPU 2703, cryptographic processor 2726, cryptographic processor interface 2727, cryptographic processor device 2728, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the H-Wallet may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the H-Wallet component to engage in secure transactions if so desired. The cryptographic component facilitates the secure accessing of resources on the H-Wallet and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The H-Wallet Database

The H-Wallet database component 2719 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the H-Wallet database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the H-Wallet database is implemented as a data-structure, the use of the H-Wallet database 2719 may be integrated into another component such as the H-Wallet component 2735. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2719 includes several tables 2719a-q. A Users table 2719a may include fields such as, but not limited to: user_id, applicant_id, firstname, lastname, address_line1, address_line2, dob, ssn, credit_check_flag, zipcode, city, state, account_params_list, account_mode, account_type, account_expiry, preferred_bank_name, preferred_branch_name, credit_report, and/or the like. The User table may support and/or track multiple entity accounts on a H-Wallet. A Clients table 2719b may include fields such as, but not limited to: client_ID, client_type, client_MAC, client_IP, presentation_format, pixel_count, resolution, screen_size, audio_fidelity, hardware_settings_list, software_compatibilities_list, installed_apps_list, and/or the like. An Apps table 2719c may include fields such as, but not limited to: app_ID, app_name, app_type, OS_compatibilities_list, version, timestamp, developer_ID, and/or the like. An Accounts table 2719d may include fields such as, but not limited to: user_id, account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Claims table 2719e may include fields such as, but not limited to: user_id, claim_id, timestamp claim_, snapshot_array, receipt_, process_sent_flag, process_clear_flag, and/or the like. An Issuers table 2719f may include fields such as, but not limited to: account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, issuer_id, issuer_name, issuer_address, ip_address, mac_address, auth_key, port_num, security settings_list, and/or the like. A Merchants table 2719g may include fields such as, but not limited to: merchant_id, merchant_name, provi merchant_address, ip_address, mac_address, auth_key, port_num, security_settings_list, and/or the like. An Acquirers table 2719h may include fields such as, but not limited to: account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Transactions table 2719i may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, rebate_ID, rebate_amount, rebate_user, rebate_sponsor, social_payment_id, and/or the like. A Batches table 2719j may include fields such as, but not limited to: applicant_firstname, applicant_lastname, applicant_address_line1, applicant_address_line2, consumer_bureau data_list, consumer_bureau_data, applicant_clear_flag, credit_limit, credit_score, account_balances, delinquency_flag, quality_flags, batch_id, transaction_id_list, timestamp_list, cleared_flag_list, clearance_trigger settings, and/or the like. A Ledgers table 2719k may include fields such as, but not limited to: request_id, timestamp, deposit_amount, batch_id, transaction_id, clear_flag, deposit_account, transaction_summary, payor_name, payor_account, and/or the like. An Insurance Provider table 27191 may include fields such as, but not limited to InsuranceID, InsuranceName, InsuranceProgram, InsuranceBlN, InsuranceCoverageTable, InsuranceVeriCode, InsuranceAuthorization, and/or the like. A Healthcare Provider table 2719m may include fields such as, but not limited to HealthProviderID, HealthProviderName, HealthProviderZipcode, HealthProviderProcedureCode, HealthProviderClaimCode, HealthProviderPricingList, and/or the like. A medical products/services table 2719n may include fields such as, but not limited to authorizedMedProductID, authorizedMedServiceID, ProductCode, ServiceProcedureCode, HealthProviderID, InsuranceID, InsuranceCoverageRate, PricingRate, and/or the like. A Rebate table 27190 may include fields such as, but not limited to rebate_id, rebate_user, rebate_transaction_id, rebate_amount, rebate_sponsor, rebate_date, rebate_healthcare_provider, rebate_procedure_code, rebate_account, and/or the like. A Social Group table 2719p may include fields such as, but not limited to social_user_id, social_group_id, social_network_id, social_media_id, social_connection_id, social_group_message, social_group_bill, social_group_payment, social_content, and/or the like. A Social Network table 2719q may include fields such as, but not limited to social_network_id, social_media_name, social_media_url, social_user_id, social_user_login, social_user_password, social_user_name, social_user_address, social_user_payment_id, social_user_group_id, social_user_content, and/or the like.

In one embodiment, the H-Wallet database may interact with other database systems. For example, employing a distributed database system, queries and data access by search H-Wallet component may treat the combination of the H-Wallet database, an integrated data security layer database as a single database entity.

In one embodiment, user programs may contain various user interface primitives, which may serve to update the H-Wallet. Also, various accounts may require custom database tables depending upon the environments and the types of clients the H-Wallet may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2719a-n. The H-Wallet may be configured to keep track of various settings, inputs, and parameters via database controllers.

The H-Wallet database may communicate to and/or with other components in a component collection, including itself, and/or facilities of the like. Most frequently, the H-Wallet database communicates with the H-Wallet component, other program components, and/or the like. The database may contain, retain, and provide information regarding other nodes and data.

### The H-Wallets

The H-Wallet component 2735 is a stored program component that is executed by a CPU. In one embodiment, the H-Wallet component incorporates any and/or all combinations of the aspects of the H-Wallet that was discussed in the previous figures. As such, the H-Wallet affects accessing, obtaining and the provision of information, services, transactions, and/or the like across various communications networks.

The H-Wallet transforms patient insurance information, and healthcare procedure schedule information inputs via H-Wallet components such as user enrollment component 2742 (e.g., FIGS. 4A-4B), card processing component 2743 (e.g., see FIGS. 20A-24), insurance authorization/adjudication component 2744 (e.g., see FIGS. 2A and 3A-3C), collection portal component 2745 (e.g., see FIGS. 7A-8B), adjudication/reconciliation component 1046 (e.g., see FIGS. 16-17C), healthcare incentive component 2747 (e.g., see FIGS. 6A-6D), PPT/HPT component 2749 (e.g., see FIGS. 11A-11C), WSS component 2750 (e.g., see FIGS. 12A-12B), PTA component 2751 (e.g., see FIGS. 21A-21B), PTC component 2752 (e.g., see FIGS. 23A-23B), TDA component 2753 (e.g., see FIG. 424) and/or the like into medical claim settlement and payment outputs (e.g., see 236 in FIG. 2A, 451/452 in FIG. 4A; 626 in FIG. 6A; 716 in FIG. 7A, and/or the like).

The H-Wallet component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools, Prototype; script.aculo.us, Simple Object Access Protocol (SOAP); SWFObject; Yahoo! User Interface; and/or the like), WebObjects, and/or the like. In one embodiment, the H-Wallet server employs a cryptographic server to encrypt and decrypt communications. The H-Wallet component may communicate to and/or with other components in a component collection, including itself, and/or facilities of the like. Most frequently, the H-Wallet component communicates with the H-Wallet database, operating systems, other program components, and/or the like. The H-Wallet may contain, communicate, generate, obtain, and/or provide program component, system, user, and/or data communications, requests, and/or responses.

### Distributed H-Wallets

The structure and/or operation of any of the H-Wallet node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the H-Wallet controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the H-Wallet controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 855;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {

$input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password); //
access database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm.IBMDI.
doc/referenceguide295.htm

and other parser implementations:

http://publib.boulder.ibm.com/infocenter/tivihelp/v2r1/index.jsp?topic=/com.ibm.IBMDI.
doc/referenceguide259.htm

all of which are hereby expressly incorporated by reference.

Additional Implementations of the H-Wallet may include:

1. A processor-implemented healthcare user payment method, comprising:

obtaining a user healthcare payment request including user credentials;

retrieving healthcare product details and a payment amount from the user healthcare payment request;

obtaining balance information of a plurality of user accounts;

determining a recommended account for the obtained user healthcare payment request based on the retrieved healthcare product details, payment amount and the obtained balance information;

transmitting a list of user accounts including the recommended account with the obtained balance information to a user mobile device;

receiving a user selection of a payment account from said list of user accounts;

verifying payment eligibility of the payment account for the obtained payment request; and

processing fund transfer from the payment account to a healthcare provider.

2. The method of embodiment 1, wherein the user healthcare payment request is received via a user electronic wallet instantiated on the user mobile device.

3. The method of embodiment 1, wherein the user credentials include a user name and a password.

4. The method of embodiment 1, wherein the user healthcare payment request is received from a healthcare provider point of sale terminal.

5. The method of embodiment 1, wherein the healthcare product details include a healthcare procedure code.

6. The method of embodiment 1, wherein the healthcare product details include a product category.

7. The method of embodiment 1, wherein the payment amount is provided in a medical bill generated by the healthcare provider.

8. The method of embodiment 1, wherein the obtaining balance information comprises:

transmitting an access request to an account manager, said access request including a secure token; and

receiving balance information from the account manager upon verification of the secure token.

9. The method of embodiment 1, wherein the user accounts comprises any of a credit card account, a debit account, and an investment account.

10. The method of embodiment 1, wherein the user accounts comprises a restricted use account.

ii. The method of embodiment 10, wherein the restricted use account comprises any of: a Flexible Spending Account (FSA), and a Health Savings Accounts (HSA).

12. The method of embodiment 1, wherein the restricted use account comprises one or more government sponsored accounts, including any of Medicare and Medicaid.

13. The method of embodiment 1, wherein the restricted use account comprises an employer sponsored healthcare benefit account.

14. The method of embodiment 1, further comprising: determining whether the retrieved healthcare product details are eligible for a restricted use account.

15. The method of embodiment 1, further comprising: determining whether there is sufficient balance on the user selected account to fulfill the payment amount.

16. The method of embodiment 1, further comprising: providing a prioritized list of payment accounts showing the recommended account placed on top of the list.

17. The method of embodiment 1, further comprising:

receiving an approval from a restricted use account sponsor when the healthcare product details comply with restricted use account rules.

18. The method of embodiment 1, further comprising:

receiving multiple user selected accounts for the payment request and a user entered split payment amount associated with each of the multiple user selected accounts.

19. The method of embodiment 1, further comprising:

determining a second account when the payment request is not eligible for the recommended account.

20. The method of embodiment 1, further comprising:

retrieving a list of restricted use rules associated with the recommended account.

21. A healthcare user payment system, comprising:

a memory;

a processor disposed in communication with said memory, and configured to issue a plurality of processing instructions stored in the memory, wherein the processor issues instructions to:

obtain a user healthcare payment request including user credentials;

retrieve healthcare product details and a payment amount from the user healthcare payment request;

obtain balance information of a plurality of user accounts;

determine a recommended account for the obtained user healthcare payment request based on the retrieved healthcare product details, payment amount and the obtained balance information;

transmit a list of user accounts including the recommended account with the obtained balance information to a user mobile device;

receive a user selection of a payment account from said list of user accounts;

verify payment eligibility of the payment account for the obtained payment request; and

process fund transfer from the payment account to a healthcare provider.

22. The system of embodiment 21, wherein the user healthcare payment request is received via a user electronic wallet instantiated on the user mobile device.

23. The system of embodiment 21, wherein the user credentials include a user name and a password.

24. The system of embodiment 21, wherein the user healthcare payment request is received from a healthcare provider point of sale terminal.

25. The system of embodiment 21, wherein the healthcare product details include a healthcare procedure code.

26. The system of embodiment 21, wherein the healthcare product details include a product category.

27. The system of embodiment 21, wherein the payment amount is provided in a medical bill generated by the healthcare provider.

28. The system of embodiment 21, wherein the obtaining balance information comprises:

transmitting an access request to an account manager, said access request including a secure token; and

receiving balance information from the account manager upon verification of the secure token.

29. The system of embodiment 21, wherein the user accounts comprises any of a credit card account, a debit account, and an investment account.

30. The system of embodiment 21, wherein the user accounts comprises a restricted use account.

31. The system of embodiment 30, wherein the restricted use account comprises any of: a Flexible Spending Account (FSA), and a Health Savings Accounts (HSA).

32. The system of embodiment 31, wherein the restricted use account comprises one or more government sponsored accounts, including any of Medicare and Medicaid.

33. The system of embodiment 30, wherein the restricted use account comprises an employer sponsored healthcare benefit account.

34. The system of embodiment 21, wherein the processor further issues instructions for: determining whether the retrieved healthcare product details are eligible for a restricted use account.

35. The system of embodiment 21, wherein the processor further issues instructions for: determining whether there is sufficient balance on the user selected account to fulfill the payment amount.

36. The system of embodiment 21, wherein the processor further issues instructions for: providing a prioritized list of payment accounts showing the recommended account placed on top of the list.

37. The system of embodiment 21, wherein the processor further issues instructions for:

receiving an approval from a restricted use account sponsor when the healthcare product details comply with restricted use account rules.

38. The system of embodiment 21, wherein the processor further issues instructions for:

receiving multiple user selected accounts for the payment request and a user entered split payment amount associated with each of the multiple user selected accounts.

39. The system of embodiment 21, wherein the processor further issues instructions for:

determining a second account when the payment request is not eligible for the recommended account.

40. The system of embodiment 21, wherein the processor further issues instructions for:

retrieving a list of restricted use rules associated with the recommended account.

41. A healthcare user payment processor-readable storage medium storing processor-executable instructions to:

obtain a user healthcare payment request including user credentials;

retrieve healthcare product details and a payment amount from the user healthcare payment request;

obtain balance information of a plurality of user accounts;

determine a recommended account for the obtained user healthcare payment request based on the retrieved healthcare product details, payment amount and the obtained balance information;

transmit a list of user accounts including the recommended account with the obtained balance information to a user mobile device;

receive a user selection of a payment account from said list of user accounts;

verify payment eligibility of the payment account for the obtained payment request; and

process fund transfer from the payment account to a healthcare provider.

42. The medium of embodiment 41, wherein the user healthcare payment request is received via a user electronic wallet instantiated on the user mobile device.

43. The medium of embodiment 41, wherein the user credentials include a user name and a password.

44. The medium of embodiment 41, wherein the user healthcare payment request is received from a healthcare provider point of sale terminal.

45. The medium of embodiment 41, wherein the healthcare product details include a healthcare procedure code.

46. The medium of embodiment 41, wherein the healthcare product details include a product category.

47. The medium of embodiment 41, wherein the payment amount is provided in a medical bill generated by the healthcare provider.

48. The medium of embodiment 41, wherein the obtaining balance information comprises:

transmitting an access request to an account manager, said access request including a secure token; and

receiving balance information from the account manager upon verification of the secure token.

49. The medium of embodiment 41, wherein the user accounts comprises any of a credit card account, a debit account, and an investment account.

50. The medium of embodiment 41, wherein the user accounts comprises a restricted use account.

51. The medium of embodiment 41, wherein the restricted use account comprises any of: a Flexible Spending Account (FSA), a Health Savings Accounts (HSA).

52. The medium of embodiment 51, wherein the restricted use account comprises one or more government sponsored accounts, including any of Medicare and Medicaid.

53. The medium of embodiment 51, wherein the restricted use account comprises an employer sponsored healthcare benefit account.

54. The medium of embodiment 51, further storing processor-executable instructions for: determining whether the retrieved healthcare product details are eligible for a restricted use account.

55. The medium of embodiment 41, further storing processor-executable instructions for: determining whether there is sufficient balance on the user selected account to fulfill the payment amount.

56. The medium of embodiment 41, further storing processor-executable instructions for: providing a prioritized list of payment accounts showing the recommended account placed on top of the list.

57. The medium of embodiment 41, further storing processor-executable instructions for:

receiving an approval from a restricted use account sponsor when the healthcare product details comply with restricted use account rules.

58. The medium of embodiment 41, further storing processor-executable instructions for:

receiving multiple user selected accounts for the payment request and a user entered split payment amount associated with each of the multiple user selected accounts.

59. The medium of embodiment 41, further storing processor-executable instructions for:

determining a second account when the payment request is not eligible for the recommended account.

60. The medium of embodiment 41, further storing processor-executable instructions for:

retrieving a list of restricted use rules associated with the recommended account.

61. A healthcare incentive processor-implemented method, comprising:

receiving an indication of healthcare service interest from a user;

querying for a healthcare provider based on the indication of healthcare service interest;

obtaining a cost estimate of the healthcare service for the healthcare provider;

obtaining a reward amount based on the cost estimate;

providing the healthcare provider to the user as a recommended provider;

receiving a user redemption request including healthcare payment information related to healthcare service performed at the healthcare provider;

verifying the healthcare payment information related to healthcare service performed at the healthcare provider; and

providing the reward amount to the user.

62. The method of embodiment 61, wherein the indication of healthcare service interest comprises a procedure code.

62. The method of embodiment 61, wherein the indication of healthcare service interest is provided to a healthcare incentive sponsor.

63. The method of embodiment 62, wherein the healthcare incentive sponsor comprises an insurance provider.

64. The method of embodiment 63, wherein the healthcare incentive sponsor comprises an employer.

65. The method of embodiment 61, wherein the querying for the healthcare provider comprises forming a query on a database of healthcare providers for healthcare providers that are eligible for providing the indicated healthcare service.

66. The method of embodiment 61, further comprising:

generating an inquiry to the healthcare provider for pricing estimate.

67. The method of embodiment 61, wherein the cost estimate comprises additional travel cost factors.

68. The method of embodiment 67, wherein the additional travel cost factors comprise any of flight tickets, living expenses, and meals.

69. The method of embodiment 61, further comprising:

determining a cost estimate for a local healthcare provider.

70. The method of embodiment 69, further comprising:

comparing the determined cost estimated for the local healthcare provider with the obtained cost estimate of the healthcare provider.

71. The method of embodiment 61, wherein the healthcare provider is an international healthcare provider.

72. The method of embodiment 70, further comprising:

generating a reward value based on a difference between the determined cost estimated for the local healthcare provider with the obtained cost estimate of the healthcare provider.

73. The method of embodiment 61, further comprising:

pre-loading an amount to a user's prepaid card after obtaining the cost estimate.

74. The method of embodiment 73, wherein the pre-loaded amount is calculated based on an estimated of user co-pay and travel expenses.

75. The method of embodiment 61, wherein the verified healthcare payment information related comprises a healthcare provider name.

76. The method of embodiment 61, wherein the verified healthcare payment information related comprises a procedure code.

77. The method of embodiment 61, wherein the reward amount is issued to the user if the healthcare payment information matches the provided healthcare provider.

78. The method of embodiment 61, wherein the reward amount is transferred to a user's restricted use healthcare account.

79. The method of embodiment 78, wherein the user's restricted use healthcare account comprises any of a flexible spending account, healthcare spending account, and line of credit.

80. The method of embodiment 61, wherein the reward amount comprises any of loyalty points, offers and discounts.

81. A healthcare incentive system, comprising:

a memory;

a processor disposed in communication with said memory, and configured to issue a plurality of processing instructions stored in the memory, wherein the processor issues instructions to:

receive an indication of healthcare service interest from a user;

query for a healthcare provider based on the indication of healthcare service interest;

obtain a cost estimate of the healthcare service for the healthcare provider;

obtain a reward amount based on the cost estimate;

provide the healthcare provider to the user as a recommended provider;

receive a user redemption request including healthcare payment information related to healthcare service performed at the healthcare provider;

verify the healthcare payment information related to healthcare service performed at the healthcare provider; and

provide the reward amount to the user.

82. The system of embodiment 81, wherein the indication of healthcare service interest comprises a procedure code.

82. The system of embodiment 81, wherein the indication of healthcare service interest is provided to a healthcare incentive sponsor.

83. The system of embodiment 82, wherein the healthcare incentive sponsor comprises an insurance provider.

84. The system of embodiment 83, wherein the healthcare incentive sponsor comprises an employer.

85. The system of embodiment 81, wherein the querying for the healthcare provider comprises forming a query on a database of healthcare providers for healthcare providers that are eligible for providing the indicated healthcare service.

86. The system of embodiment 81, wherein the processor further issues instructions for: generating an inquiry to the healthcare provider for pricing estimate.

87. The system of embodiment 81, wherein the cost estimate comprises additional travel cost factors.

88. The system of embodiment 87, wherein the additional travel cost factors comprise any of flight tickets, living expenses, and meals.

89. The system of embodiment 81, wherein the processor further issues instructions for:

determining a cost estimate for a local healthcare provider.

90. The system of embodiment 89, wherein the processor further issues instructions for:

comparing the determined cost estimated for the local healthcare provider with the obtained cost estimate of the healthcare provider.

91. The system of embodiment 81, wherein the healthcare provider is an international healthcare provider.

92. The system of embodiment 90, wherein the processor further issues instructions for:

generating a reward value based on a difference between the determined cost estimated for the local healthcare provider with the obtained cost estimate of the healthcare provider.

93. The system of embodiment 81, wherein the processor further issues instructions for: pre-loading an amount to a user's prepaid card after obtaining the cost estimate.

94. The system of embodiment 93, wherein the pre-loaded amount is calculated based on an estimated of user co-pay and travel expenses.

95. The system of embodiment 81, wherein the verified healthcare payment information related comprises a healthcare provider name.

96. The system of embodiment 81, wherein the verified healthcare payment information related comprises a procedure code.

97. The system of embodiment 81, wherein the reward amount is issued to the user if the healthcare payment information matches the provided healthcare provider.

98. The system of embodiment 81, wherein the reward amount is transferred to a user's restricted use healthcare account.

99. The system of embodiment 98, wherein the user's restricted use healthcare account comprises any of a flexible spending account, healthcare spending account, and line of credit.

100. The system of embodiment 81, wherein the reward amount comprises any of loyalty points, offers and discounts.

101. A healthcare incentive processor-readable medium storing processor-executable instructions executable by a processor to:

receive an indication of healthcare service interest from a user;

query for a healthcare provider based on the indication of healthcare service interest;

obtain a cost estimate of the healthcare service for the healthcare provider;

obtain a reward amount based on the cost estimate;

provide the healthcare provider to the user as a recommended provider;

receive a user redemption request including healthcare payment information related to healthcare service performed at the healthcare provider;

verify the healthcare payment information related to healthcare service performed at the healthcare provider; and

provide the reward amount to the user.

102. The medium of embodiment 101, wherein the indication of healthcare service interest comprises a procedure code.

102. The medium of embodiment 101, wherein the indication of healthcare service interest is provided to a healthcare incentive sponsor.

103. The medium of embodiment 102, wherein the healthcare incentive sponsor comprises an insurance provider.

104. The medium of embodiment 103, wherein the healthcare incentive sponsor comprises an employer.

105. The medium of embodiment 101, wherein the querying for the healthcare provider comprises forming a query on a database of healthcare providers for healthcare providers that are eligible for providing the indicated healthcare service.

106. The medium of embodiment 101, further storing processor-executable instructions for:

generating an inquiry to the healthcare provider for pricing estimate.

107. The medium of embodiment 101, wherein the cost estimate comprises additional travel cost factors.

108. The medium of embodiment 107, wherein the additional travel cost factors comprise any of flight tickets, living expenses, and meals.

109. The medium of embodiment 101, further storing processor-executable instructions for:

determining a cost estimate for a local healthcare provider.

110. The medium of embodiment 109, further storing processor-executable instructions for:

comparing the determined cost estimated for the local healthcare provider with the obtained cost estimate of the healthcare provider.

111. The medium of embodiment 101, wherein the healthcare provider is an international healthcare provider.

112. The medium of embodiment 110, further storing processor-executable instructions for:

generating a reward value based on a difference between the determined cost estimated for the local healthcare provider with the obtained cost estimate of the healthcare provider.

113. The medium of embodiment 101, further storing processor-executable instructions for:

pre-loading an amount to a user's prepaid card after obtaining the cost estimate.

114. The medium of embodiment 113, wherein the pre-loaded amount is calculated based on an estimated of user co-pay and travel expenses.

115. The medium of embodiment 101, wherein the verified healthcare payment information related comprises a healthcare provider name.

116. The medium of embodiment 101, wherein the verified healthcare payment information related comprises a procedure code.

117. The medium of embodiment 101, wherein the reward amount is issued to the user if the healthcare payment information matches the provided healthcare provider.

118. The medium of embodiment 101, wherein the reward amount is transferred to a user's restricted use healthcare account.

119. The medium of embodiment 118, wherein the user's restricted use healthcare account comprises any of a flexible spending account, healthcare spending account, and line of credit.

120. The medium of embodiment 81, wherein the reward amount comprises any of loyalty points, offers and discounts.

121. A healthcare payment collection portal processor-implemented method, comprising:

obtaining a healthcare payment bill from a healthcare provider;

determining a user responsible amount based on the obtained healthcare payment bill;

facilitating transmission of a user payment request via a healthcare collection portal;

obtaining a user payment initiation trigger from the healthcare collection portal;

verifying user credentials associated with the user payment initiation trigger;

identifying, via a processor, a healthcare payment command within the user payment initiation trigger; and

initiating a funds payment transaction based on the identified healthcare payment command.

122. The method of embodiment 121, wherein the healthcare payment bill is obtained at a server.

123. The method of embodiment 121, wherein the healthcare collection portal comprises a social media platform.

124. The method of embodiment 121, wherein the user payment request comprises a secure social media message.

125. The method of embodiment 121, wherein the transmission of a user payment request is approved by user enrollment.

126. The method of embodiment 121, wherein the user payment initiation trigger comprises a user communication message generated from the healthcare collection portal.

127. The method of embodiment 121, wherein the user payment initiation trigger comprises user social data.

128. The method of embodiment 127, wherein the identifying the healthcare payment command includes:

parsing the user social data;

extracting a social pay command string within the user social data; and

determining a payor identifier, a payee identifier, and a payment amount using the social pay command string.

129. The method of embodiment 128, further comprising:

querying a database for an identifier of a funds account using the payee identifier;

determining, based on querying the database, that a payee associated with the payee identifier should be enrolled in social pay services; and

providing a request to enroll in social pay services.

130. The method of embodiment 121, further comprising:

analyzing the healthcare payment command to determine whether the funds payment transaction should be initiated;

determining that payment verification is required from a payee of the funds payment transaction; and

generating a payment verification request using the healthcare payment command; and

providing the payment verification request.

131. The method of embodiment 121, further comprising:

analyzing the healthcare payment command to determine whether the funds payment transaction should be initiated;

determining that the healthcare payment command is a fraudulent transaction attempt; and

providing a notification to terminate the funds payment transaction.

132. The method of embodiment 121, further comprising:

determining that the healthcare payment command is a request for payment; and

providing an indication of the request for payment for display within a virtual wallet application.

133. The method of embodiment 132, further comprising:

obtaining permission to initiate the funds payment transaction, in response to the provided indication of the request for payment for display within the virtual wallet application; and

wherein the funds payment transaction is initiated in response to obtaining the permission to initiate it.

134. The method of embodiment 121, wherein the healthcare payment collection portal comprises a calling center.

135. The method of embodiment 121, wherein the healthcare payment collection portal comprises an online bill pay website.

136. The method of embodiment 121, wherein the healthcare payment collection portal provides a communication component for financial transaction with a financial network.

137. The method of embodiment 121, wherein the user credentials comprises a security token.

138. The method of embodiment 121, wherein the user credentials comprises a username and a password.

139. The method of embodiment 121, wherein the healthcare payment collection portal comprises a profile of a healthcare provider.

140. The method of embodiment 139, wherein the healthcare provider is required to enroll with the healthcare payment collection portal.

141. A healthcare payment collection portal system, comprising:

a memory;

a processor disposed in communication with said memory, and configured to issue a plurality of processing instructions stored in the memory, wherein the processor issues instructions to:

obtain a healthcare payment bill from a healthcare provider;

determine a user responsible amount based on the obtained healthcare payment bill;

facilitate transmission of a user payment request via a healthcare collection portal;

obtain a user payment initiation trigger from the healthcare collection portal;

verify user credentials associated with the user payment initiation trigger;

identify a healthcare payment command within the user payment initiation trigger; and

initiate a funds payment transaction based on the identified healthcare payment command.

142. The system of embodiment 141, wherein the healthcare payment bill is obtained at a server.

143. The system of embodiment 141, wherein the healthcare collection portal comprises a social media platform.

144. The system of embodiment 141, wherein the user payment request comprises a secure social media message.

145. The system of embodiment 141, wherein the transmission of a user payment request is approved by user enrollment.

146. The system of embodiment 141, wherein the user payment initiation trigger comprises a user communication message generated from the healthcare collection portal.

147. The system of embodiment 141, wherein the user payment initiation trigger comprises user social data.

148. The system of embodiment 147, wherein the identifying the healthcare payment command includes:

parsing the user social data;

extracting a social pay command string within the user social data; and

determining a payor identifier, a payee identifier, and a payment amount using the social pay command string.

149. The system of embodiment 148, wherein the processor further issues instructions for:

querying a database for an identifier of a funds account using the payee identifier;

determining, based on querying the database, that a payee associated with the payee identifier should be enrolled in social pay services; and

providing a request to enroll in social pay services.

150. The system of embodiment 141, wherein the processor further issues instructions for:

analyzing the healthcare payment command to determine whether the funds payment transaction should be initiated;

determining that payment verification is required from a payee of the funds payment transaction; and

generating a payment verification request using the healthcare payment command; and

providing the payment verification request.

151. The system of embodiment 141, wherein the processor further issues instructions for:

analyzing the healthcare payment command to determine whether the funds payment transaction should be initiated;

determining that the healthcare payment command is a fraudulent transaction attempt; and

providing a notification to terminate the funds payment transaction.

152. The system of embodiment 141, wherein the processor further issues instructions for:

determining that the healthcare payment command is a request for payment; and

providing an indication of the request for payment for display within a virtual wallet application.

153. The system of embodiment 152, wherein the processor further issues instructions for:

obtaining permission to initiate the funds payment transaction, in response to the provided indication of the request for payment for display within the virtual wallet application; and

wherein the funds payment transaction is initiated in response to obtaining the permission to initiate it.

154. The system of embodiment 141, wherein the healthcare payment collection portal comprises a calling center.

155. The system of embodiment 141, wherein the healthcare payment collection portal comprises an online bill pay website.

156. The system of embodiment 141, wherein the healthcare payment collection portal provides a communication component for financial transaction with a financial network.

157. The system of embodiment 141, wherein the user credentials comprises a security token.

158. The system of embodiment 141, wherein the user credentials comprises a username and a password.

159. The system of embodiment 141, wherein the healthcare payment collection portal comprises a profile of a healthcare provider.

160. The system of embodiment 159, wherein the healthcare provider is required to enroll with the healthcare payment collection portal.

161. A healthcare payment collection portal processor-readable medium storing processor-executable instructions executable by a processor to:

obtain a healthcare payment bill from a healthcare provider;

determine a user responsible amount based on the obtained healthcare payment bill;

facilitate transmission of a user payment request via a healthcare collection portal;

obtain a user payment initiation trigger from the healthcare collection portal;

verify user credentials associated with the user payment initiation trigger;

identify a healthcare payment command within the user payment initiation trigger; and

initiate a funds payment transaction based on the identified healthcare payment command.

162. The medium of embodiment 161, wherein the healthcare payment bill is obtained at a server.

163. The medium of embodiment 161, wherein the healthcare collection portal comprises a social media platform.

164. The medium of embodiment 161, wherein the user payment request comprises a secure social media message.

165. The medium of embodiment 161, wherein the transmission of a user payment request is approved by user enrollment.

166. The medium of embodiment 161, wherein the user payment initiation trigger comprises a user communication message generated from the healthcare collection portal.

167. The medium of embodiment 161, wherein the user payment initiation trigger comprises user social data.

168. The medium of embodiment 167, wherein the identifying the healthcare payment command includes:

parsing the user social data;

extracting a social pay command string within the user social data; and

determining a payor identifier, a payee identifier, and a payment amount using the social pay command string.

169. The medium of embodiment 168, further storing processor-executable instructions for:

querying a database for an identifier of a funds account using the payee identifier;

determining, based on querying the database, that a payee associated with the payee identifier should be enrolled in social pay services; and

providing a request to enroll in social pay services.

170. The medium of embodiment 161, further storing processor-executable instructions for:

analyzing the healthcare payment command to determine whether the funds payment transaction should be initiated;

determining that payment verification is required from a payee of the funds payment transaction; and

generating a payment verification request using the healthcare payment command; and

providing the payment verification request.

171. The medium of embodiment 161, further storing processor-executable instructions for:

analyzing the healthcare payment command to determine whether the funds payment transaction should be initiated;

determining that the healthcare payment command is a fraudulent transaction attempt; and

providing a notification to terminate the funds payment transaction.

172. The medium of embodiment 161, further storing processor-executable instructions for:

determining that the healthcare payment command is a request for payment; and

providing an indication of the request for payment for display within a virtual wallet application.

173. The medium of embodiment 172, further storing processor-executable instructions for:

obtaining permission to initiate the funds payment transaction, in response to the provided indication of the request for payment for display within the virtual wallet application; and

wherein the funds payment transaction is initiated in response to obtaining the permission to initiate it.

174. The medium of embodiment 161, wherein the healthcare payment collection portal comprises a calling center.

175. The medium of embodiment 161, wherein the healthcare payment collection portal comprises an online bill pay website.

176. The medium of embodiment 161, wherein the healthcare payment collection portal provides a communication component for financial transaction with a financial network.

177. The medium of embodiment 161, wherein the user credentials comprises a security token.

178. The medium of embodiment 161, wherein the user credentials comprises a username and a password.

179. The medium of embodiment 161, wherein the healthcare payment collection portal comprises a profile of a healthcare provider.

180. The medium of embodiment 179, wherein the healthcare provider is required to enroll with the healthcare payment collection portal.

181. A wallet healthcare fulfillment and network efficient processor-implemented method, comprising:

obtaining, asynchronously, patient health procedure requirement information from a healthcare provider;

obtaining, asynchronously, patient health procedure payment amount authorization from a patient insurer;

obtaining, asynchronously, a patient health procedure payment authorization request from the healthcare provider, wherein the health procedure payment authorization request was generated from:
providing, asynchronously, highlighting indicia of supported payment sources to a patient funding source selection mechanism based on obtained patient health procedure requirement information, and patient health procedure payment amount authorization;
obtaining, asynchronously, a patient selection of a funding source;

determining payment authorization for the patient health procedure by obtaining the asynchronously obtained patient health procedure requirement information and patient health procedure payment authorization request via a low-latency data request;

effecting a charge of the selected funding source for the patient health procedure in an amount of the health procedure payment amount authorization;

providing the patient an option to pay any excess amount due with an alternative funding source;

providing the patient an option to obtain refund amounts due to using an alternative health care provider charging less than the patient health procedure payment authorization amount when the alternative health care provider is approved for refund provision.

182. The method of embodiment 181, wherein patient health procedure requirement information, health procedure payment amount authorization, patient health procedure payment authorization requests are asynchronously obtained at an access controlled social media network portal, and wherein low bandwidth requests for limited access control obtained information may be provided on demand to any of health care providers, patient insurers, issuers, payment networks, acquirers, and patients.

183. A wallet healthcare fulfillment and network efficient system, comprising:

a memory;

a processor disposed in communication with said memory, and configured to issue a plurality of processing instructions stored in the memory, wherein the processor issues instructions to:

obtain, asynchronously, patient health procedure requirement information from a healthcare provider;

obtain, asynchronously, patient health procedure payment amount authorization from a patient insurer;

obtain, asynchronously, a patient health procedure payment authorization request from the healthcare provider, wherein the health procedure payment authorization request was generated from:

provide, asynchronously, highlighting indicia of supported payment sources to a patient funding source selection mechanism based on obtained patient health procedure requirement information, and patient health procedure payment amount authorization;

obtain, asynchronously, a patient selection of a funding source;

determine payment authorization for the patient health procedure by obtaining the asynchronously obtained patient health procedure requirement information and patient health procedure payment authorization request via a low-latency data request;

effect a charge of the selected funding source for the patient health procedure in an amount of the health procedure payment amount authorization;

provide the patient an option to pay any excess amount due with an alternative funding source;

provide the patient an option to obtain refund amounts due to using an alternative health care provider charging less than the patient health procedure payment authorization amount when the alternative health care provider is approved for refund provision.

184. The system of embodiment 183, wherein patient health procedure requirement information, health procedure payment amount authorization, patient health procedure payment authorization requests are asynchronously obtained at an access controlled social media network portal, and wherein low bandwidth requests for limited access control obtained information may be provided on demand to any of health care providers, patient insurers, issuers, payment networks, acquirers, and patients.

185. A processor-readable storing wallet healthcare fulfillment and network efficient processor-executable instructions issuable by a processor to:

obtain, asynchronously, patient health procedure requirement information from a healthcare provider;

obtain, asynchronously, patient health procedure payment amount authorization from a patient insurer;

obtain, asynchronously, a patient health procedure payment authorization request from the healthcare provider, wherein the health procedure payment authorization request was generated from:

provide, asynchronously, highlighting indicia of supported payment sources to a patient funding source selection mechanism based on obtained patient health procedure requirement information, and patient health procedure payment amount authorization;

obtain, asynchronously, a patient selection of a funding source;

determine payment authorization for the patient health procedure by obtaining the asynchronously obtained patient health procedure requirement information and patient health procedure payment authorization request via a low-latency data request;

effect a charge of the selected funding source for the patient health procedure in an amount of the health procedure payment amount authorization;

provide the patient an option to pay any excess amount due with an alternative funding source;

provide the patient an option to obtain refund amounts due to using an alternative health care provider charging less than the patient health procedure payment authorization amount when the alternative health care provider is approved for refund provision.

186. The medium of embodiment 185, wherein patient health procedure requirement information, health procedure payment amount authorization, patient health procedure payment authorization requests are asynchronously obtained at an access controlled social media network portal, and wherein low bandwidth requests for limited access control obtained information may be provided on demand to any of health care providers, patient insurers, issuers, payment networks, acquirers, and patients.

In order to address various issues and advance the art, the entirety of this application for HEALTHCARE WALLET PAYMENT PROCESSING APPARATUSES, METHODS AND SYSTEMS (including the Cover Page, Title, Headings, Field, Background, Summary, Brief Description of the Drawings, Detailed Description, Claims, Abstract, FIGUREs, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a H-Wallet individual and/or enterprise user, database configuration and/or relational model, data type, data transmission and/or network framework, syntax structure, and/or the like, various embodiments of the H-Wallet, may be implemented that enable a great deal of flexibility and customization. For example, aspects of the H-Wallet may be adapted for gas/electricity corporate account payment. While various embodiments and discussions of the H-Wallet have been directed to healthcare claim, however, it is to be understood that the embodiments described herein may be readily configured and/or customized for a wide variety of other applications and/or implementations.

What is claimed is:

1. A processor-implemented healthcare user payment method, comprising:
obtaining a user healthcare payment request including user credentials;
retrieving healthcare product details and a payment amount from the user healthcare payment request;
obtaining balance information of a plurality of user accounts;
determining a recommended account for the obtained user healthcare payment request based on the retrieved healthcare product details, payment amount and the obtained balance information;
transmitting a list of user accounts including the recommended account with the obtained balance information to a user mobile device;
receiving a user selection of a payment account from said list of user accounts;
verifying payment eligibility of the payment account for the obtained payment request; and
processing fund transfer from the payment account to a healthcare provider.

2. The method of claim 1, wherein the user healthcare payment request is received via a user electronic wallet instantiated on the user mobile device.

3. The method of claim 1, wherein the user credentials include a user name and a password.

4. The method of claim 1, wherein the user healthcare payment request is received from a healthcare provider point of sale terminal.

5. The method of claim 1, wherein the healthcare product details include a healthcare procedure code.

6. The method of claim 1, wherein the healthcare product details include a product category.

7. The method of claim 1, wherein the payment amount is provided in a medical bill generated by the healthcare provider.

8. The method of claim 1, wherein the obtaining balance information comprises:
transmitting an access request to an account manager, said access request including a secure token; and
receiving balance information from the account manager upon verification of the secure token.

9. The method of claim 1, wherein the user accounts comprises any of a credit card account, a debit account, and an investment account.

10. The method of claim 1, wherein the user accounts comprises a restricted use account.

11. The method of claim 10, wherein the restricted use account comprises any of: a Flexible Spending Account (FSA), and a Health Savings Accounts (HSA).

12. The method of claim 1, wherein the restricted use account comprises one or more government sponsored accounts, including any of Medicare and Medicaid.

13. The method of claim 1, wherein the restricted use account comprises an employer sponsored healthcare benefit account.

14. The method of claim 1, further comprising: determining whether the retrieved healthcare product details are eligible for a restricted use account.

15. The method of claim 1, further comprising: determining whether there is sufficient balance on the user selected account to fulfill the payment amount.

16. The method of claim 1, further comprising: providing a prioritized list of payment accounts showing the recommended account placed on top of the list.

17. The method of claim 1, further comprising:
receiving an approval from a restricted use account sponsor when the healthcare product details comply with restricted use account rules.

18. The method of claim 1, further comprising:
receiving multiple user selected accounts for the payment request and a user entered split payment amount associated with each of the multiple user selected accounts.

19. A healthcare user payment system, comprising:
a memory;
a processor disposed in communication with said memory, and configured to issue a plurality of processing instructions stored in the memory, wherein the processor issues instructions to:
obtain a user healthcare payment request including user credentials;
retrieve healthcare product details and a payment amount from the user healthcare payment request;
obtain balance information of a plurality of user accounts;
determine a recommended account for the obtained user healthcare payment request based on the retrieved healthcare product details, payment amount and the obtained balance information;
transmit a list of user accounts including the recommended account with the obtained balance information to a user mobile device;
receive a user selection of a payment account from said list of user accounts;
verify payment eligibility of the payment account for the obtained payment request; and
process fund transfer from the payment account to a healthcare provider.

20. A healthcare user payment processor-readable storage medium storing processor-executable instructions to:
obtain a user healthcare payment request including user credentials;
retrieve healthcare product details and a payment amount from the user healthcare payment request;
obtain balance information of a plurality of user accounts;
determine a recommended account for the obtained user healthcare payment request based on the retrieved healthcare product details, payment amount and the obtained balance information;
transmit a list of user accounts including the recommended account with the obtained balance information to a user mobile device;
receive a user selection of a payment account from said list of user accounts;
verify payment eligibility of the payment account for the obtained payment request; and
process fund transfer from the payment account to a healthcare provider.
